(19) United States
(12) Patent Application Publication
(10) Pub. No.: US 2006/0133079 A1
(43) Pub. Date: Jun. 22, 2006

(54) Lighting systems and components thereof

(76) Inventor: Michael Callahan, New York, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/911,028

(22) Filed: Aug. 4, 2004

Related U.S. Application Data
(63) Continuation-in-part of application No. 10/403,651, filed on Mar. 31, 2003.
(60) Provisional application No. 60/492,537, filed on Aug. 5, 2003.
(60) Provisional application No. 60/523,530, filed on Nov. 19, 2003.

(51) Int. Cl. F21V 13/00

(52) U.S. Cl. 362/242

(57) ABSTRACT

A lighting system including various improvements is disclosed. Fixtures can accept lamps of differing variants and types in the same lamp socket without damage and with automatic connection to the appropriate power. Telescoping fixture housings and an optical system in which compound optical arrays produce multiple parallel beams and focal points reduce fixture size. A multi-stage color-mixing system efficiently produces both saturated colors and tints from a simple mechanism comparable in complexity and cost to prior art systems. Such fixtures can be packaged to ship contained entirely within prior art rigid truss, deploying to “use” position with little or no effort. A unified system supplies power and control to such fixtures, both “conventional” and “automated” as well as chain motors using the same power and data multi-cable cable. And both trusses and shipping cases are fabricated from simple structural shapes.

This application relates to lighting equipment and systems and improvements thereto. It represents a continuation-in-part of application Ser. No.10/403,651, filed Mar. 31, 2003 and incorporates and claims benefit to provisional applications 60/492,537 filed Aug. 5, 2003 and 60/523,530 filed Nov. 19, 2003.

### BRIEF DESCRIPTION OF THE INVENTION

The application discloses improvements to lighting equipment and systems.

### BRIEF DESCRIPTION OF THE DRAWINGS

FIG. 1A illustrates a prior art lamp/socket arrangement.

FIG. 1B illustrates one prior art application of different lamp variants.

FIG. 1C illustrates another prior art application of different lamp variants.

FIG. 1D illustrates an improved lamp/socket arrangement that circuits different lamp variants differently.

FIG. 1E illustrates an improved lamp/socket arrangement circuiting different lamp variants to different connectors.

FIG. 1F illustrates an improved lamp/socket arrangement including changeable power leads.

FIG. 1G illustrates an improved lamp/socket arrangement including a changeable socket assembly.

FIG. 1H illustrates an improved lamp/socket arrangement providing for reversible diode insertion.

FIG. 1I illustrates an improved lamp/socket arrangement and a semiconductor power control means.

FIG. 1J is a detail view of an alternate semiconductor power control means topology.

FIG. 1K illustrates an improved lamp/socket arrangement and provides for both line-voltage and half-wave lamp variants and reverses half-wave polarity by reversing the lamp in the socket.

FIG. 1L illustrates an improved lamp/socket arrangement in which a half-wave lamp variant incorporates a diode and reversing the lamp in the socket reverses polarity.

FIG. 1M illustrates an improved lamp/socket arrangement in which two different lamp types are supplied.

FIG. 1N illustrates an improved lamp/socket arrangement providing separate power control/conditioning for different lamp types.

FIG. 1O illustrates an improved lamp/socket arrangement providing both common and separate components for two lamp types.

FIG. 1PA is an end elevation of an improved lamp socket seen from the lamp side.

FIG. 1PB is a section through the improved lamp socket illustrated in FIG. 1PA.

FIG. 1PC is a section through the improved lamp socket illustrated in FIG. 1PA, through a plane rotated 90 degrees from the plane of FIG. 1PB.

FIG. 1PD is an end elevation of the base of one lamp from the socket side.

FIG. 2PE is a side elevation of the lamp illustrated in FIG. 2PD.

FIG. 2PF is an end elevation of the base of the lamp of the prior two Figures rotated 90 degrees.

FIG. 2PG is a side elevation of the lamp of the prior three Figures rotated 90 degrees relative to the elevation of FIG. 2PE.

FIG. 2PH is an end elevation of a different lamp seen from the socket side.

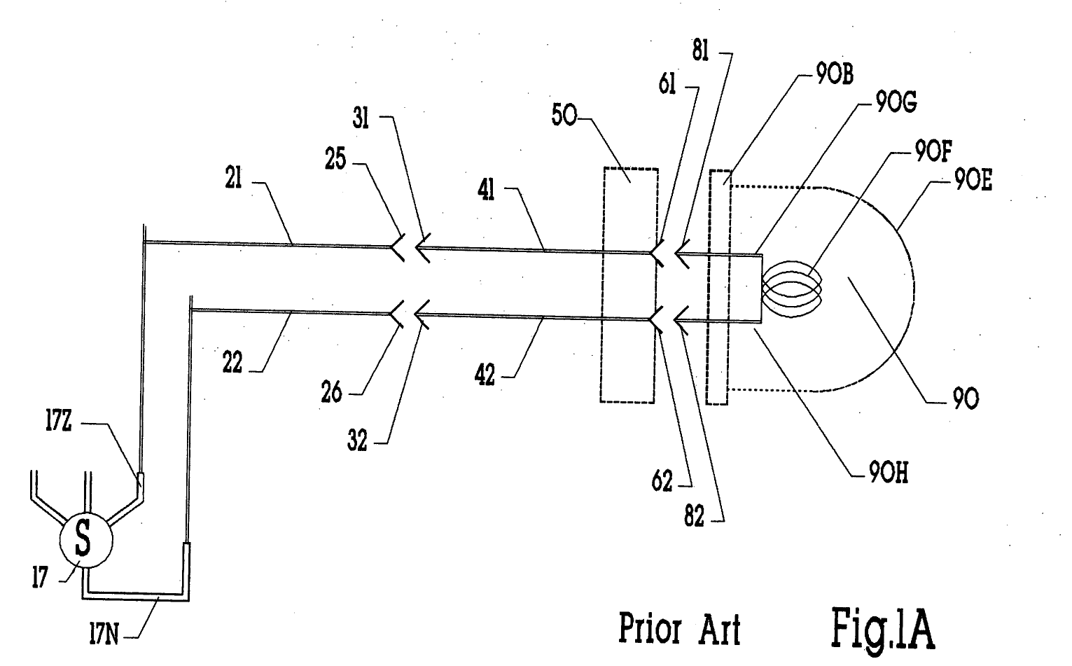

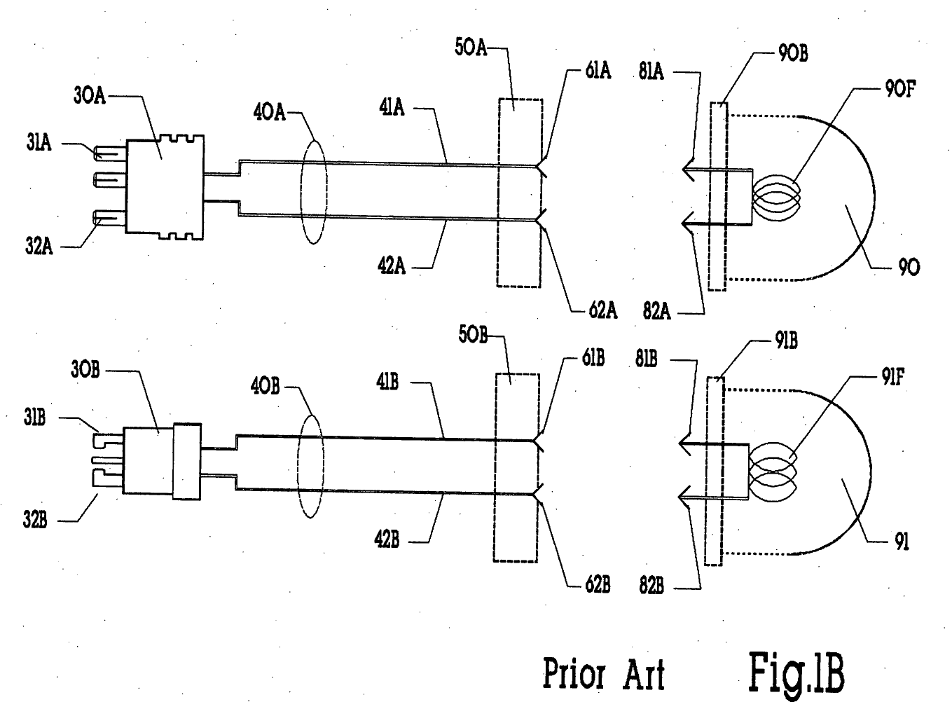

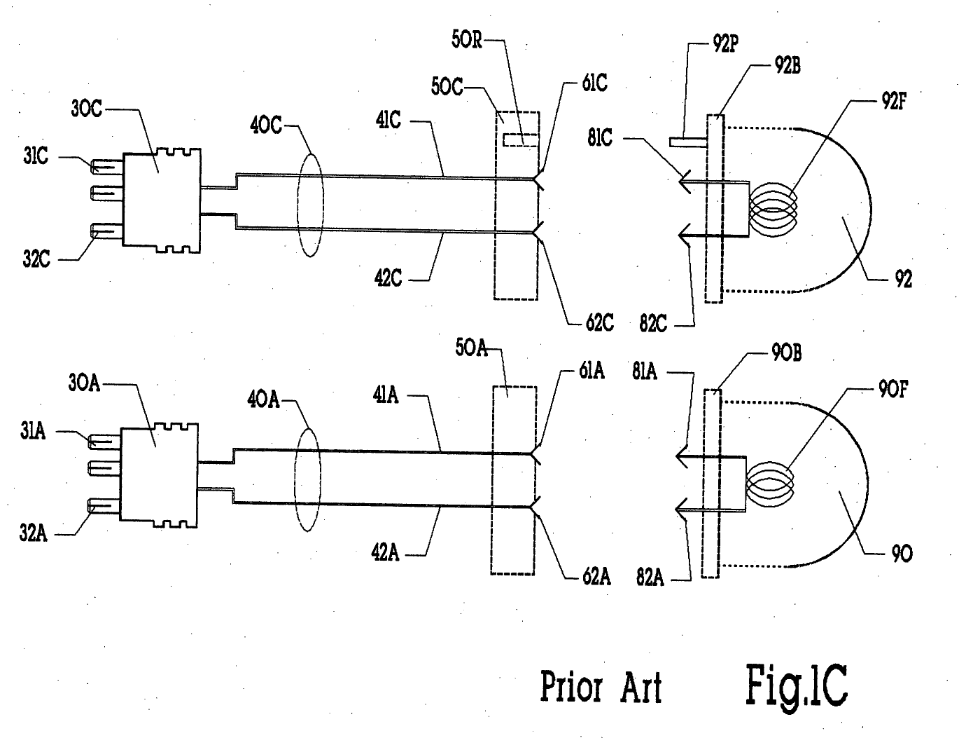

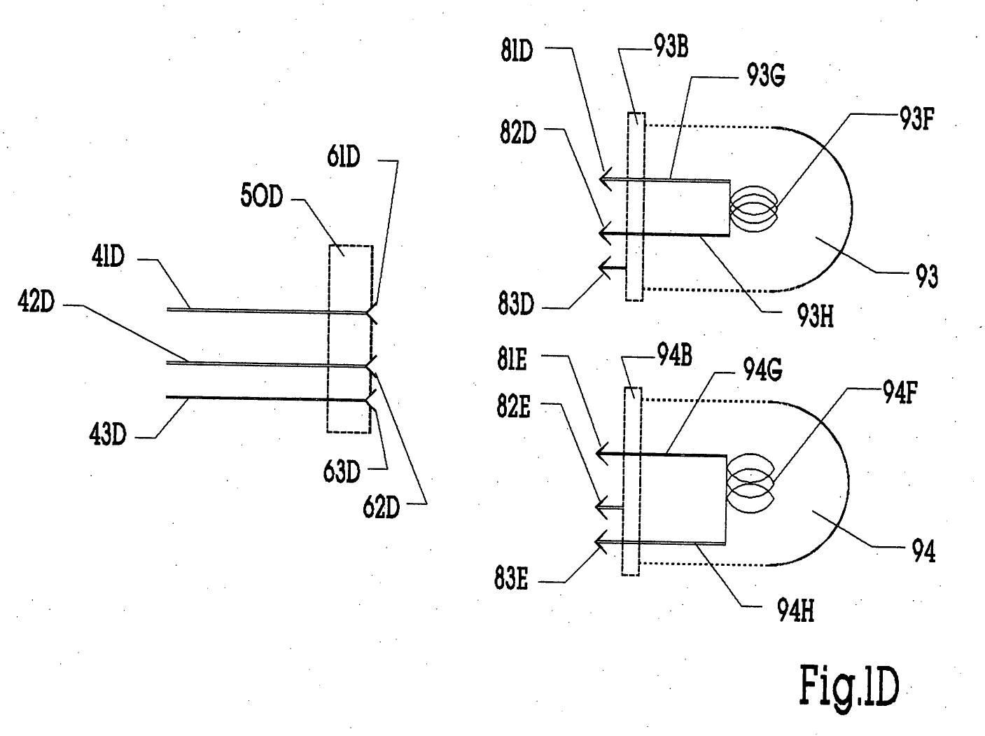

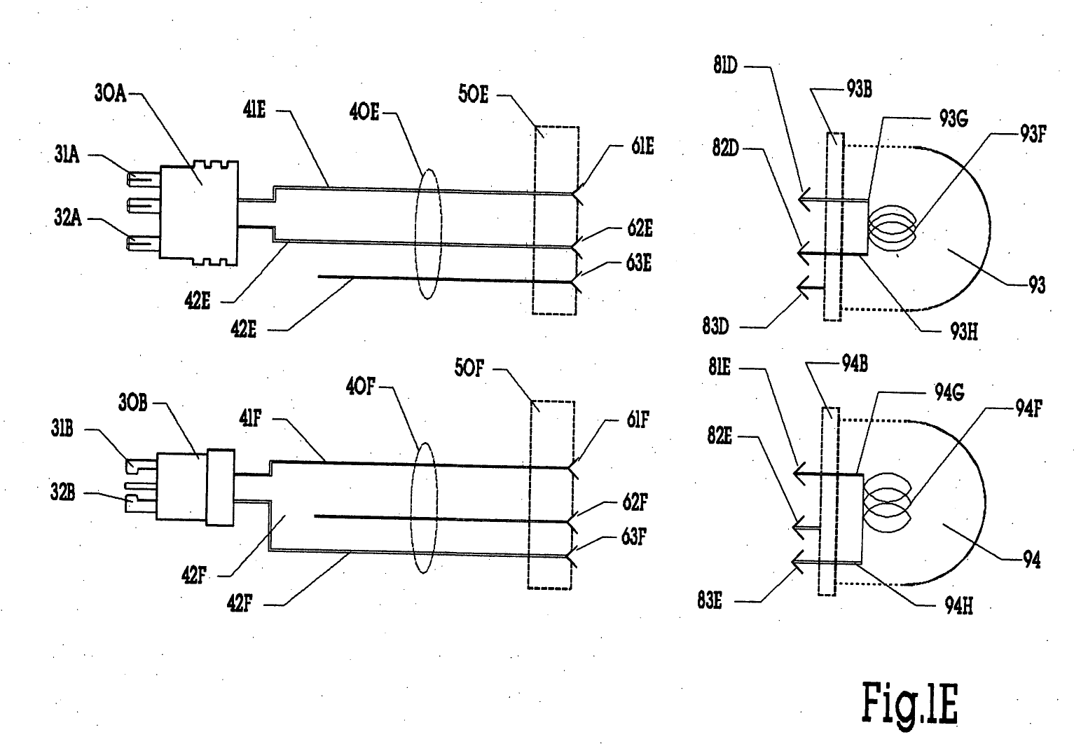

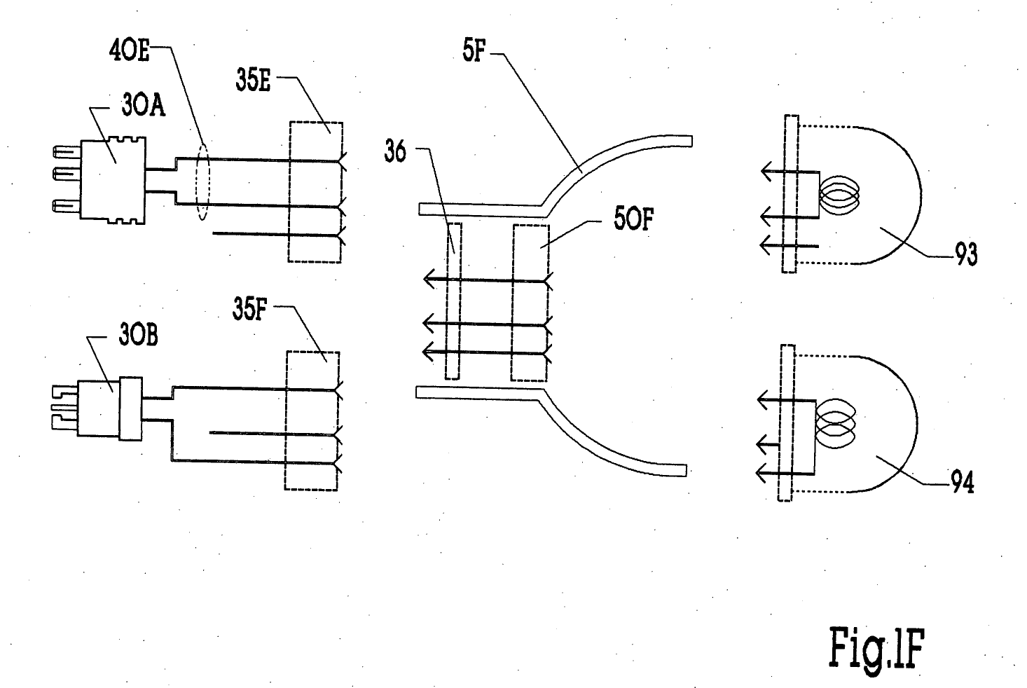

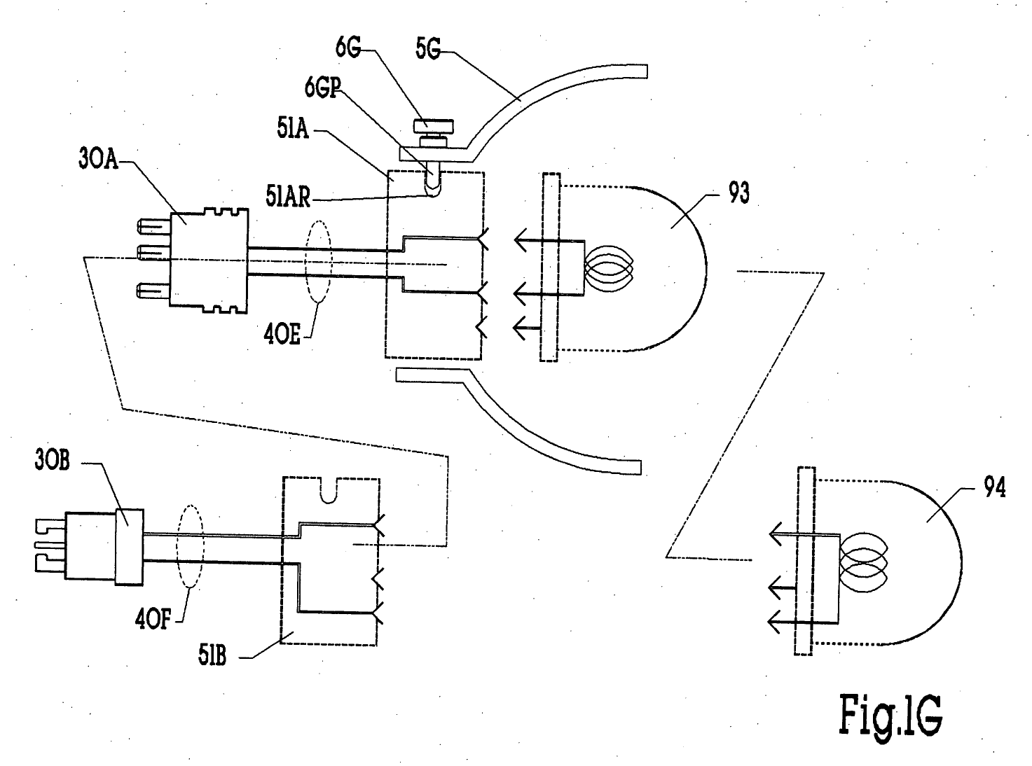

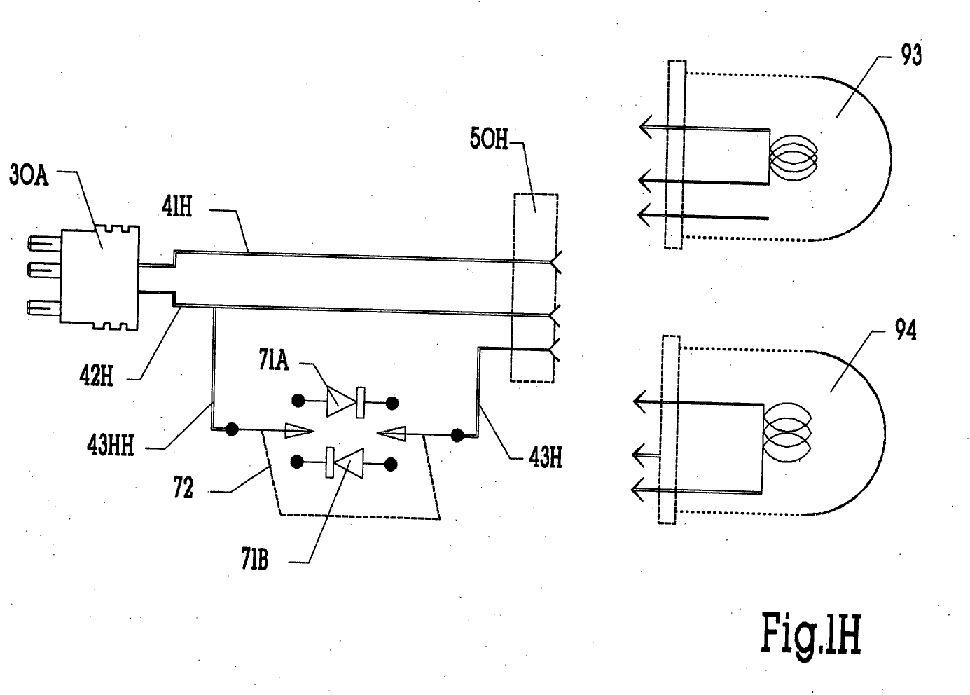

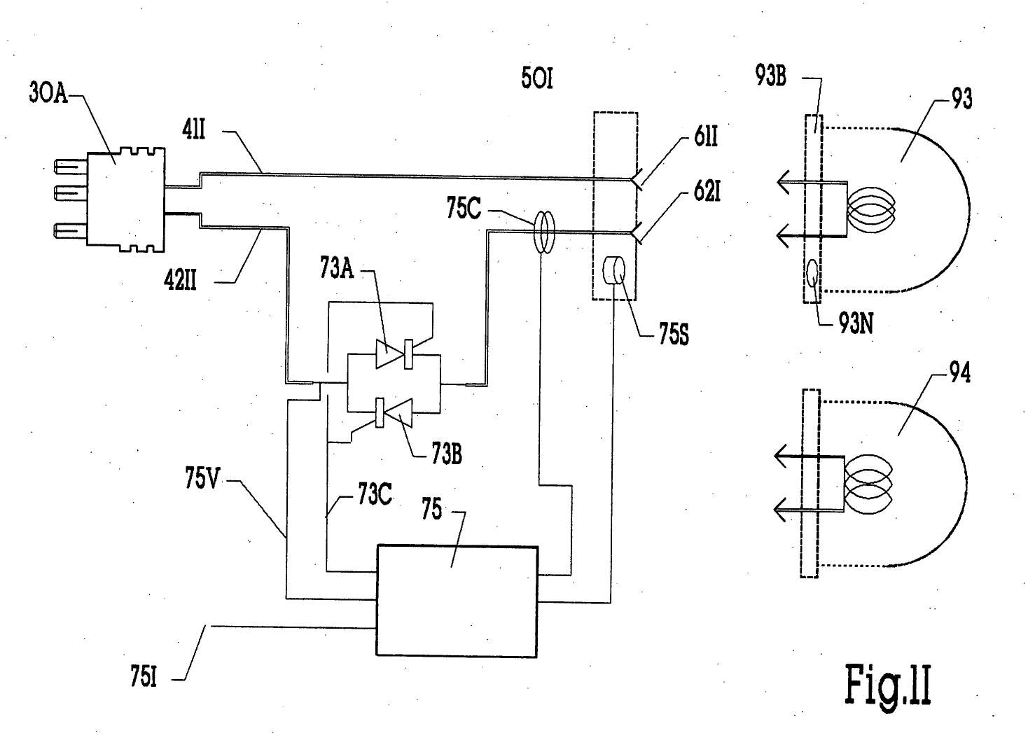

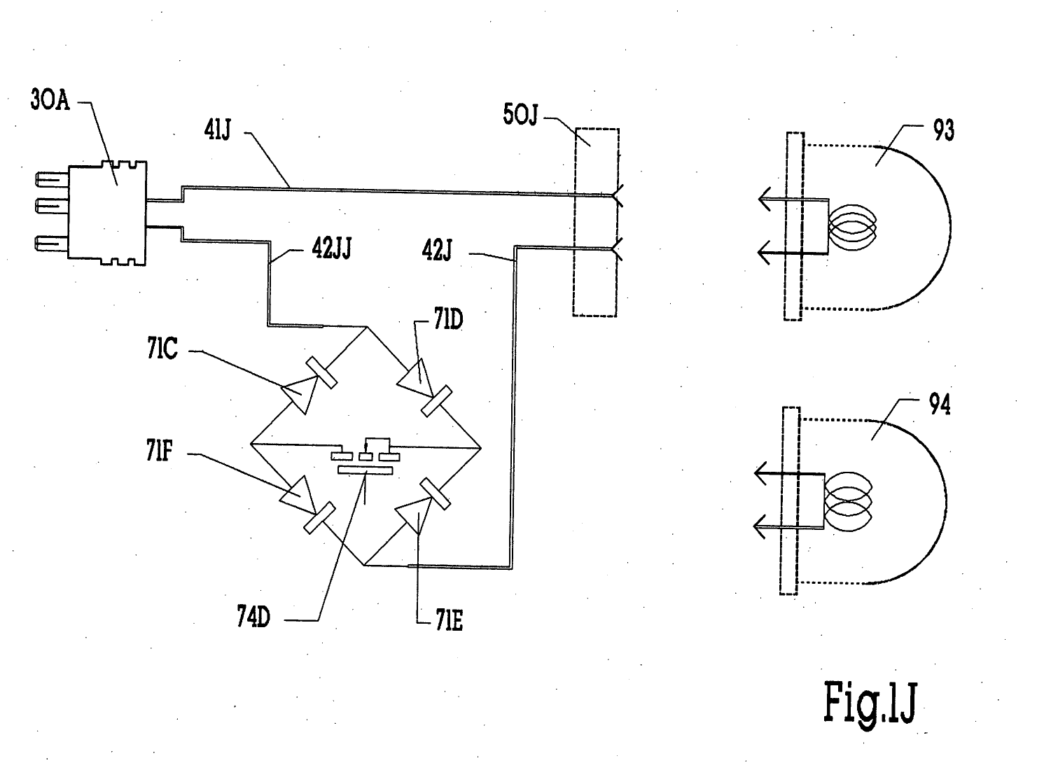

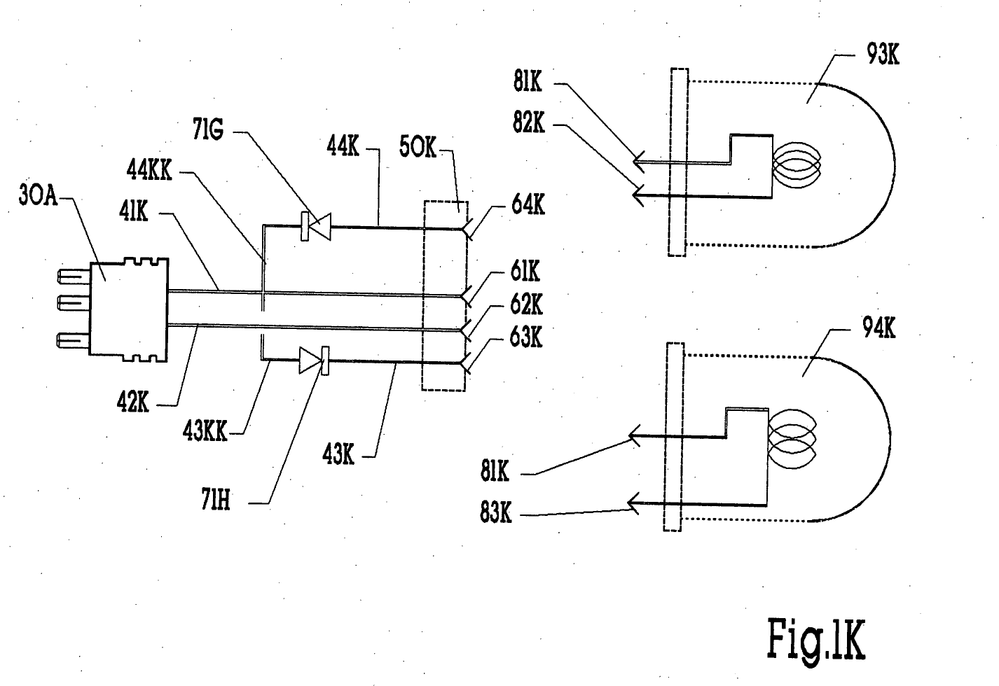

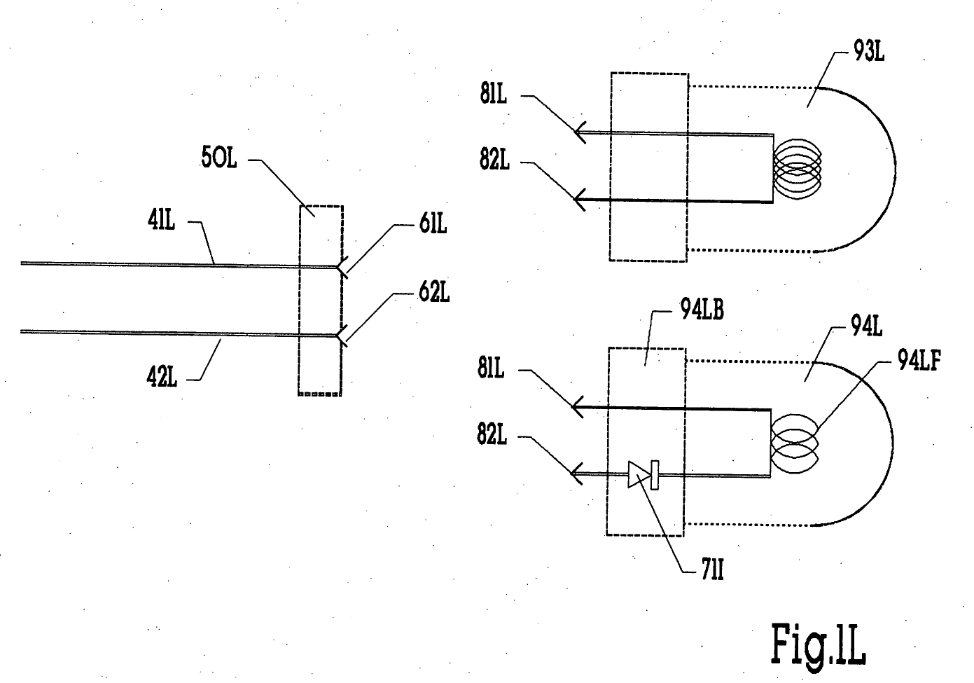

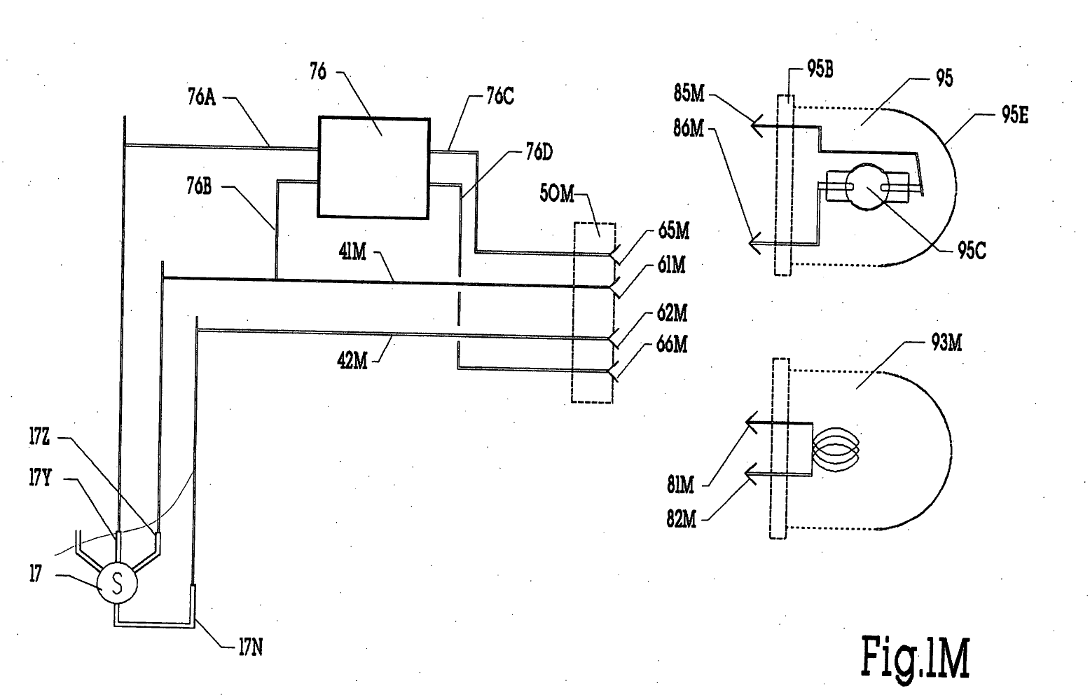

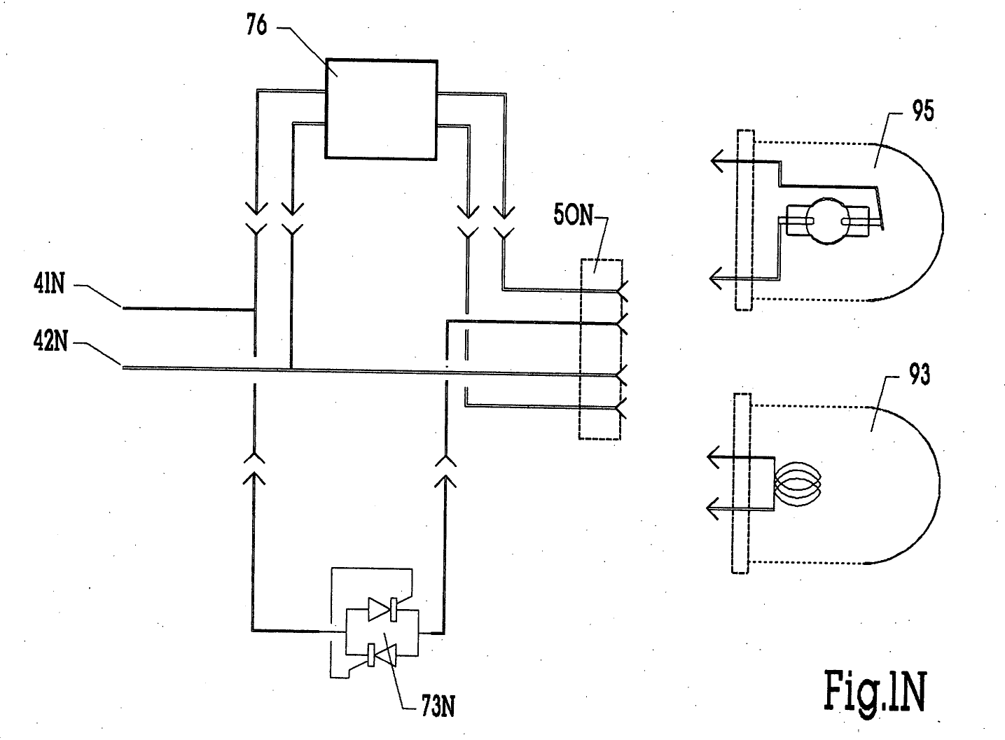

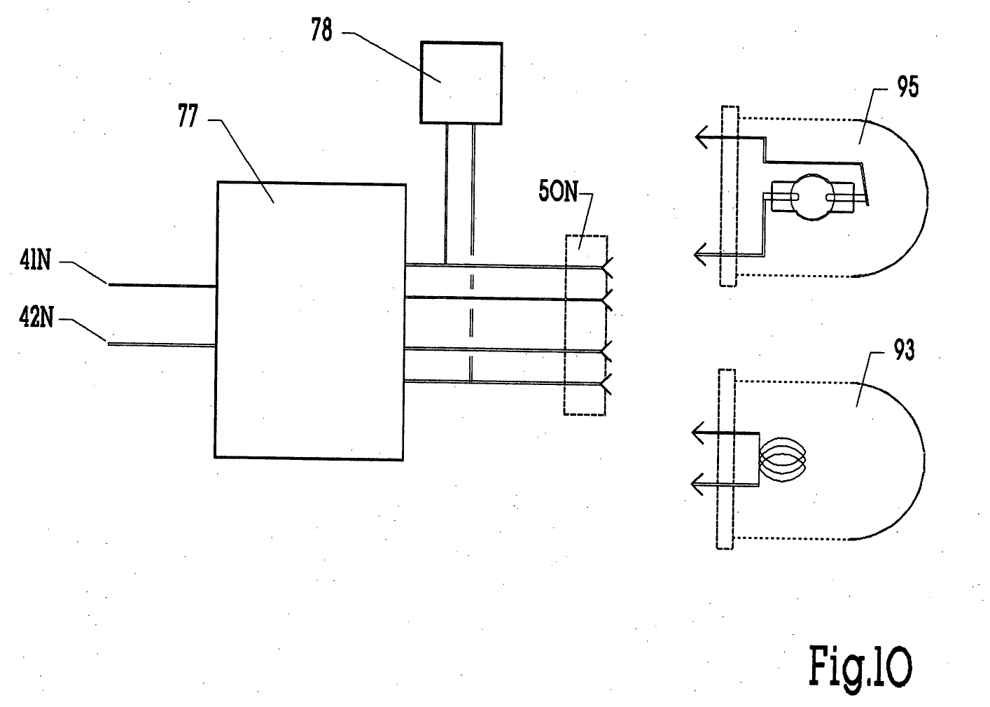

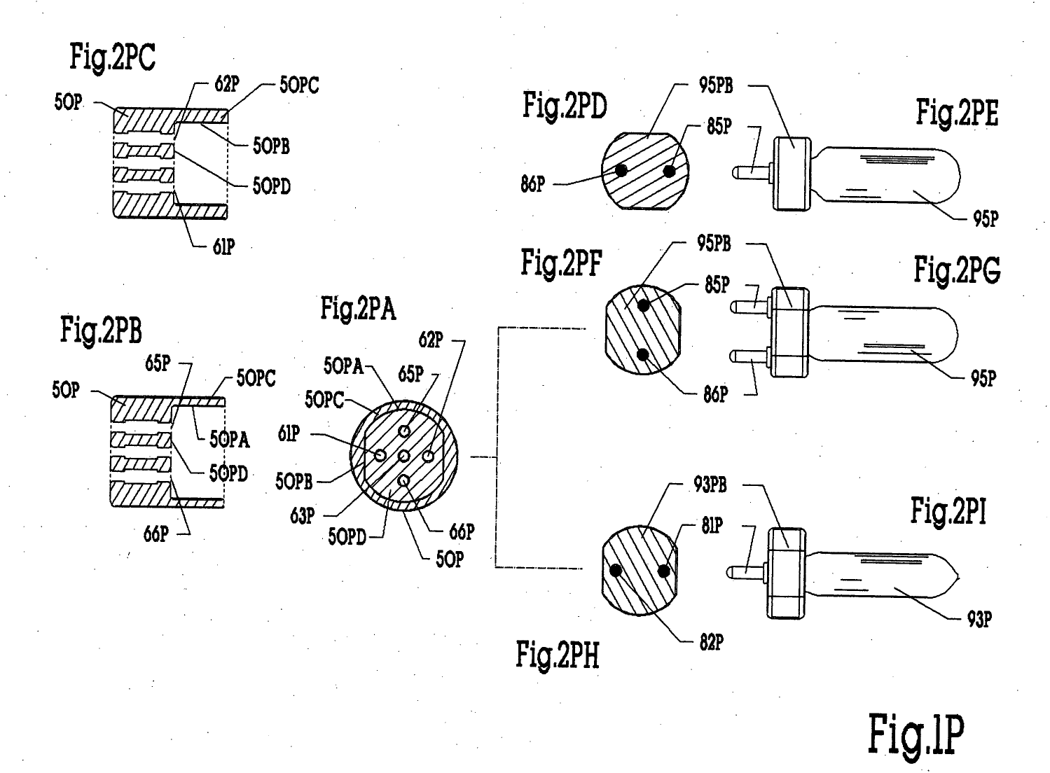

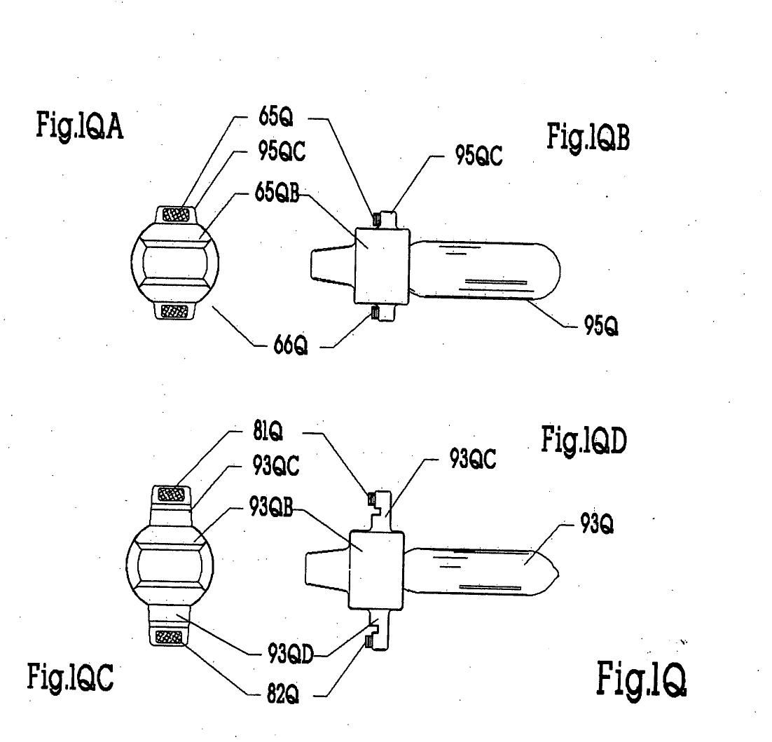

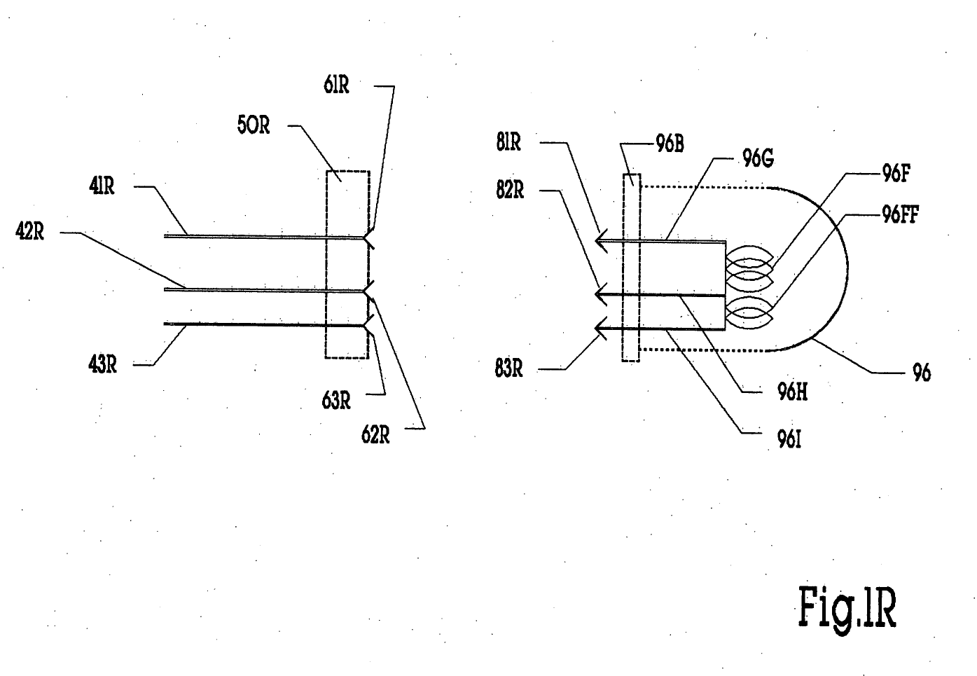

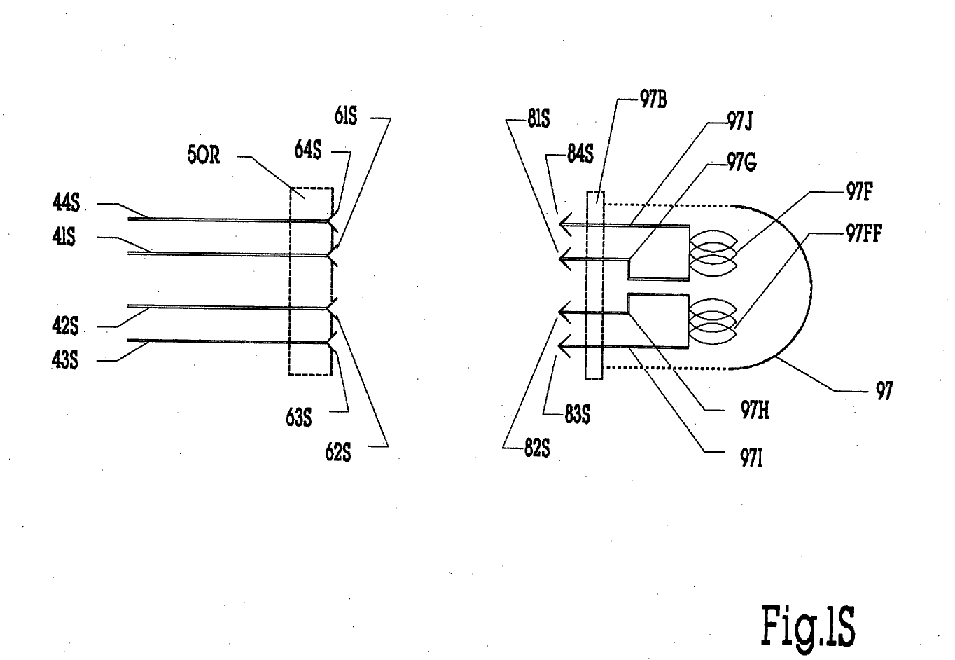

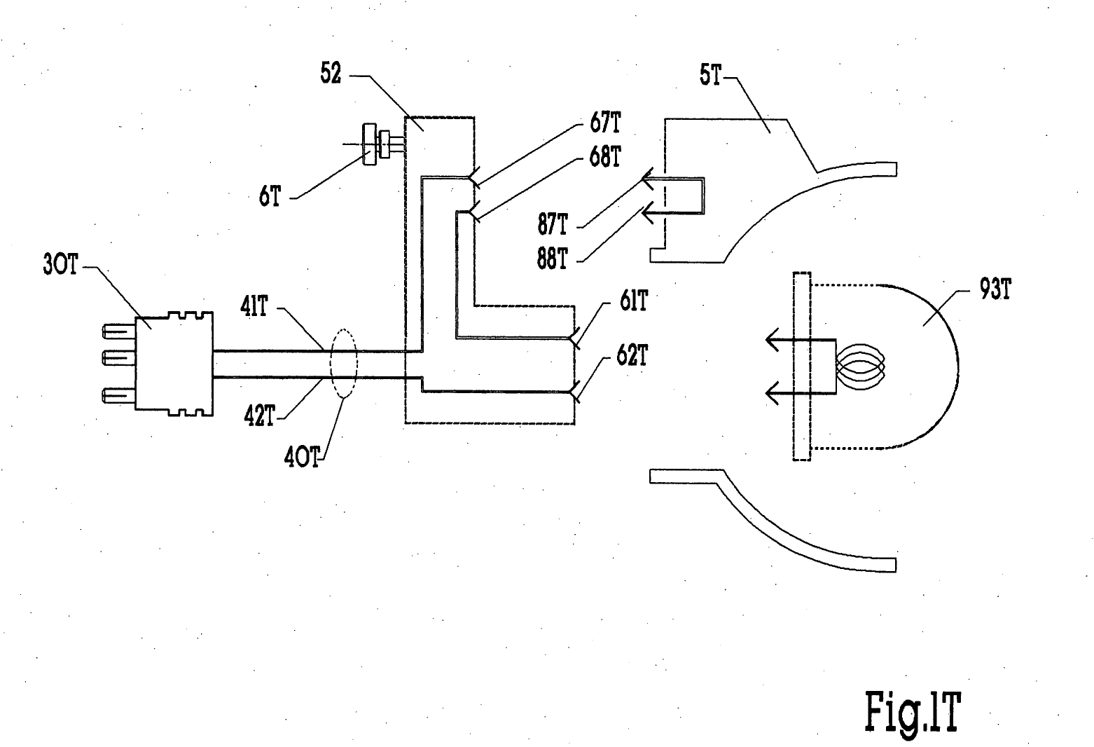

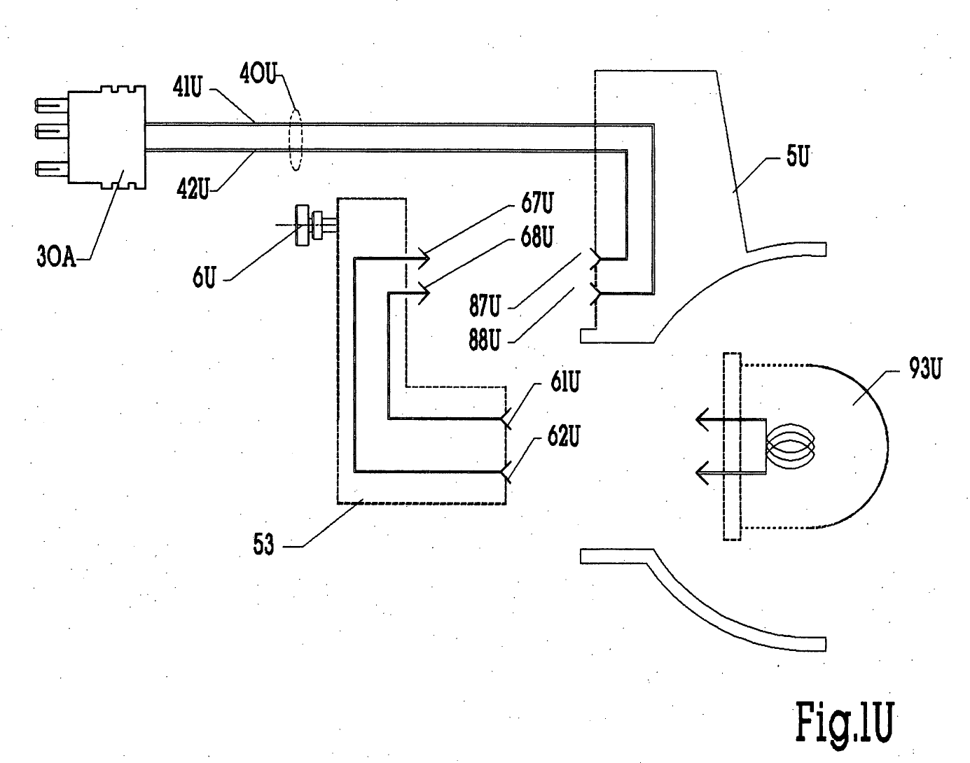

FIG. 1PI is a side elevation of the different lamp of the prior Figure.

FIG. 1QA is an end elevation of one lamp of a different base design than the prior Figures.

FIG. 1QB is a side elevation of the lamp of the prior Figure.

FIG. 1QC is an end elevation of another lamp of the different base design illustrated in the prior two Figures.

FIG. 1QD is a side elevation of the lamp of the prior Figure.

FIG. 1R illustrates an improved lamp/socket design that permits the selective energization of one or more of a plurality of filaments in a lamp.

FIG. 1S illustrates an improved lamp/socket design that permits the selective circuiting and energization of one or more of a plurality of filaments in a lamp.

FIG. 1T illustrates an improved design in which an assembly including lamp socket is energized on insertion in the fixture.

FIG. 1U illustrates another improved design in which an assembly including lamp socket is energized on insertion in the fixture.

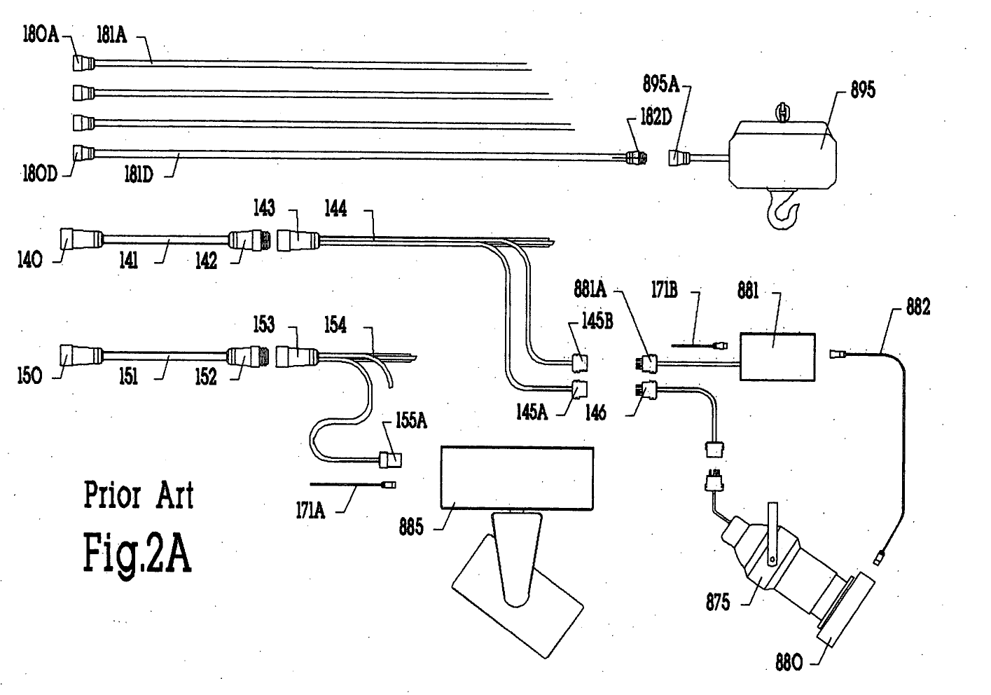

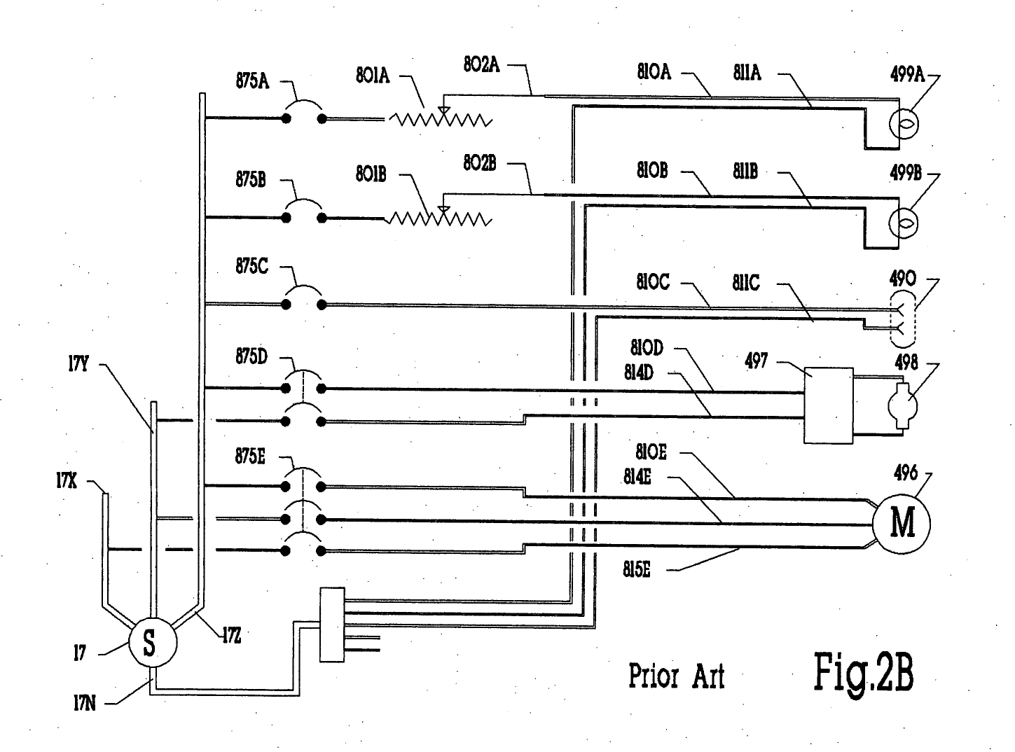

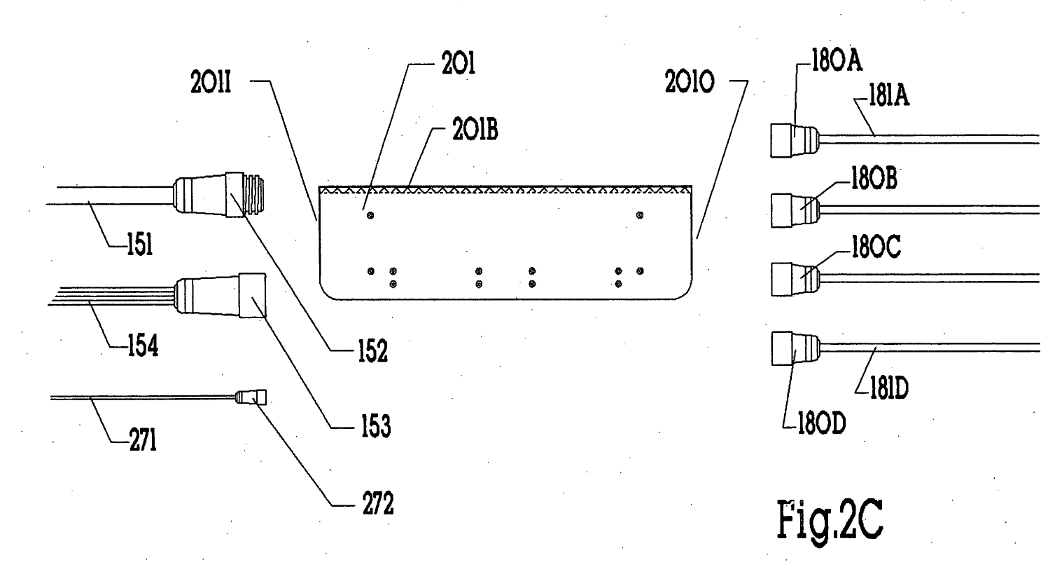

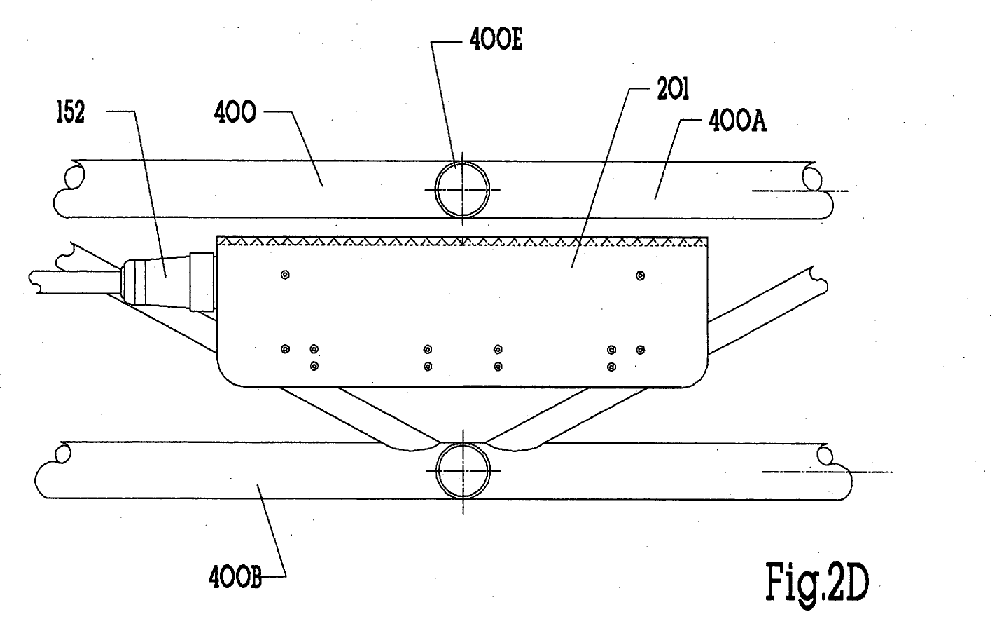

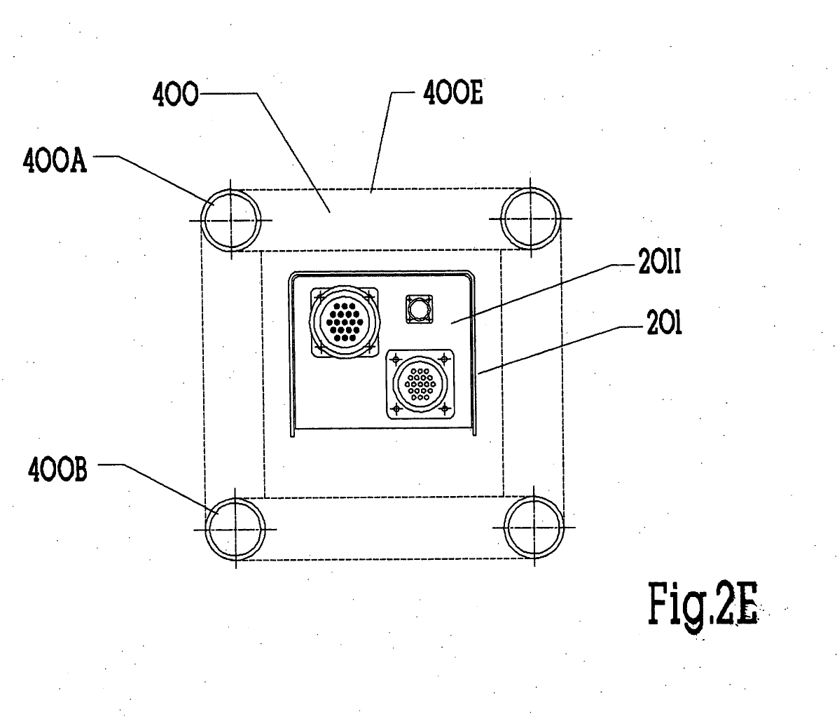

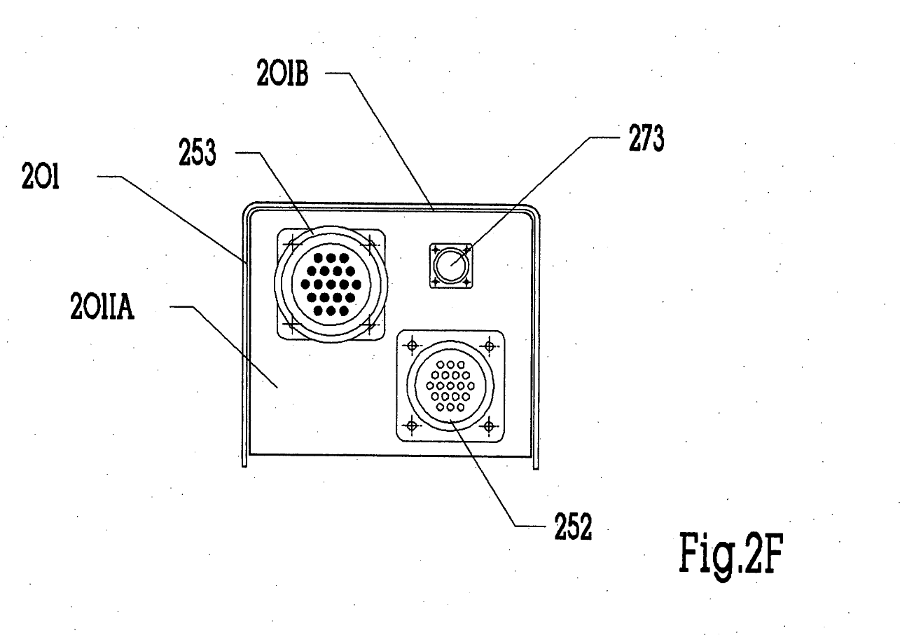

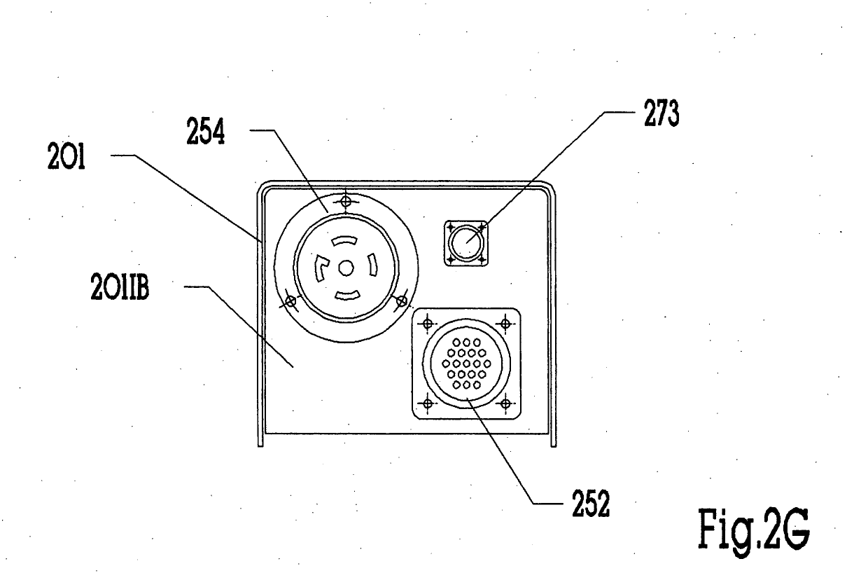

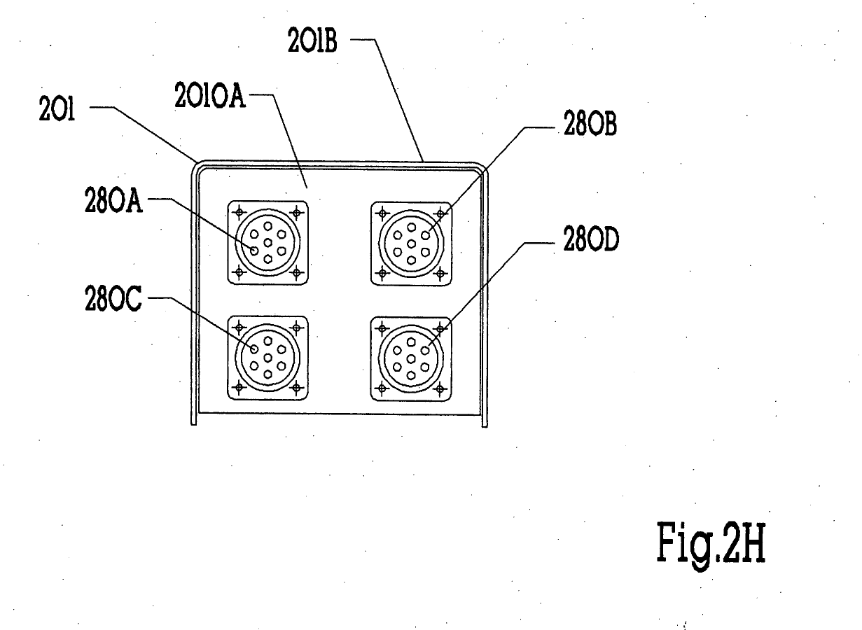

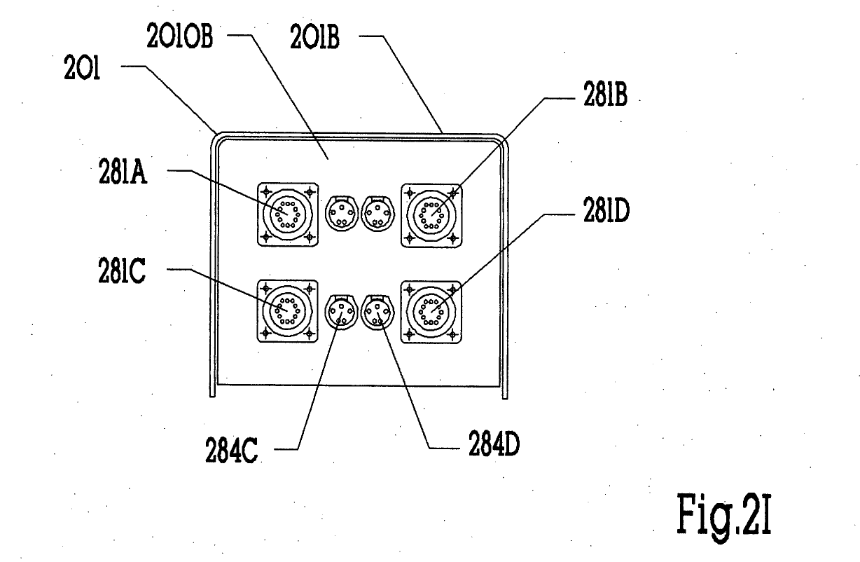

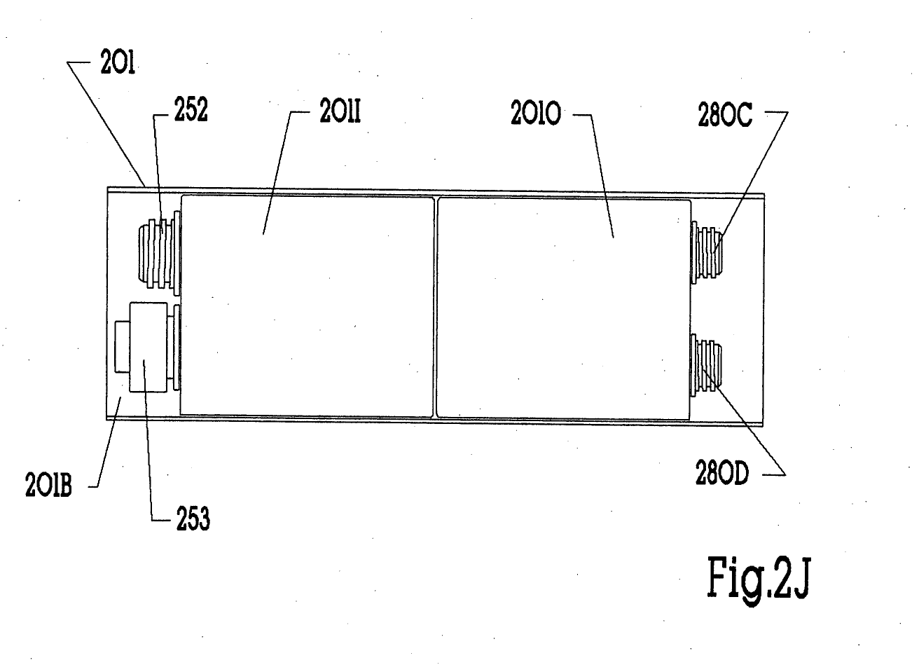

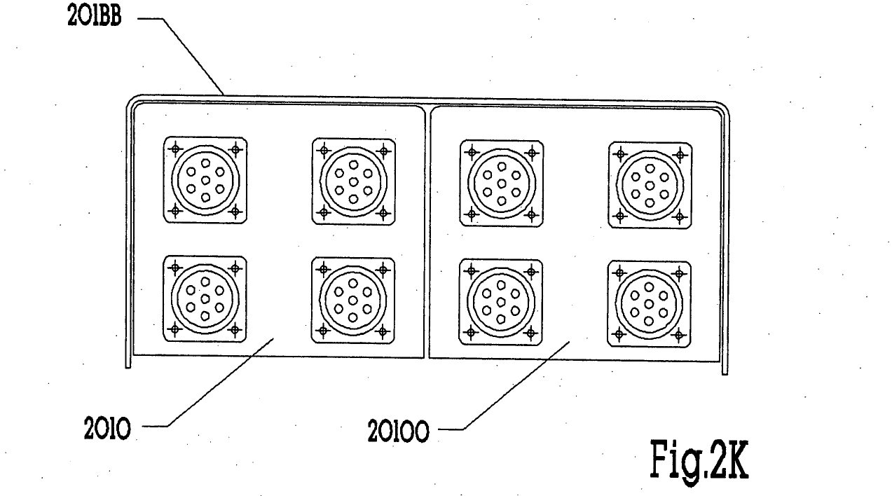

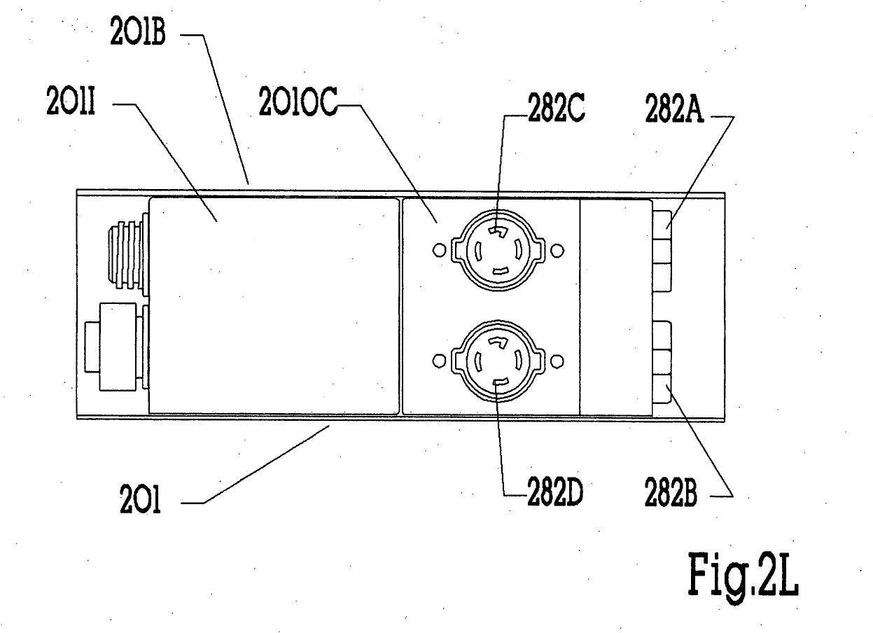

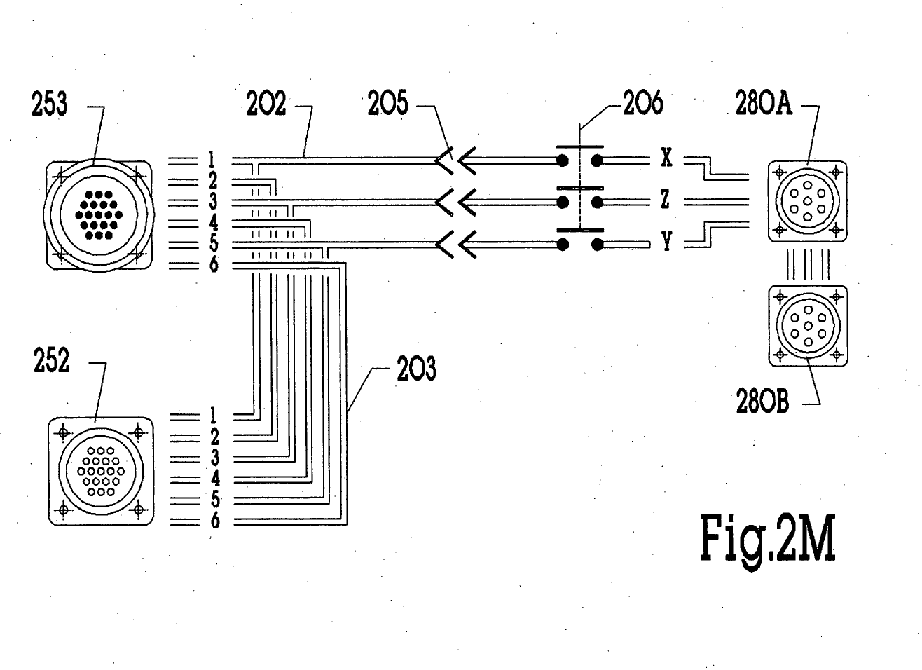

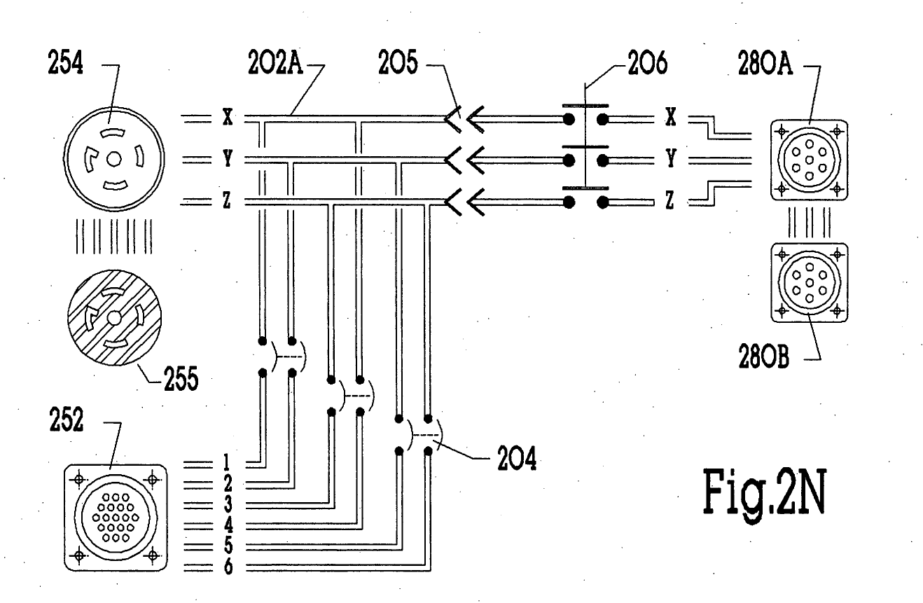

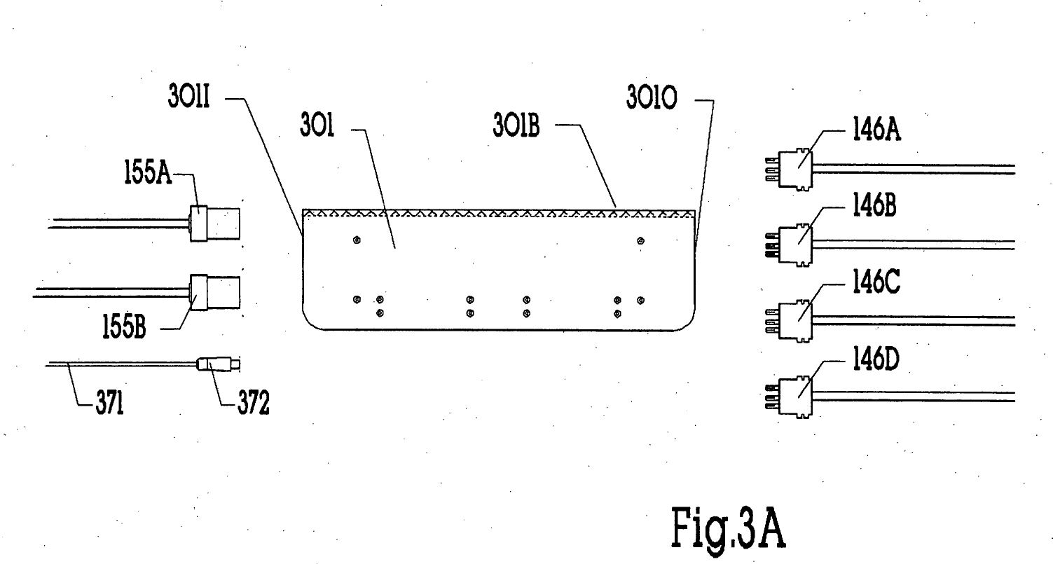

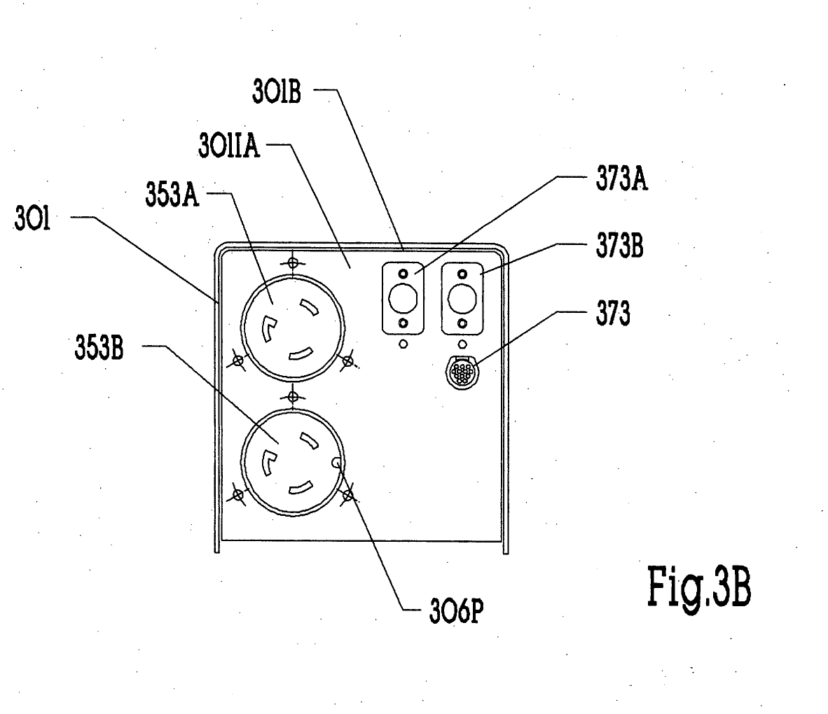

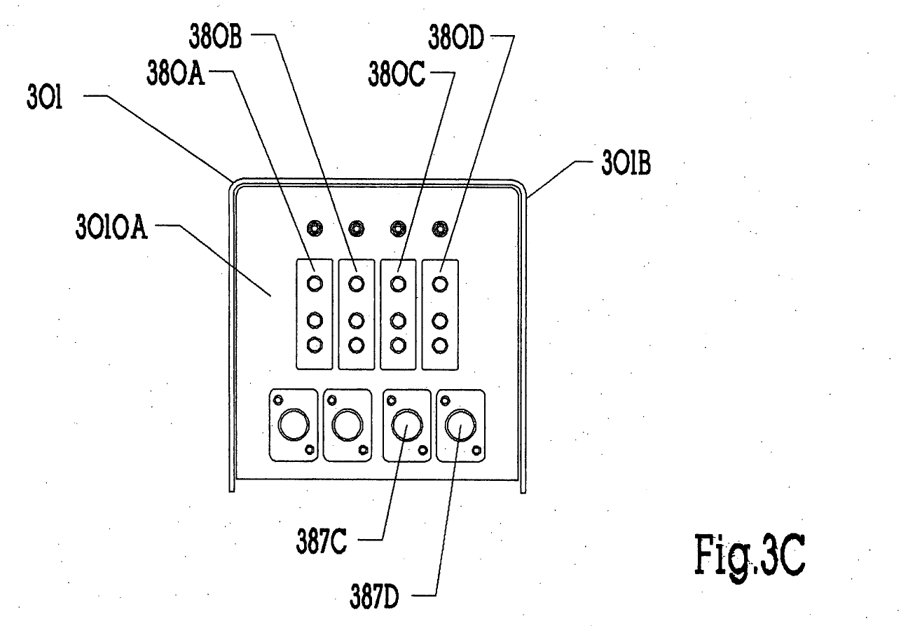

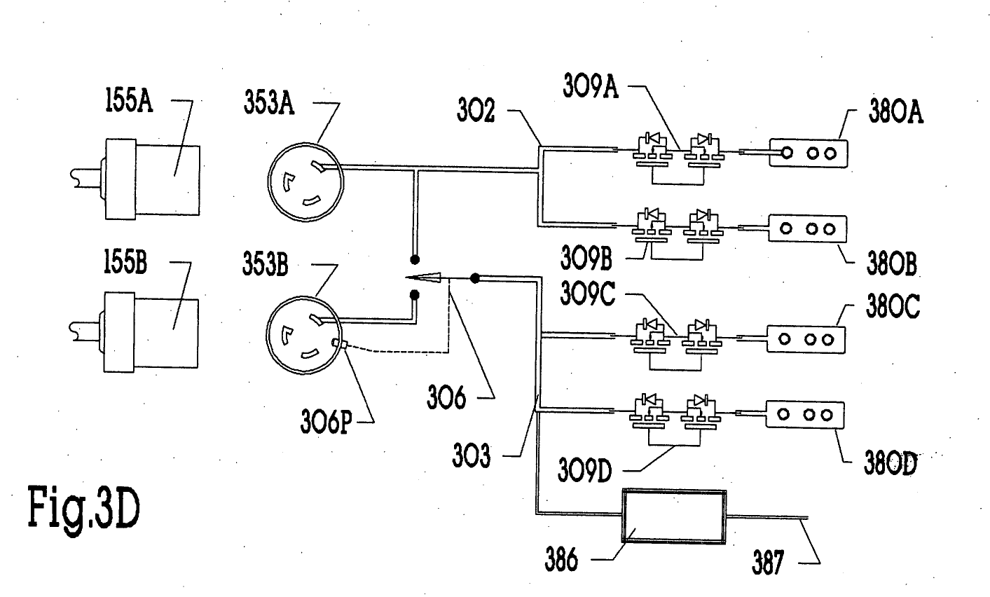

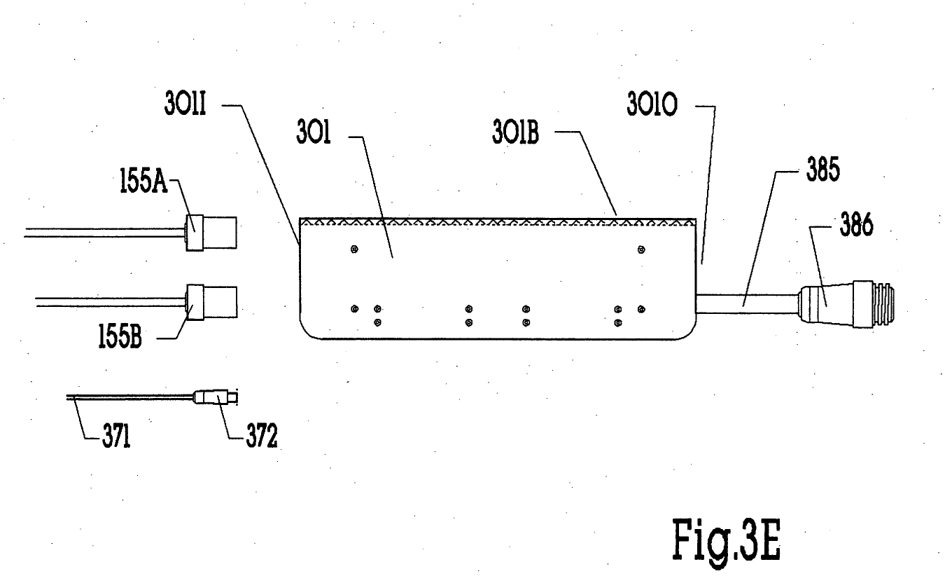

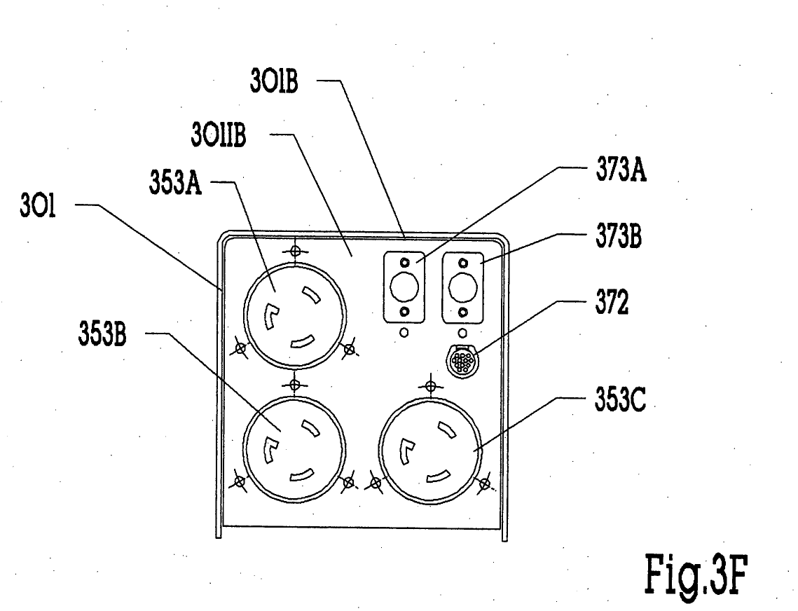

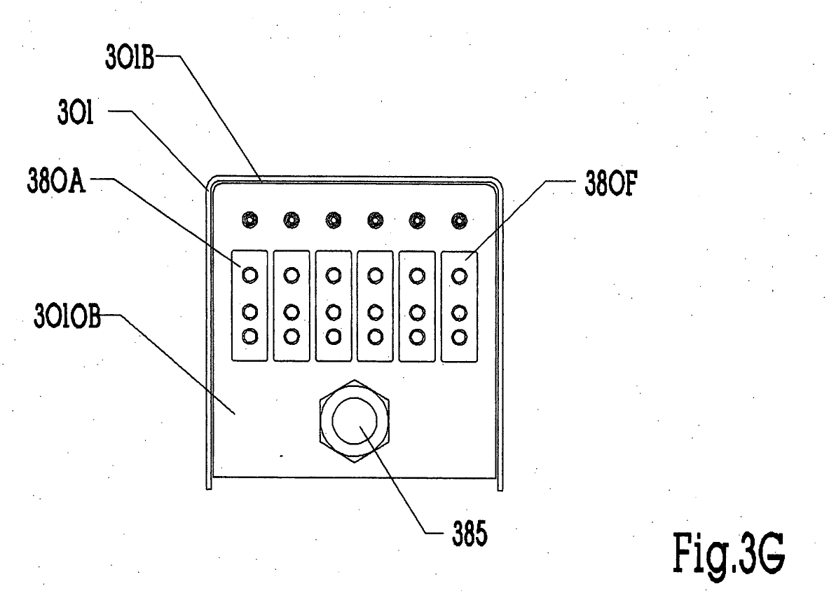

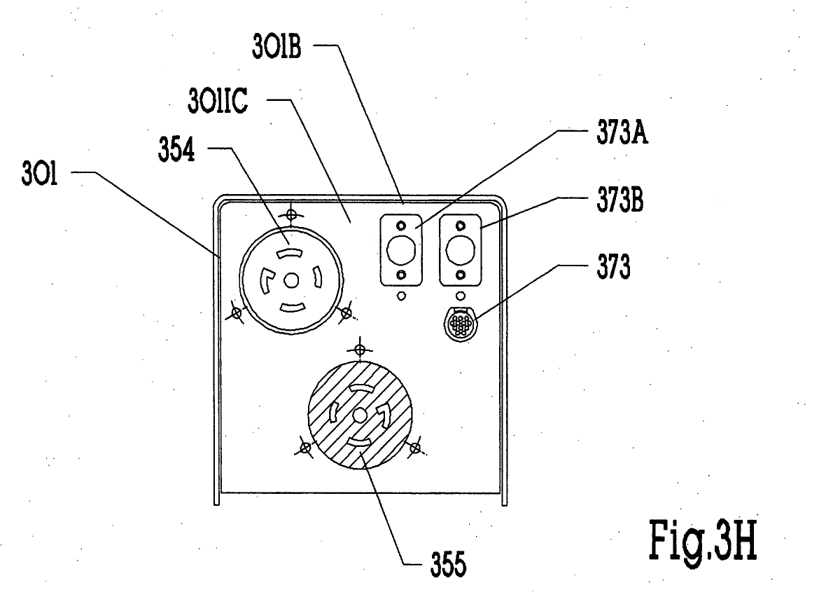

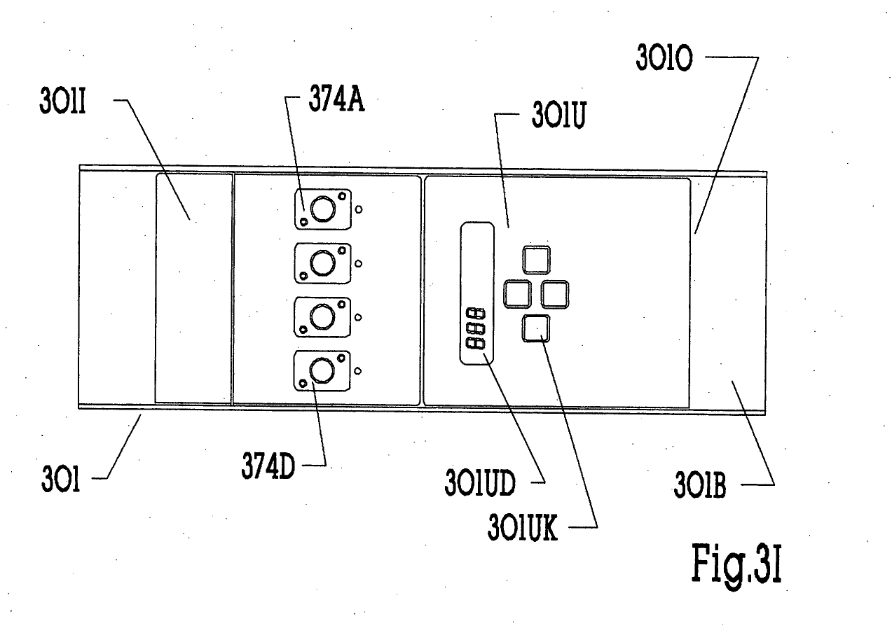

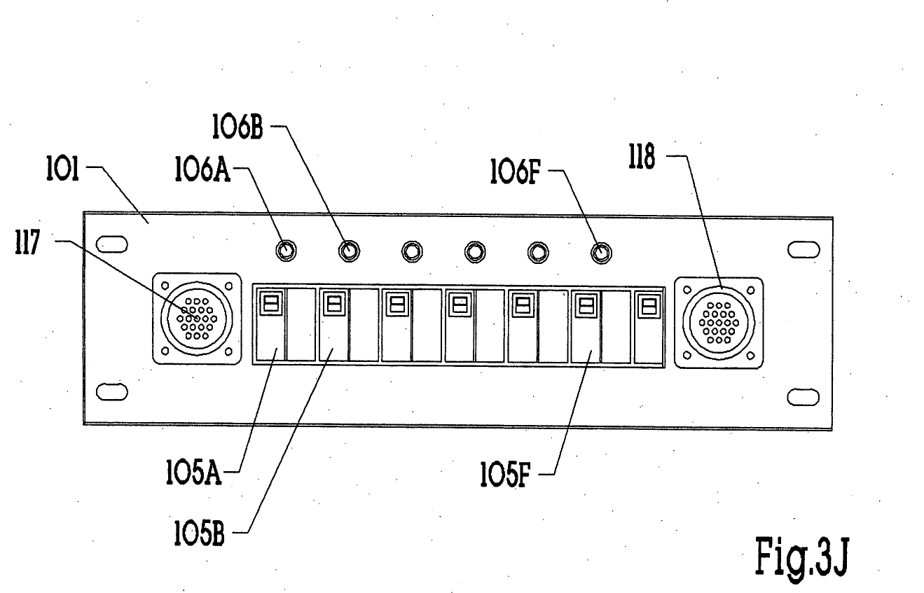

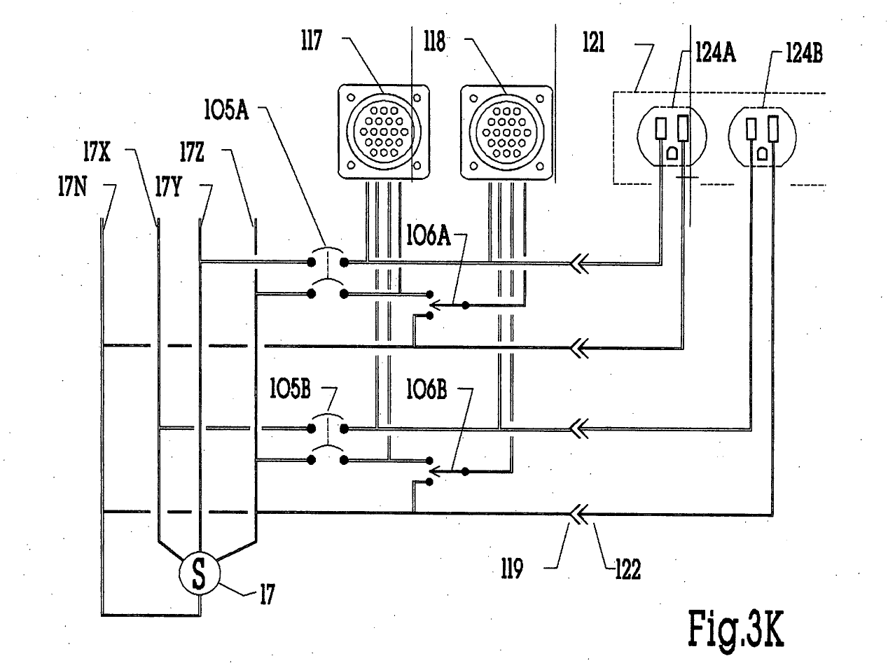

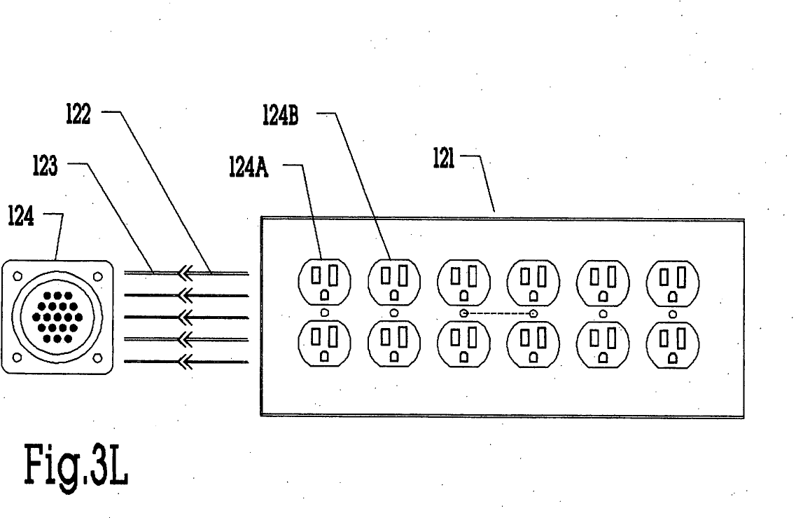

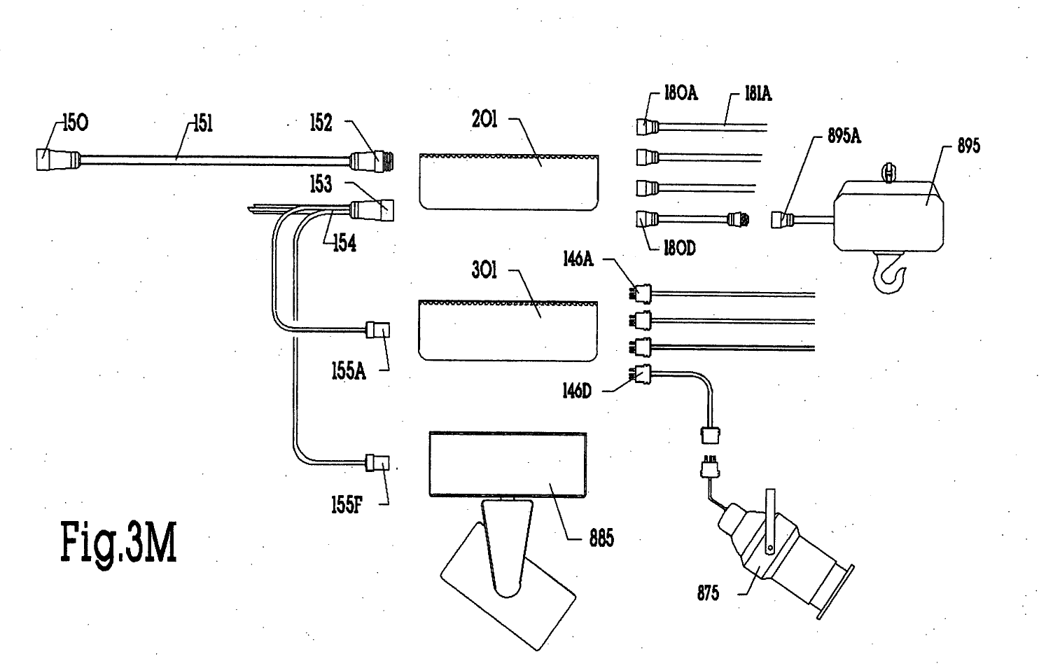

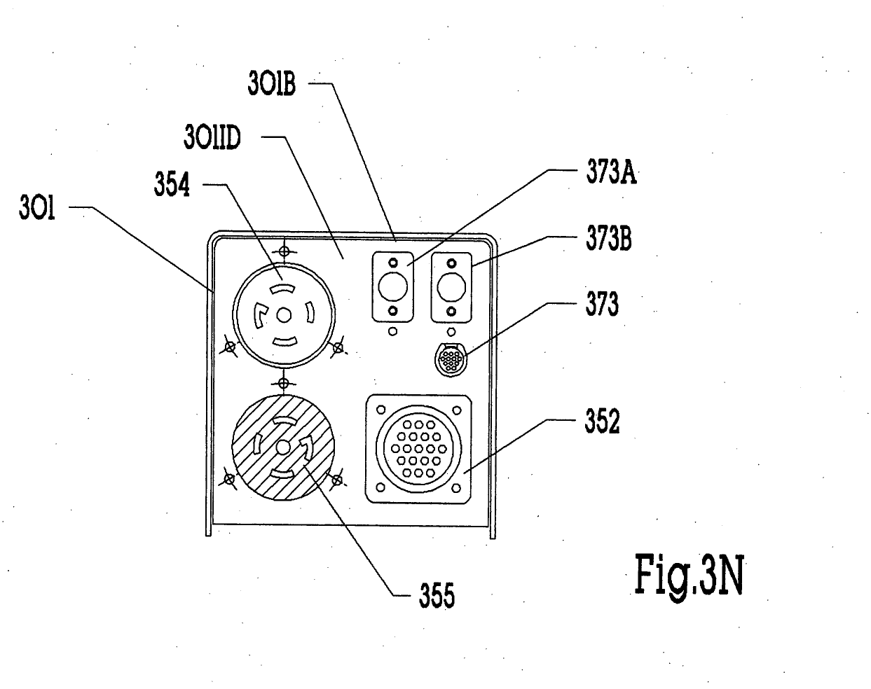

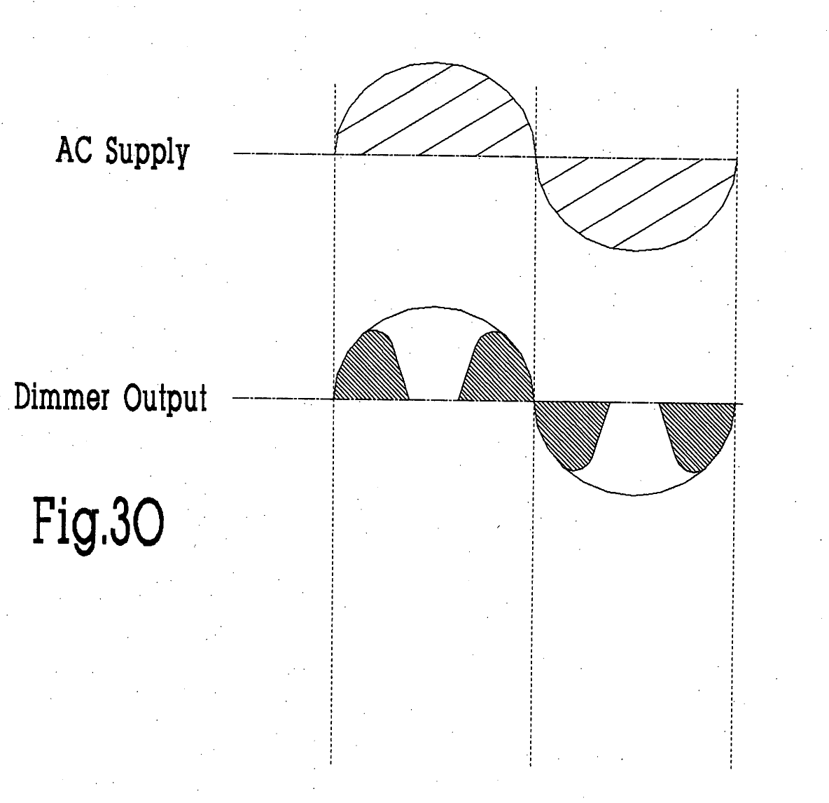

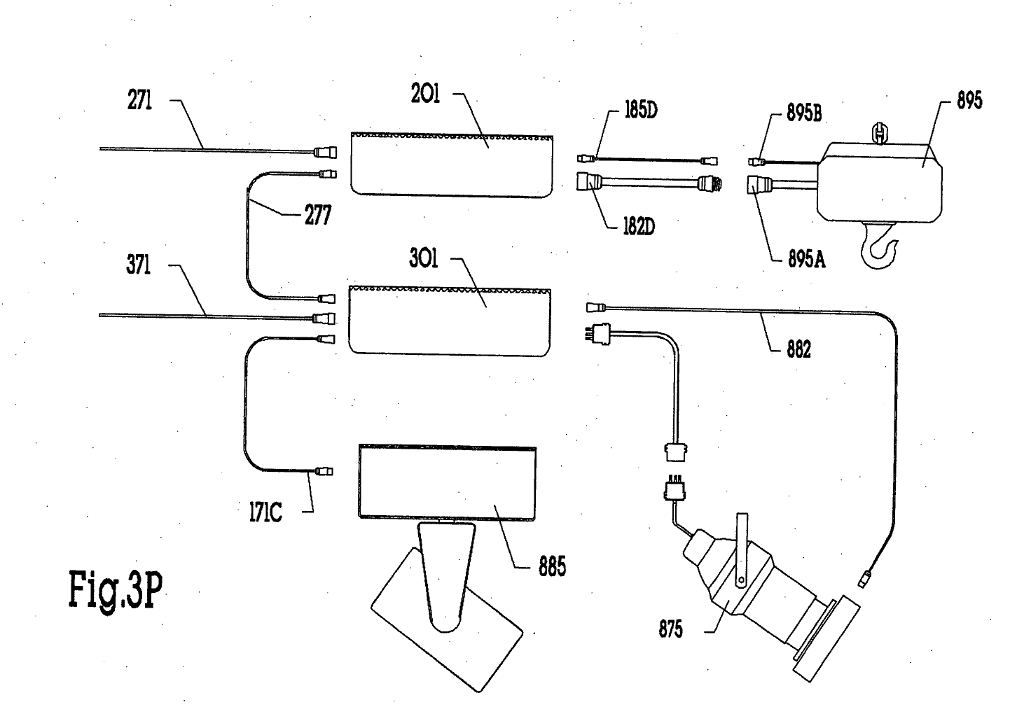

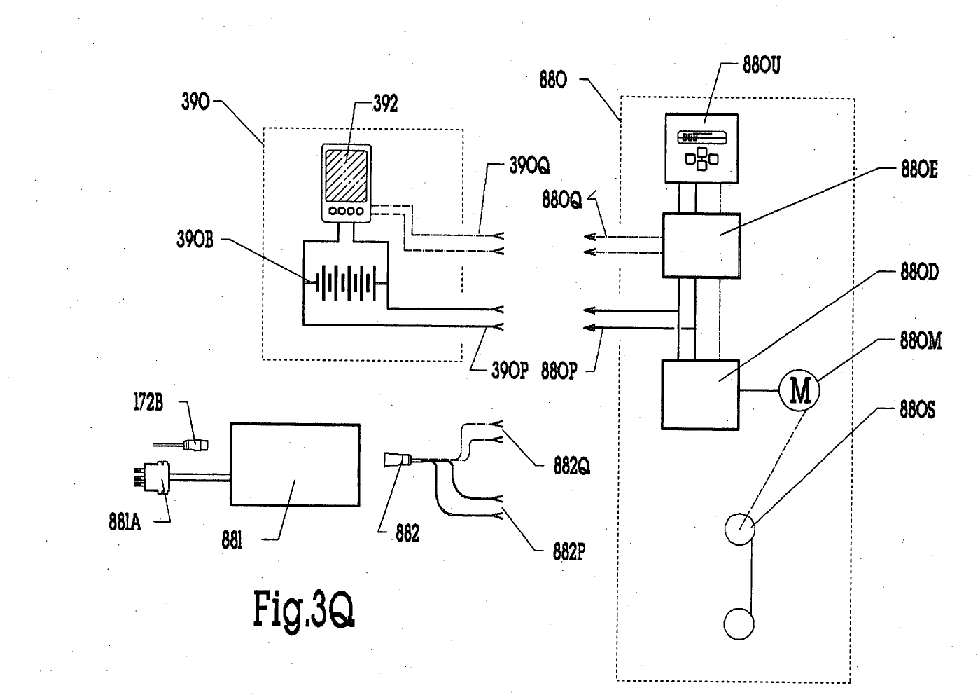

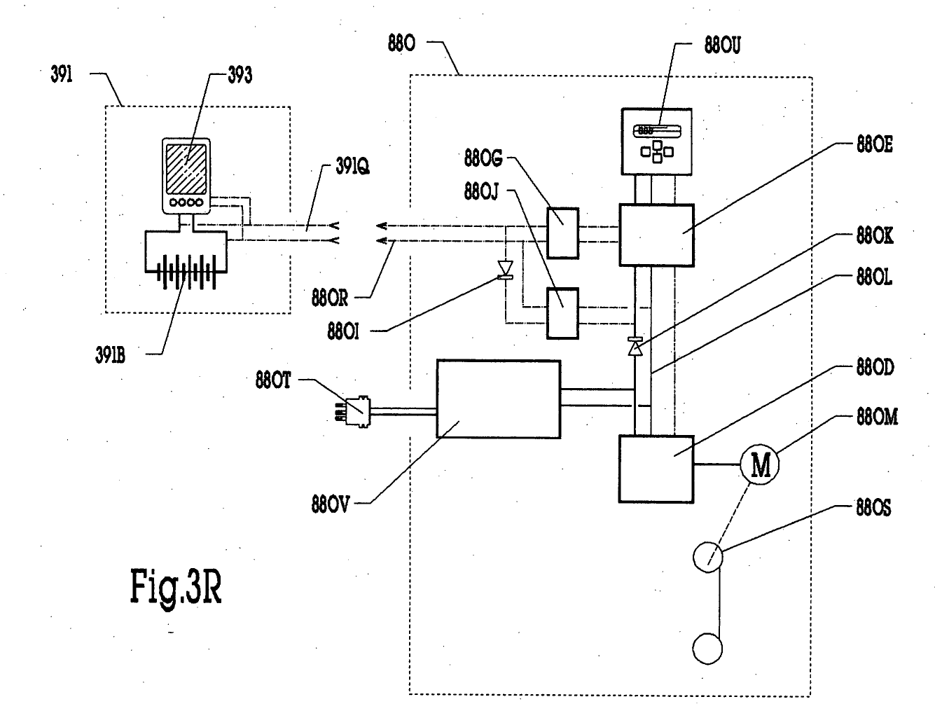

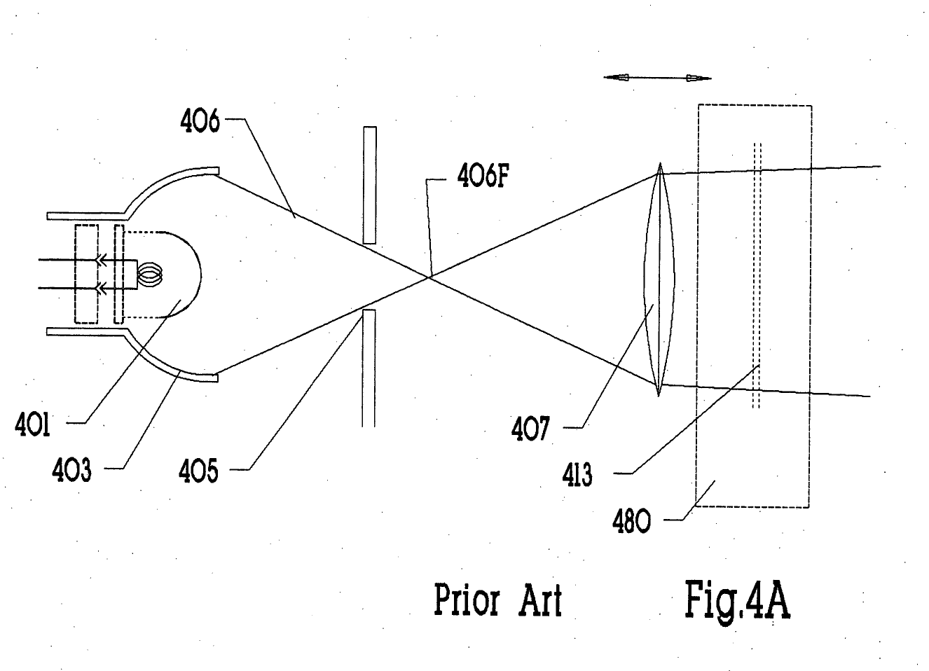

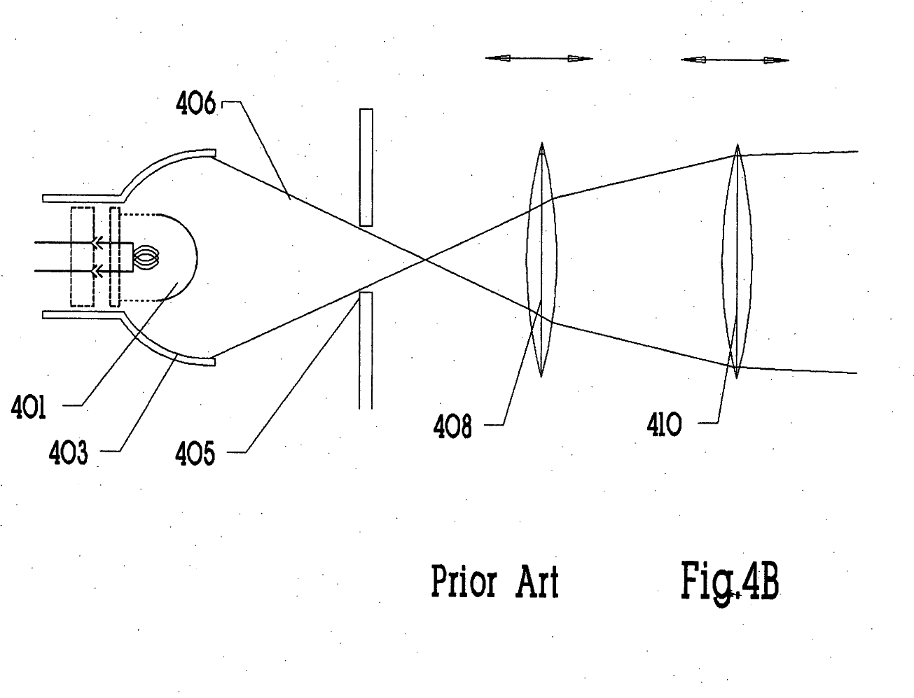

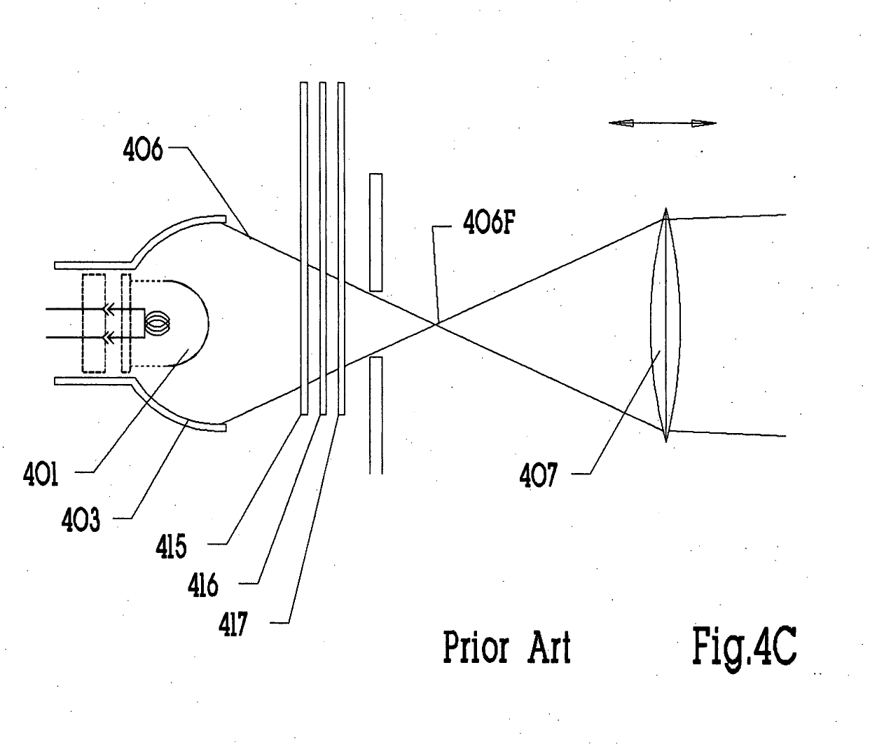

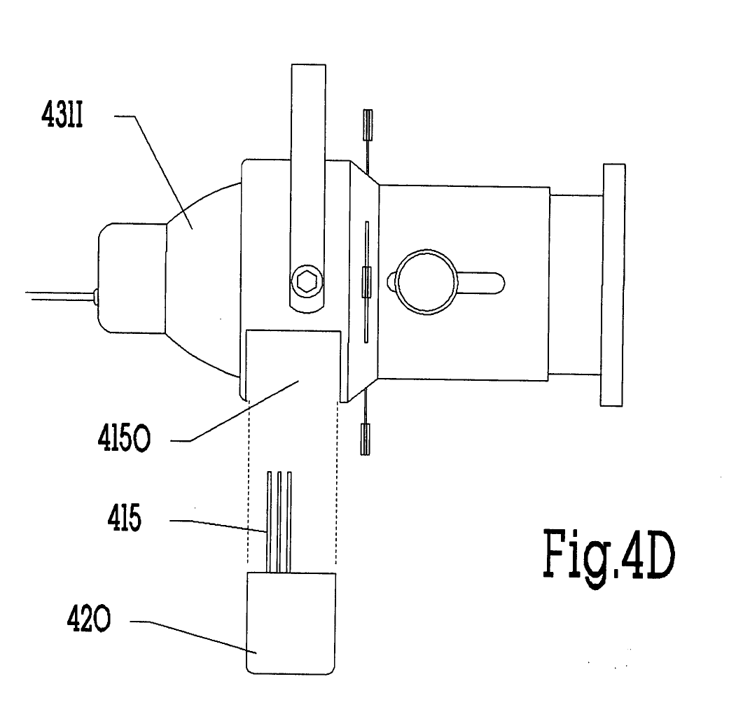

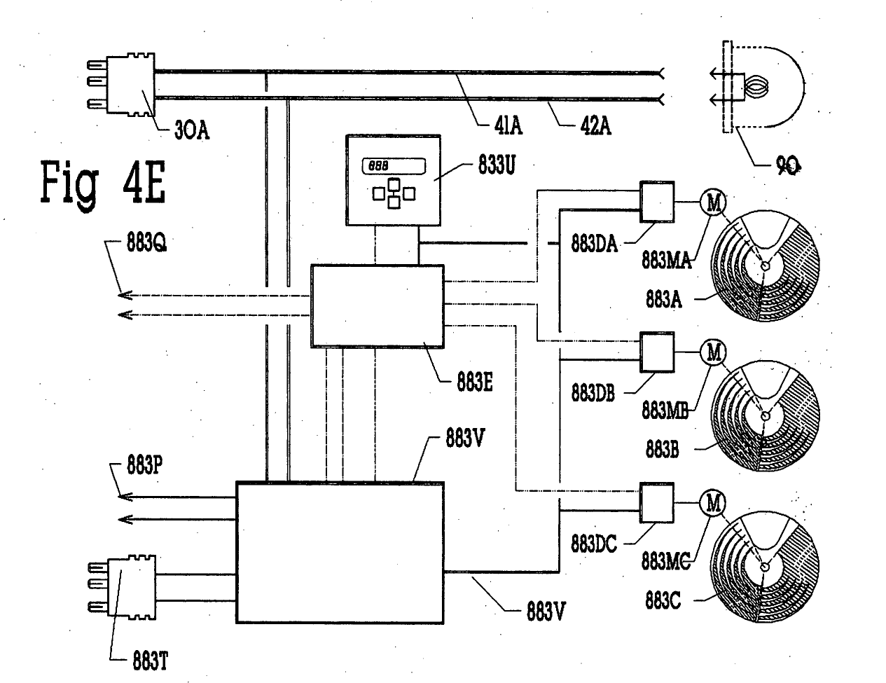

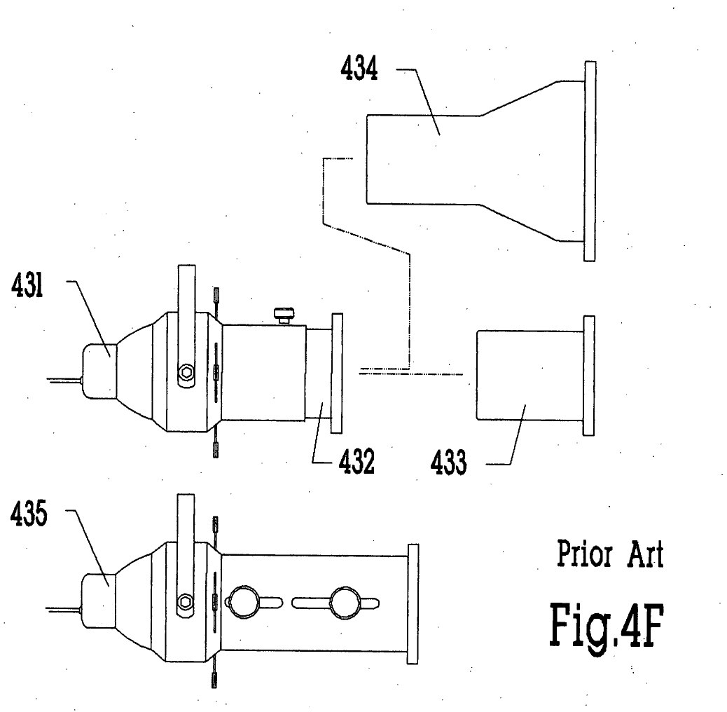

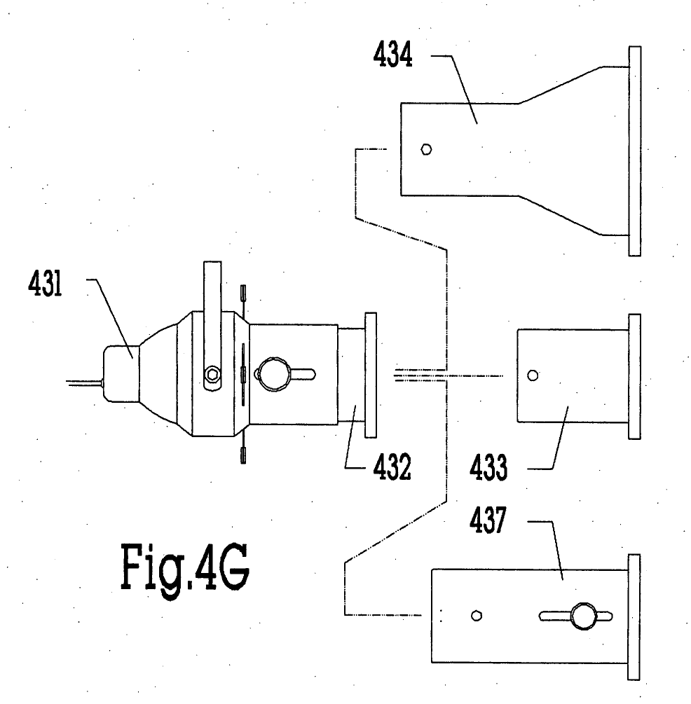

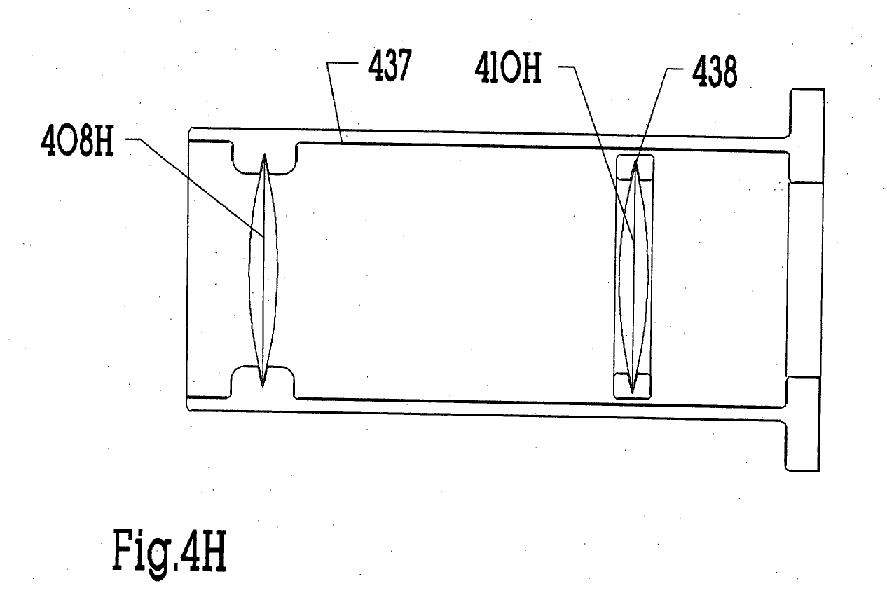

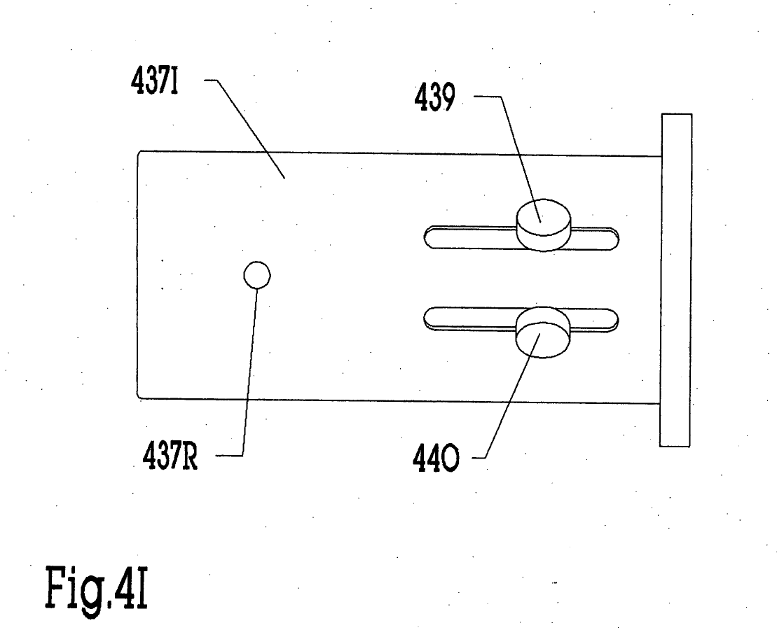

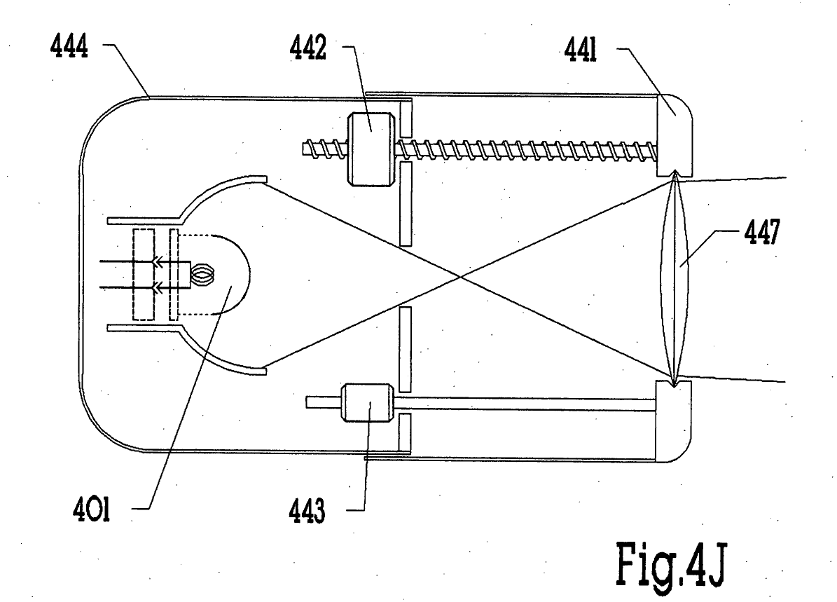

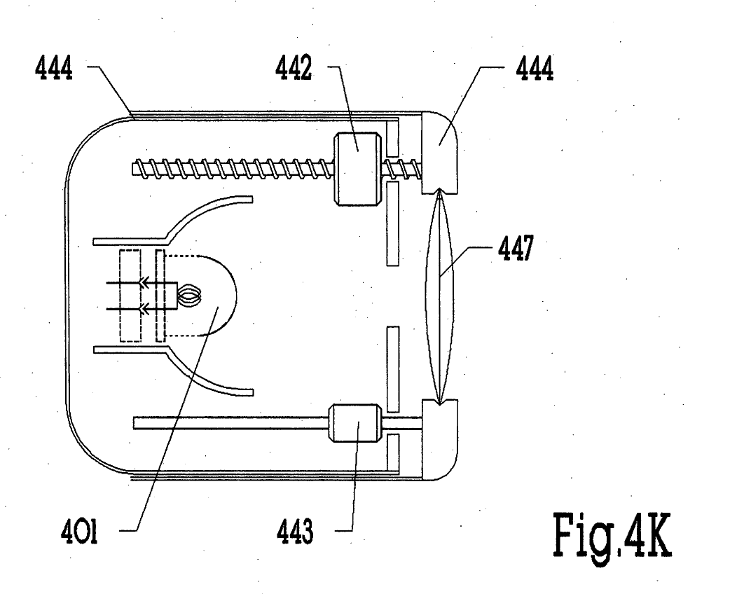

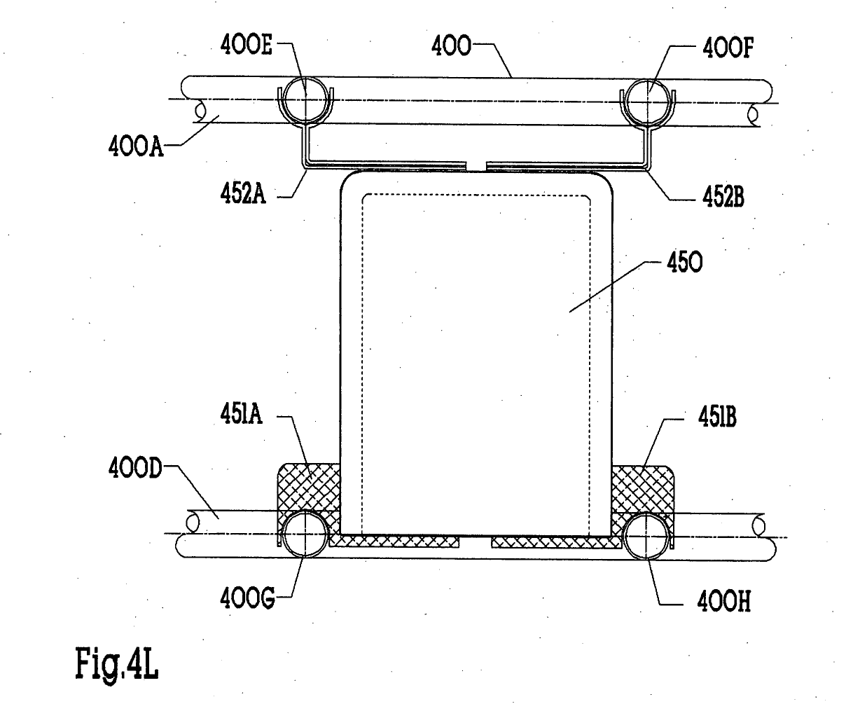

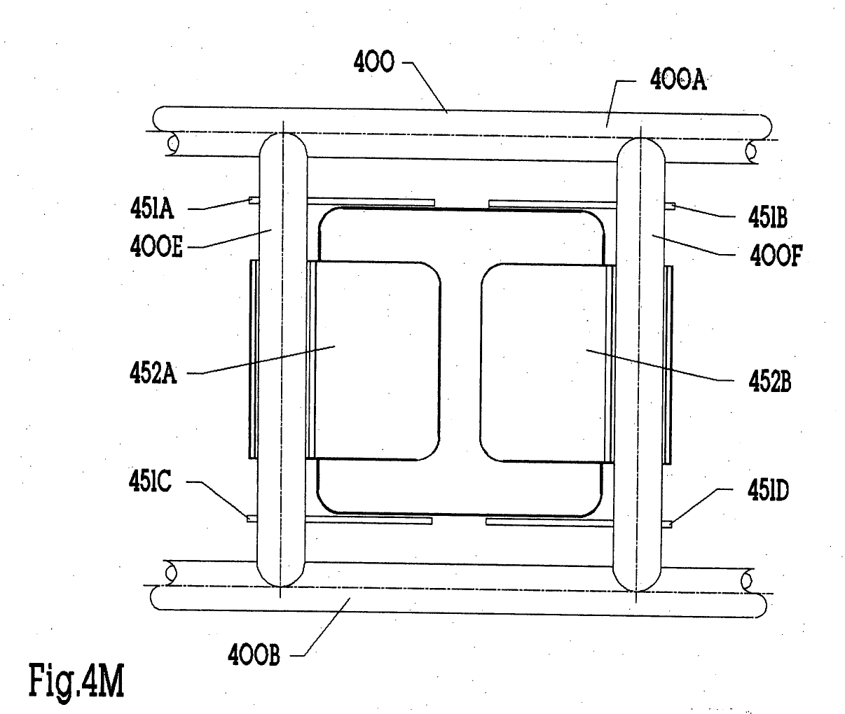

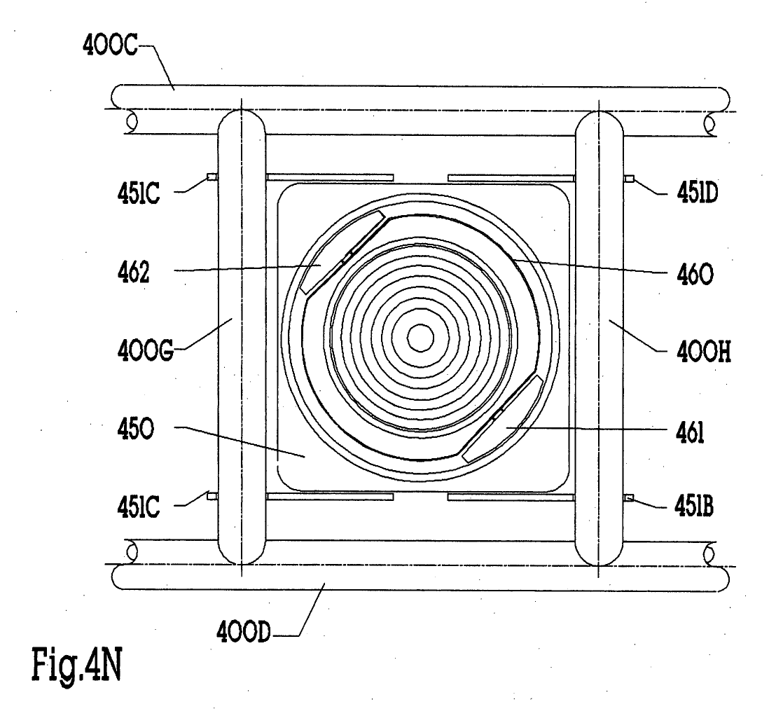

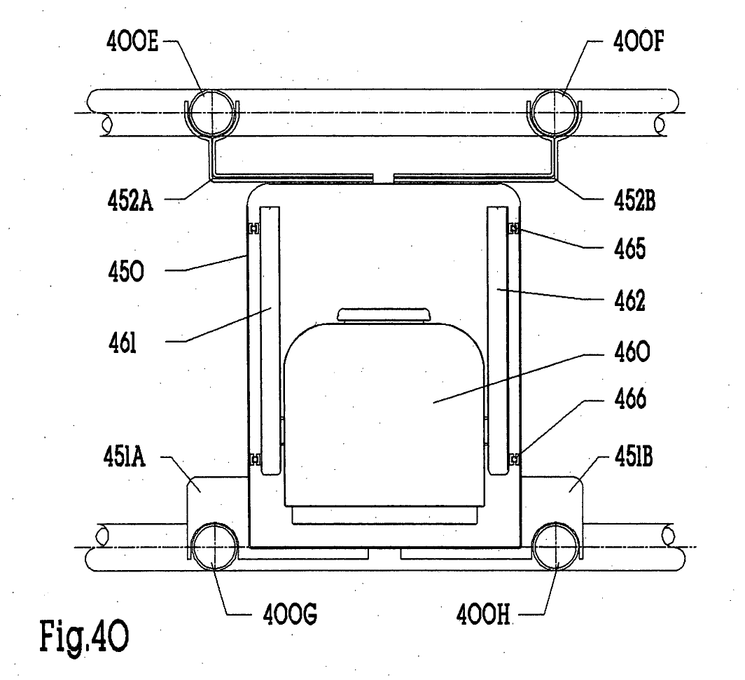

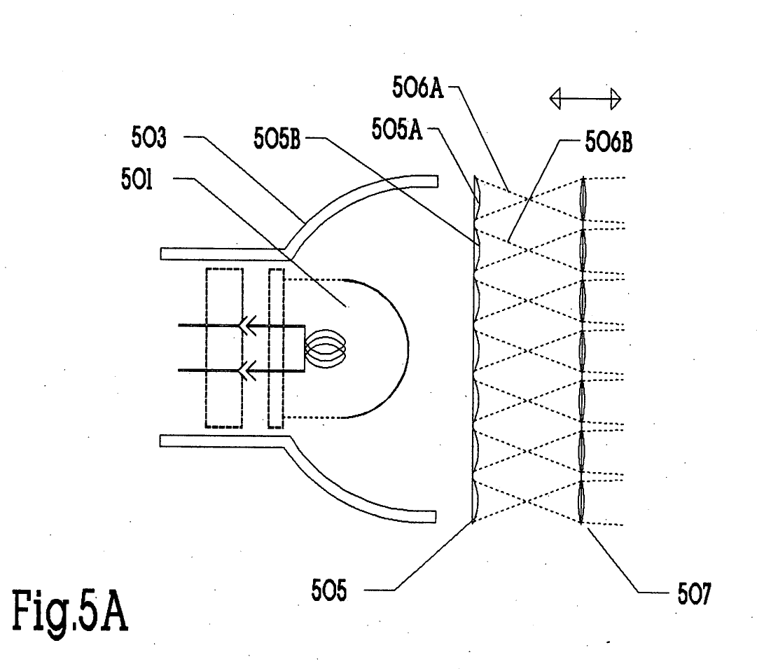

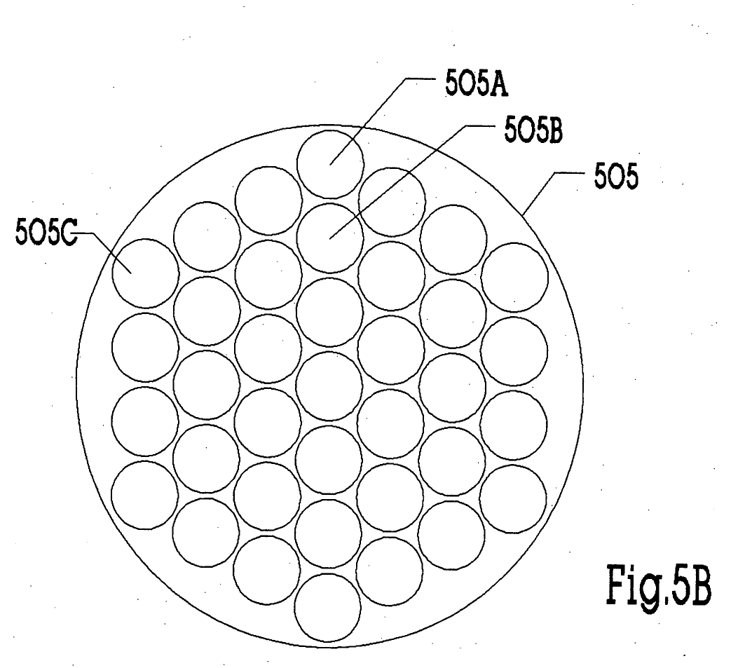

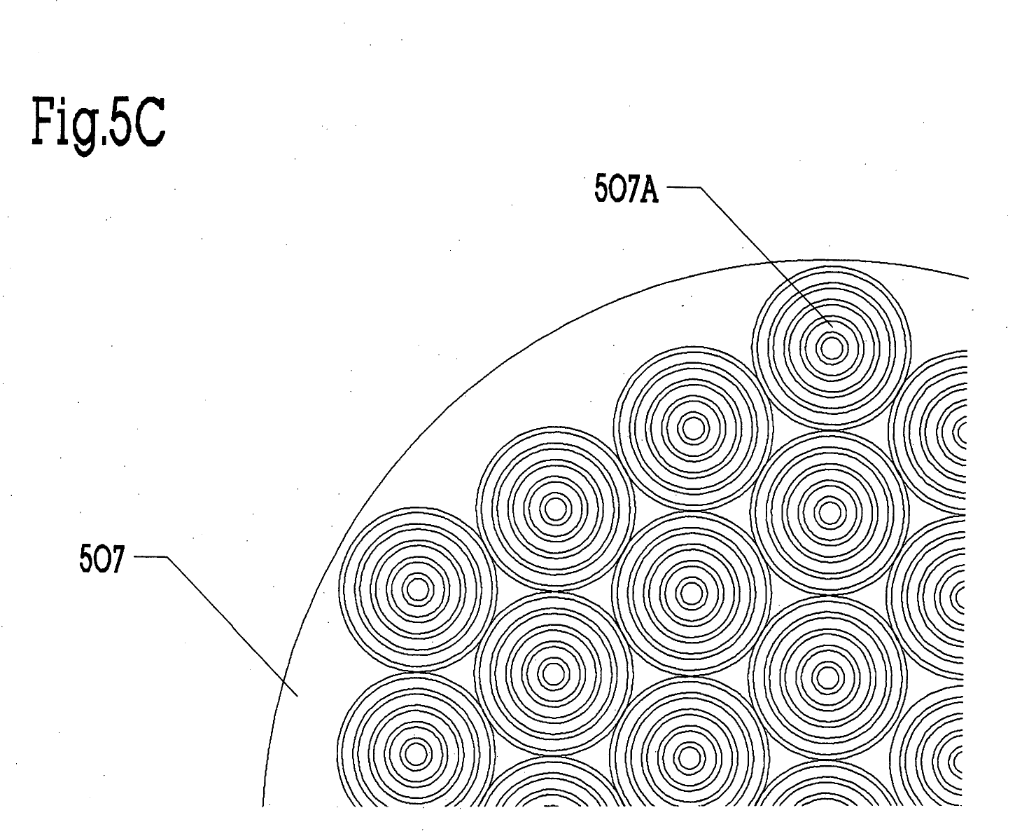

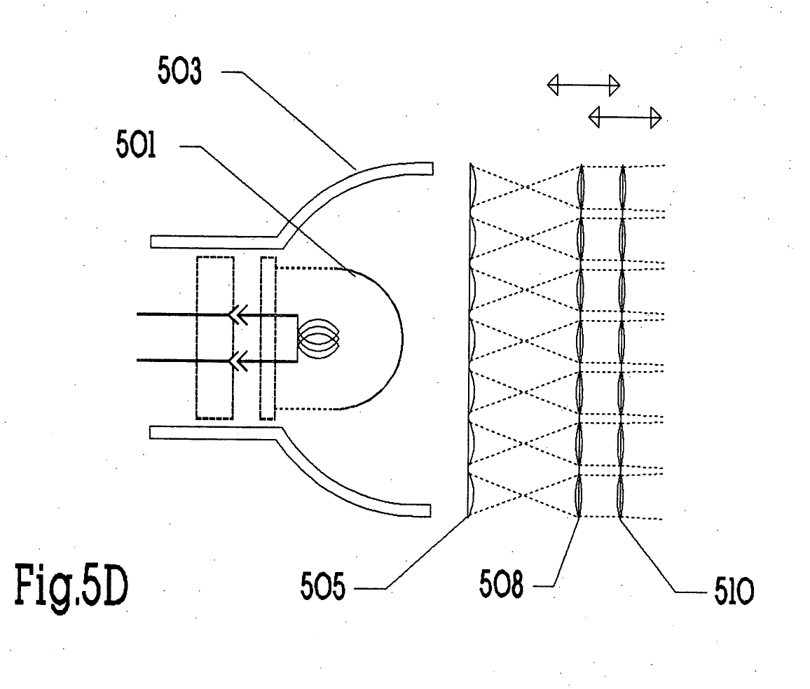

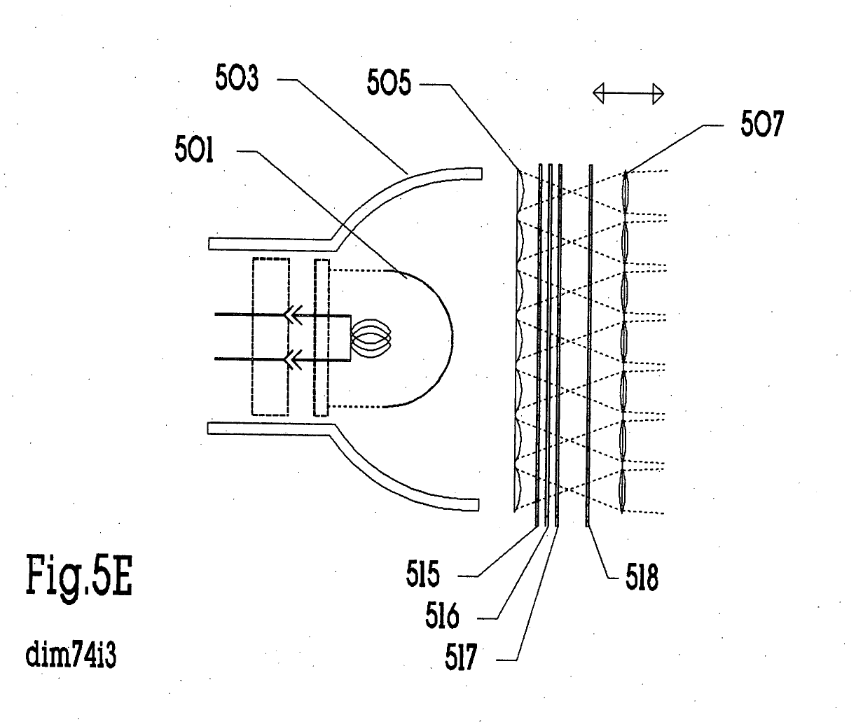

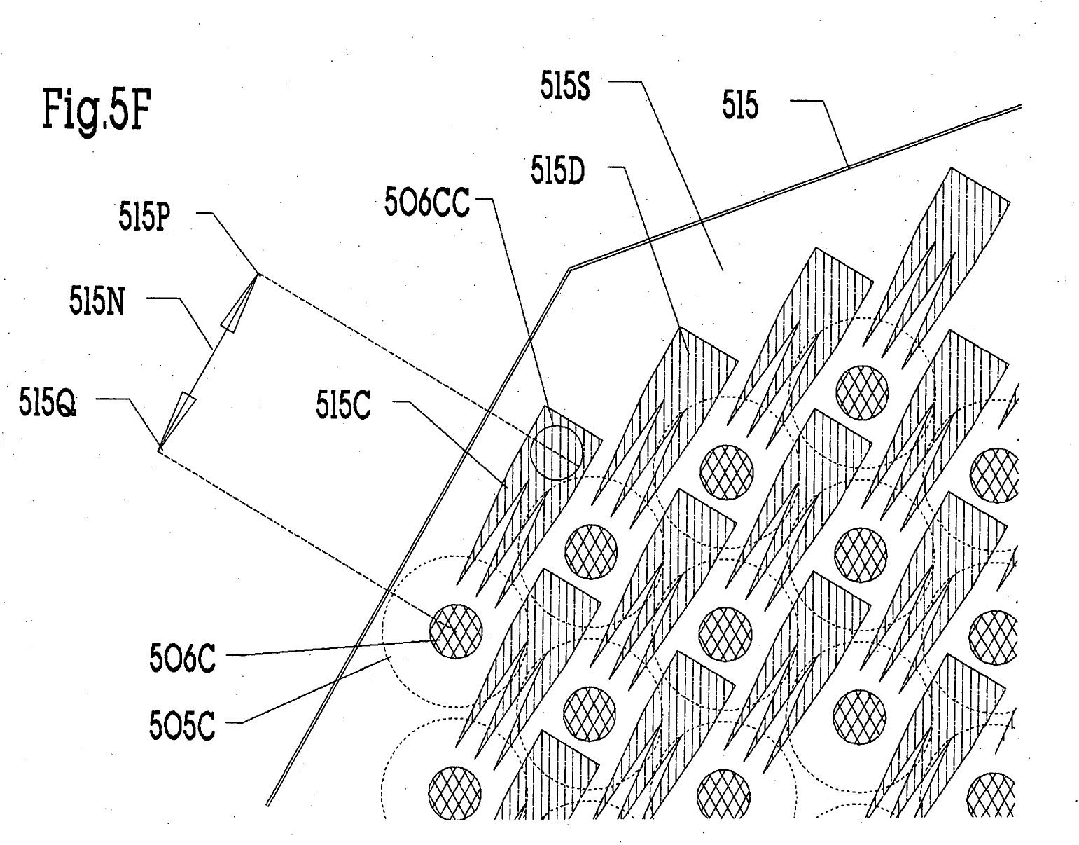

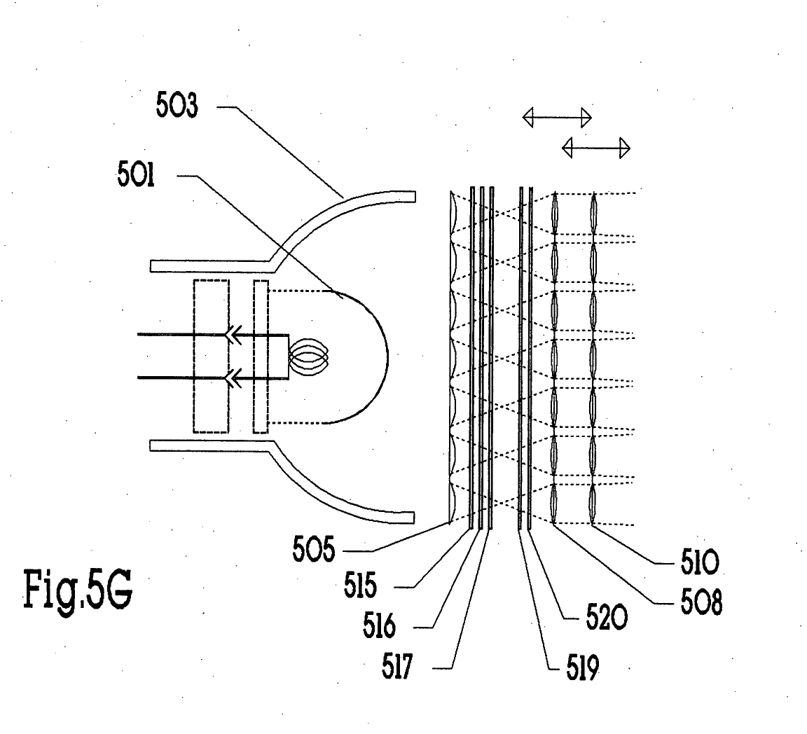

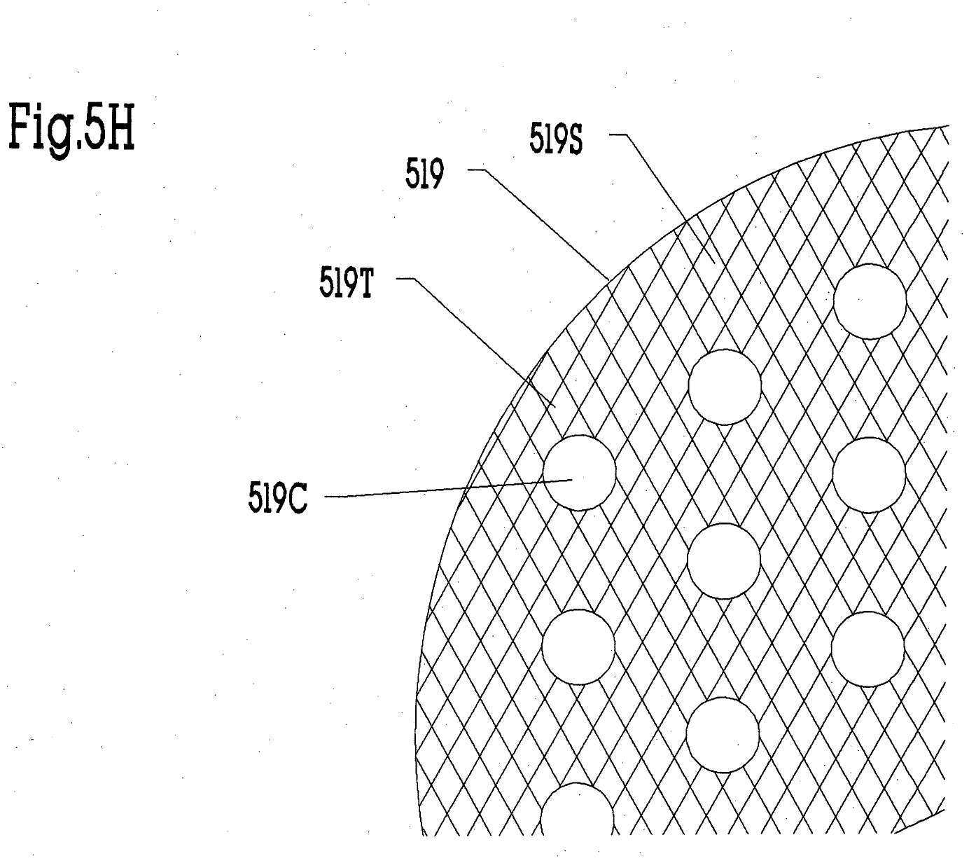

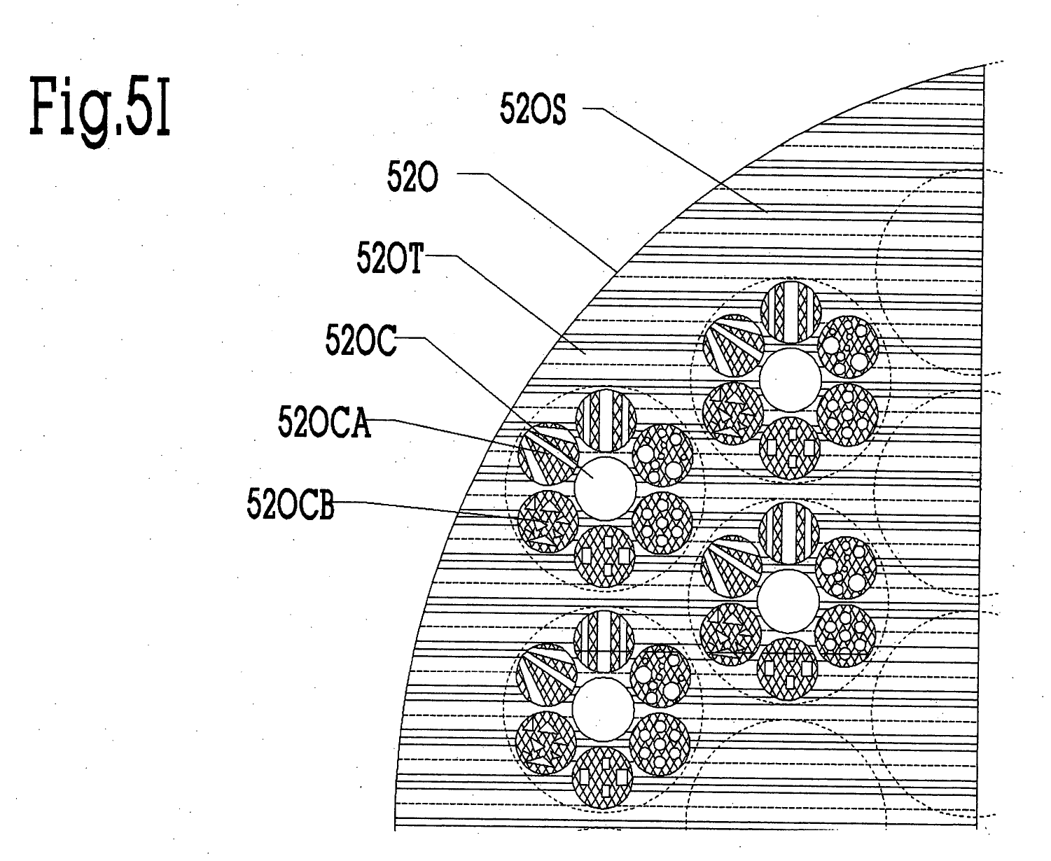

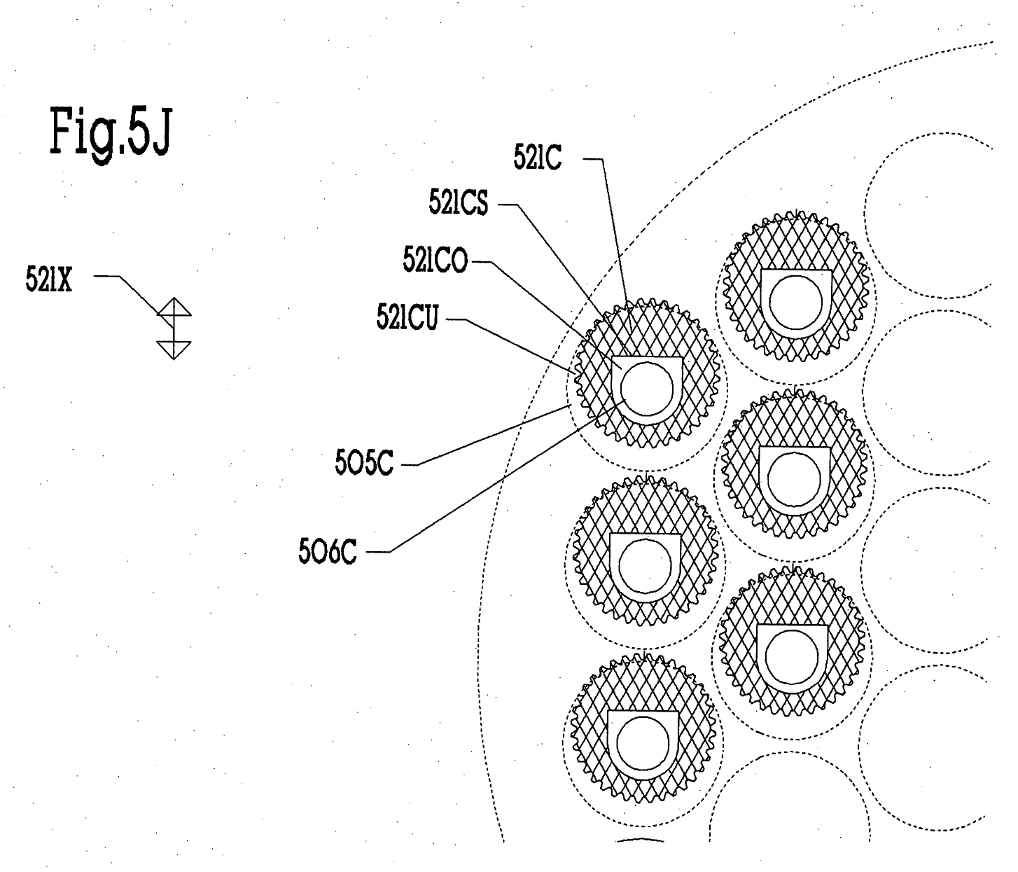

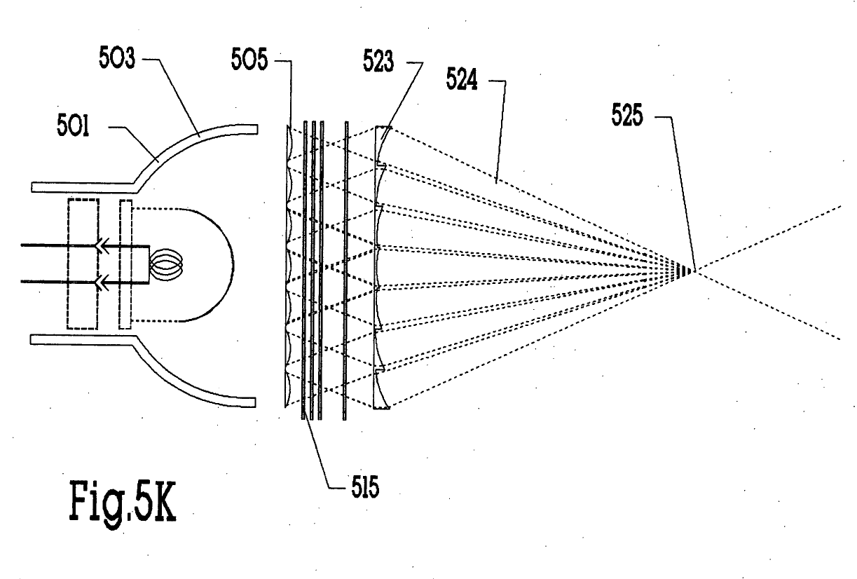

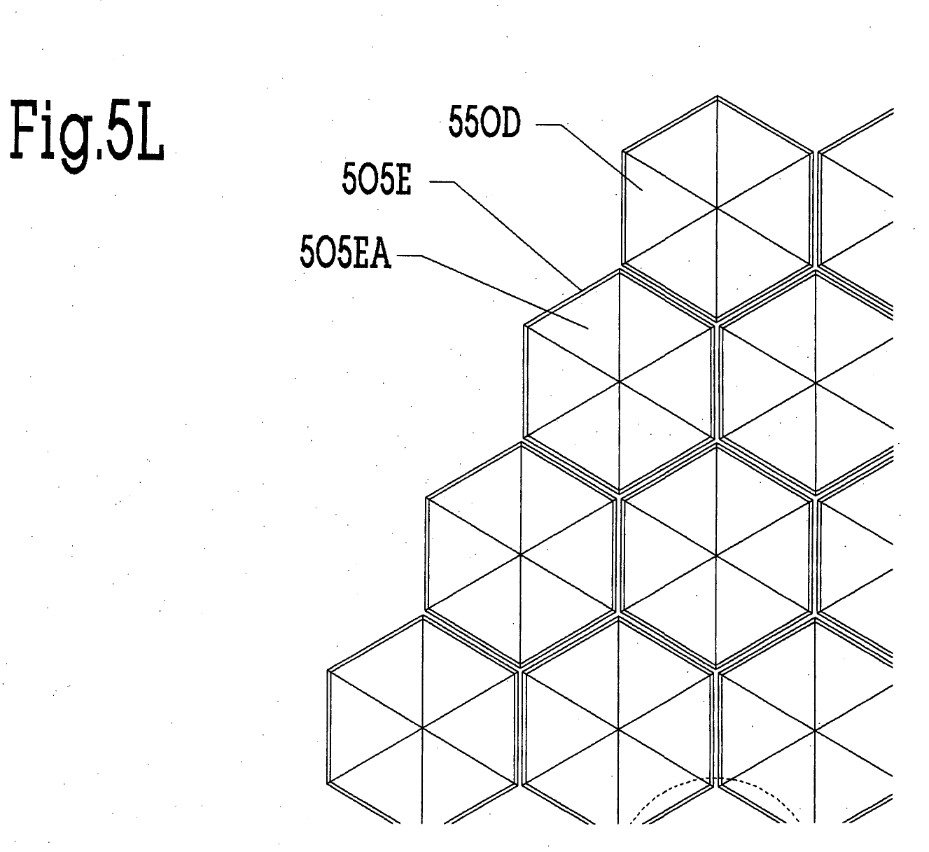

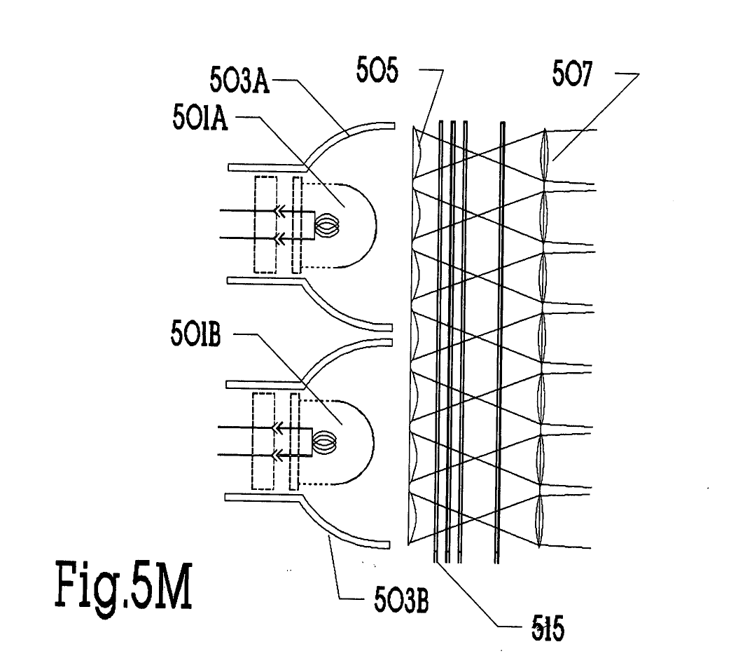

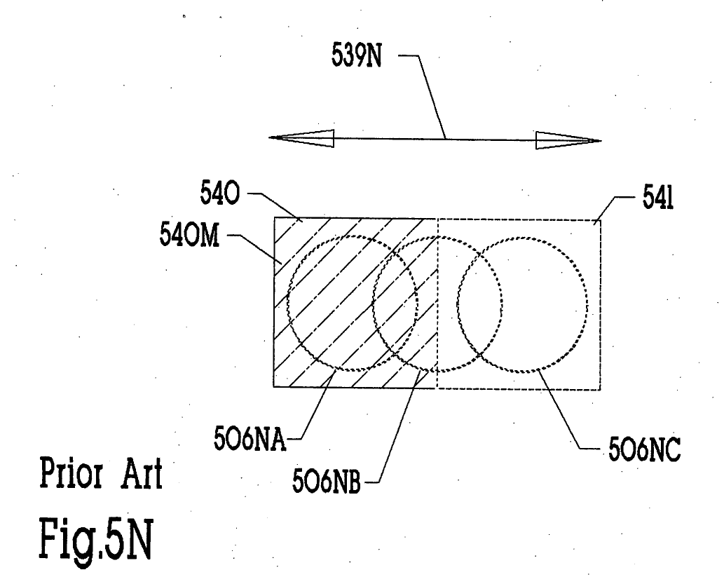

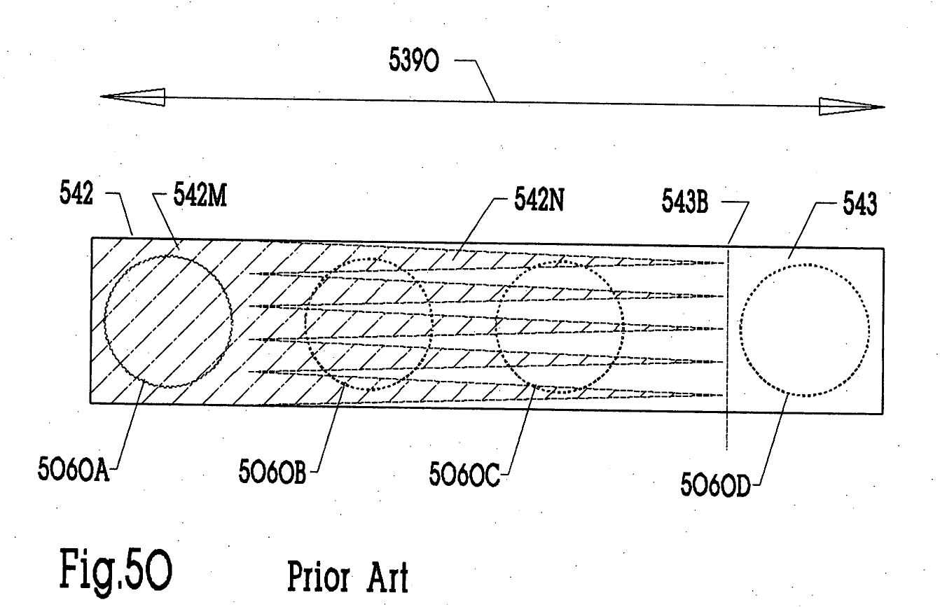

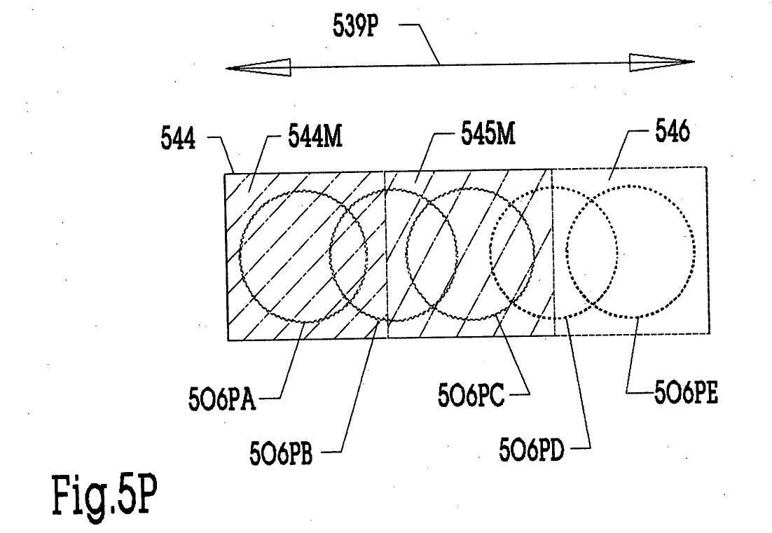

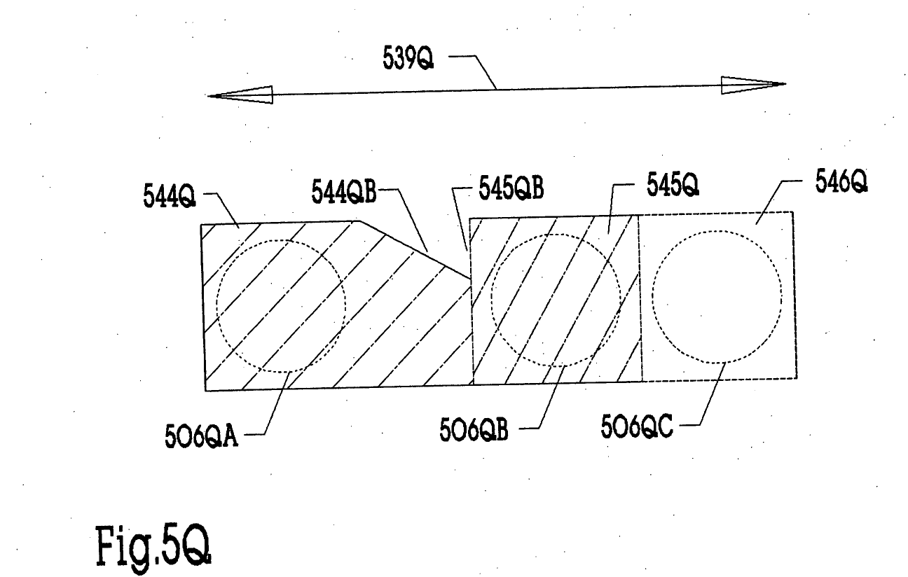

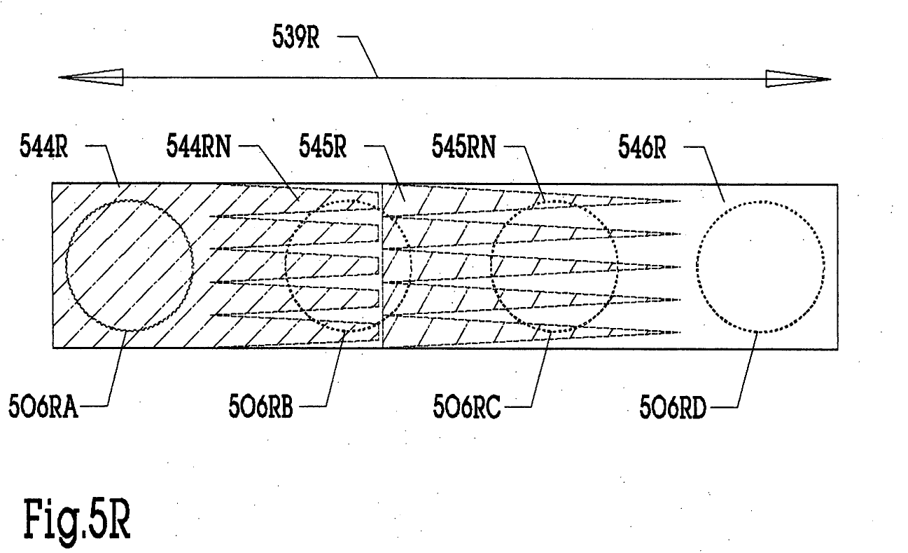

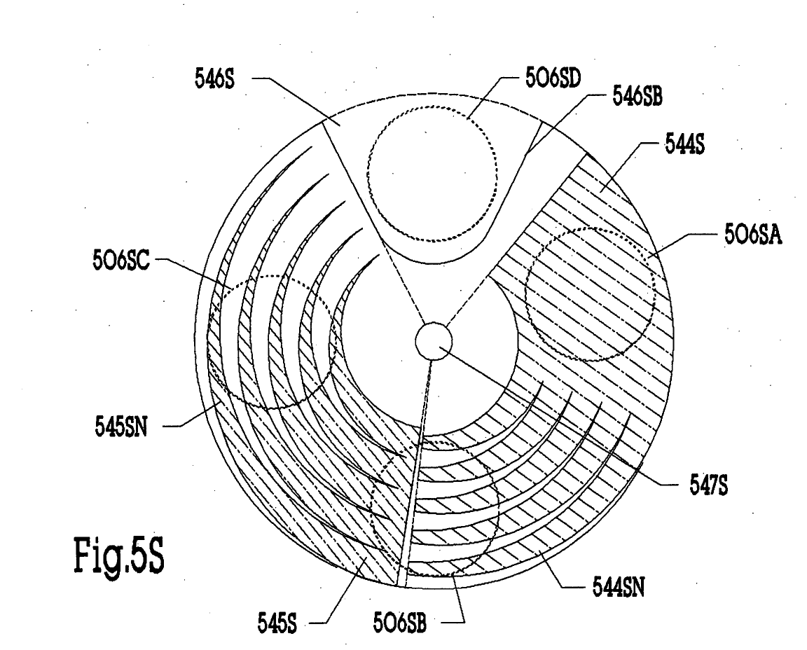

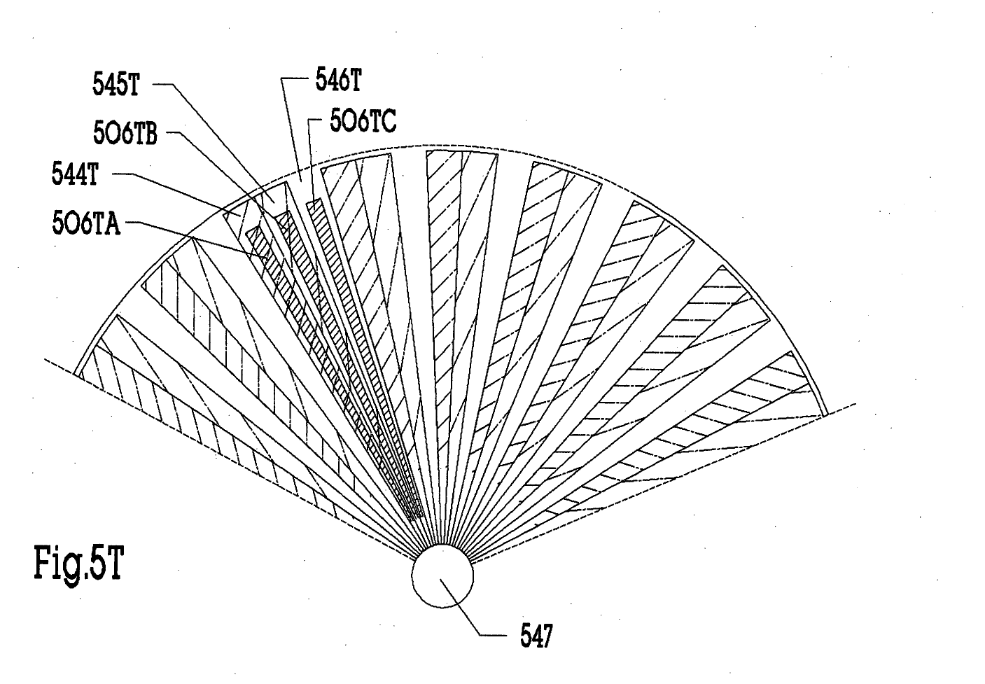

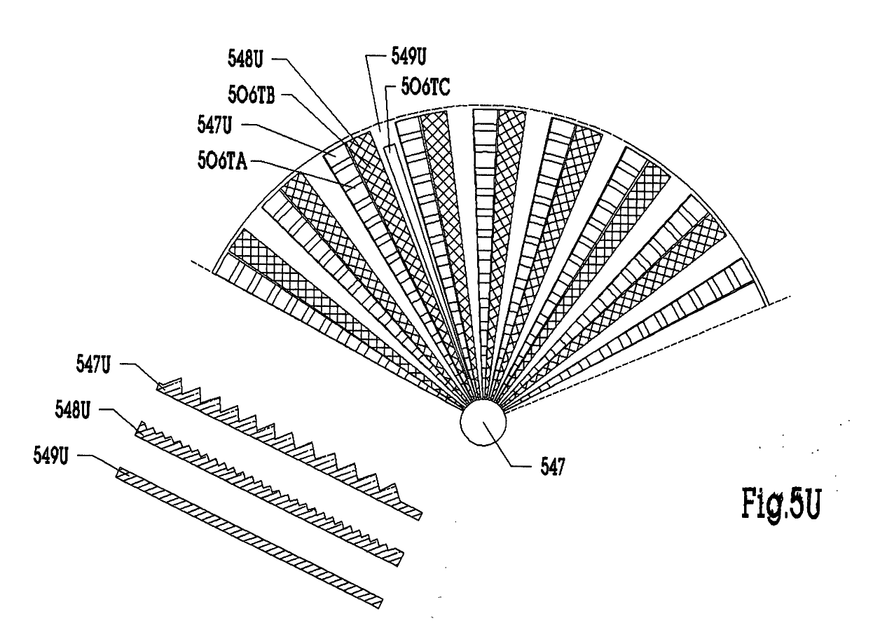

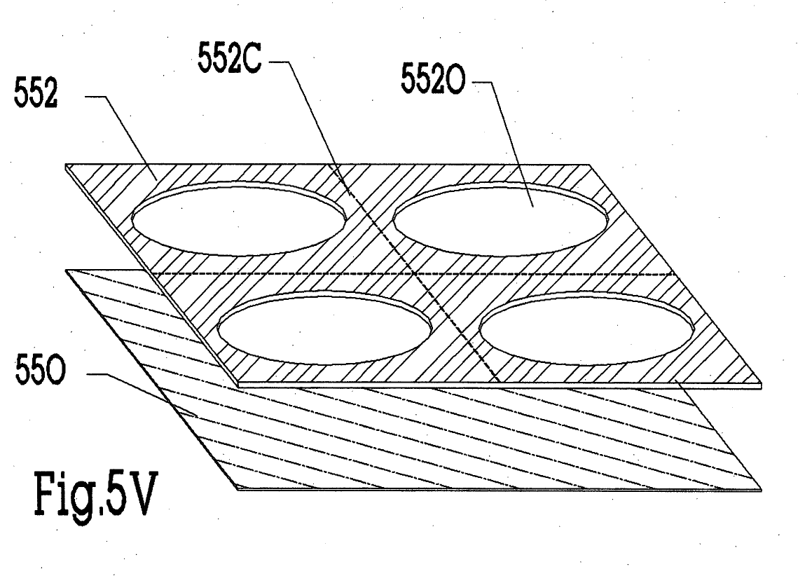

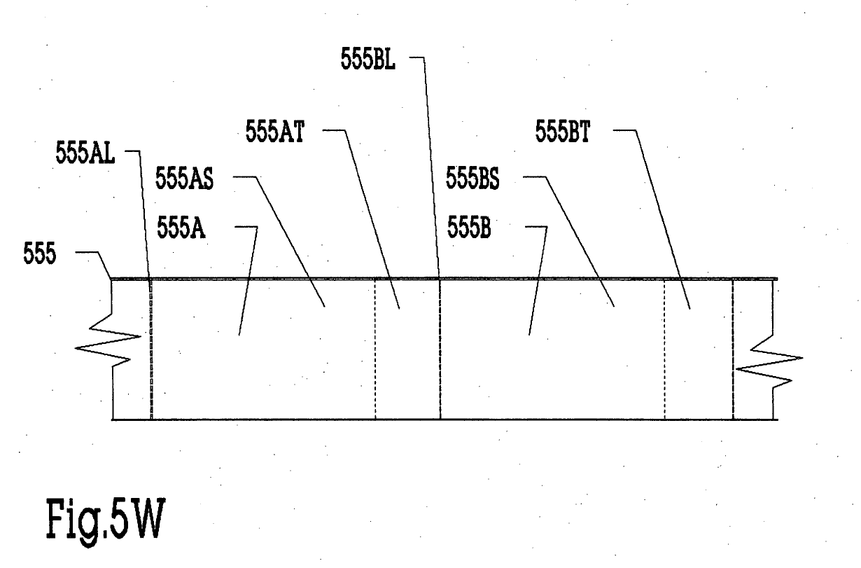

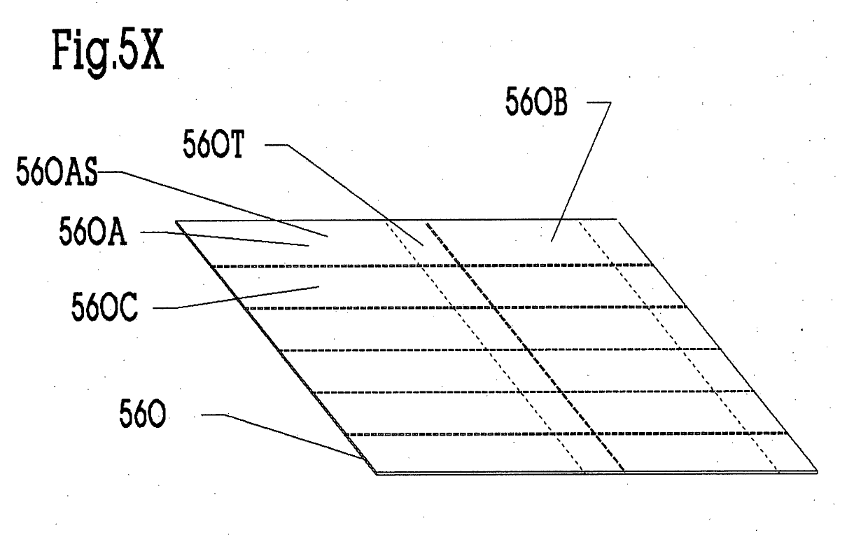

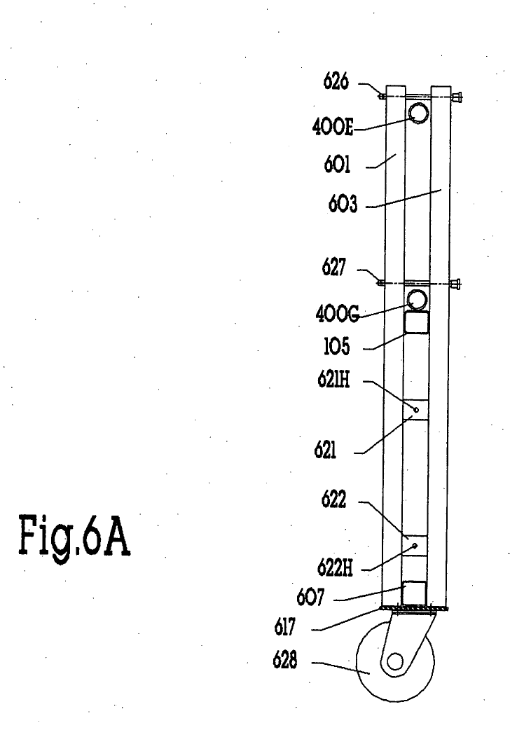

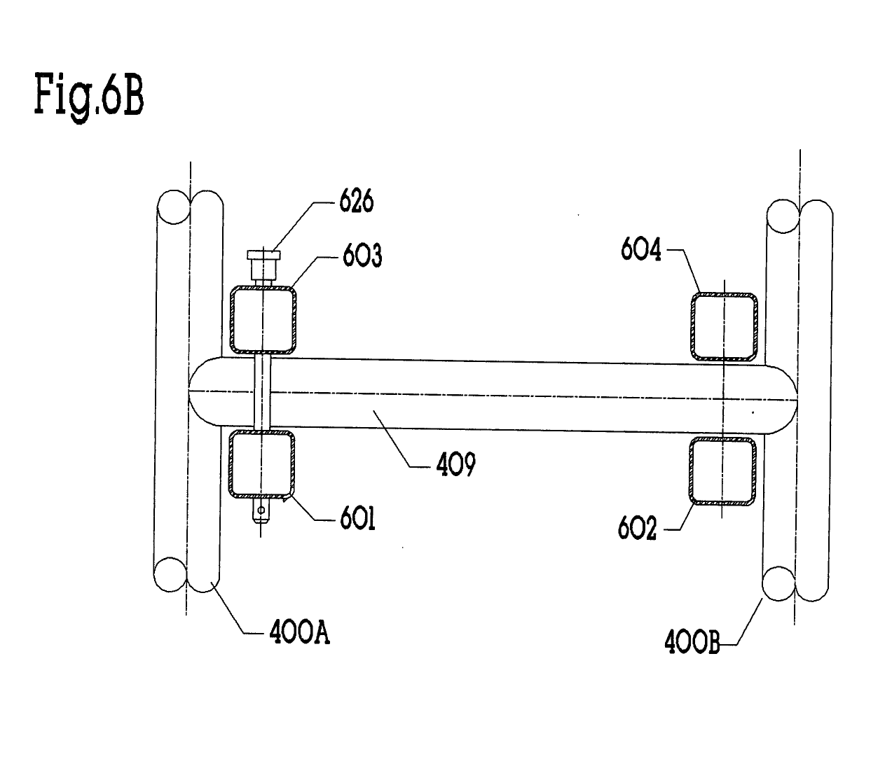

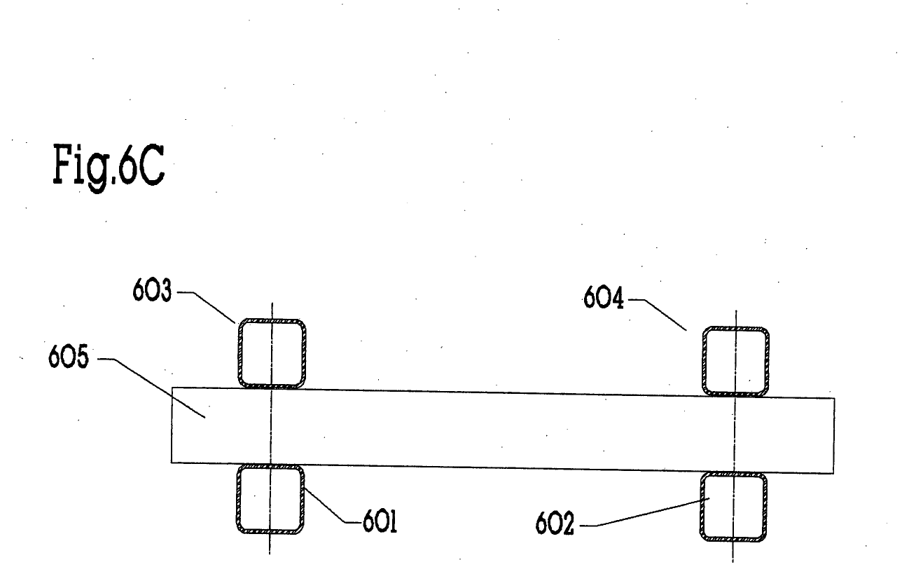

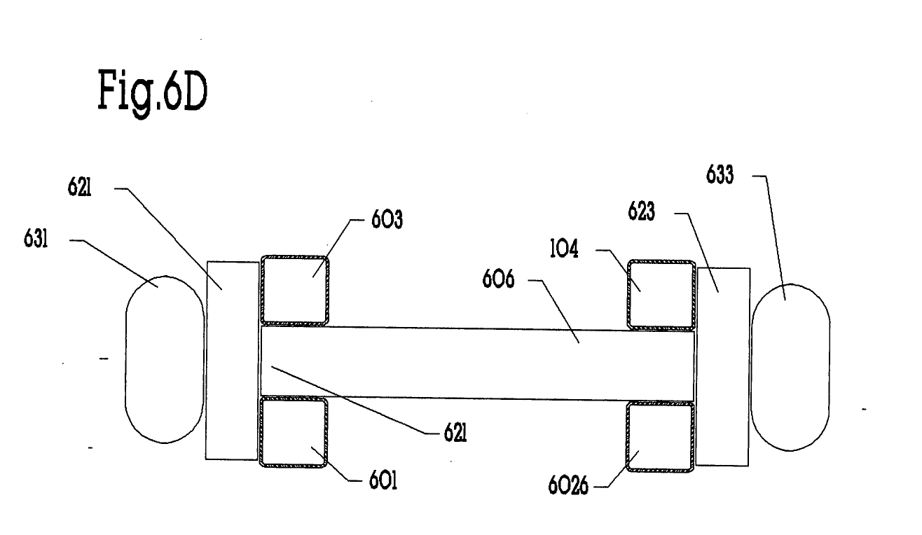

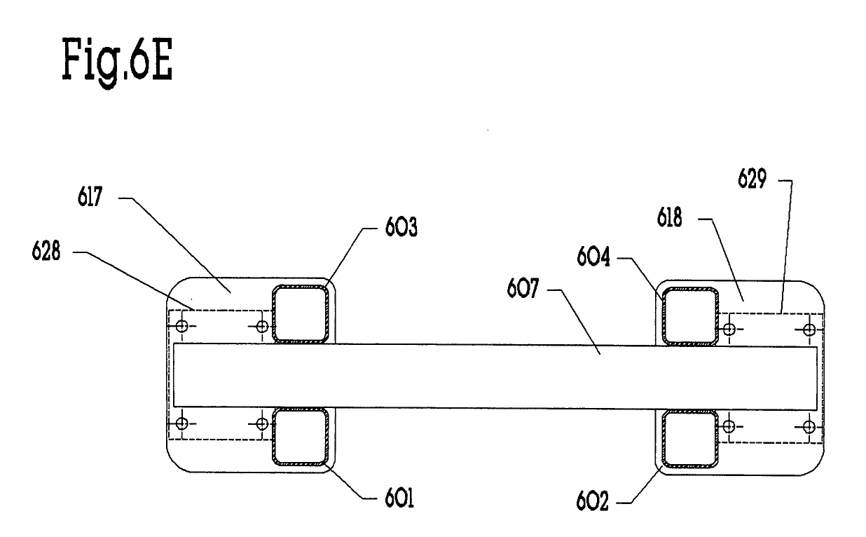

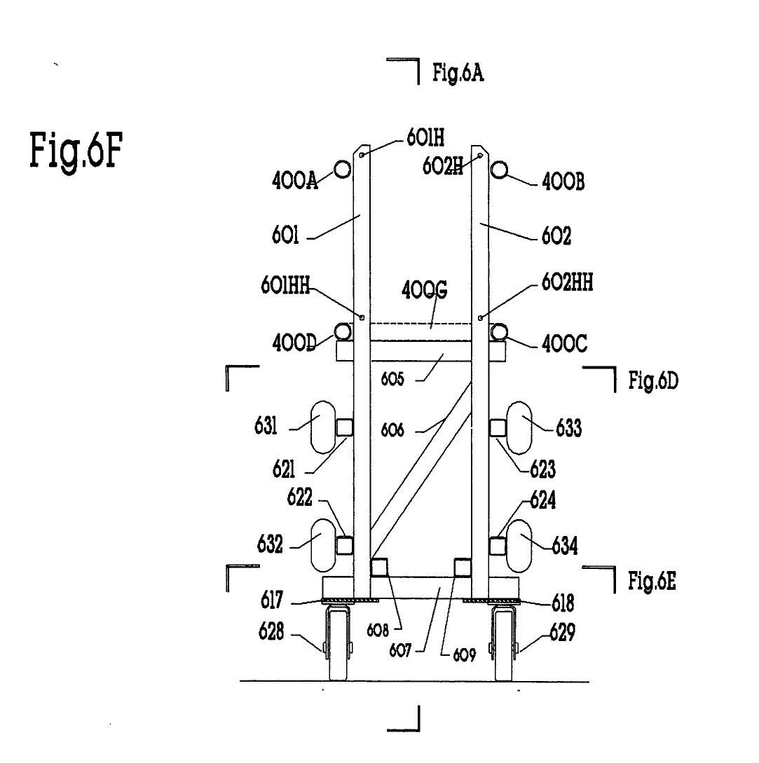

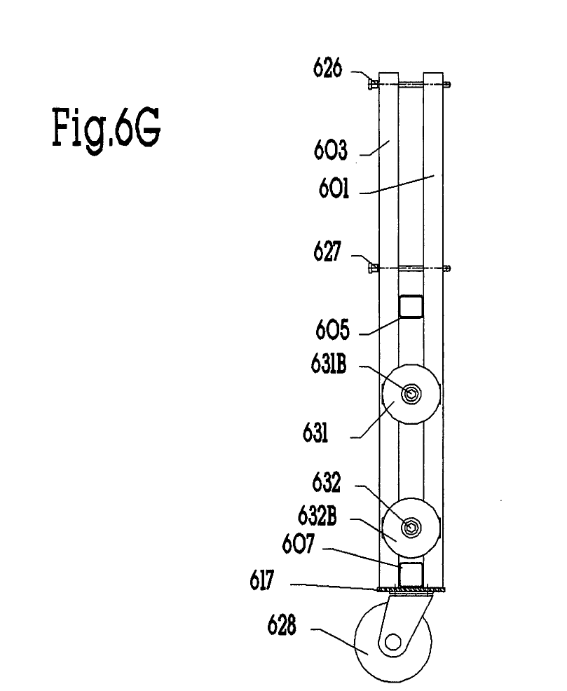

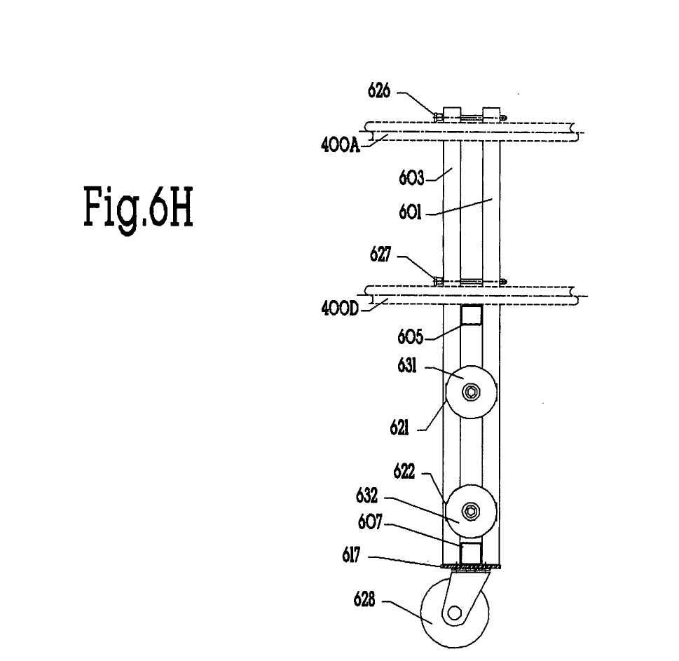

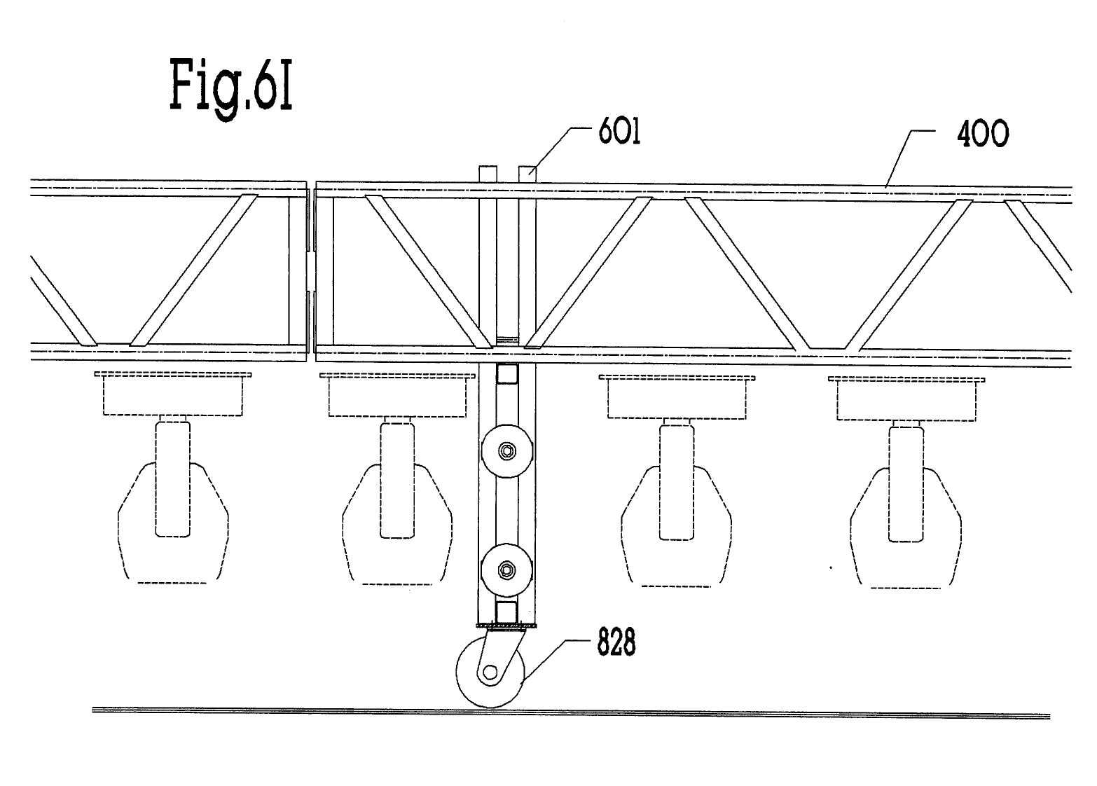

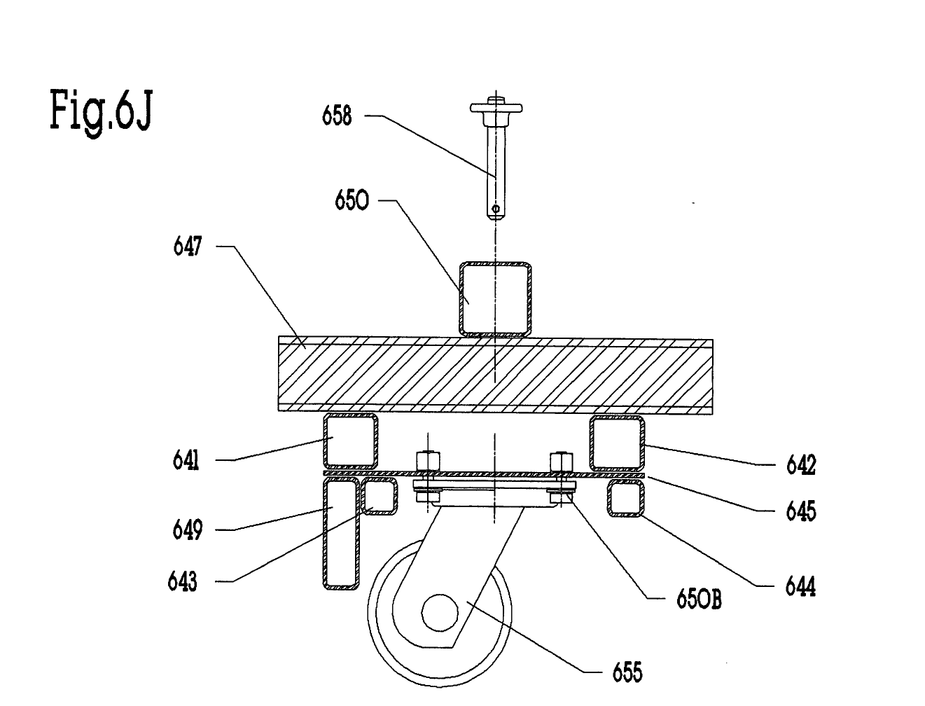

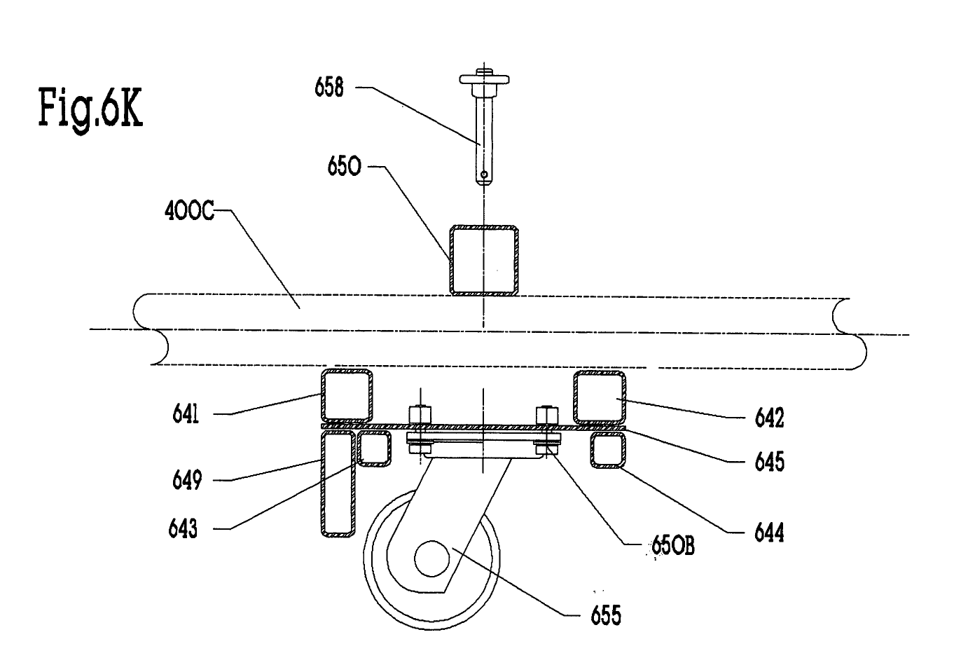

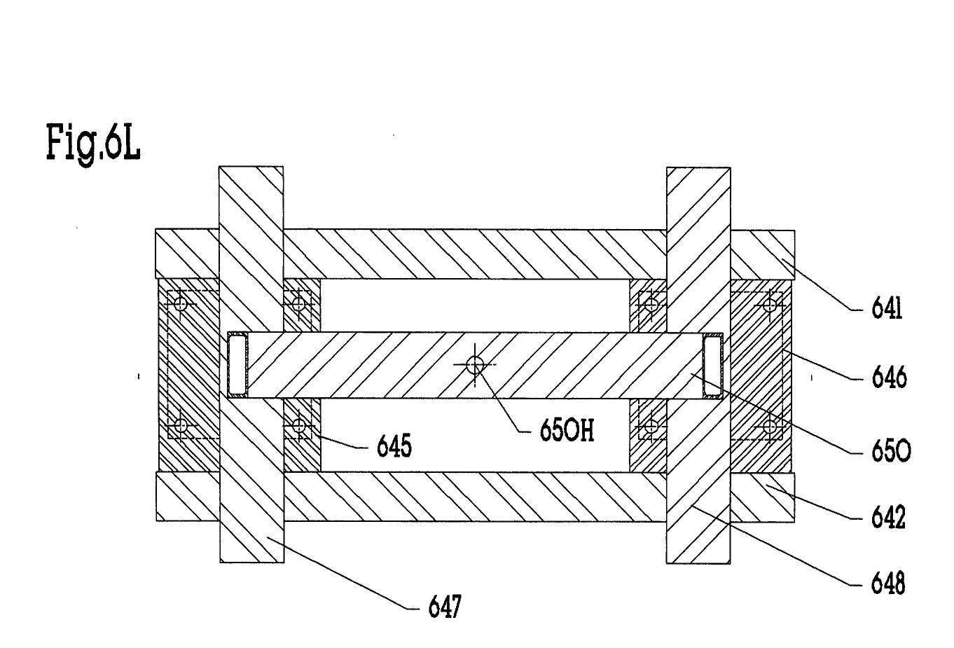

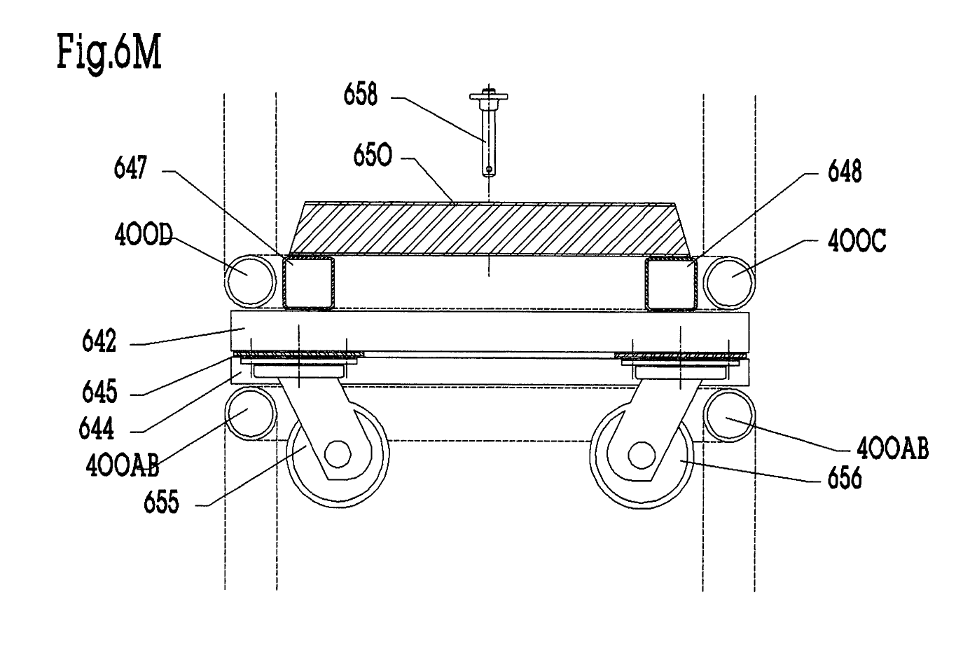

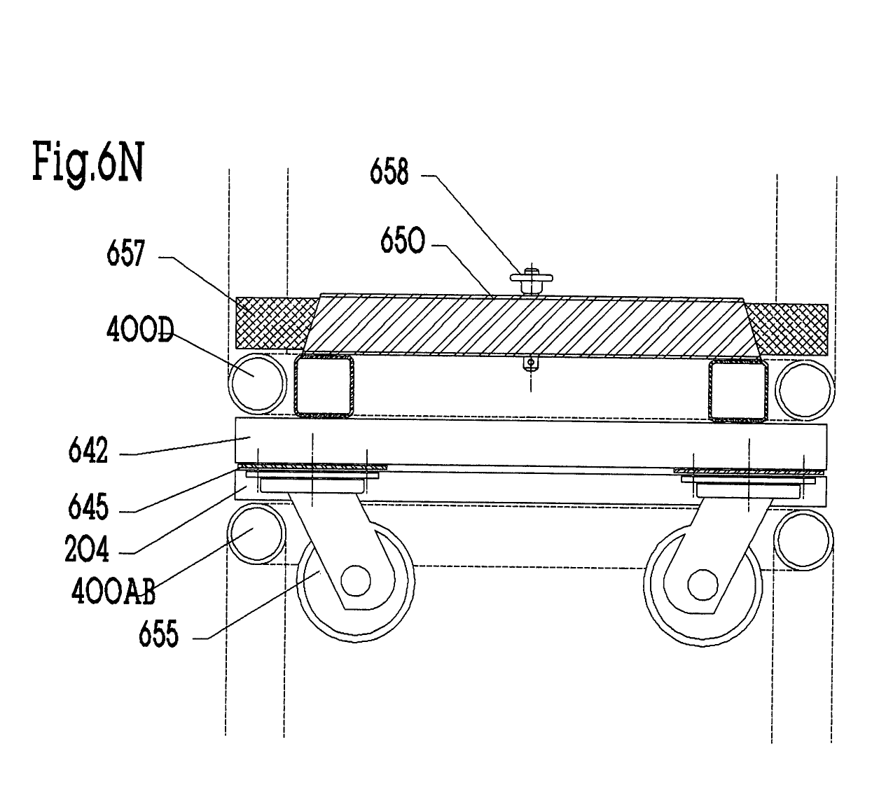

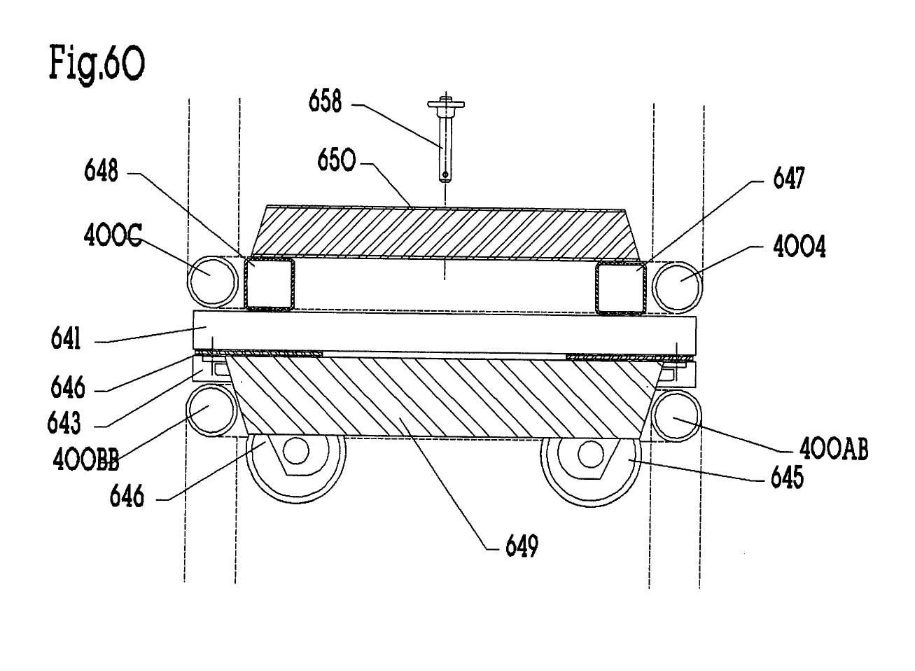

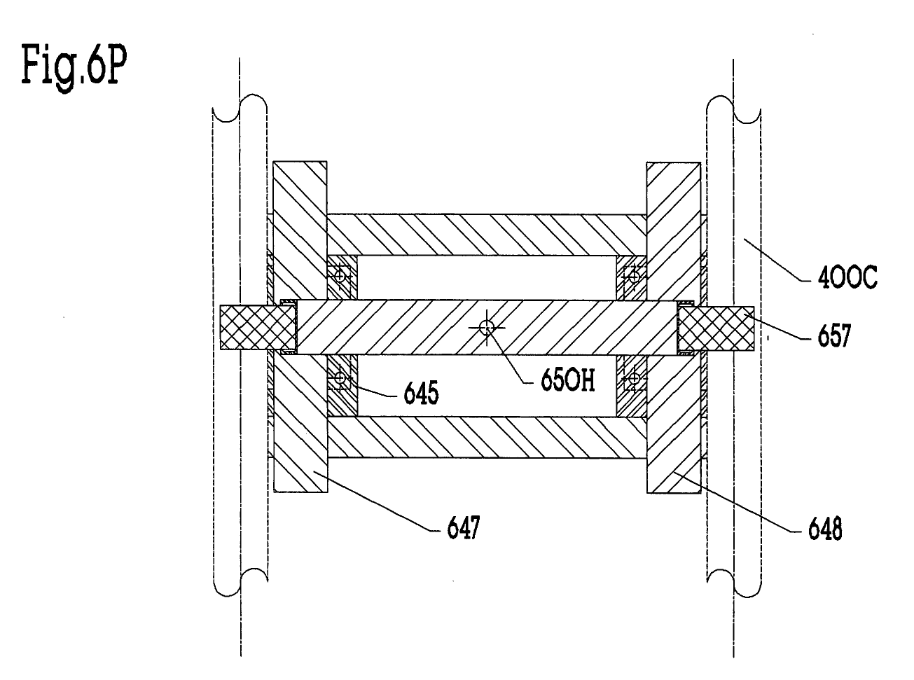

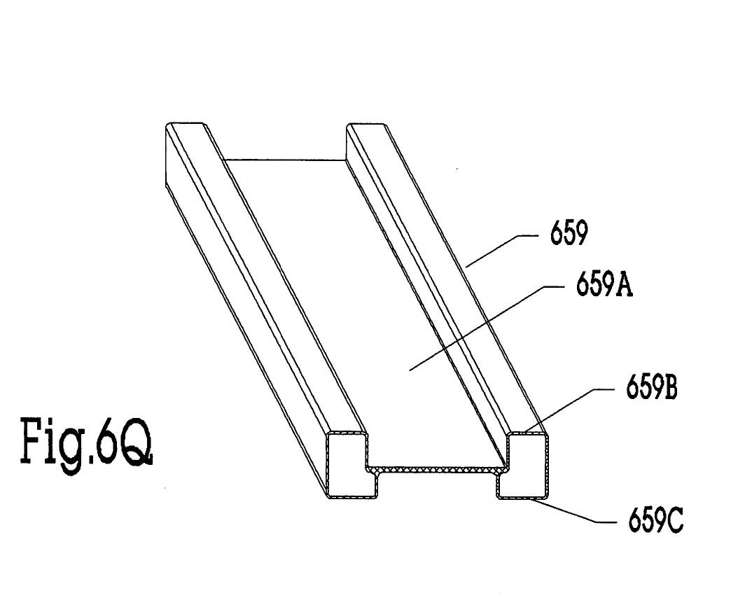

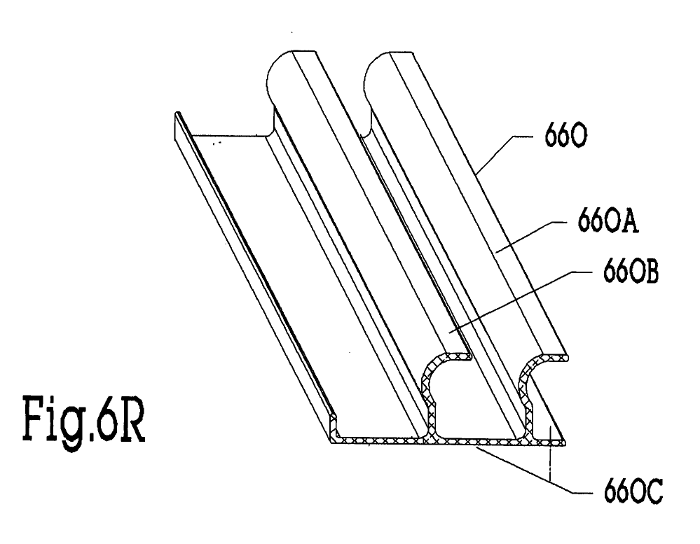

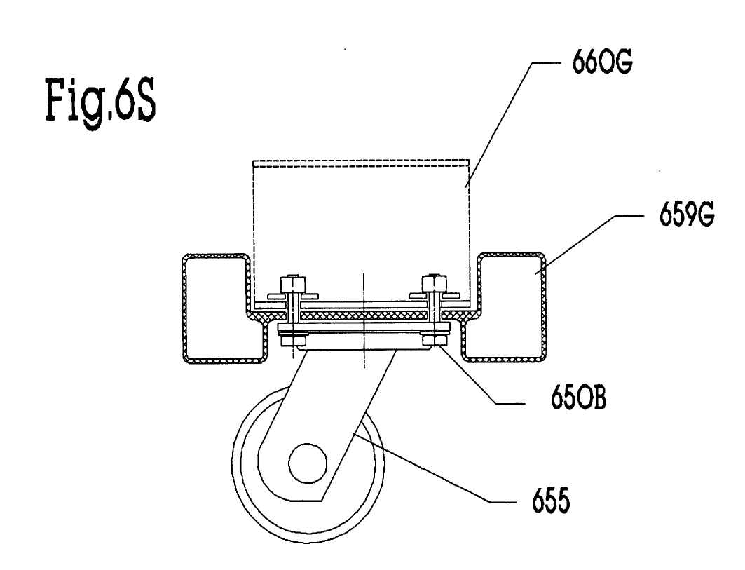

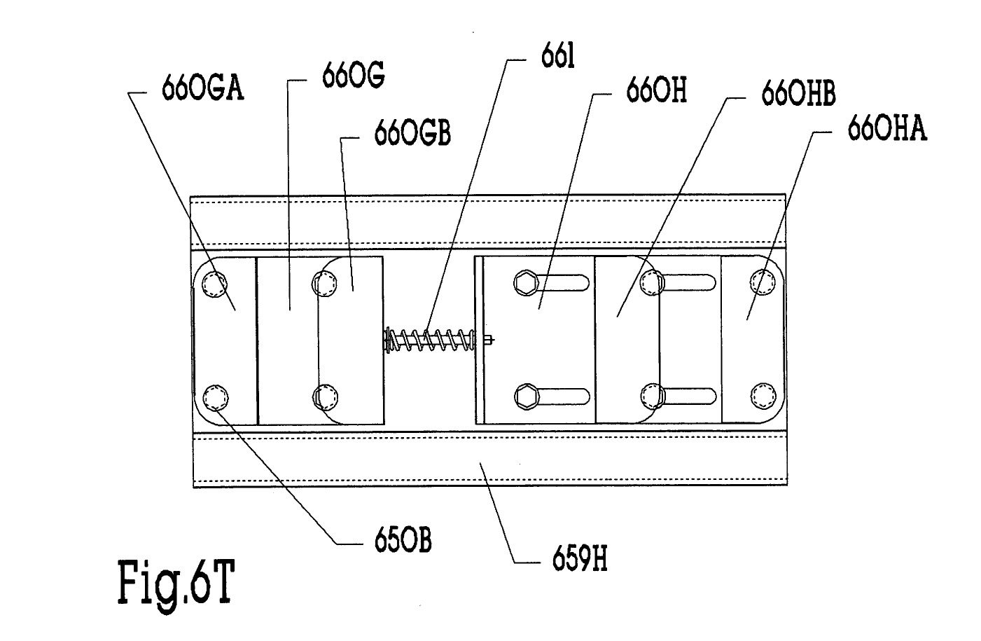

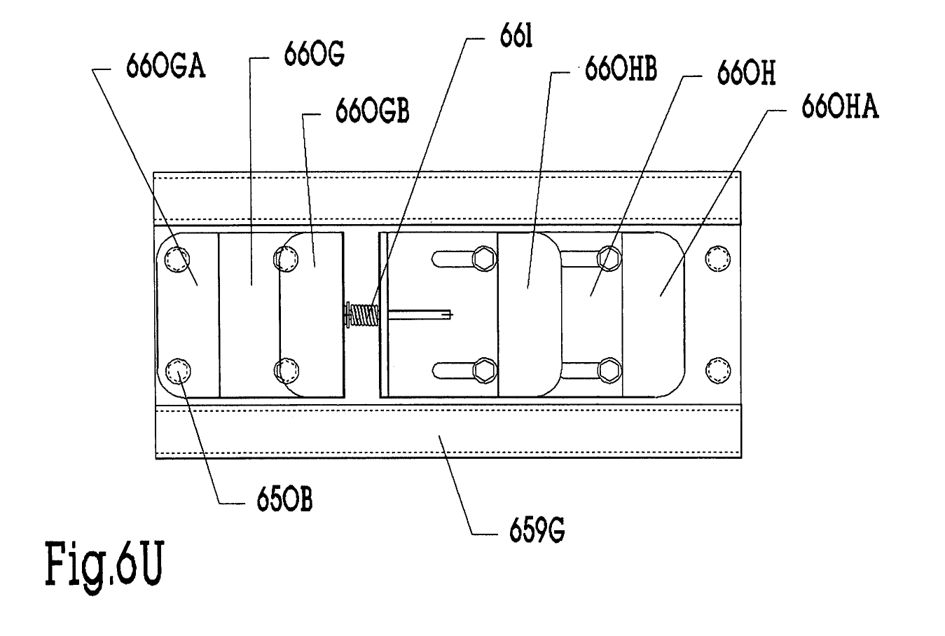

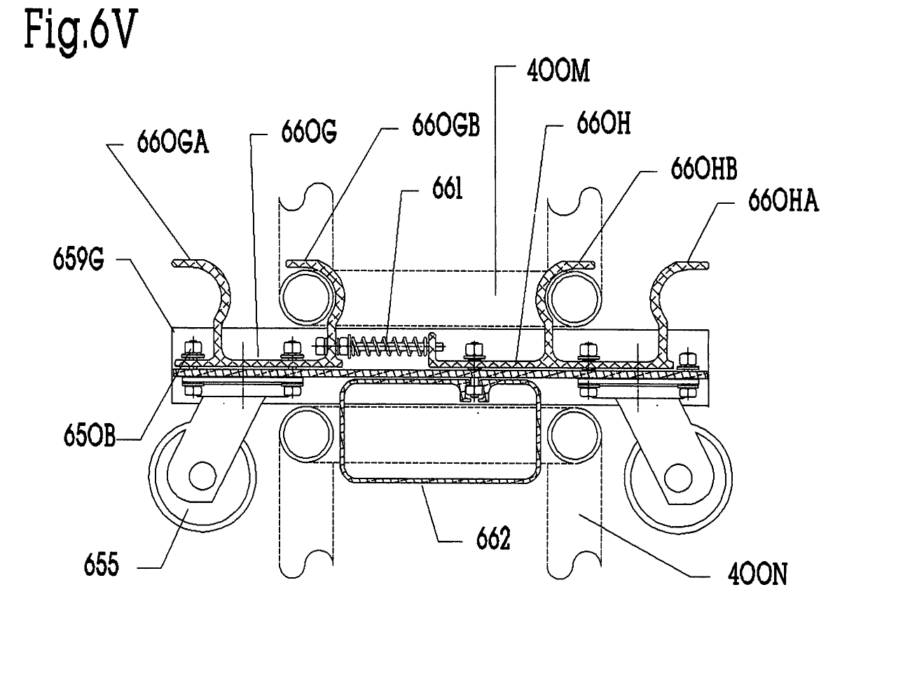

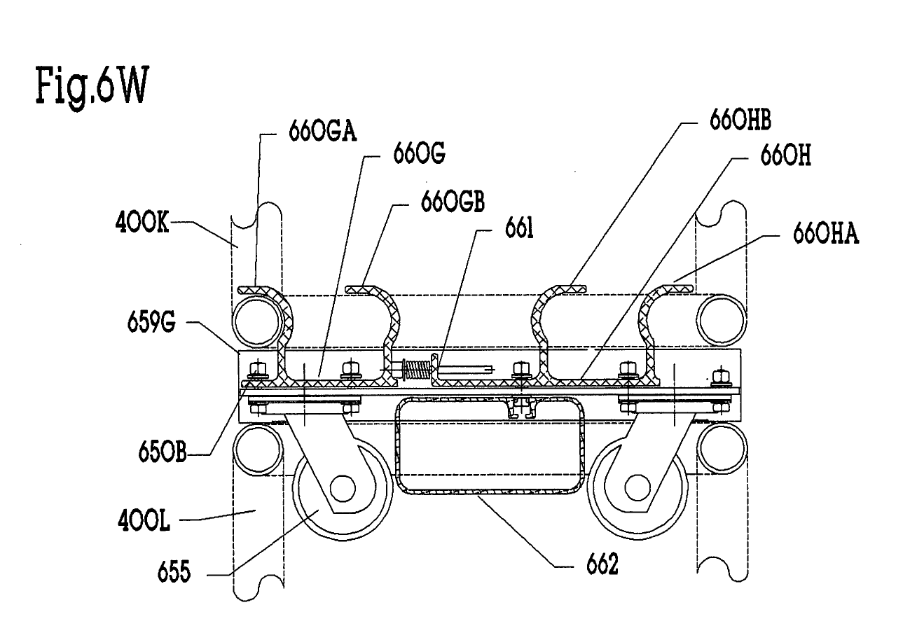

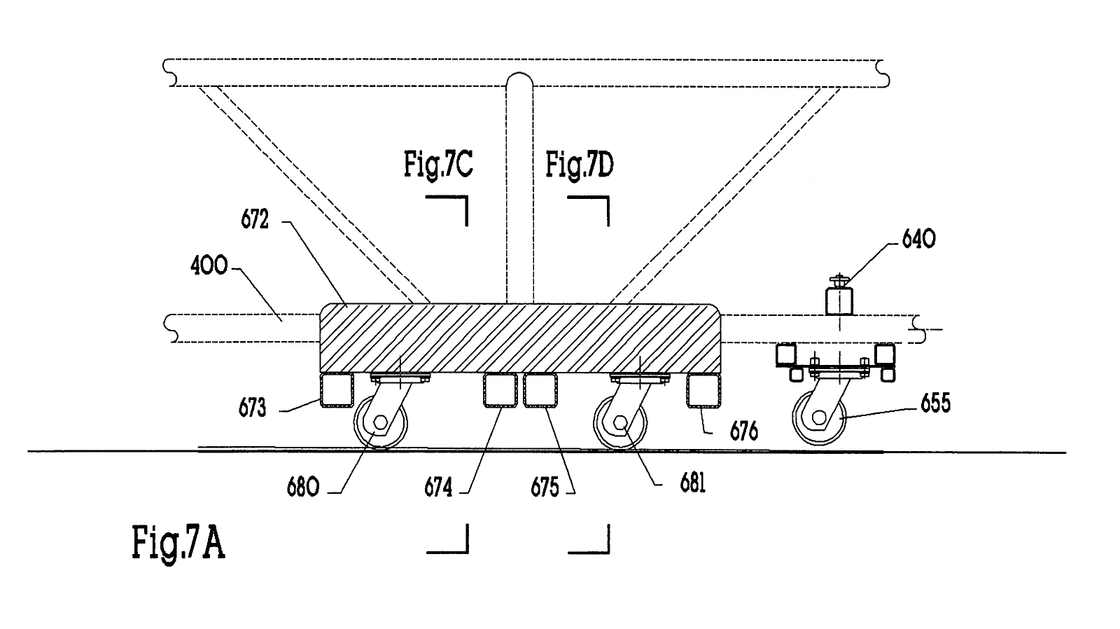

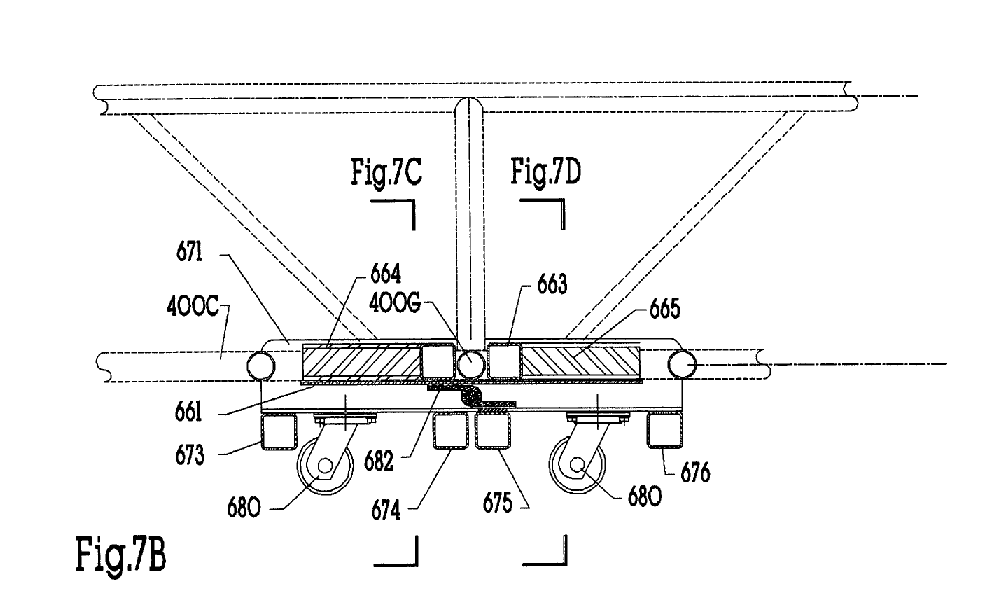

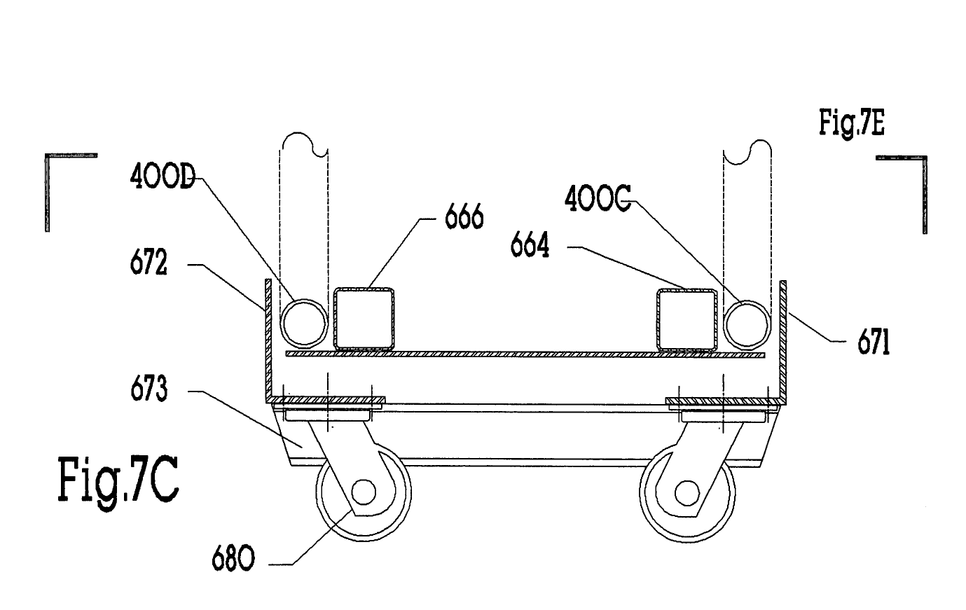

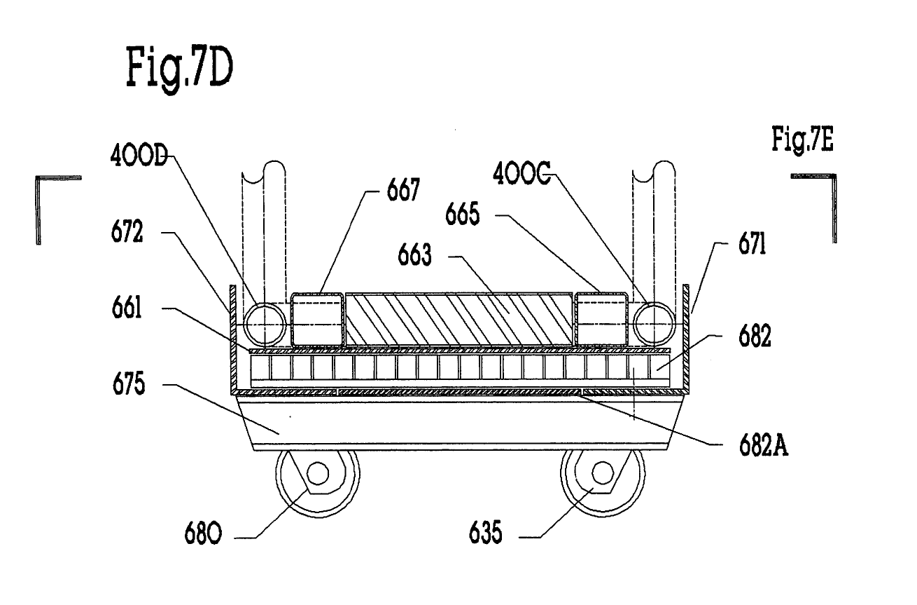

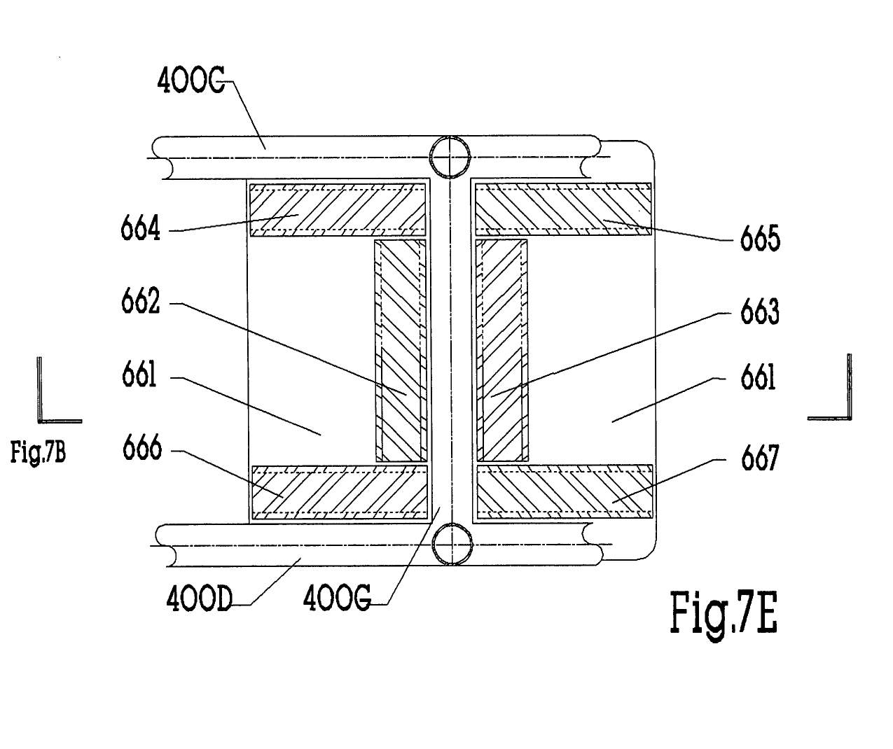

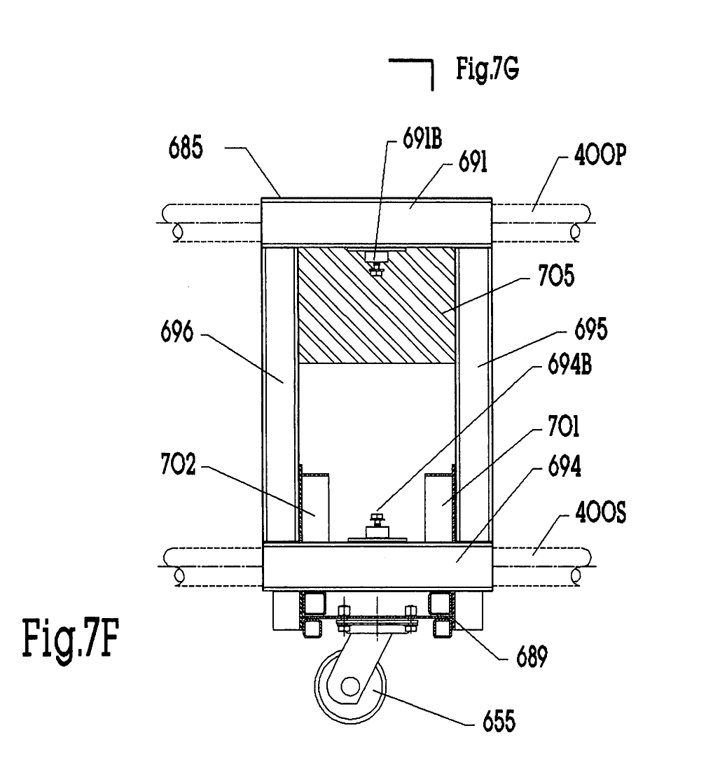

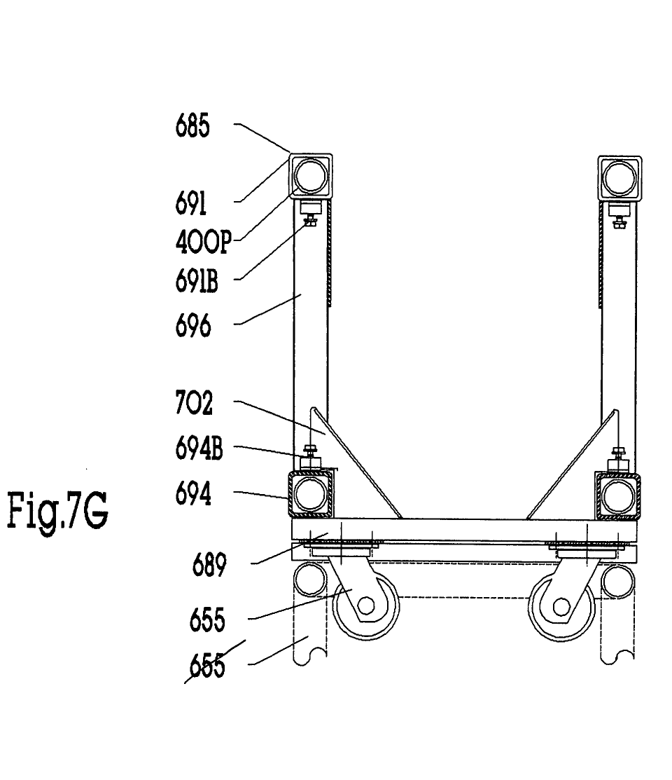

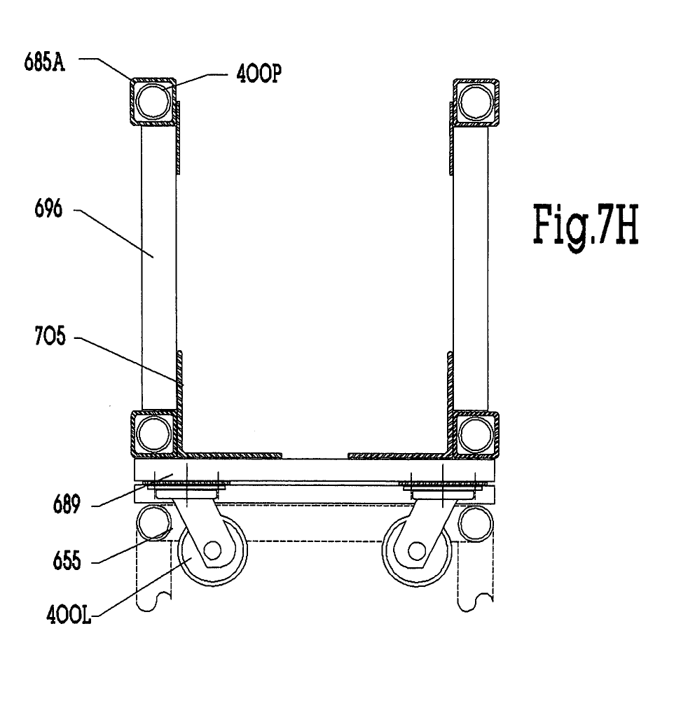

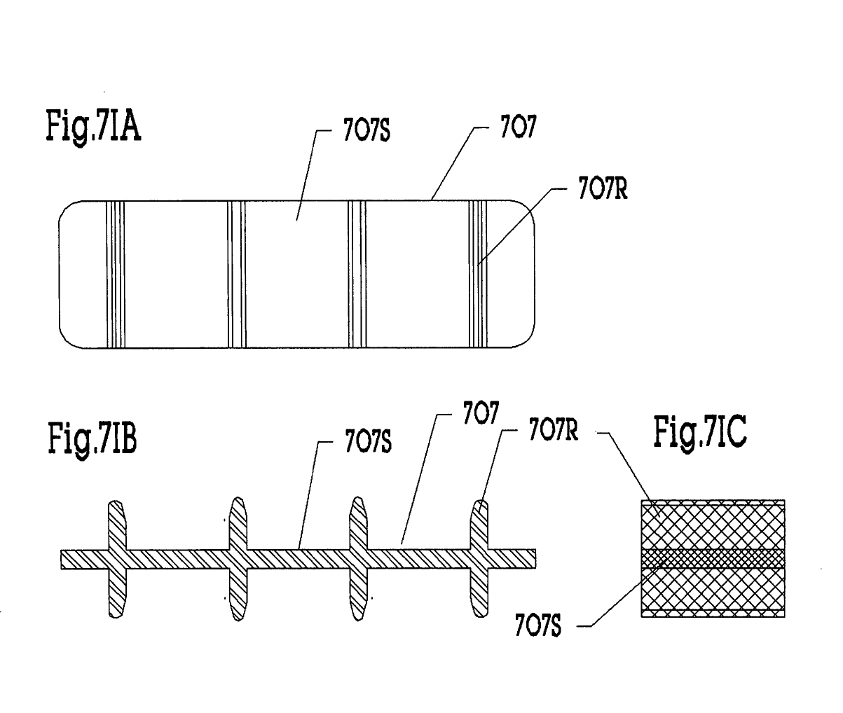

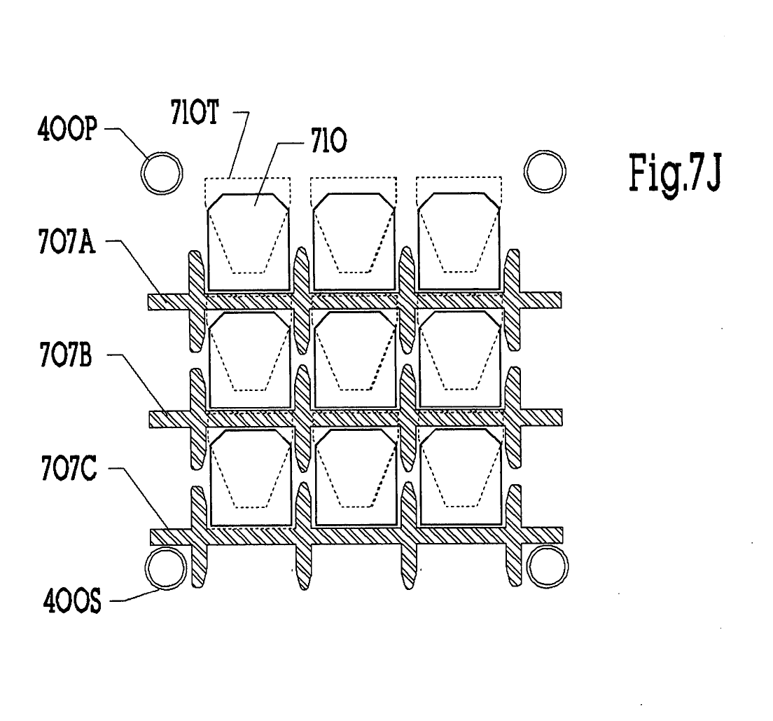

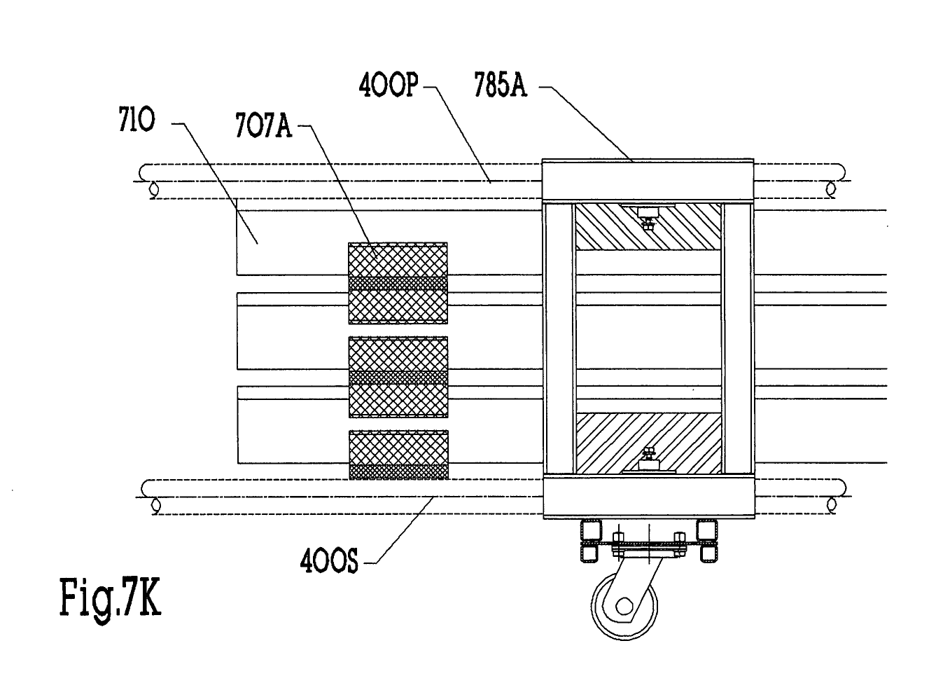

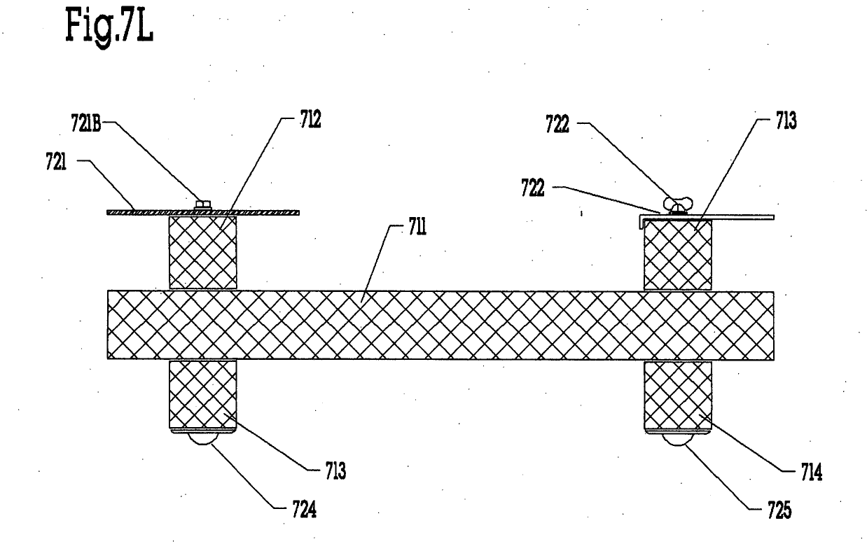

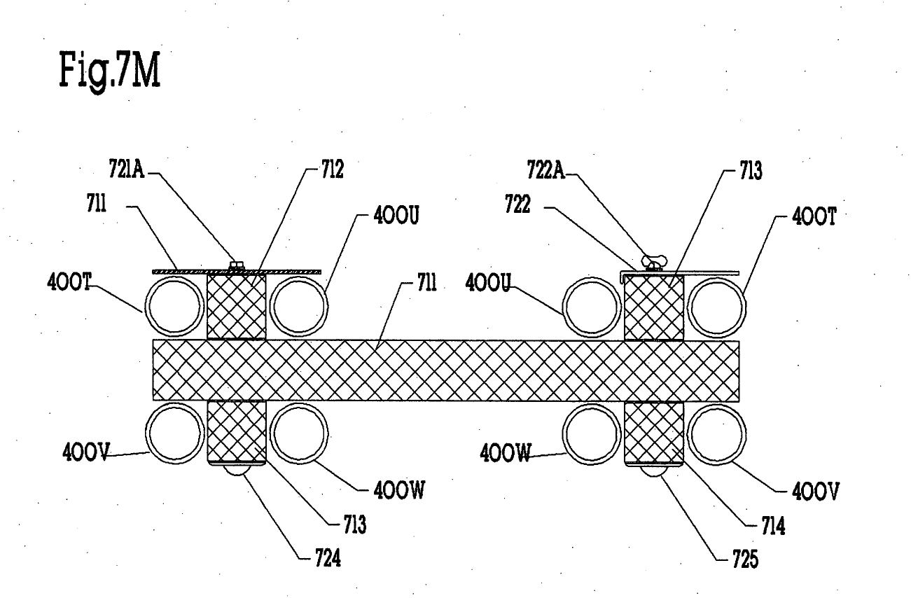

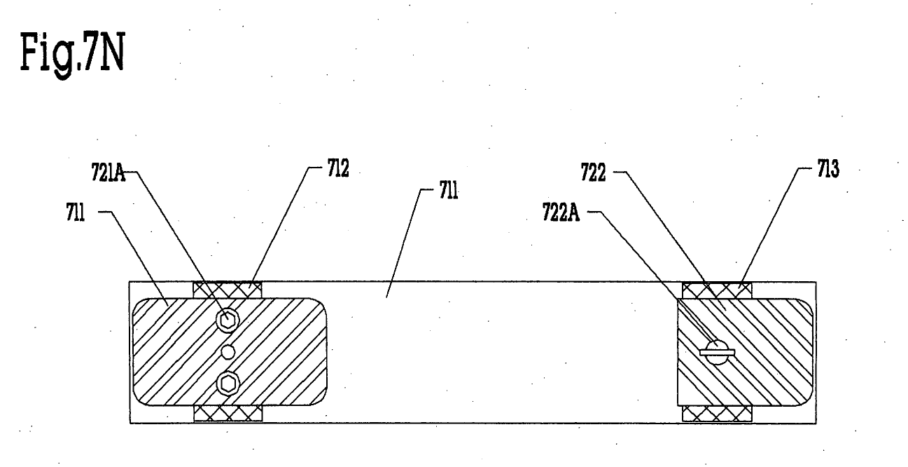

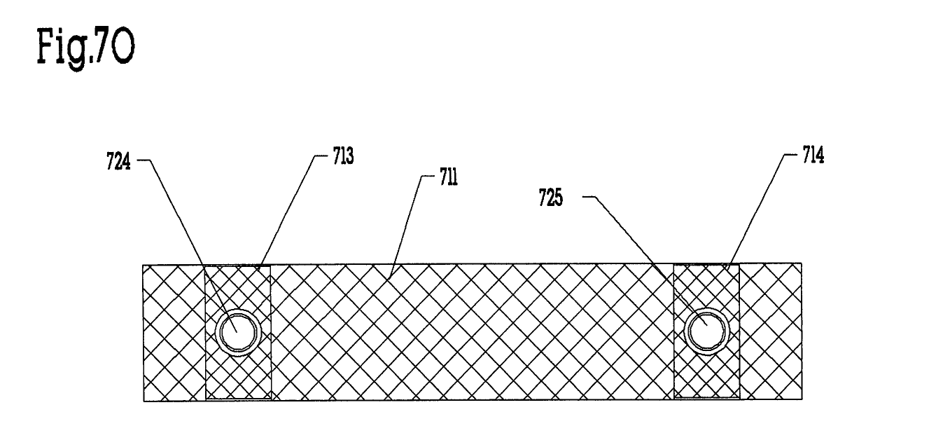

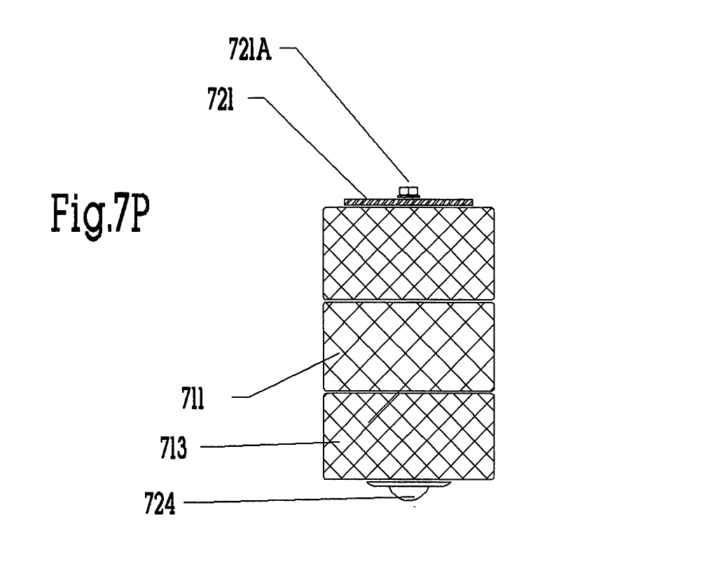

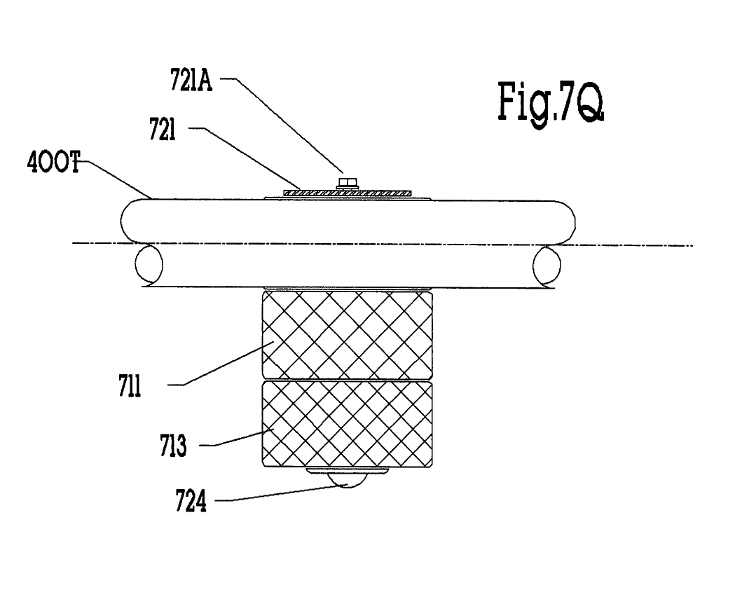

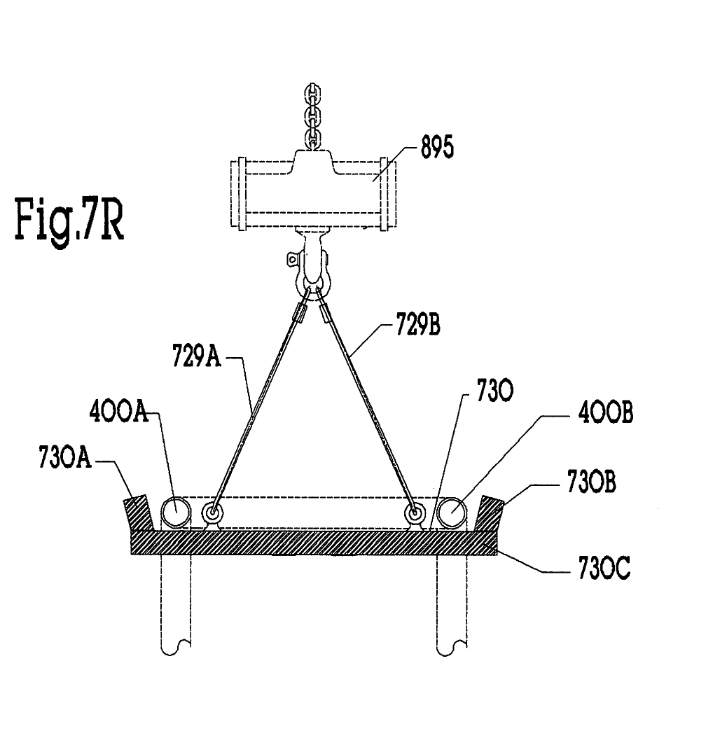

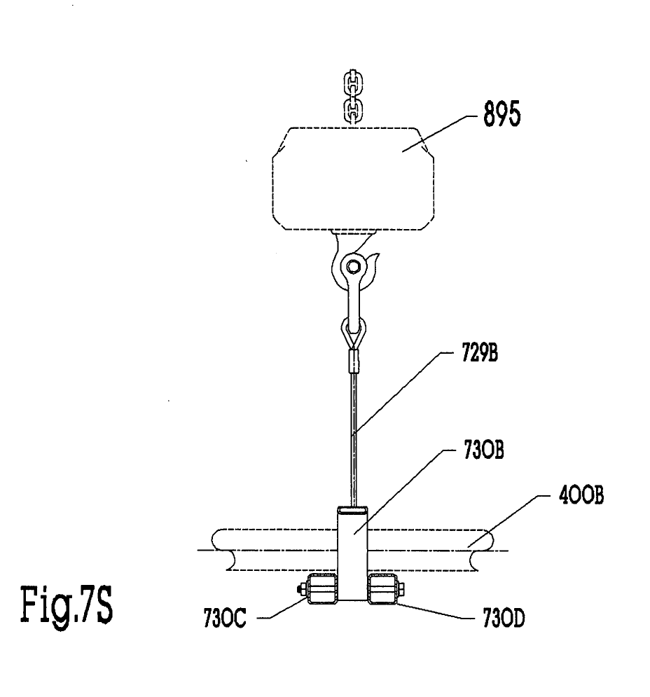

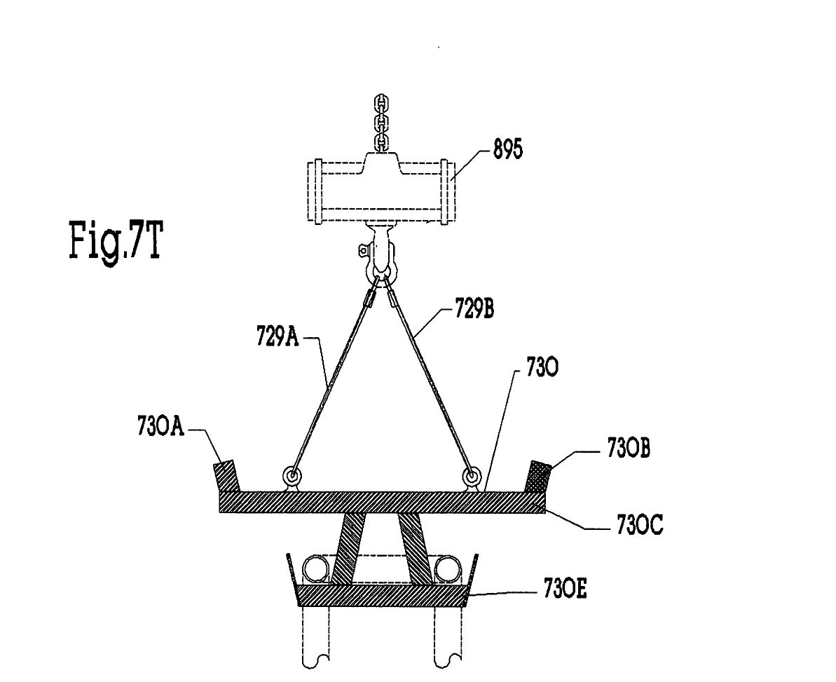

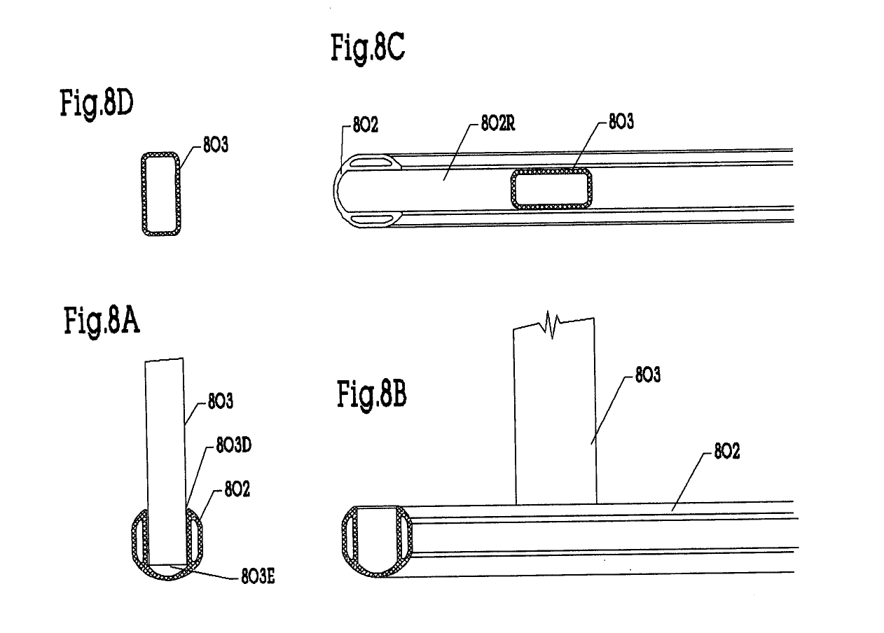

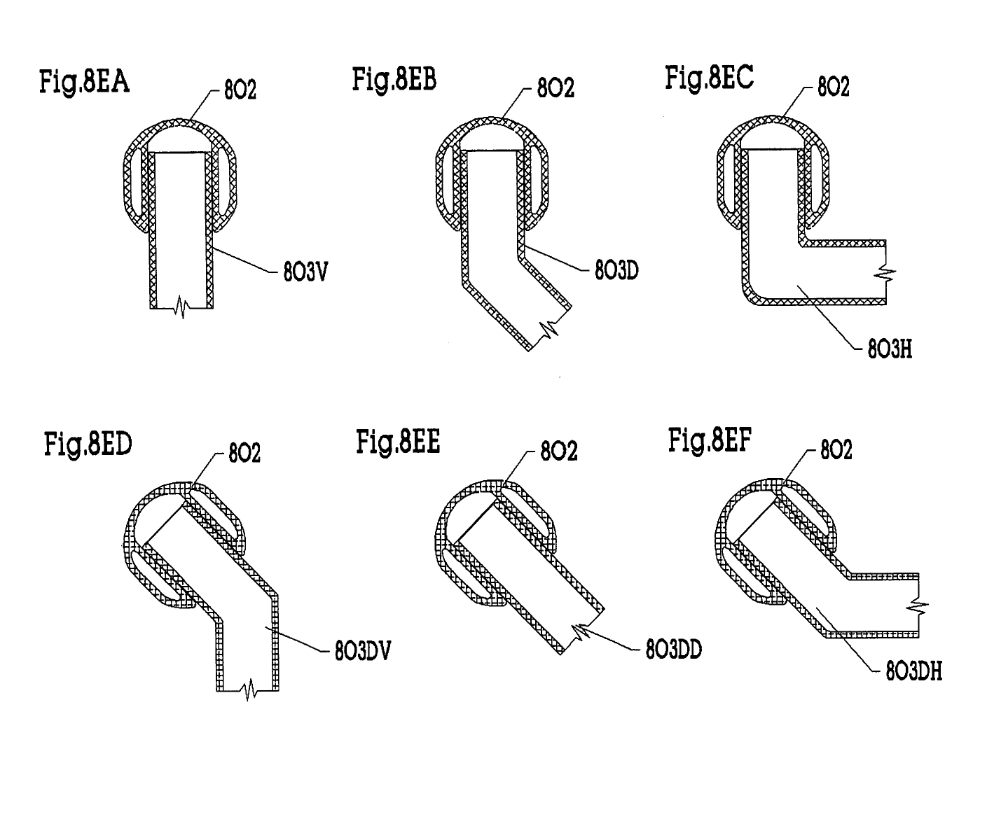

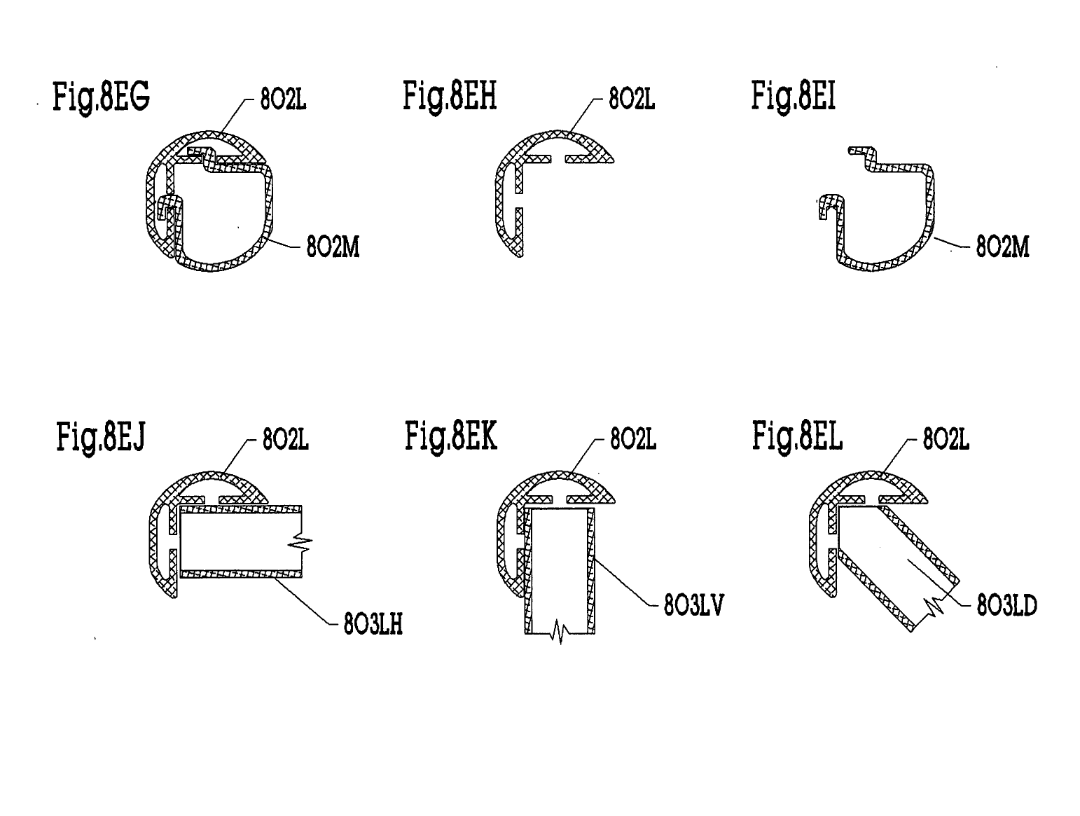

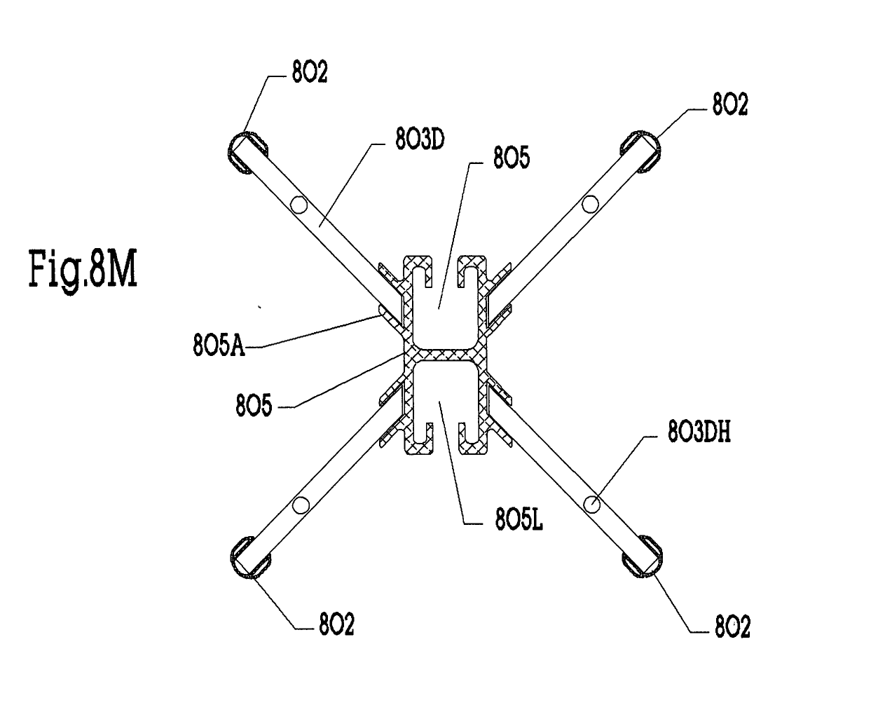

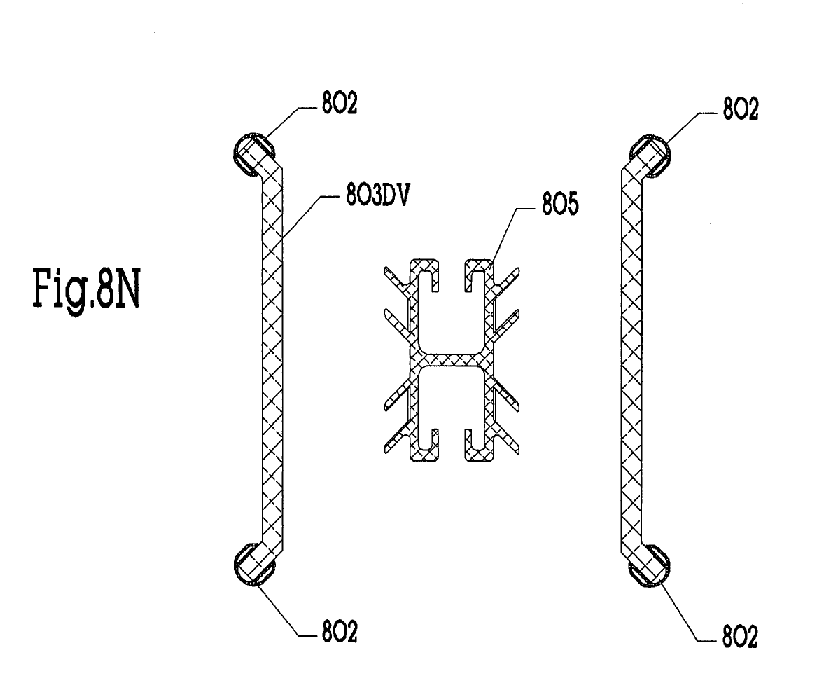

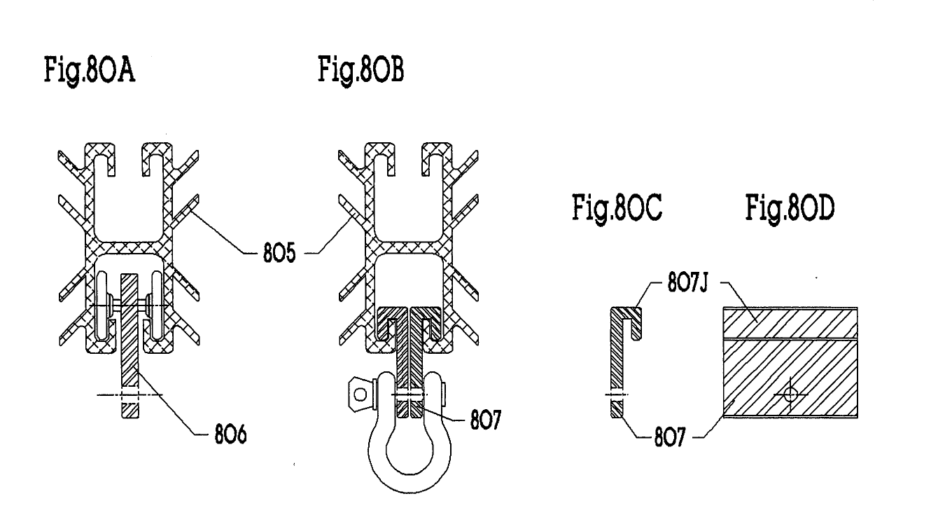

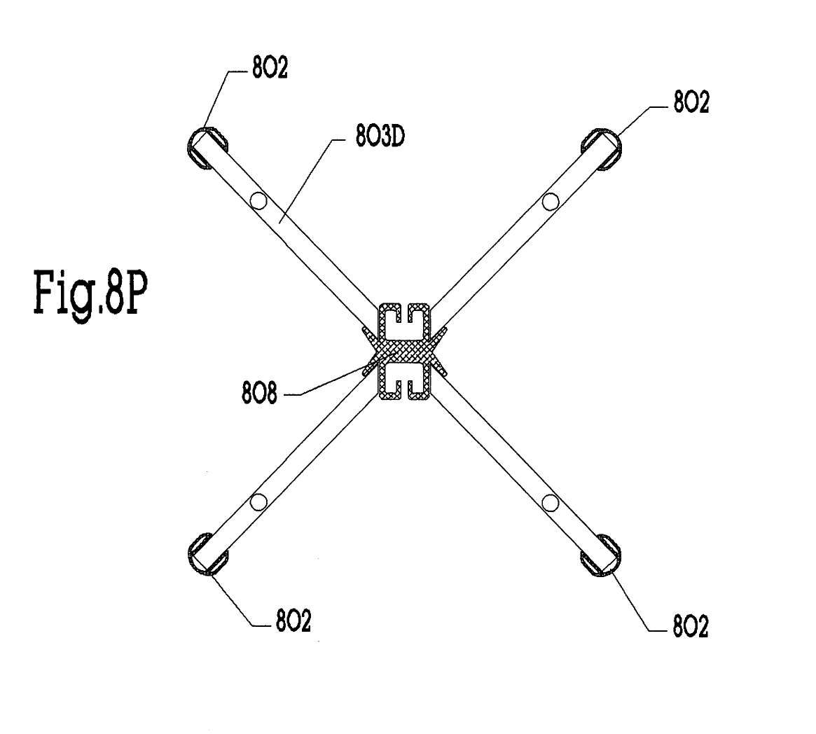

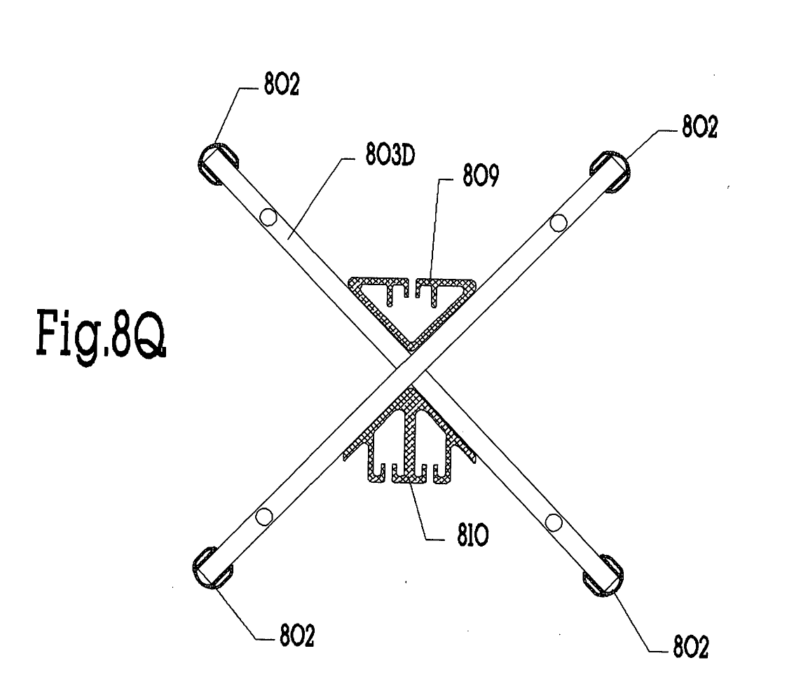

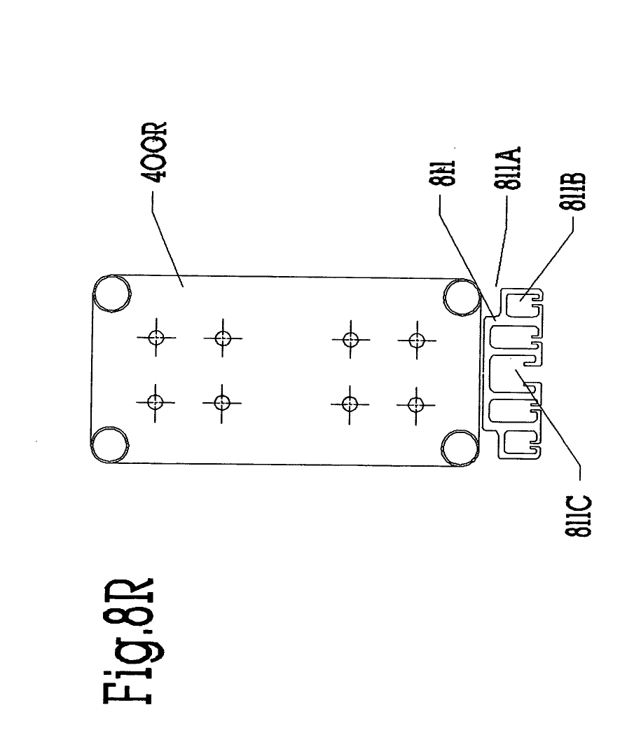

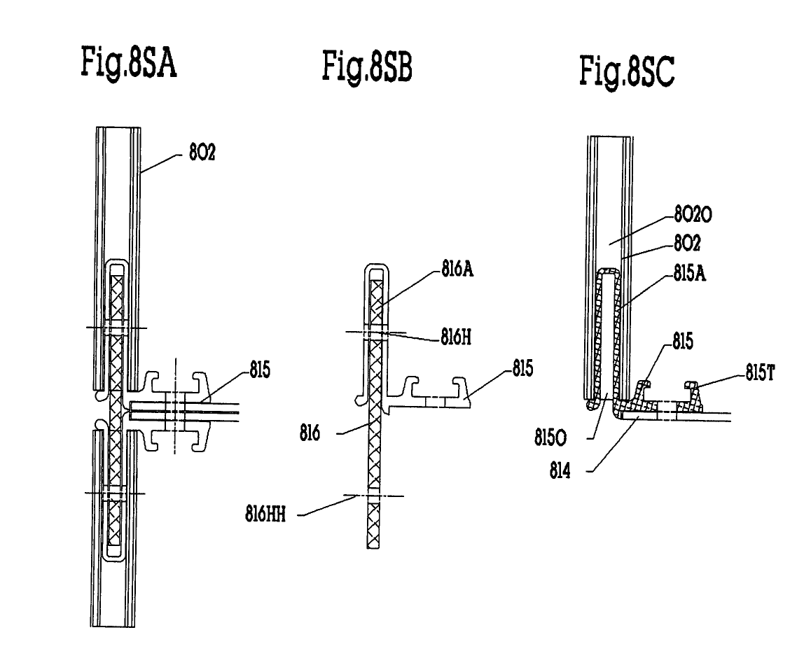

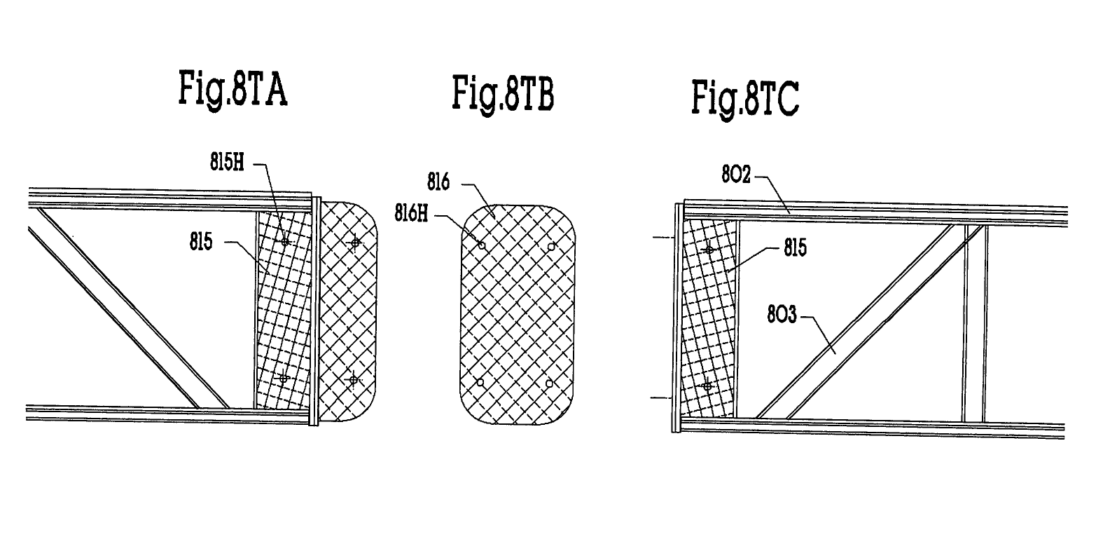

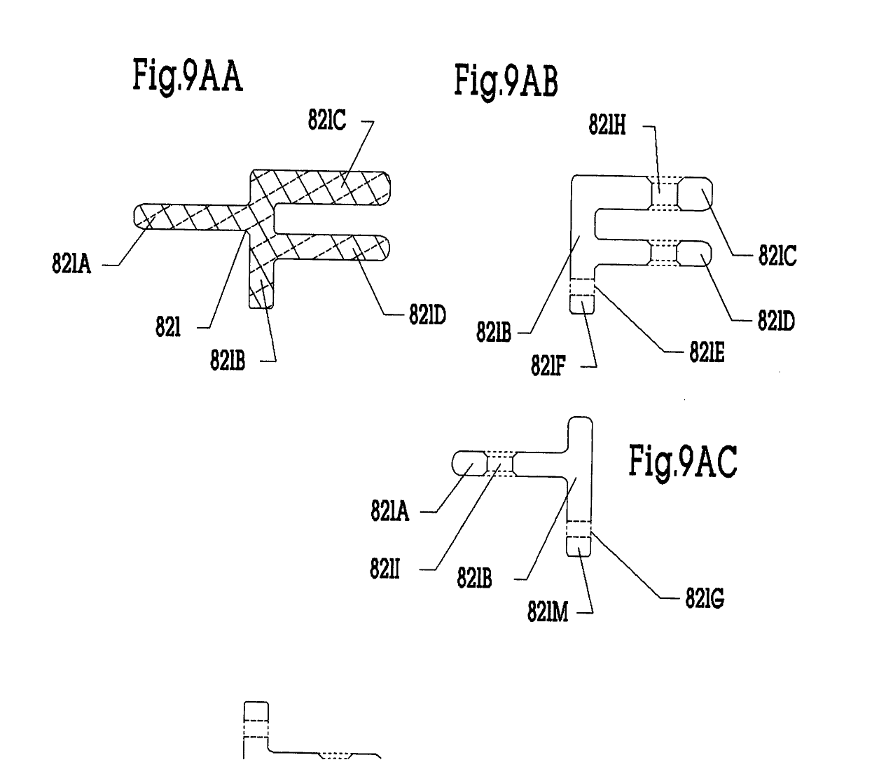

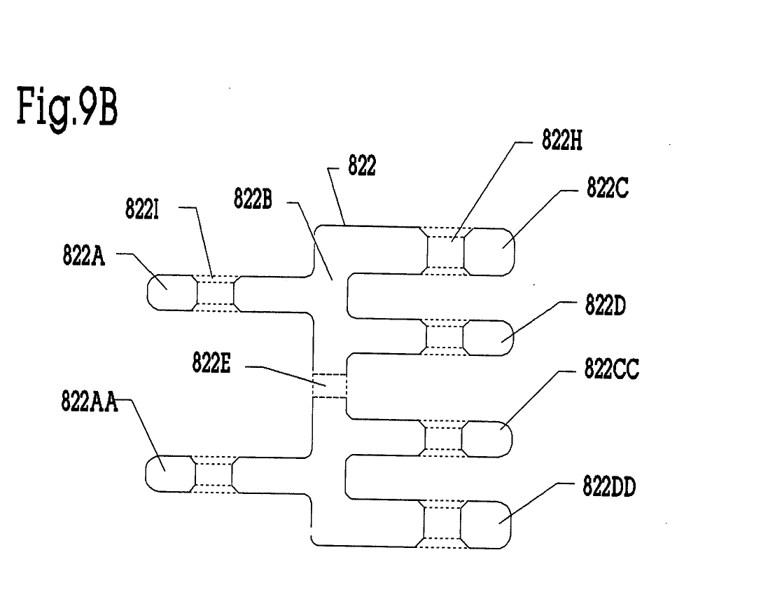

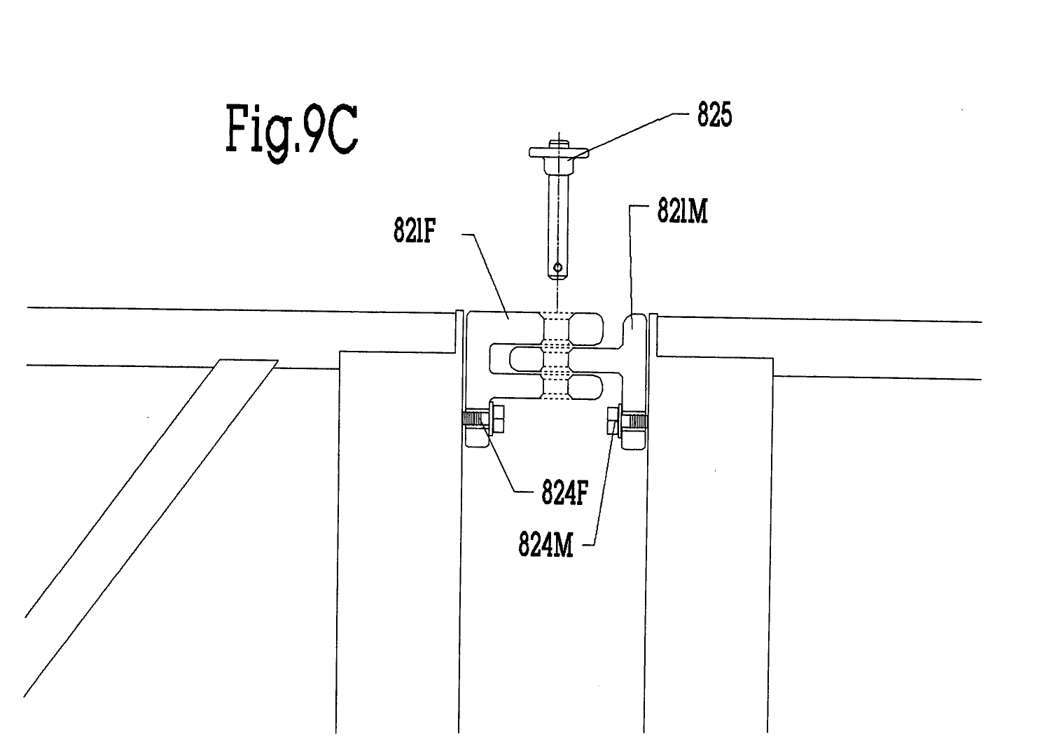

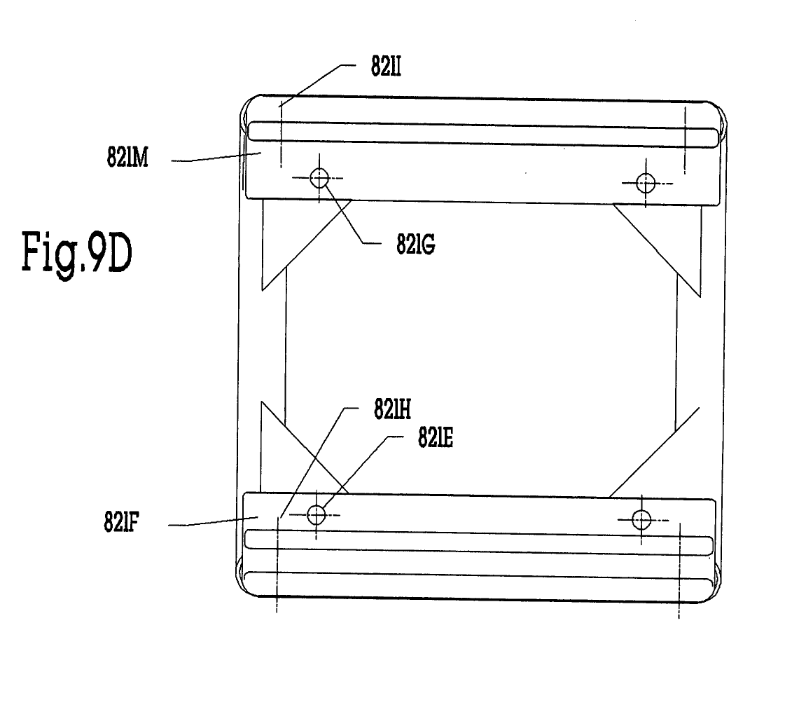

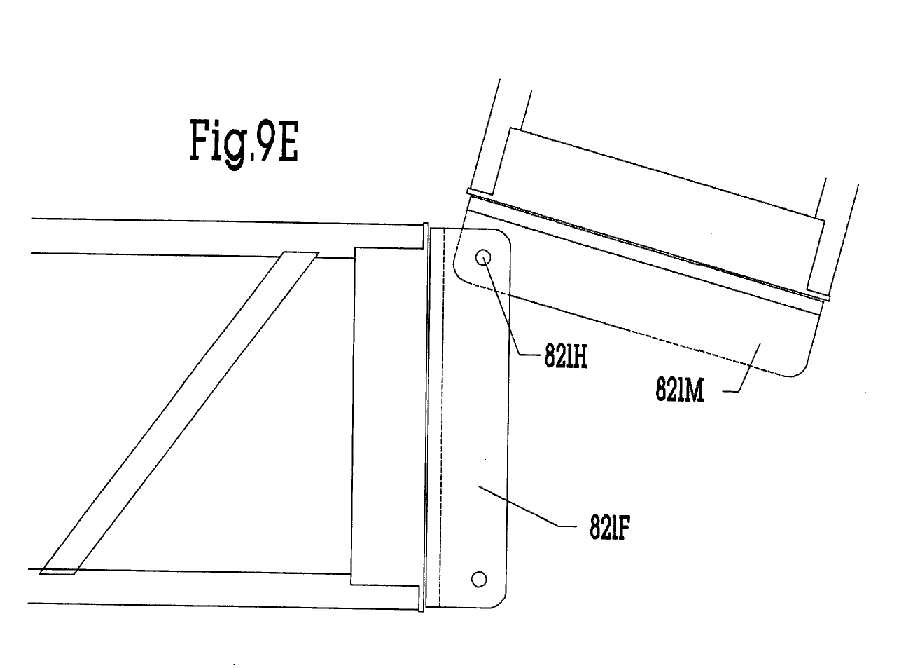

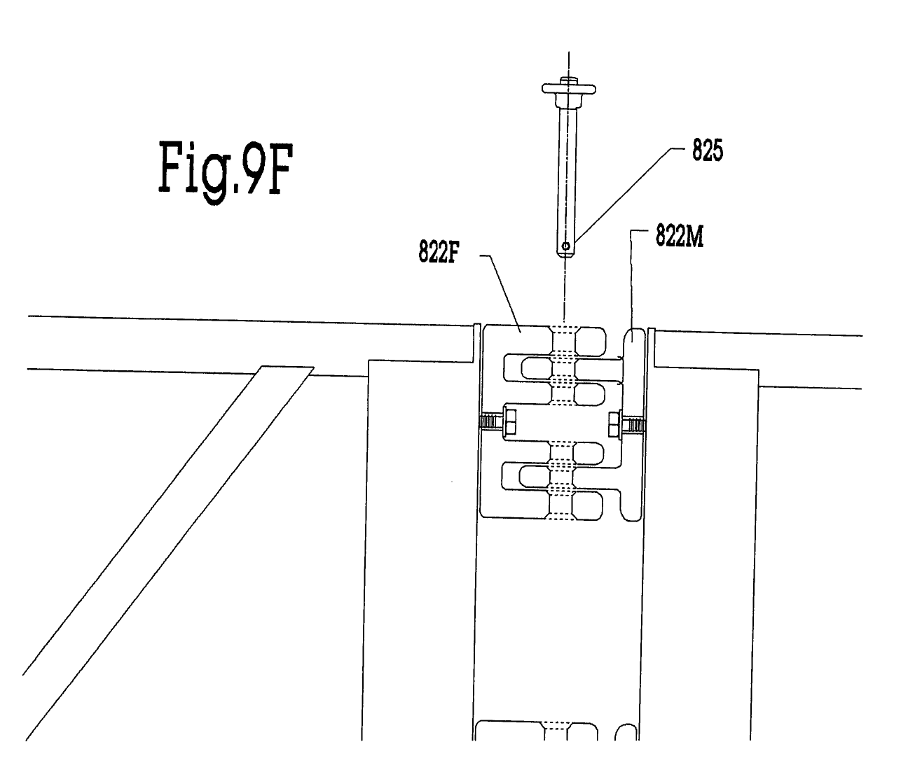

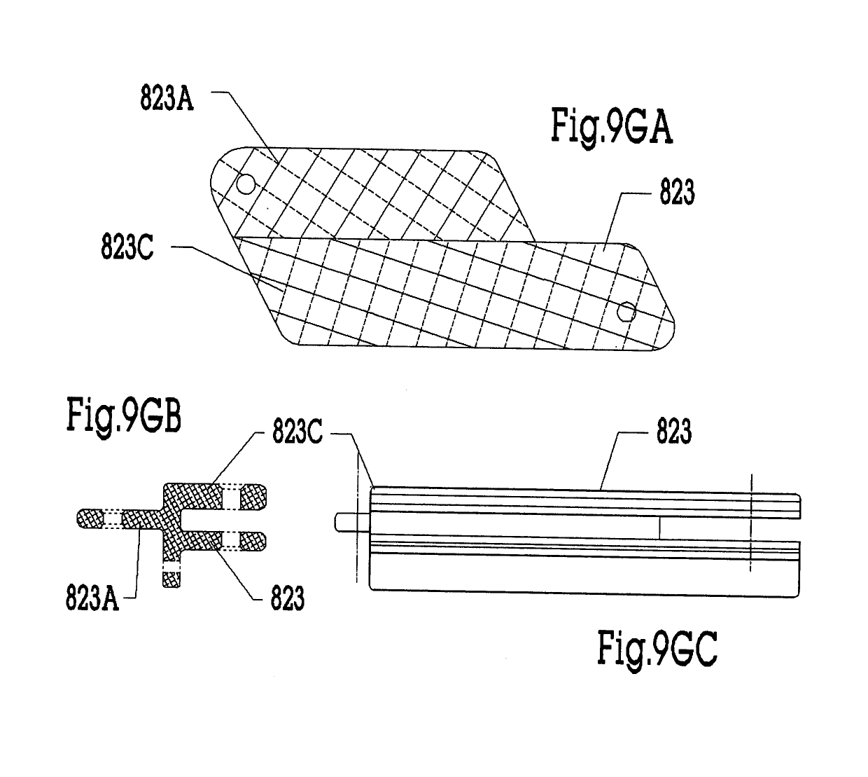

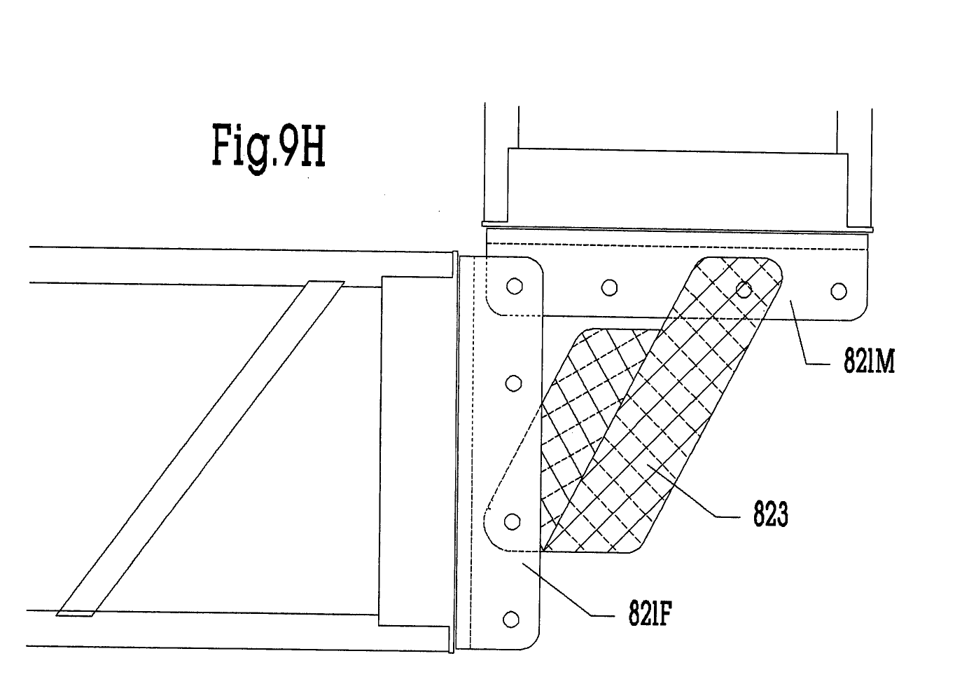

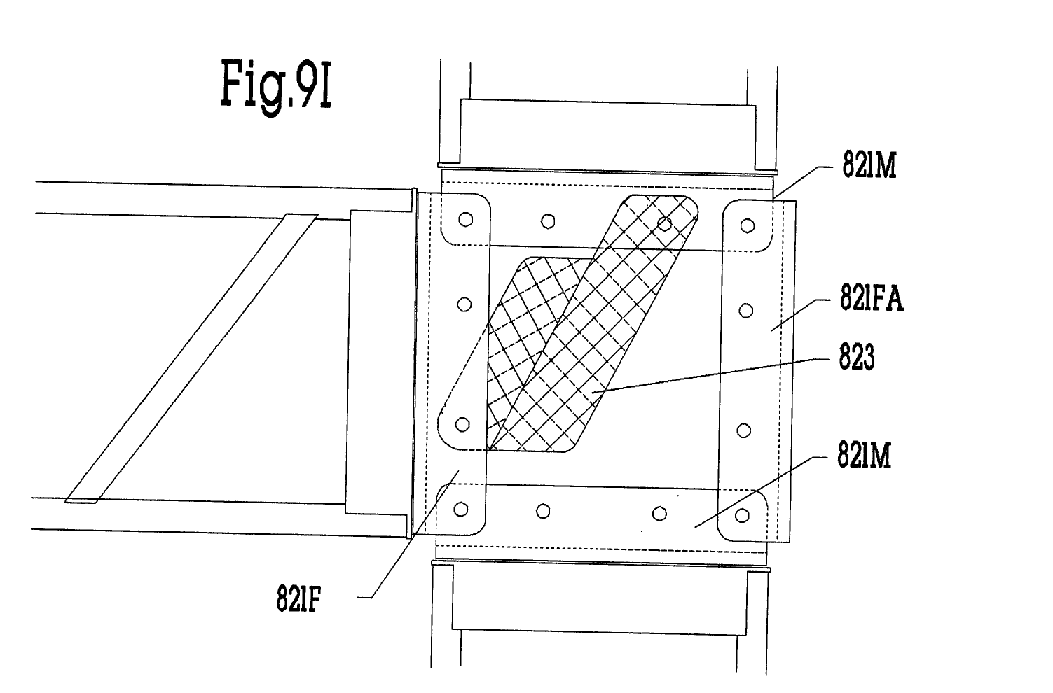

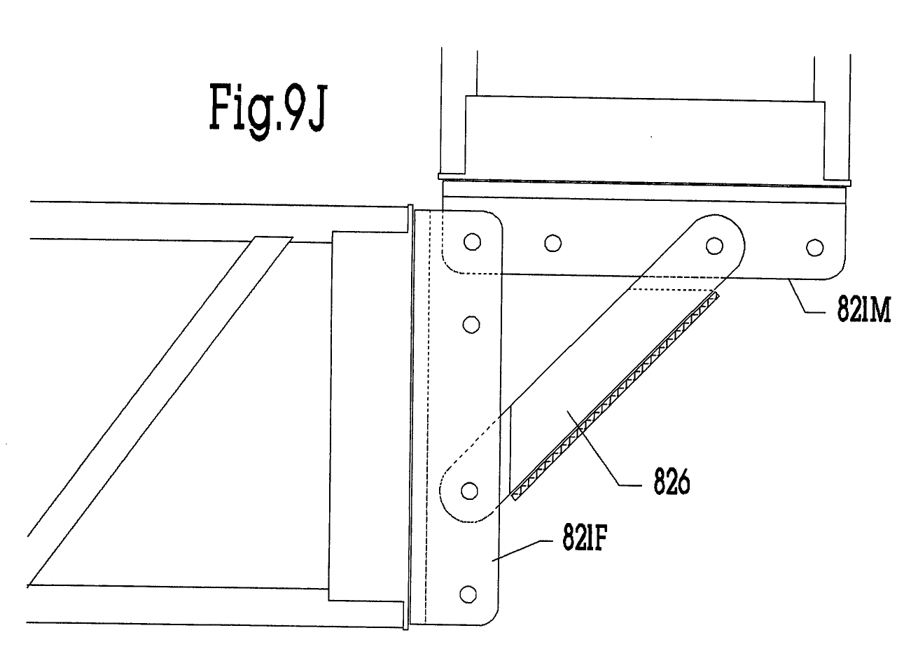

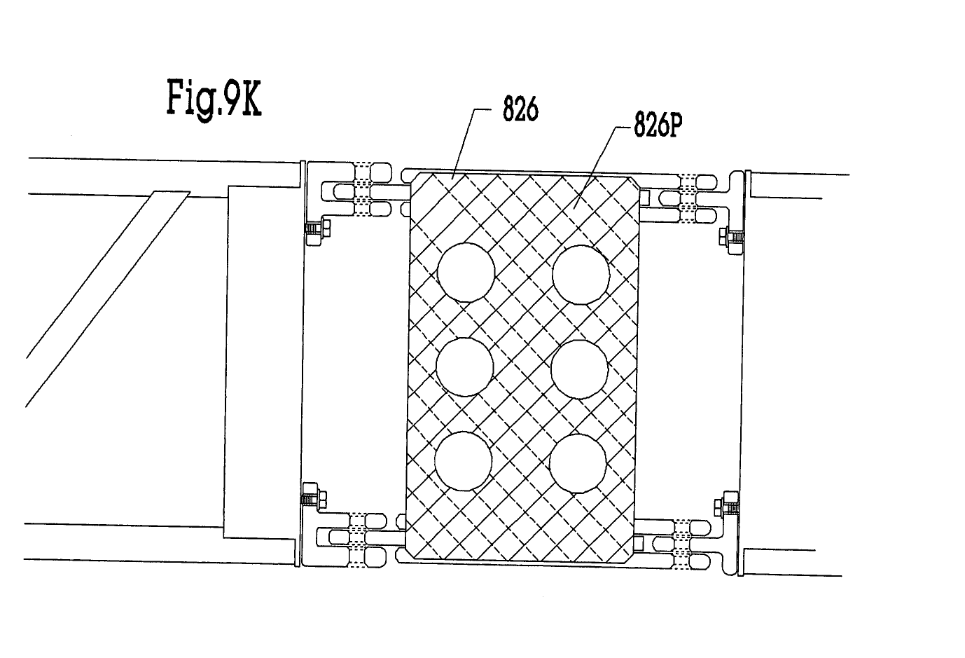

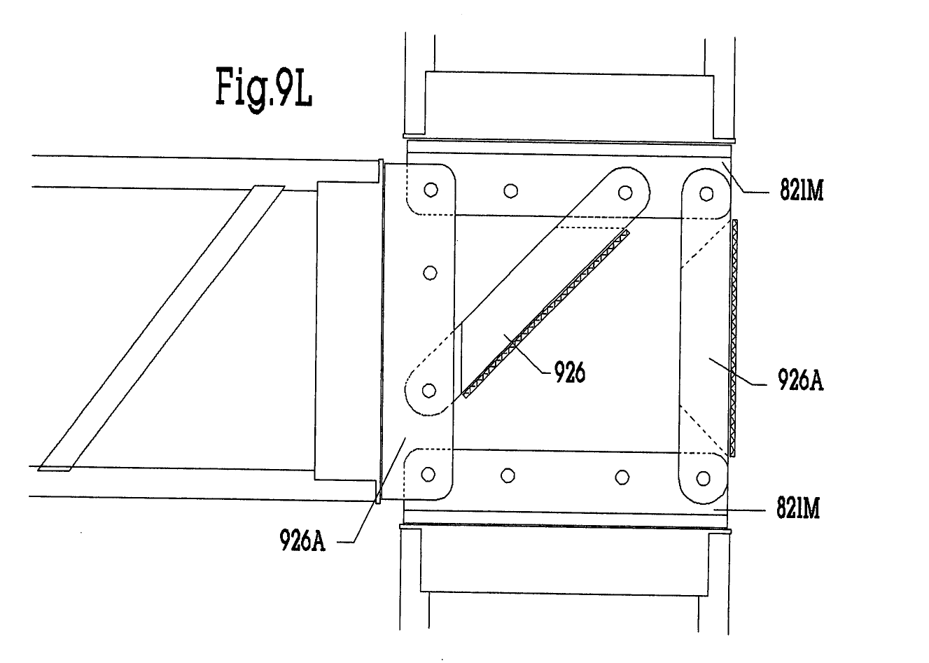

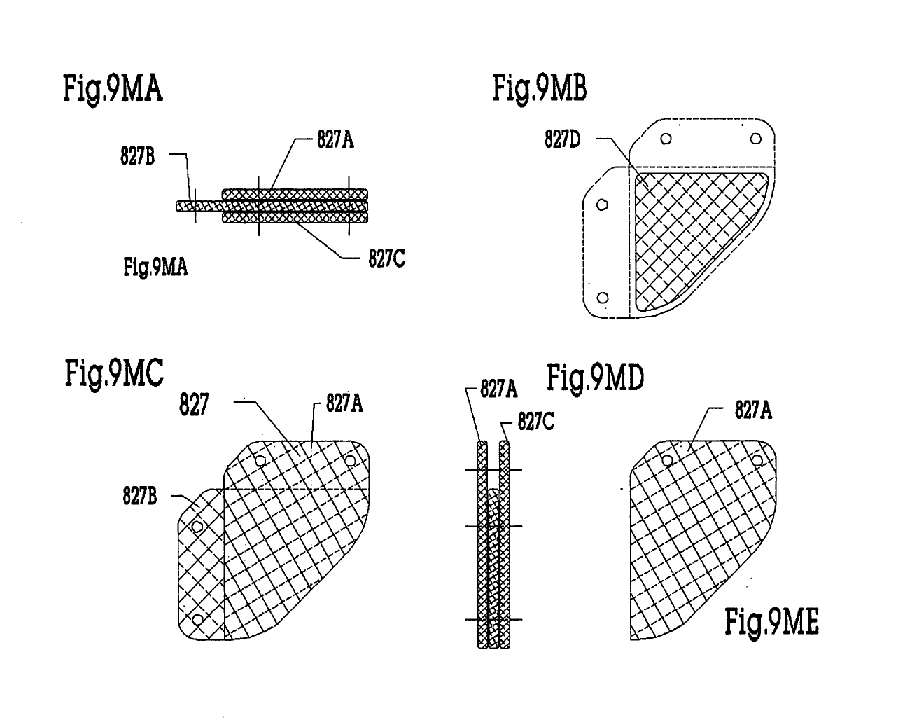

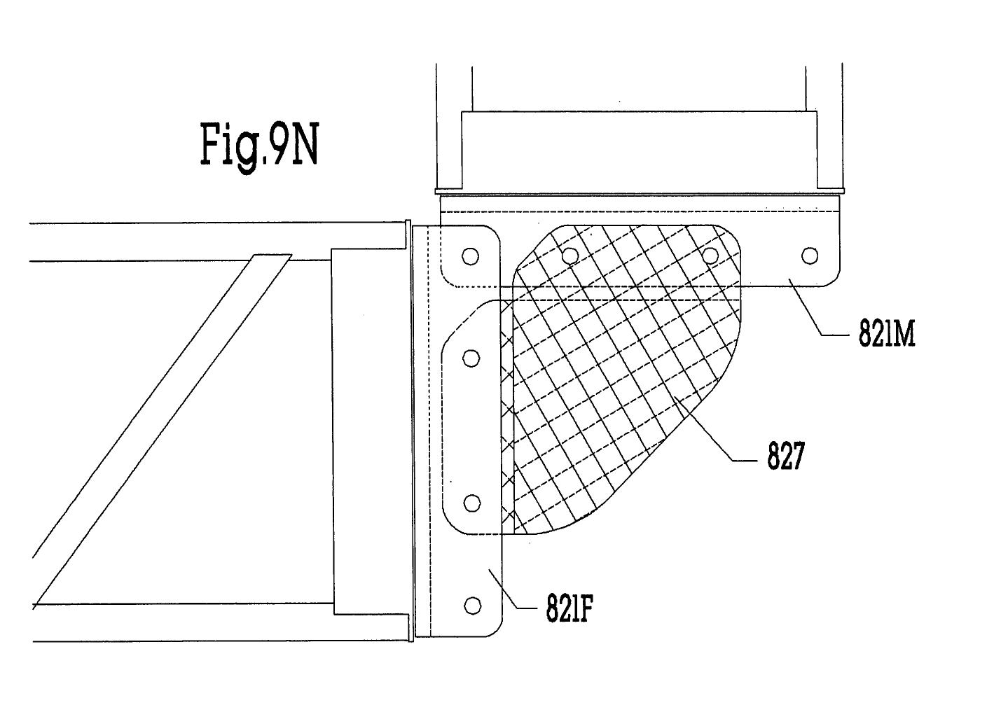

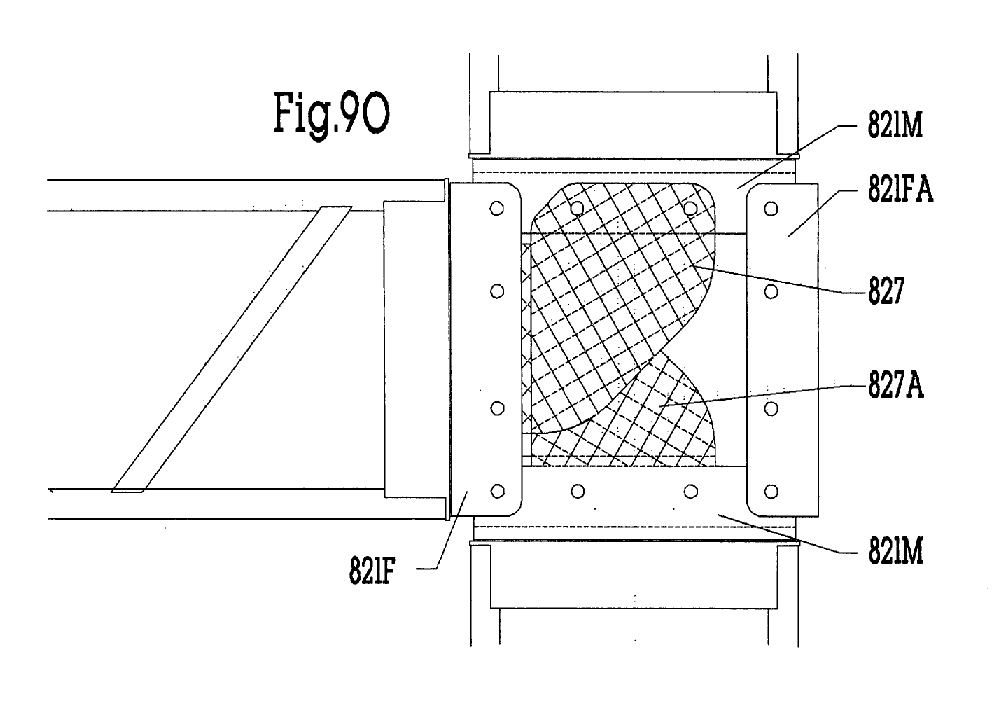

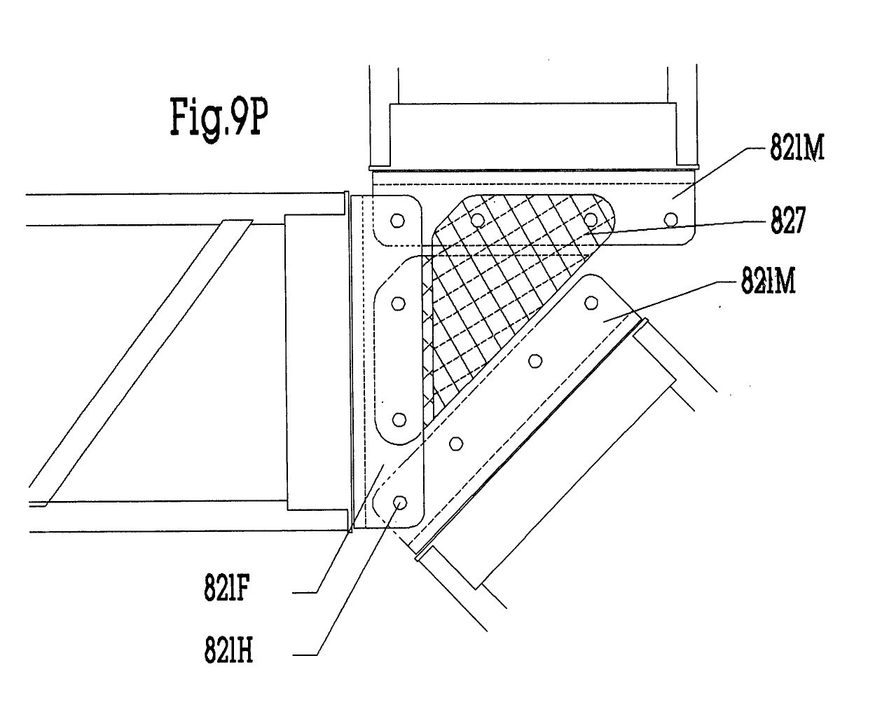

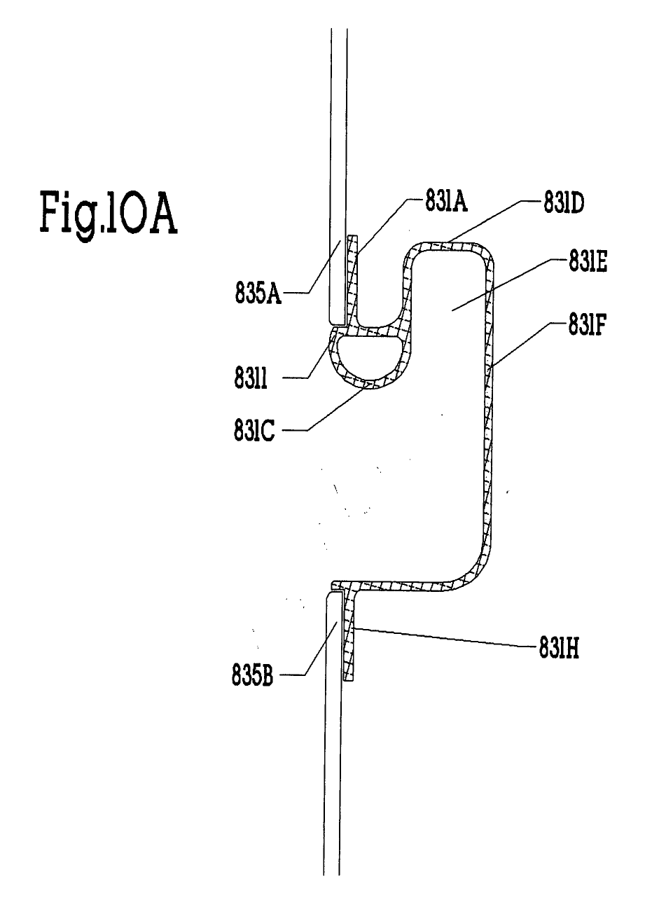

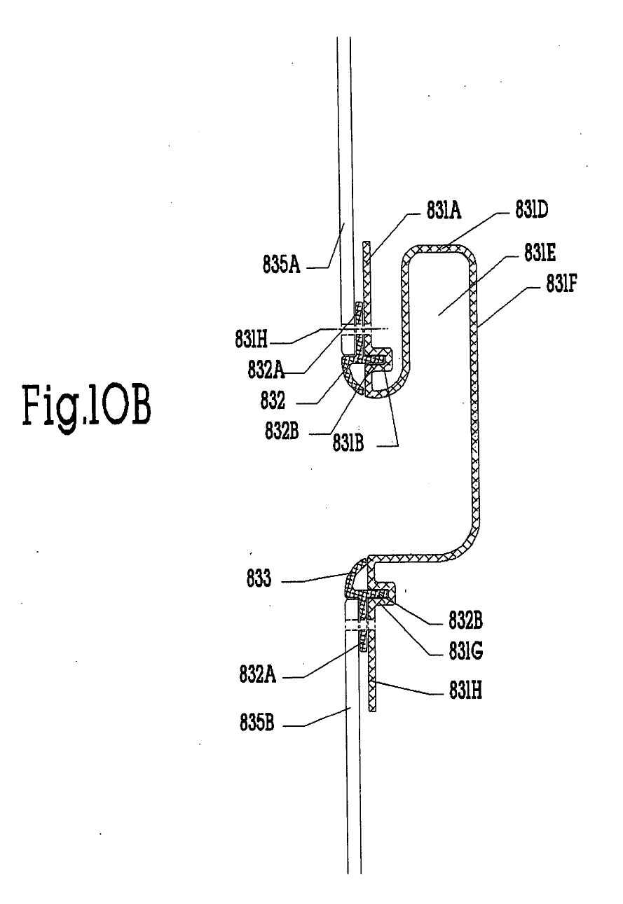

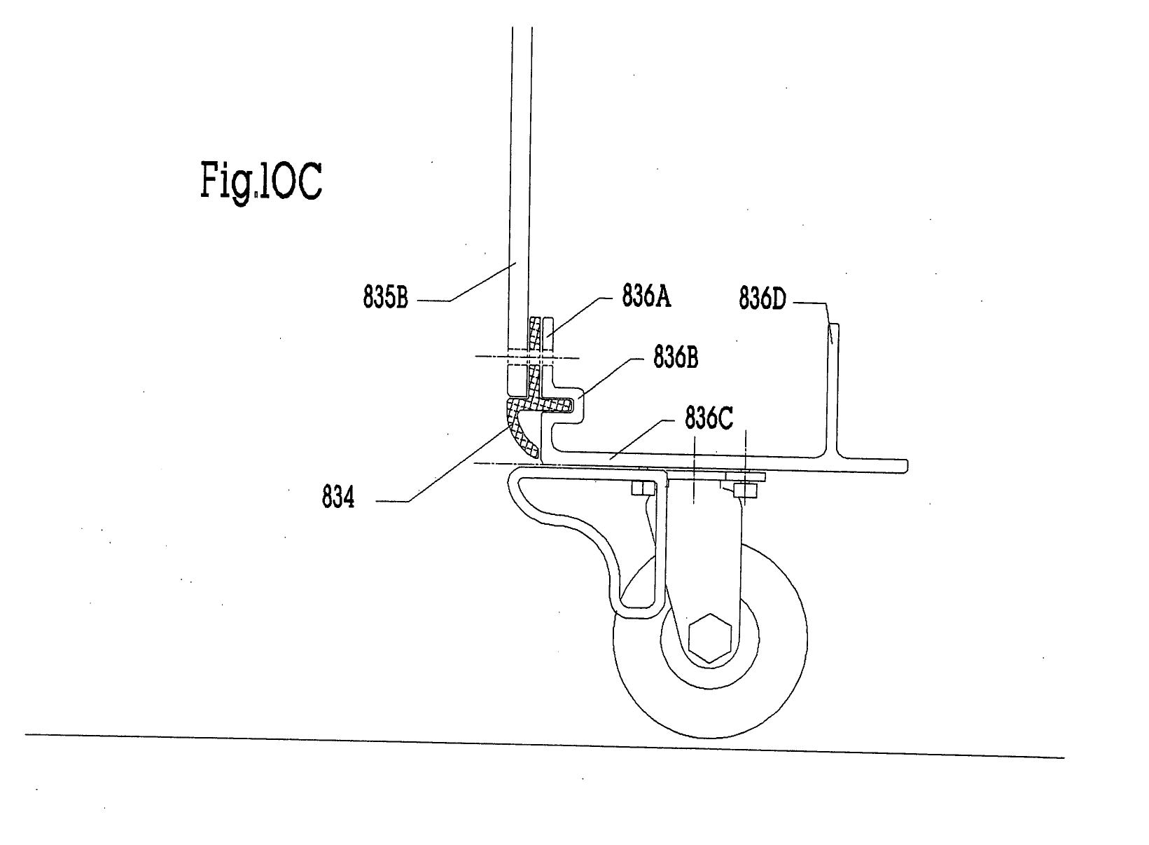

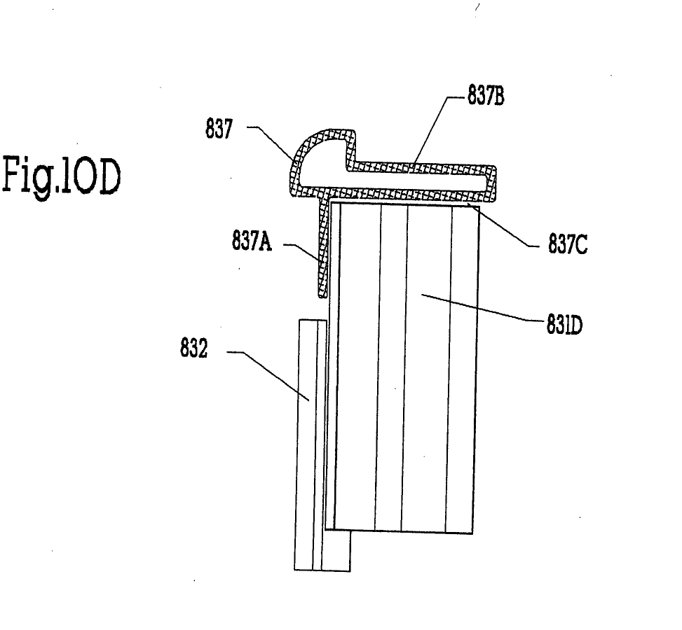

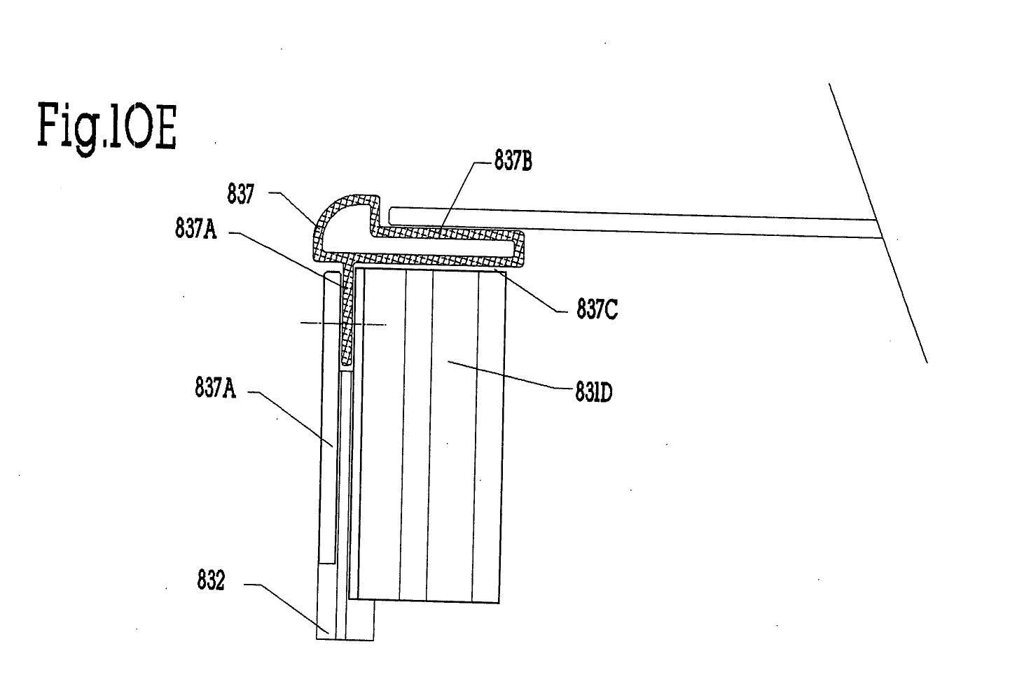

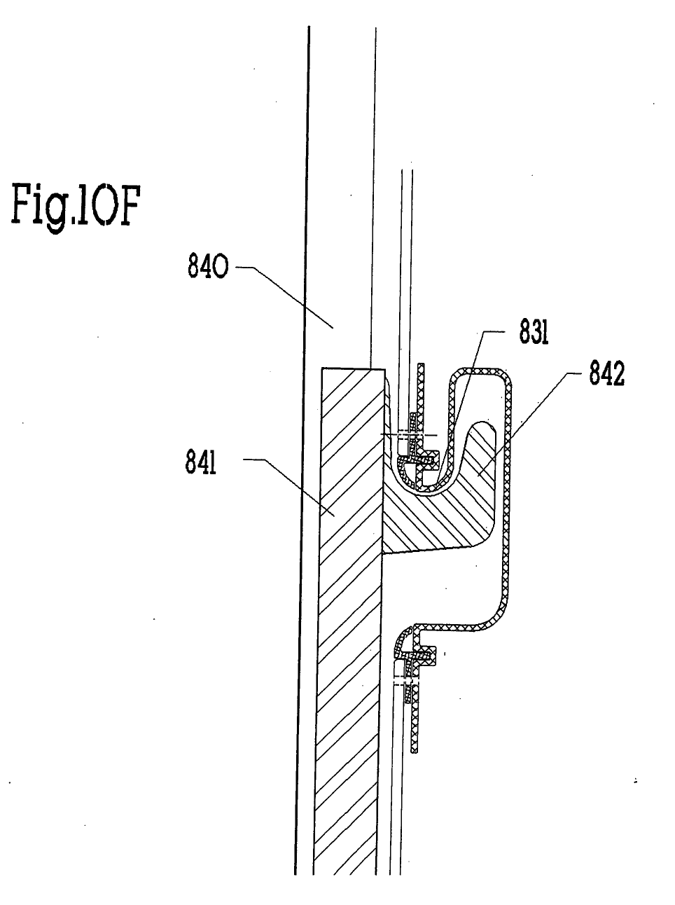

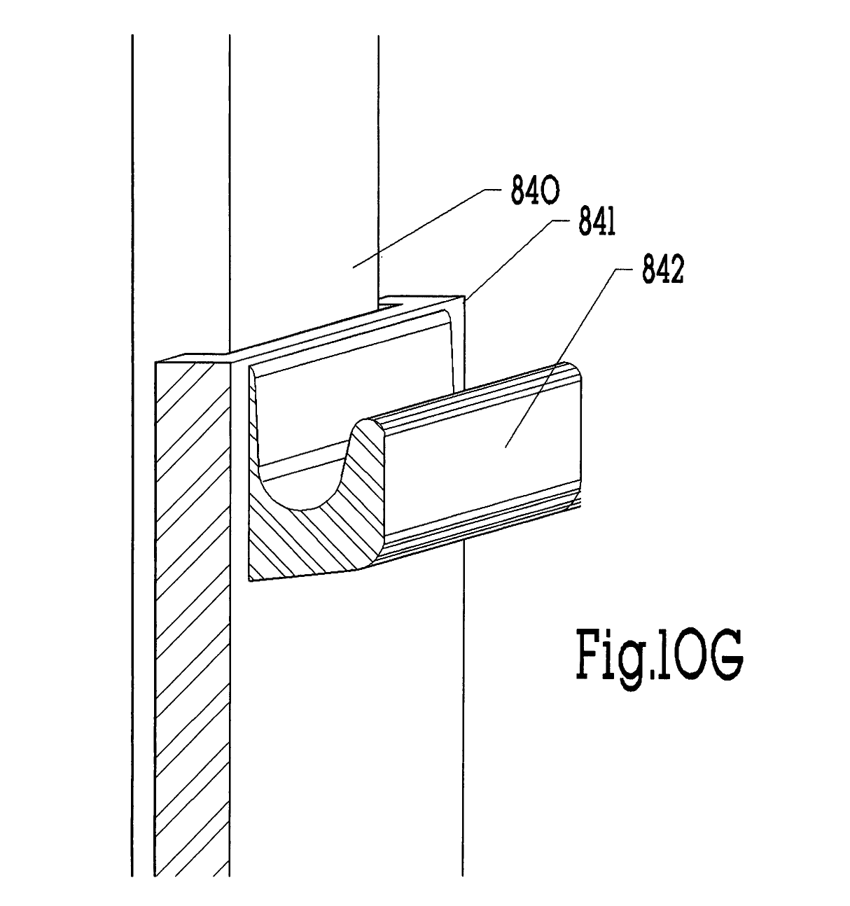

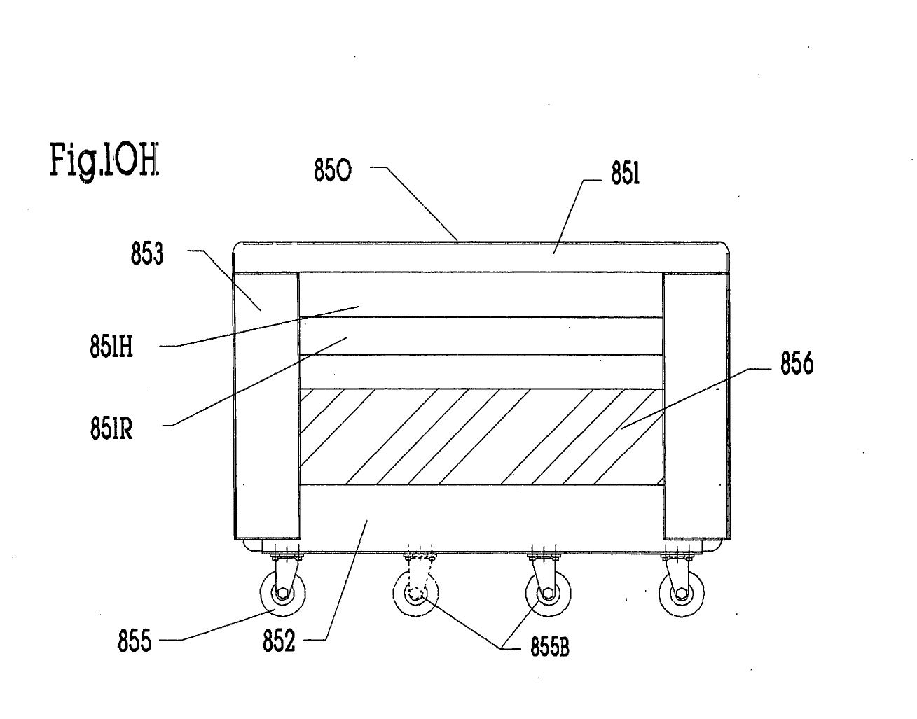

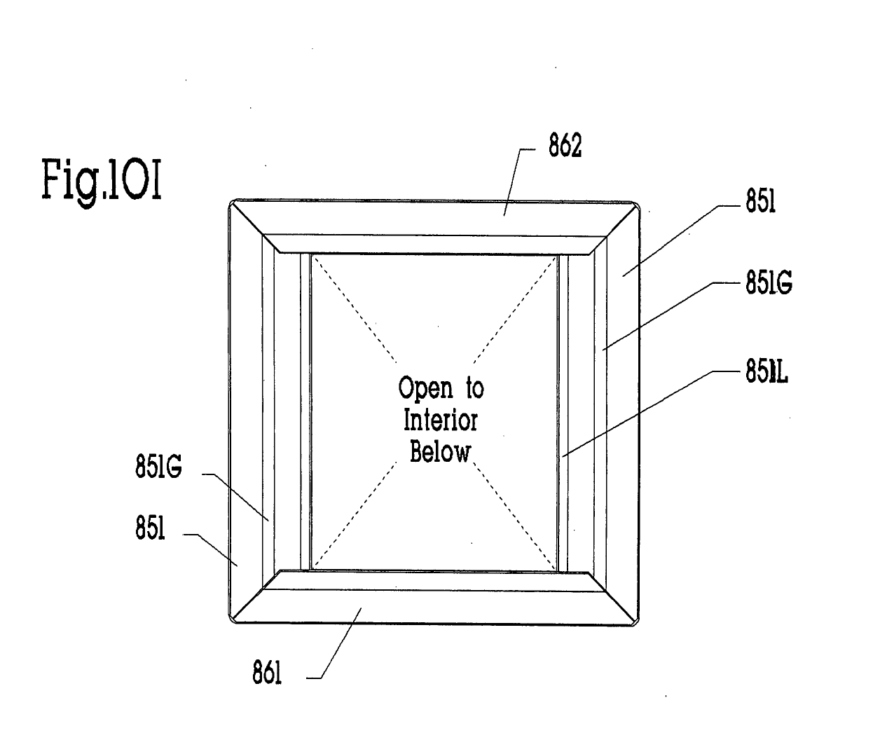

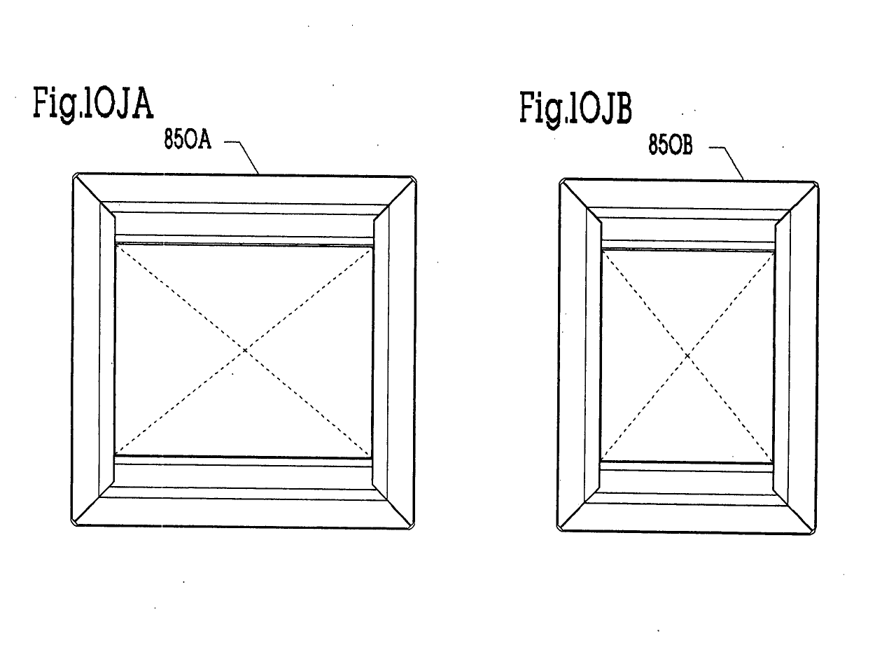

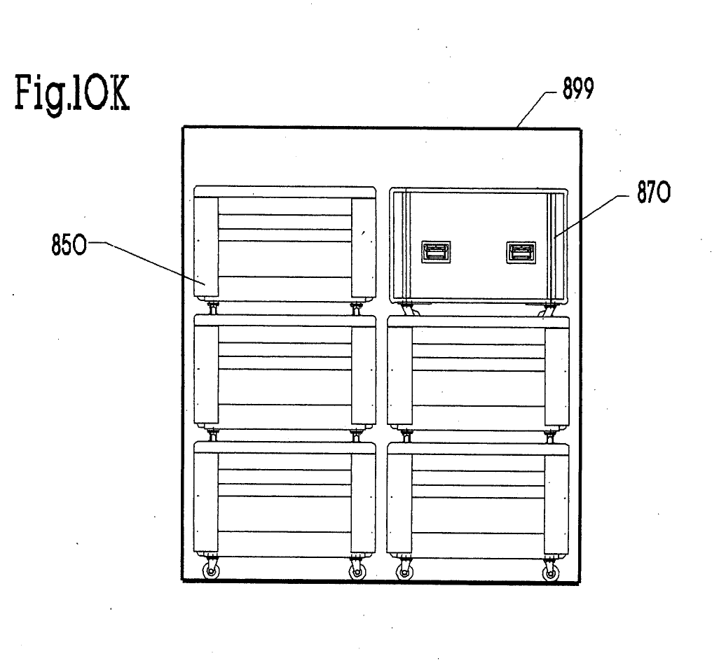

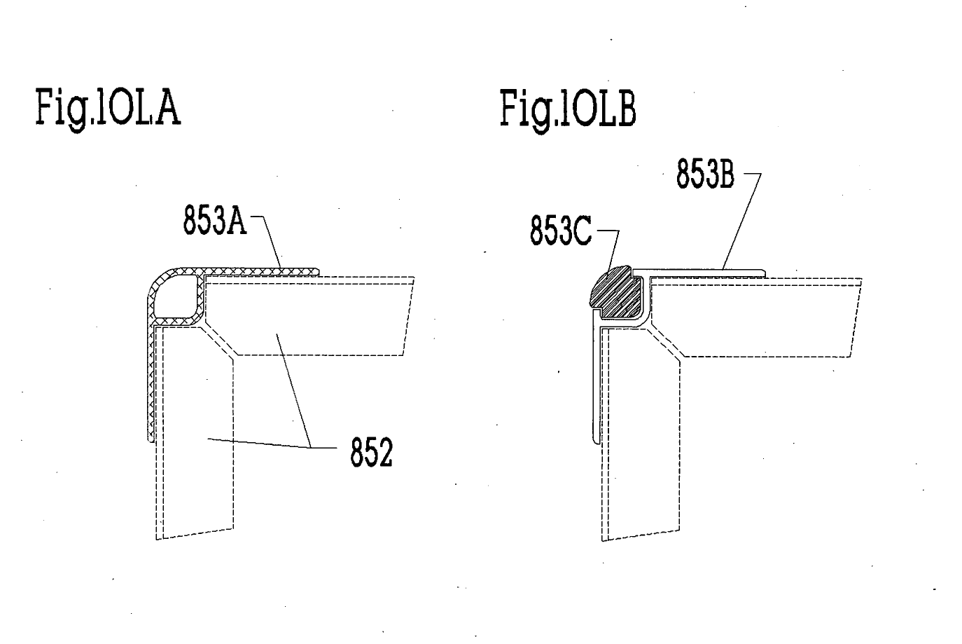

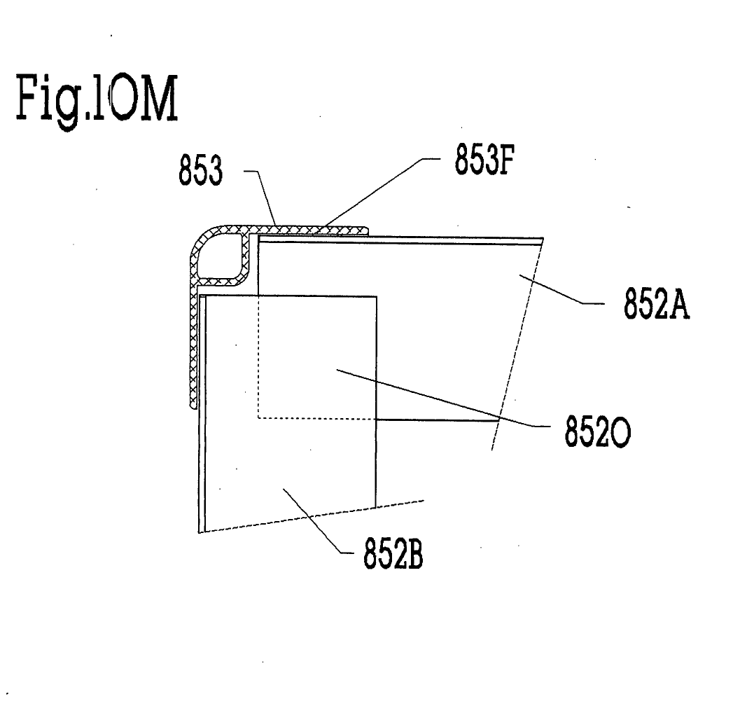

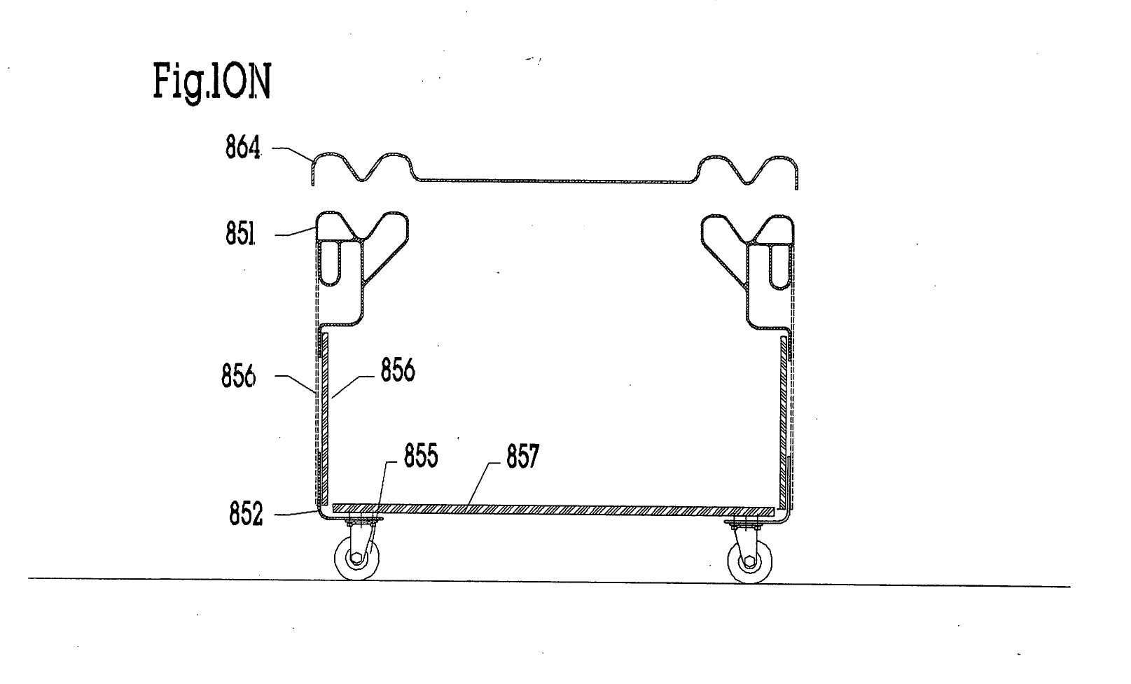

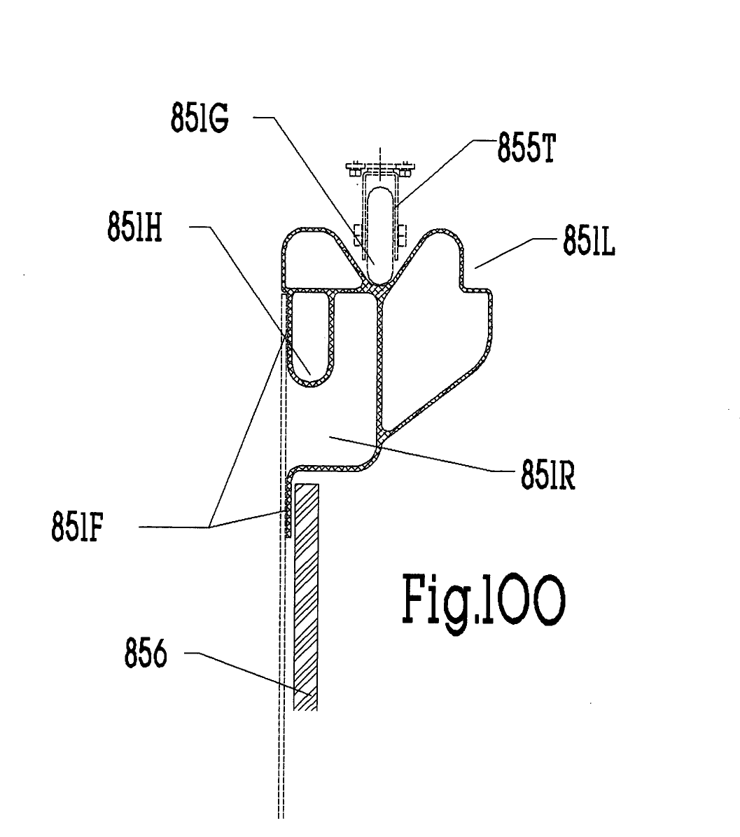

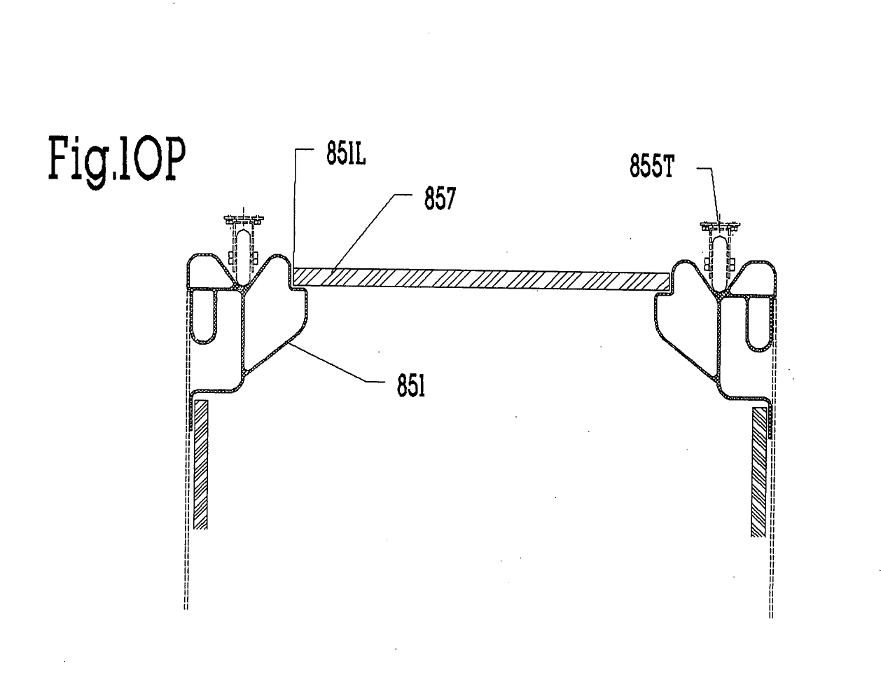

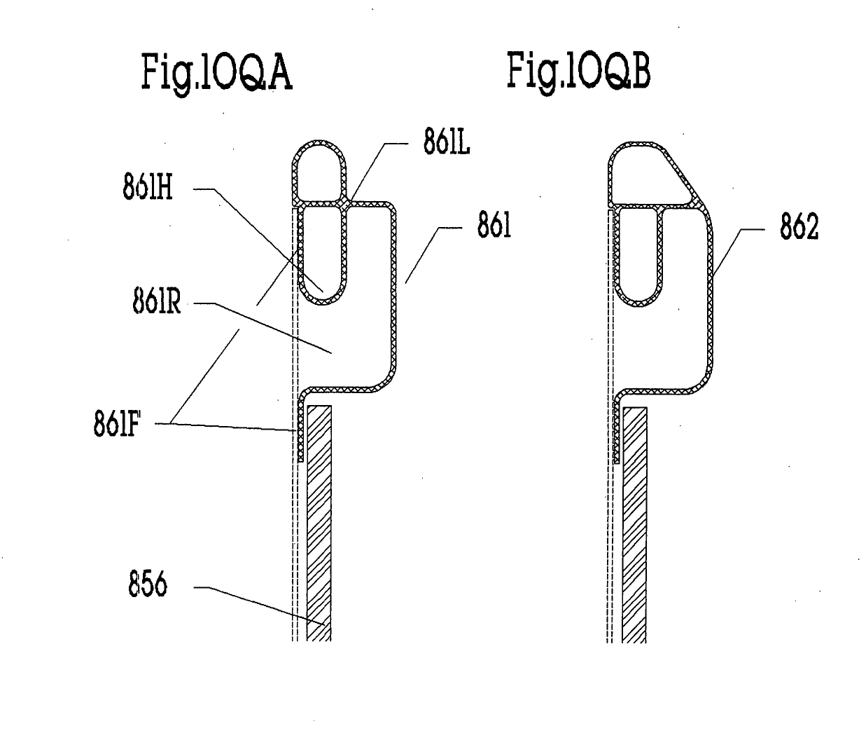

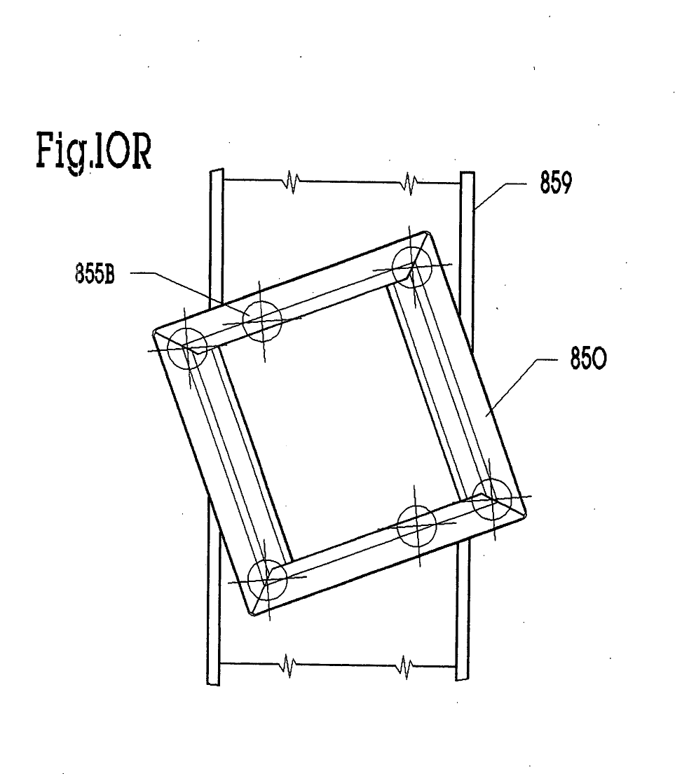

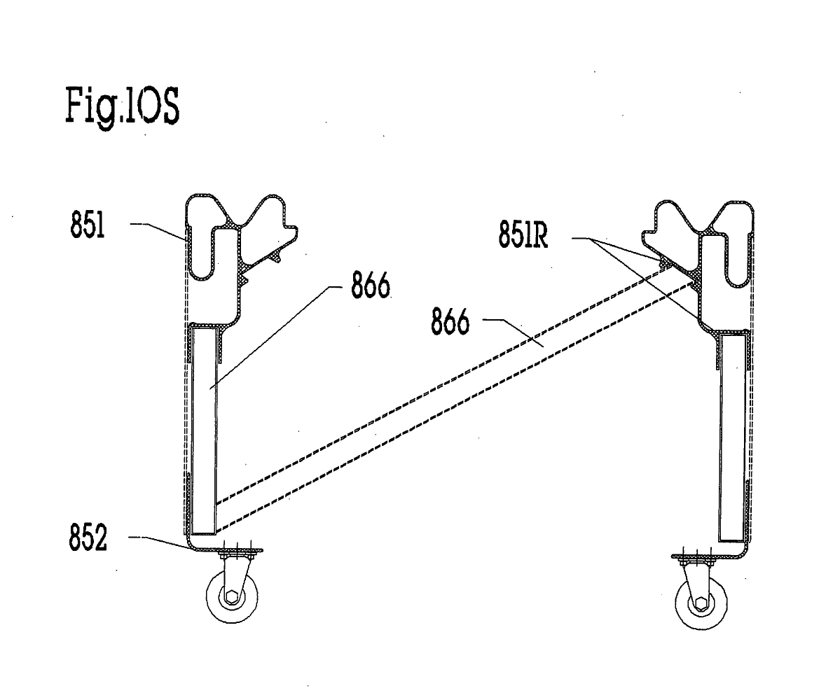

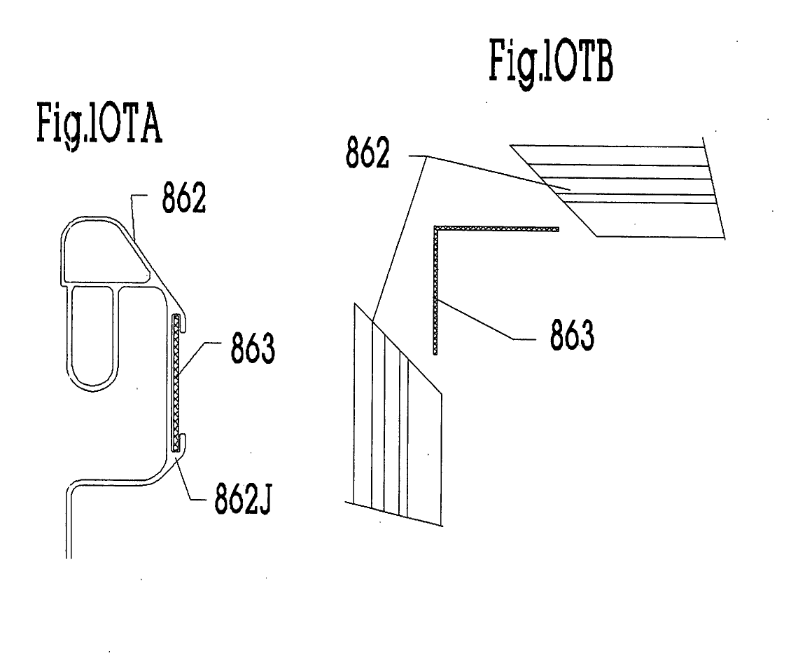

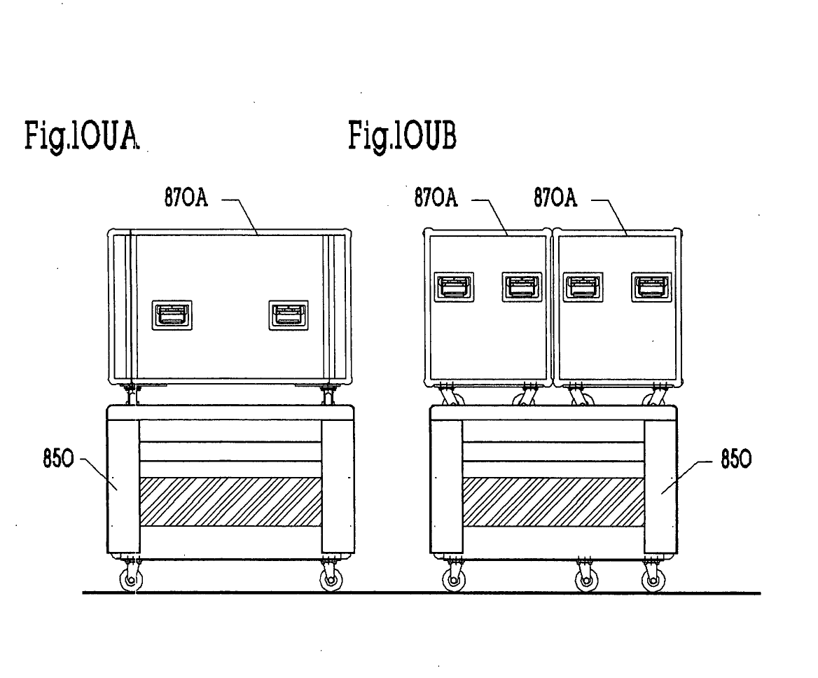

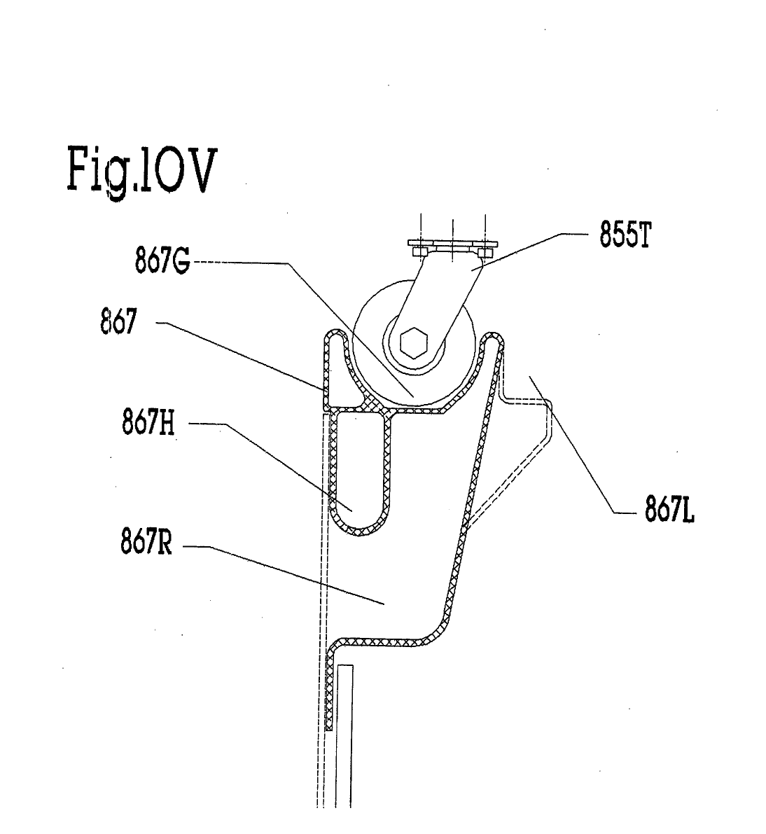

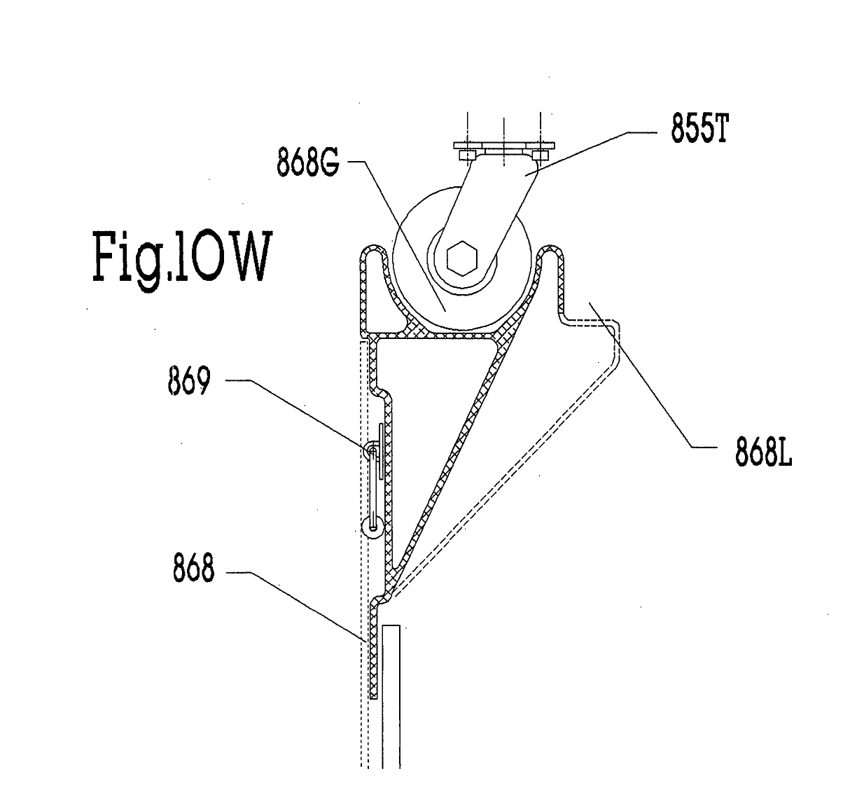

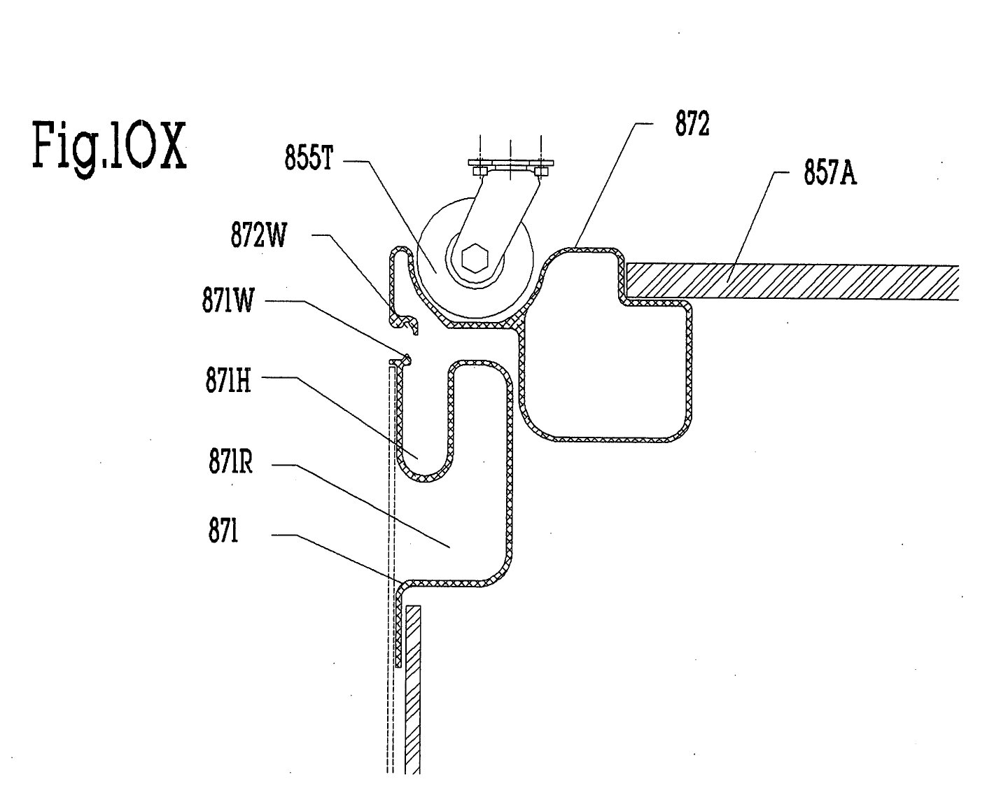

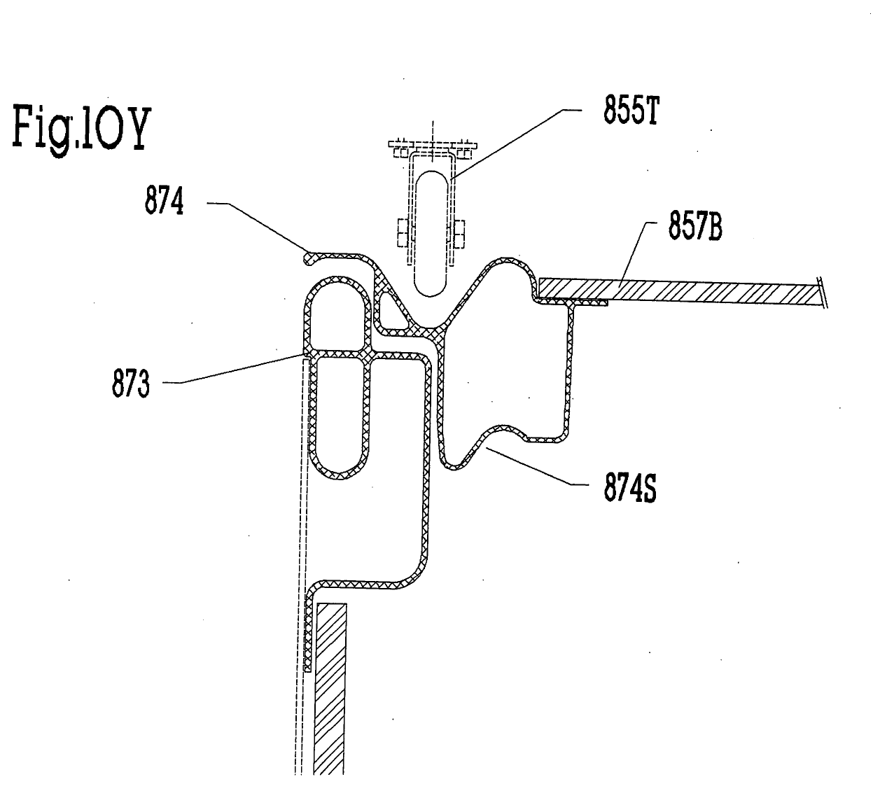

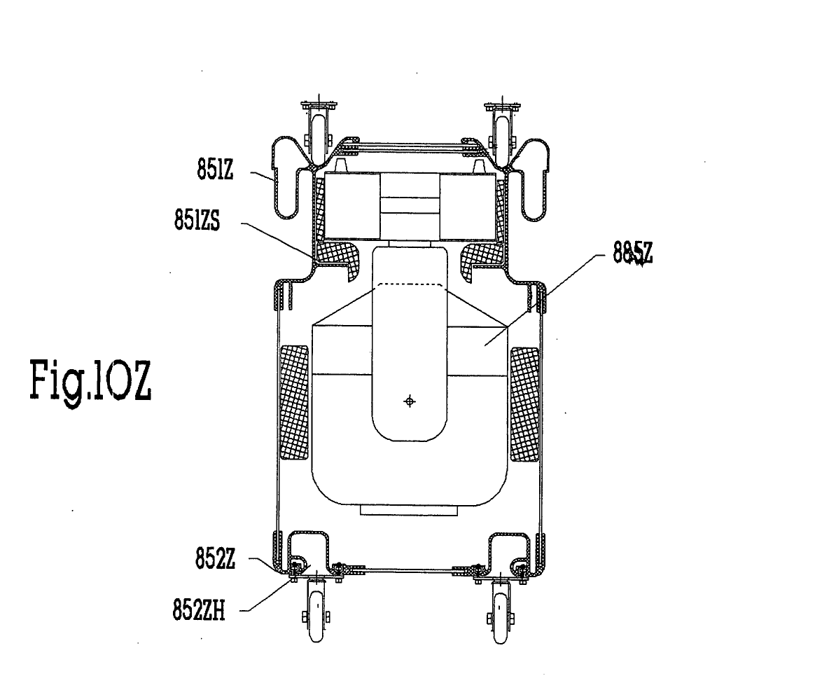

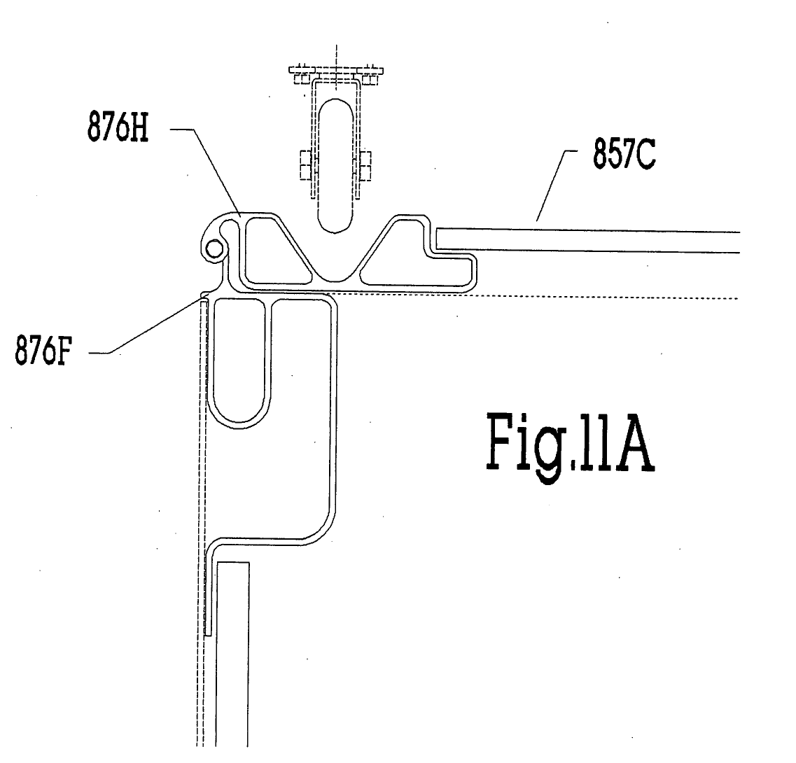

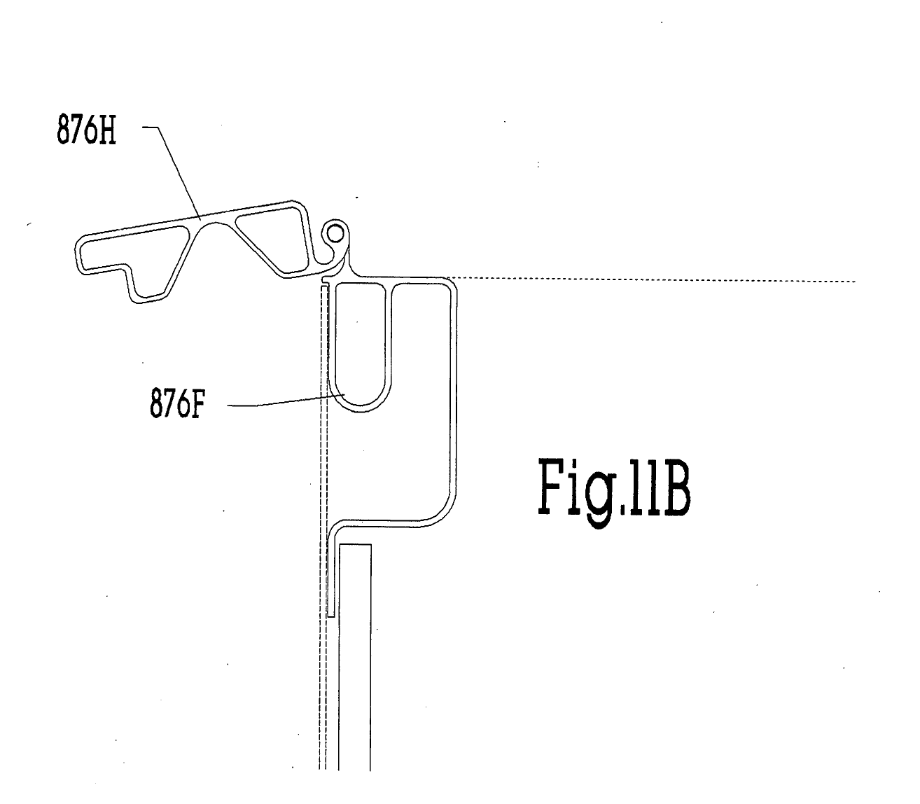

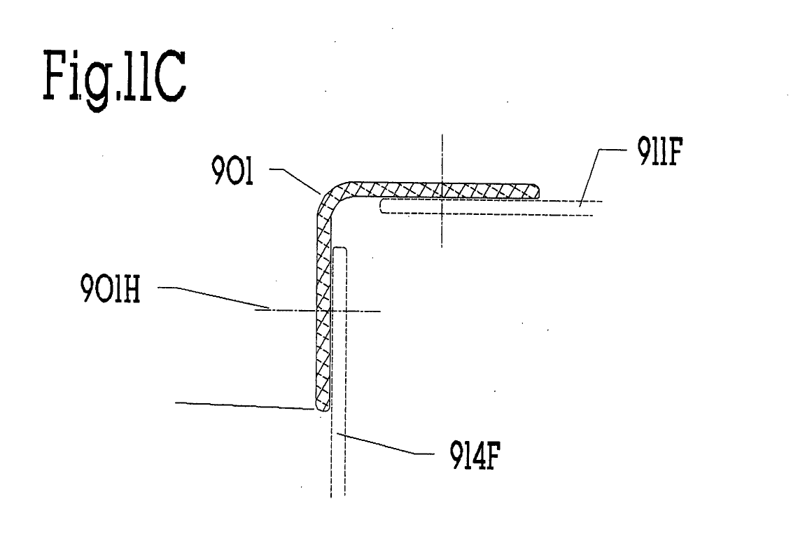

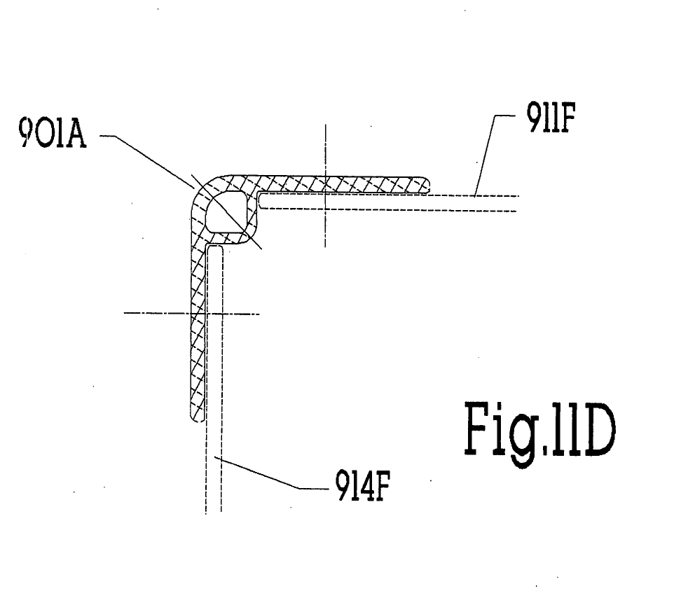

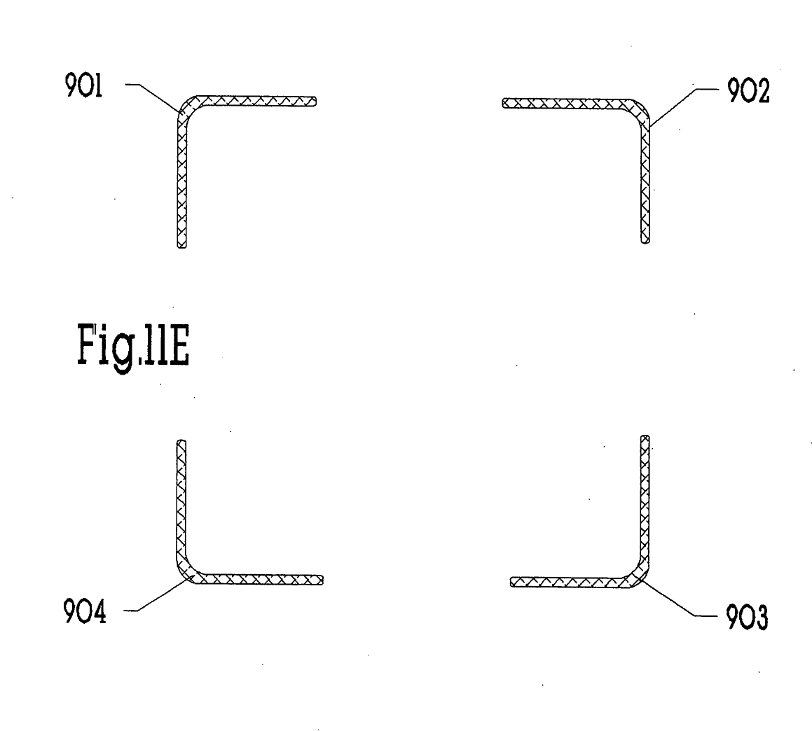

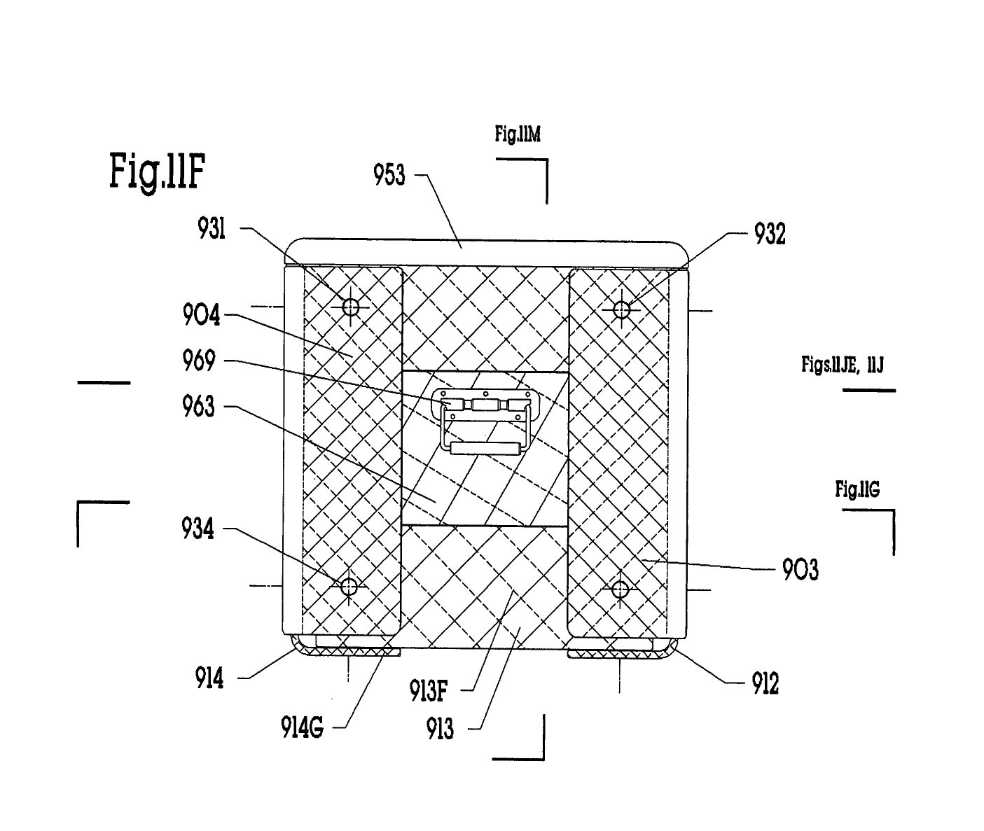

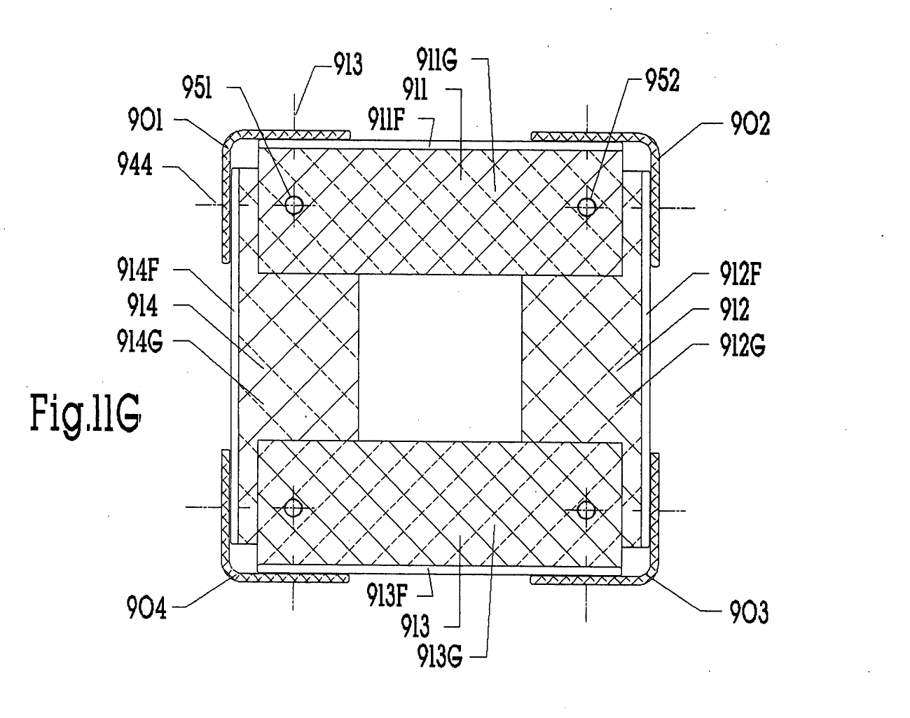

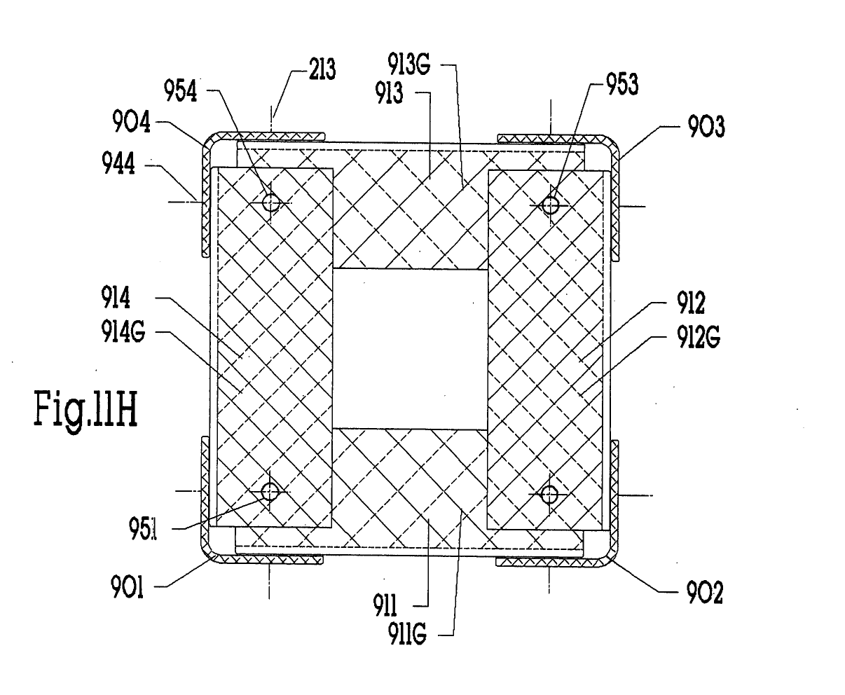

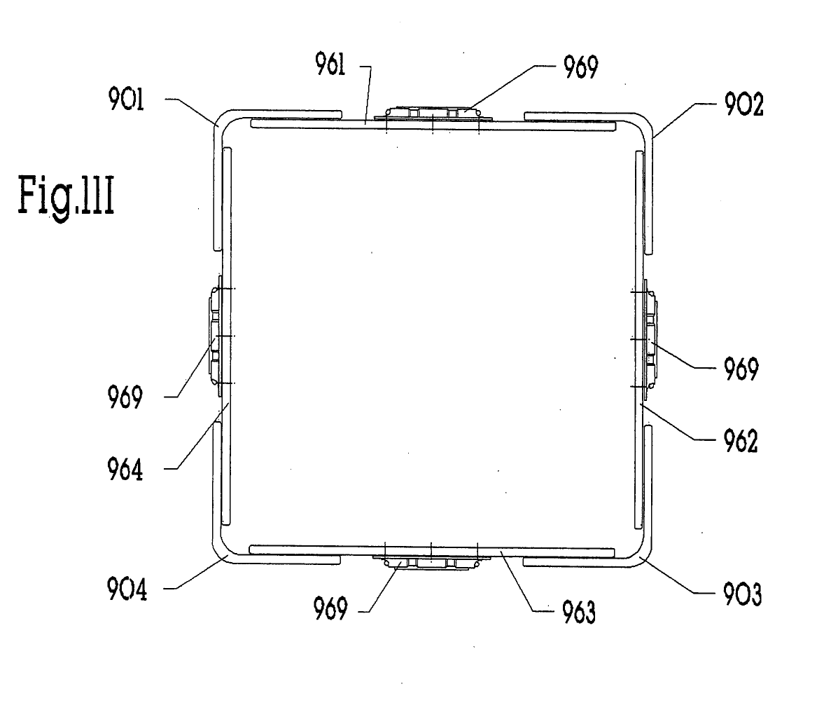

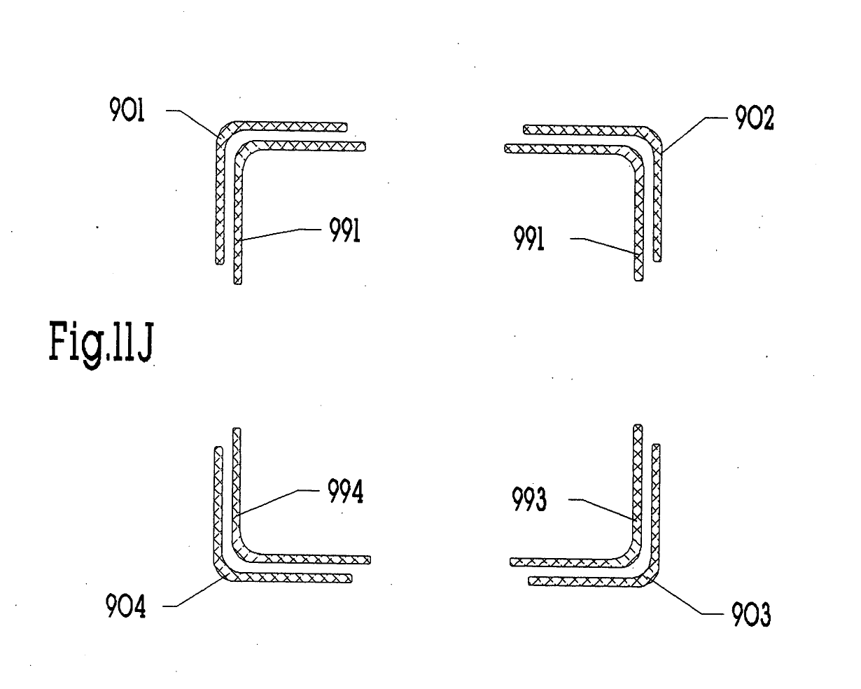

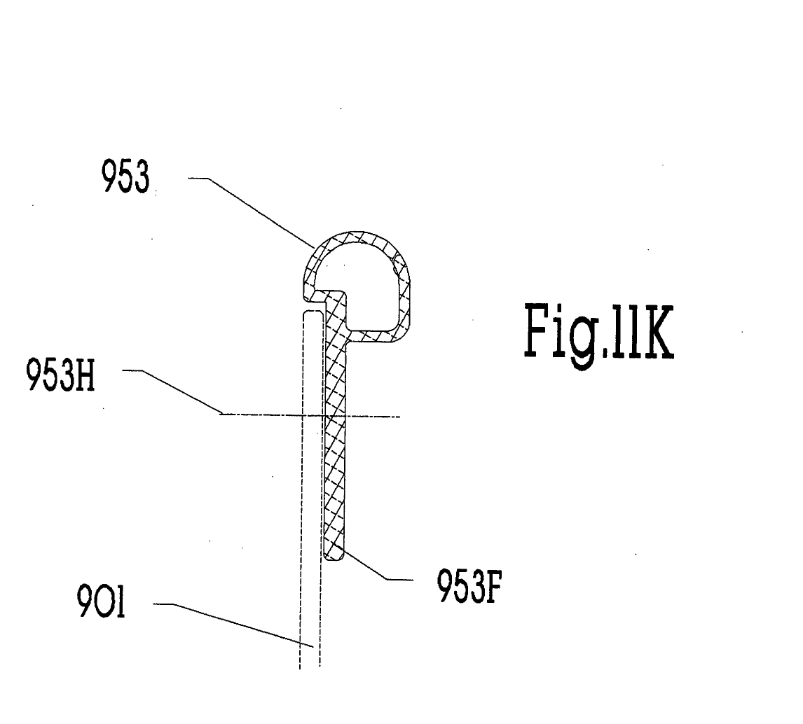

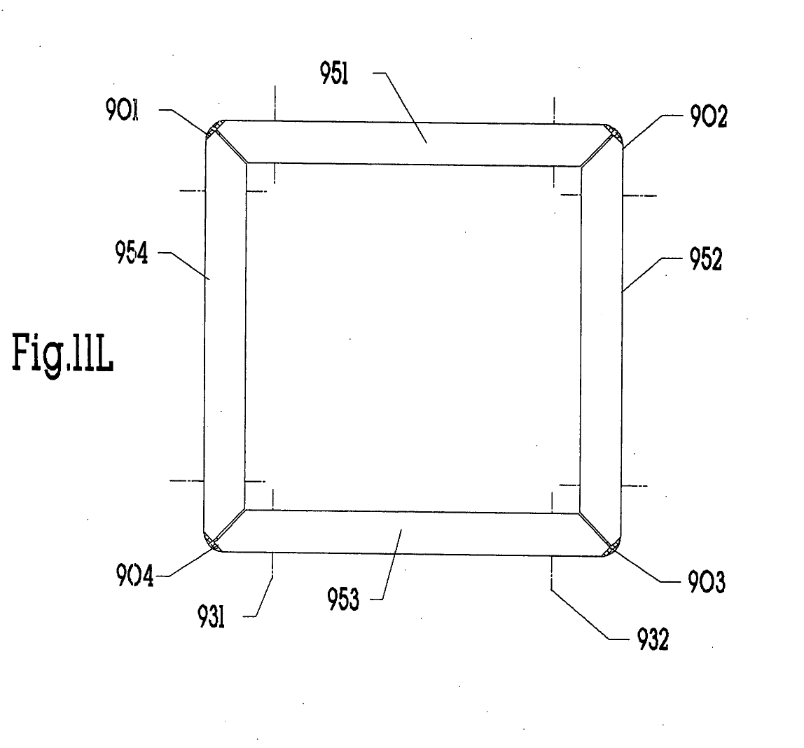

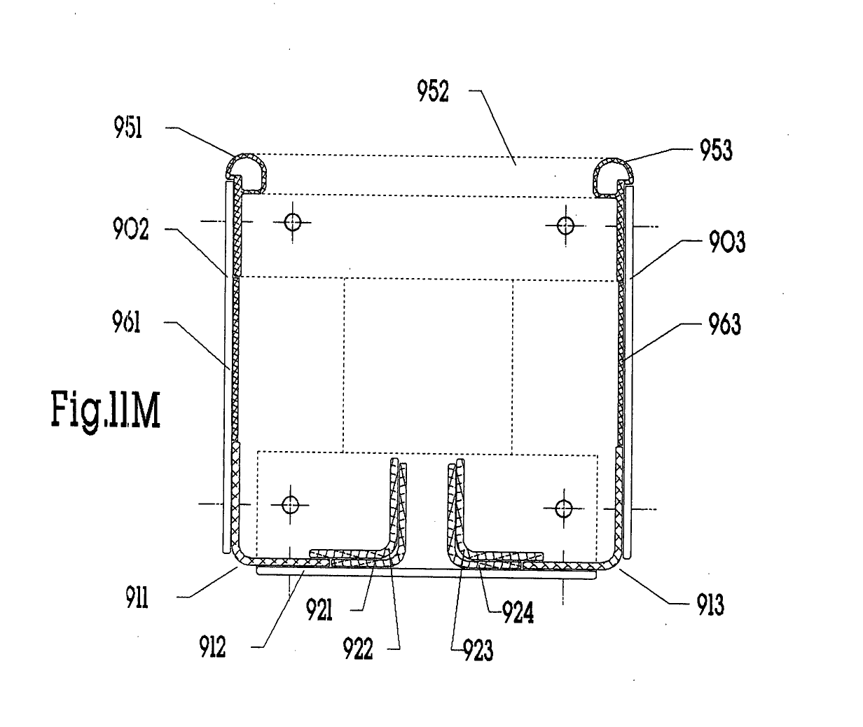

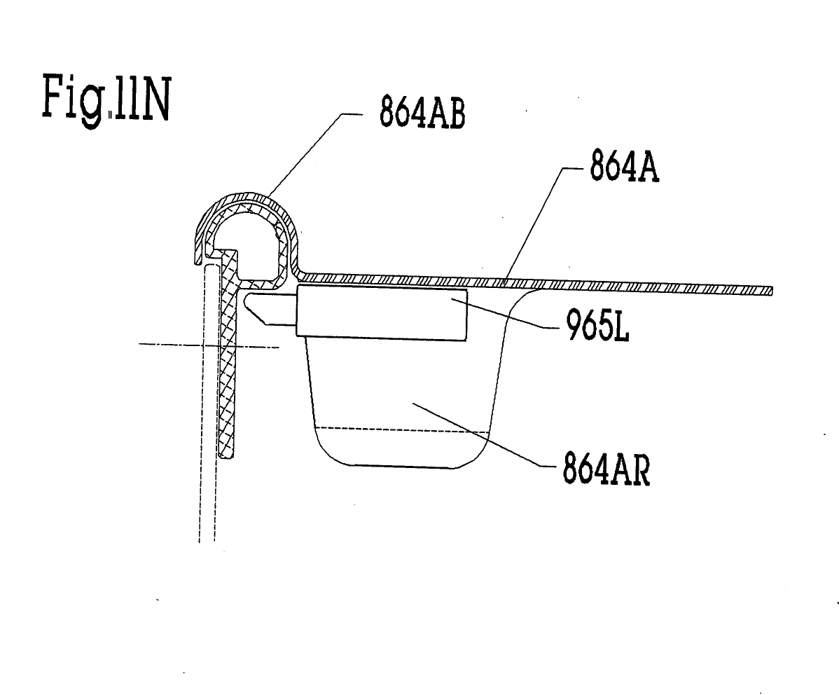

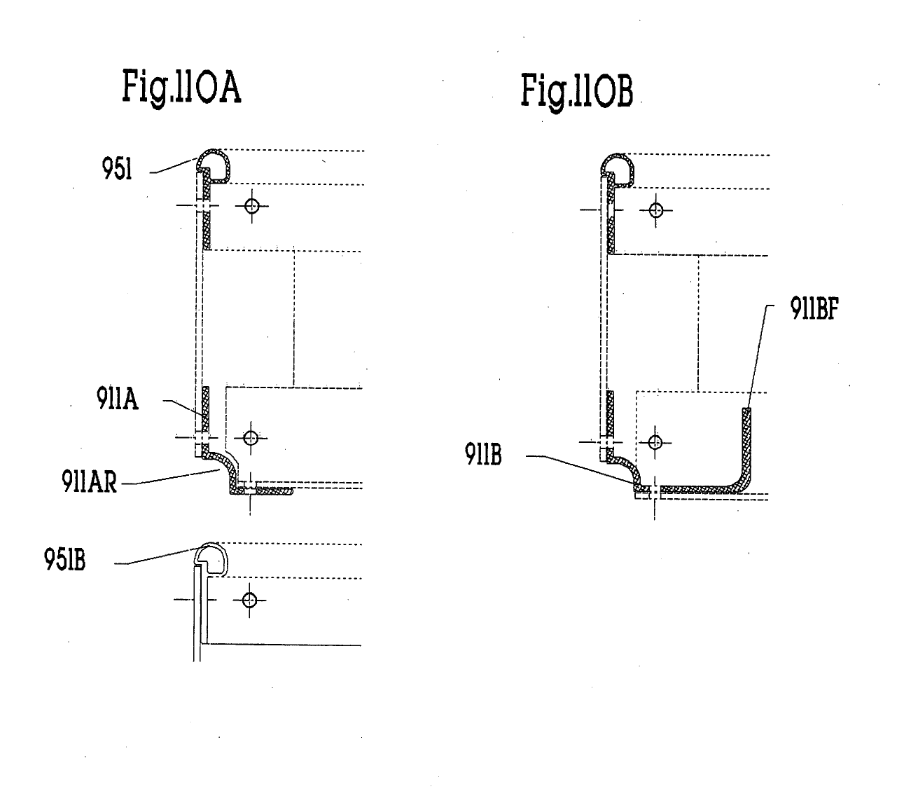

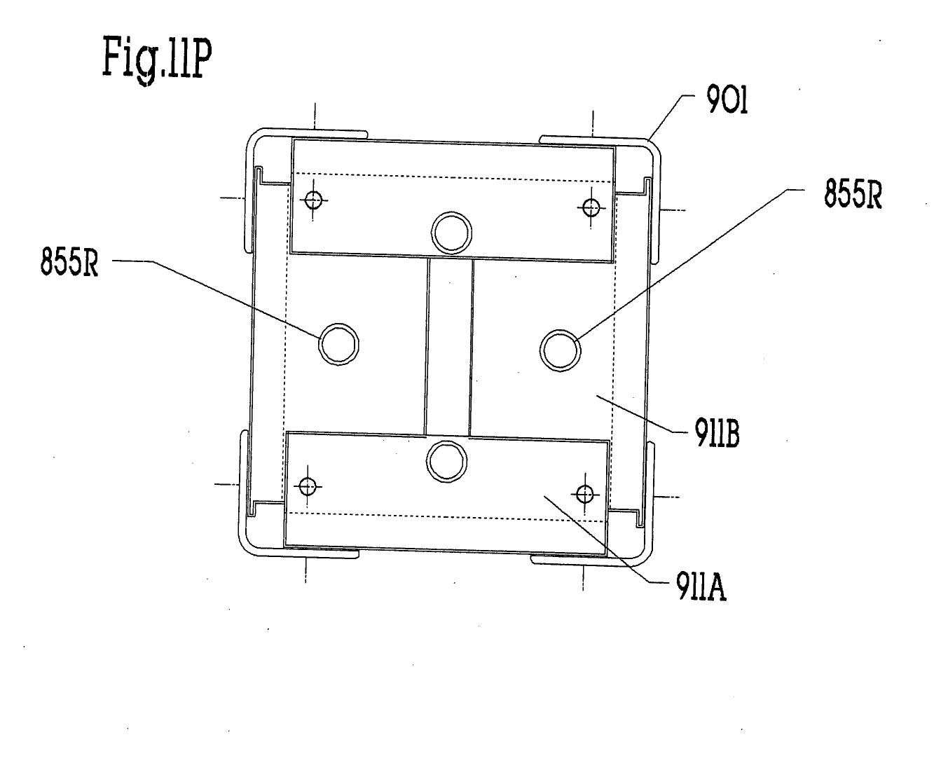

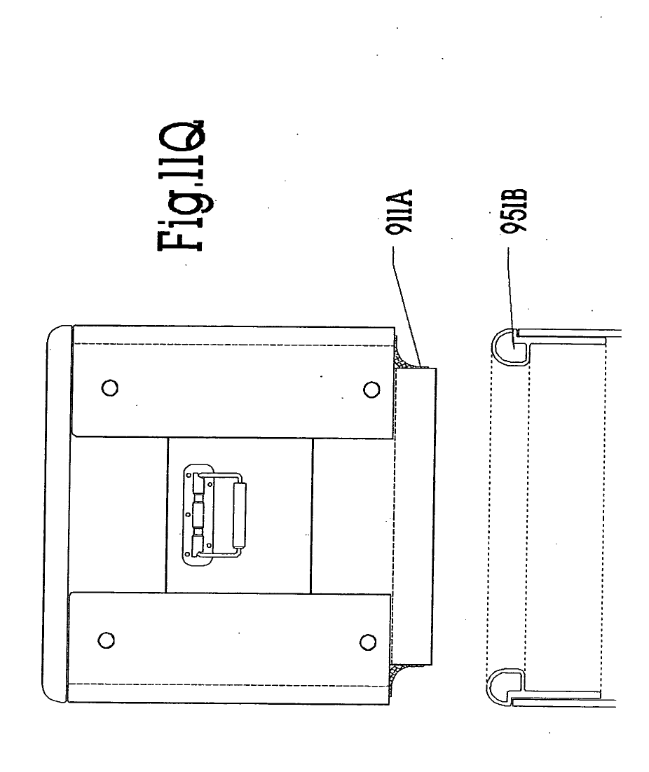

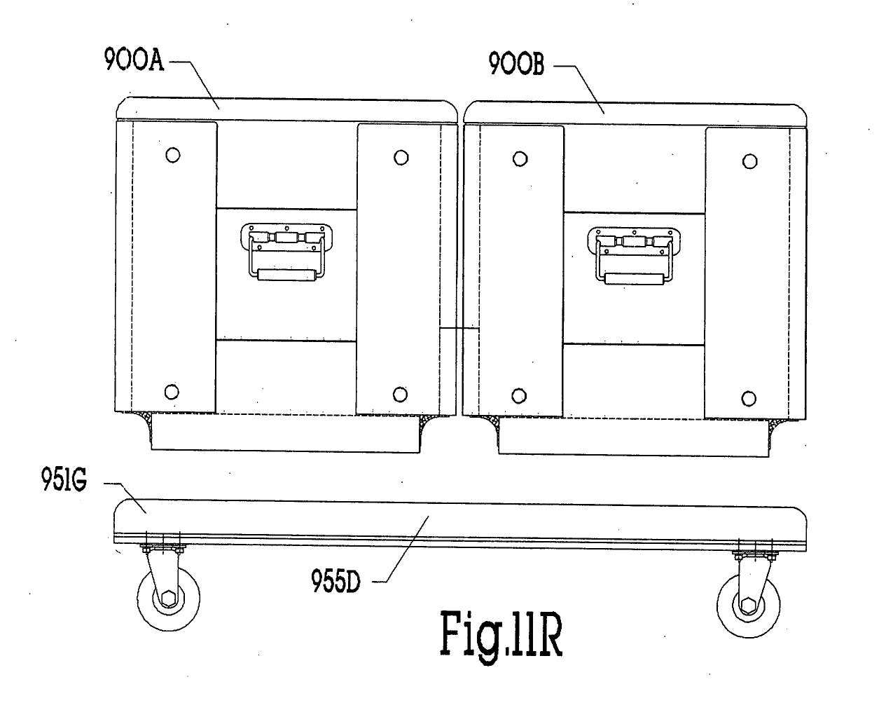

FIG. 2A illustrates the power and data cabling requirements of a prior art lighting system.

FIG. 2B illustrates the power distribution requirements of a prior art lighting system.

FIG. 2C illustrates one embodiment of a unit providing power to both lighting fixtures and chain motors.

FIG. 2D is a side view of the embodiment of the prior Figure installed internal to a truss.

FIG. 2E is an end-wise view of the embodiment of the prior Figures installed internal to a truss.

FIG. 2F is an end elevation of one possible input module for the unit of the prior Figures.

FIG. 2G is an end elevation of an alternative input module for the unit of the prior Figures.

FIG. 2H is an end elevation of one possible output module for the unit of the prior Figures.

FIG. 2I is an end elevation of an alternative output module for the unit of the prior Figures.

FIG. 2J is a bottom view of the embodiment of the prior Figures.

FIG. 2K is an end elevation of a double-wide embodiment.

FIG. 2L is a bottom view of the embodiment of the prior Figures with a third possible output module.

FIG. 2M illustrates paralleling of connectors for lighting fixtures and chain motors on a multi-circuit input power connector.

FIG. 2N illustrates paralleling of connectors for lighting fixtures and chain motors on a multi-phase input power connector.

FIG. 3A illustrates one embodiment of a unit including dimmers.

FIG. 3B is an end elevation of the input side of the unit of the prior Figure.

FIG. 3C is an end elevation of the output side of the unit of the prior two Figures.

FIG. 3D is a block diagram of a unit such as the embodiment of the prior three Figures.

FIG. 3E illustrates another embodiment of a unit including dimmers.

FIG. 3F is an end elevation of the input side of the unit of the prior Figure.

FIG. 3G is an end elevation of the output side of the unit of the prior two Figures.

FIG. 3H is an end elevation of the input side of the units of the prior Figures with a different power input scheme.

FIG. 3I is a bottom view of unit like those in the prior Figures, illustrating data output and user interface provisions.

FIG. 3J is a frontal elevation of a power distribution unit.

FIG. 3K is a block diagram of a power distribution unit such as illustrated in the prior Figure.

FIG. 3L is an elevation of a connector panel.

FIG. 3M is a block diagram of an improved system for distributing and controlling power in a lighting system employing a multi-circuit input connector for power.

FIG. 3N is an elevation of an input module that combines a multi-phase power input connector with a feed-through receptacle and a receptacle for other lighting fixtures.

FIG. 3O illustrates a dimmer waveform minimizing instantaneous voltage.

FIG. 3P illustrates control/data flow in the improved system of the prior Figures.

FIG. 3P illustrates one possible power control waveform.

FIG. 3Q illustrates one possible method of providing temporary power to device electronics.

FIG. 3R illustrates another possible method of providing temporary power to device electronics.

FIG. 4A illustrates a typical optical design of certain prior art fixture types.

FIG. 4B illustrates a typical optical design having a variable focal length.

FIG. 4C illustrates an optical design with a means for varying beam color near a focal point.

FIG. 4D is a side elevation of a fixture accepting a module containing a mechanism for changing beam color and/or other parameters.

FIG. 4E is a block diagram of a mechanism for changing beam color.

FIG. 4F illustrates methods used to change lenses of certain prior art lighting fixtures.

FIG. 4G illustrates an improved method for changing lenses of lighting fixtures.

FIG. 4H is a section through a replaceable lens barrel containing a variable-focal-length lens system, the embodiment fixing one lens with respect to the barrel.

FIG. 4I is an external view of a replaceable lens barrel containing a variable-focal-length lens system, a plurality of lenses being adapted for movement relative to the barrel.

FIG. 4J is a section through a lighting fixture whose overall length can be dramatically reduced, shown in its extended, “use” position.

FIG. 4K is a section through a lighting fixture whose overall length can be dramatically reduced, shown in its retracted position.

FIG. 4L is a side elevation of a lighting fixture adapted for shipping inside a truss structure, shown in its shipping condition.

FIG. 4M is a top view of the lighting fixture of the prior Figure, shown installed in a truss.

FIG. 4N is a bottom view or reverse plan of the lighting fixture of the prior Figures, shown in its shipping condition.

FIG. 4O is a section through the lighting fixture of the prior Figures from the same perspective as FIG. 4L, shown in its shipping condition.

FIG. 4P is a section through the lighting fixture of the prior Figures through a plane parallel to those of FIGS. 4M and 4N.

FIG. 4Q is a side elevation of the lighting fixture of the prior Figures from the same perspective as FIG. 4L, shown with the fixture head extended for use.

FIG. 4R is a side elevation of the lighting fixture of the prior Figures from the same perspective as the prior Figure, shown with the fixture head extended for use and tilted toward the viewer.

FIG. 4S is an end elevation of the prior Figure.

FIG. 4T is a section through a lighting fixture that relocates its actuators to reduce size.

FIG. 5A illustrates an optical system using compound optical elements to produce a plurality of generally parallel focal points.

FIG. 5B is an end elevation of one design for a compound optical element.

FIG. 5C is a detail view of one possible design of a compound optical element.

FIG. 5D illustrates an optical system using compound optical elements including a plurality of such optical elements for output.

FIG. 5E illustrates an optical system using compound optical elements and including a plurality of means for changing beam characteristics such as color.

FIG. 5F is a detail view of a means for changing beam color or other characteristic adapted for the optical system illustrated in the prior Figures.

FIG. 5G illustrates means for changing beam parameters in a system having plural output elements.

FIG. 5H illustrates an aperture plate suitable for use in the system of the prior Figures.

FIG. 5I illustrates a “gobo” plate suitable for use in the system of the prior Figures.

FIG. 5J illustrates “shutter” elements suitable for use in the system of the prior Figures.

FIG. 5K illustrates the use of a compound optical element to “reassemble” a single beam.

FIG. 5L is a detail view of one design for a compound optical element.

FIG. 5M illustrates an optical system like that of the prior Figures that employs a plurality of light sources.

FIG. 5N illustrates a prior art method of changing beam color or other characteristic by proportional insertion of material in the beam.

FIG. 5O illustrates a prior art method of changing beam color or other characteristic by proportional insertion of material in the beam that employs a graduated transition.

FIG. 5P illustrates a multi-stage method of changing color or other beam characteristic.

FIG. 5Q illustrates a multi-stage method of changing color or other beam characteristic with an improved transition between the two stages.

FIG. 5R illustrates a multi-stage method of changing color or other beam characteristic with graduated transitions within the two stages.

FIG. 5S illustrates the multi-stage method of the prior Figure as applied to a rotary disc.

FIG. 5T is a detail of an alternative embodiment of a multi-stage filter.

FIG. 5U is a detail of different optical elements as applied to the alternative embodiment of the prior Figure.

FIG. 5V illustrates an improved “gel frame”.

FIG. 5W illustrates an improved “gaffer tape”

FIG. 5X illustrates sheet-fed labels.

FIG. 6A is a side section of one embodiment of “legs” for supporting a prior art truss with fixtures pre-installed.

FIG. 6B is a top or plan view of the truss legs of the prior Figure in use.

FIG. 6C is a section of the truss legs of the prior Figures in a parallel plane.

FIG. 6D is a section of the truss legs of the prior Figures in a lower parallel plane.

FIG. 6E is a section of the truss legs of the prior Figures in a still lower parallel plane.

FIG. 6F is an end elevation of the truss legs of the prior Figures.

FIG. 6G is a side elevation of the truss legs of the prior Figures from the same perspective as FIG. 6A.

FIG. 6H is a side elevation of the truss legs of the prior Figures from the same perspective as FIG. 6A, shown in use.

FIG. 6I is a side elevation of the truss legs of the prior Figures in use.

FIG. 6J is a side elevation of a wheeled truss dolly.

FIG. 6K is a side elevation of the wheeled truss dolly as shown in the prior Figure in use.

FIG. 6L is a plan or top view of the wheeled truss dolly of the prior Figures.

FIG. 6M is an end elevation of the wheeled truss dolly of the prior Figures in use, stacked atop another truss.

FIG. 6N is an end elevation of the wheeled truss dolly of the prior Figures in use, stacked atop another truss, and showing a locking feature.

FIG. 6O is an end elevation of the wheeled truss dolly of the prior Figures in use, stacked atop another truss, from the opposite side as the prior two Figures.

FIG. 6P is a plan or top view of the subject matter of FIG. 6N.

FIG. 6Q illustrates one possible structural shape suitable for use in a wheeled truss dolly.

FIG. 6R illustrates another possible structural shape suitable for use in a wheeled truss dolly.

FIG. 6S is a side elevation of a wheeled truss dolly assembled from the structural shapes of the prior two Figures.

FIG. 6T is a top or plan view of the wheeled truss dolly of the prior Figure in “latching” position.

FIG. 6U is a top or plan view of the wheeled truss dolly of the prior Figures in “retracted” position.

FIG. 6V is an end view of the wheeled truss dolly of the prior Figures in “latching” position.

FIG. 6W is an end view of the wheeled truss dolly of the prior Figures in “retracted” position.

FIG. 7A is a side elevation of a “rocking” wheeled truss dolly.

FIG. 7B is a side section of the “rocking” wheeled truss dolly from the same perspective as the prior Figure.

FIG. 7C is an end-wise section of the “rocking” wheeled truss dolly of the prior Figures.

FIG. 7D is another end-wise section of the “rocking” wheeled truss dolly of the prior Figures, showing a pivoting component.

FIG. 7E is a top or plan view of the “rocking” wheeled truss dolly of the prior Figures.

FIG. 7F is side elevation of a pipe rack adapter.

FIG. 7G is an end elevation of the pipe rack adapter of the prior Figure.

FIG. 7H is an end elevation of another embodiment of a pipe rack adapter.

FIG. 7IA is a top or plan view of an adapter for shipping striplights, including in the pipe rack illustrated in the prior Figures.

FIG. 7IB is an end view of the adapter for shipping striplights illustrated in the prior Figure.

FIG. 7IC is a side view of the adapter for shipping striplights illustrated in the prior Figures.

FIG. 7J is an end view of the adapters for shipping striplights illustrated in the prior Figures in use in a pipe dolly.

FIG. 7K is a side view of the adapters for shipping striplights illustrated in the prior Figures in use in a pipe dolly.

FIG. 7L is an end view of a truss “stacker”.

FIG. 7M is an end view of the truss “stacker” of the prior Figure in use.

FIG. 7N is a top or plan view of the truss “stacker” of the prior Figures.

FIG. 7O is a bottom or reverse plan view of the truss “stacker” of the prior Figures.

FIG. 7P is an end view of the truss “stacker” of the prior Figures.

FIG. 7R is an end view of a truss “lifter”.

FIG. 7S is a side view of the truss “lifter” of the prior Figure in use.

FIG. 7T is an end view of a truss “lifter” of the prior Figures adapted to lift multiple truss sizes.

FIG. 8A is an end elevation of a structural shape having a recess into which intersecting members can be fitted.

FIG. 8B is a view of FIG. 8A from one side.

FIG. 8C is a view of FIG. 8A from the top.

FIG. 8D is a section of the intersecting member.

FIG. 8E is a section of the same subject matter as the prior Figures, equivalent to FIG. 8A.

FIG. 8F is a section of the same subject matter as the prior Figures with a 45 degree bend incorporated in the intersecting member.

FIG. 8G is a section of the same subject matter as the prior Figures with a 90 degree bend incorporated in the intersecting member.

FIG. 8H is a section of the same subject matter as the prior Figures with the structural shape rotated at a 45 degree angle and a 45 degree bend incorporated in the intersecting member.

FIG. 8I is a section of the same subject matter as the prior Figures with the structural shape rotated at a 45 degree angle and an intersecting member.

FIG. 8J a section of the same subject matter as the prior Figures with the structural shape rotated at a 45 degree angle and a 90 degree bend incorporated in the intersecting member.

FIG. 8K is a section of two interlocking structural shapes.

FIG. 8KA is a detail of one of the two shapes of the prior Figure.

FIG. 8KB is a detail of the other of the two shapes of FIG. 83G.

FIG. 8LA is a section of a member intersecting the shape illustrated in FIG. 8EH at one angle.

FIG. 8LB is a section of a member intersecting the shape illustrated in FIG. 8EH at another angle.

FIG. 8LC is a section of a member intersecting the shape illustrated in FIG. 8EH at another angle.

FIG. 8M is an end elevation of a truss assembled from the structural shapes of the prior Figures and including a central shape providing flexible attachment.

FIG. 8N is a section through the truss of the prior Figure showing other intersecting members reinforcing the truss.

FIG. 8OA is a detail section of the central member illustrated in the prior Figures showing it accepting a wheeled carrier.

FIG. 8OB is a detail section of the central member illustrated in the prior Figures showing it accepting a hanger assembly.

FIG. 8OC is a detail section of one of the hanger parts.

FIG. 8OD is a side elevation of the same hanger part.

FIG. 8P is an end elevation of a truss with a different central member.

FIG. 8Q is an end elevation of a truss with separate central shapes and continuous intersecting members.

FIG. 8R is a truss of rectangular section capable of attaching a hanging/hanger assembly.

FIG. 8SA is a section of another structural shape that can be used with the structural shape illustrated beginning at FIG. 4A, as part of an assembly that joins two truss sections.

FIG. 8SB is a section from the same perspective as the prior Figure of the another structural shape and the plate used to join two such shapes.

FIG. 8SC is a section from the same perspective as the prior two Figures of the another structural shape attached to the structural shape of FIG. 4A at a truss end.

FIG. 8TA is a side elevation of the subject matter of the prior three Figures as assembled in FIG. 8SA.

FIG. 8TB is a side elevation from the same perspective as the prior Figure of the plate used to join truss sections.

FIG. 8TC is a side elevation of the subject matter of the prior three Figures as assembled in FIG. 8SC.

FIG. 9AA is a section of a structural shape that can be fabricated to form male and female adapters for converting trusses from bolted to clevis-type connections.

FIG. 9AB is a section from the same perspective of the structural shape of the prior Figure fabricated into a female part.

FIG. 9AC is a section from the same perspective of the structural shape of FIG. 9AA fabricated into a male part.

FIG. 9B is a section of a structural shape of higher load-bearing capacity than the shape of FIG. 9AA.

FIG. 9C is a side elevation of the adapters of FIGS. 9AB and 9AC bolted to truss sections and mated.

FIG. 9D is an end elevation of a truss section with the adapters of FIGS. 9AB and 9AC attached.

FIG. 9E is a top view of two truss sections fitted with the adapters illustrated in the prior Figures, which are being used as a hinge.

FIG. 9F is a side elevation from the same perspective as FIG. 9C but employing adapters fabricated from the higher-capacity shape of FIG. 9B.

FIG. 9GA is a plan view of a section of the structural shape of FIG. 9AA fabricated into a stiffener.

FIG. 9GB is a section through the structural shape employed in the prior Figure.

FIG. 9GC is a side elevation of the stiffener of the prior Figures.

FIG. 9H is a plan view of the stiffener bar of the prior three Figures installed in the truss arrangement of FIG. 9E to lock the trusses at right angles.

FIG. 9I is a plan view of a similar arrangement of trusses to the prior Figure, but with the addition of a third truss section locked at right angles by the use of a female truss end adapter.

FIG. 9J is a plan view of a truss arrangement like FIG. 9H, but employing a “gate”.

FIG. 9K is a side elevation of the “gate” used in the prior Figure.

FIG. 9L is a plan view of a truss arrangement like that of FIG. 9I, but employing two “gates”.

FIG. 9MA is a side view of a “wedge”.

FIG. 9MB is a plan view of a spacer layer of the “wedge” of the prior Figure.

FIG. 9MC is a plan view of the assembled “wedge” of the prior two Figures.

FIG. 9MD is an end view of the assembled “wedge” of the prior Figures from a perspective at a right angle to that of FIG. 9MA.

FIG. 9ME is a plan view of a top or bottom plate layer of the “wedge” of the prior Figures.

FIG. 9N is a plan view illustrating the use of a “wedge” to lock two truss sections at right angles.

FIG. 9O is a plan view illustrating the use of two “wedges” and a female truss end adapter to lock three truss sections at right angles.

FIG. 9P is a plan view illustrating the use of a “wedge” and truss end adapters to lock two trusses at right angles, while hinging a third.

FIG. 10A is a section through a shape used to produce a recessed handle in a roadcase or container.

FIG. 10B is a section through a more complex assembly of shapes forming an embodiment of recessed handle similar to that of the prior Figure.

FIG. 10C is a section through an assembly of shapes that may be used at the lower edge of a roadcase or container.

FIG. 10D is a section at right angles to those of the prior Figures showing the intersection of the handle shape and a vertical corner shape.

FIG. 10E is a section similar to the prior Figure.

FIG. 10F is the section of FIG. 10B illustrating the hook or bracket on a motorized lifter engaging the handle.

FIG. 10G is a perspective view of the hook, bracket, and track of the prior Figure.

FIG. 10H is a side elevation of a roadcase or container assembled from structural shapes.

FIG. 10I is a plan view of the roadcase or container of the prior Figure.

FIG. 10JA duplicates the view of the prior Figure, to contrast it with FIG. 10JB.

FIG. 10JB illustrates the variations in roadcase or container dimensions that can readily be produced.

FIG. 10K is an end elevation of the roadcase or container of the prior Figures stacked in a truck.

FIG. 10LA is a section of one possible structural shape for edges.

FIG. 10LB is a section through another possible structural shape for edges that incorporates a bumper detail.

FIG. 10M is a plan view illustrating how structural shapes can be joined.

FIG. 10N is a section through the roadcase or container of the prior Figures, showing a top edge structural shape and a molded lid.

FIG. 10O is a detail of the top edge structural shape seen in the prior Figure.

FIG. 10P is a section equivalent to that of FIG. 10N, showing the use of a rigid lid.

FIG. 10QA is an alternate top edge shape of reduced width.

FIG. 10QB is another alternative top edge shape of reduced width.

FIG. 10R is a plan view of a roadcase or container on a narrow ramp, showing the use of offset inboard wheels.

FIG. 10S is a section similar to FIG. 10N, illustrating the use of internal bracing.

FIG. 10TA is a section of a shape incorporating a detail for accepting a reinforcing angle at corners.

FIG. 10TB is an exploded plan view of two shapes joined at a corner and of a reinforcing angle.

FIG. 10UA is a side elevation illustrating how two roadcases of a different type can be stacked atop the illustrated roadcase or container.

FIG. 10UB is a side elevation of the subject matter of the prior Figure rotated right angles.

FIG. 10V is a section of a top edge structural shape of reduced width.

FIG. 10W is a section of another top edge shape of reduced width.

FIG. 10X is a section of two structural shapes that form a top edge and a lid frame.

FIG. 10Y is a section of an alternative pair of shapes that form a top edge and lid frame.

FIG. 10Z is a section of a roadcase adapted for carrying automated fixtures.

FIG. 11A is a section of a top edge structural shape with a hinged portion in closed position.

FIG. 11B is a section of a top edge structural shape with a hinged portion in open position to improve access to roadcase or container contents.

FIG. 11C is a section through a corner structural shape.

FIG. 11D is a section through another corner structural shape.

FIG. 11E is a section through the corner cube/chain motor container of the subsequent Figures.

FIG. 11F is a side elevation of a corner cube/motor container.

FIG. 11G is a section through the corner cube/motor container.

FIG. 11H is a reverse plan or bottom view of the corner cube/motor container.

FIG. 11I is a section equivalent of FIG. 11E with the addition of side panels and handles.

FIG. 11J is a section equivalent to FIG. 11E, showing doubled corner structural shapes.

FIG. 11K is a section of a possible top edge structural shape.

FIG. 11L is a plan or top view of the corner cube/motor container, showing the top edge shape.

FIG. 11M is a section through the corner cube/motor container in a plane parallel with side elevations.

FIG. 11N is a sectional detail of a possible molded lid.

FIG. 11OA is a section equivalent to FIG. 11M, showing an alternative shape for the lower edge.

FIG. 10OB is a section through the embodiment of the prior Figure at right angles to the view in that Figure.

FIG. 11P is a reverse plan or bottom view equivalent to FIG. 11P, showing the addition of ball casters.

FIG. 11Q is a side elevation of a corner cube/motor container using the lower edge shape seen in FIGS. 11OA and 11OB.

FIG. 11R is a side elevation illustrating to such corner cubes/motor containers in relationship to a wheeled dolly.

### DETAILED DESCRIPTION OF THE INVENTION

Socket

One aspect of the invention relates to improvements in the manner in which lamps are accommodated in lighting fixtures.

FIG. 1A illustrates prior art.

The light source illustrated is incandescent, and comprises a filament 90F supplied with power via two conductors 90G and 90H. Dashed line 90E indicates the lamp's envelope and, in this Figure, is attached to a lamp “base” 90B that mounts two electrical contacts 81 and 82 that form the electrical interface between the conductors 90G and 90H of lamp 90 and power.

These lamp-side electrical contacts 81 and 82 are illustrated as capable of coming into an electrically conducting relationship with contacts 61 and 62, which can be mounted in a common lamp “socket” 50 on the supply side of the interface. (In some embodiments, as illustrated here, contacts are adjacent in the same base and socket, while in others, mating contact pairs are located, for example, at opposite ends of a tubular envelope.)

In this simple representation, the supply-side contacts 61 and 62 are shown connected with the electrical power source 17. An additional set of contacts 31 and 32 that mate with contacts 25 and 26 are illustrated and may represent the contacts of a connector pair, for example, at the end of a fixture's power lead. There can also be additional components for functions that can include over-current protection/power distribution; power control/dimming; and/or (in the case of gas discharge sources) power conditioning and starting.

Most lighting fixtures are capable of accepting any one of a plurality of different available lamp variants. In the case of incandescent sources, lamps may differ in one or more of several characteristics, including in their design operating voltage (for example, for use on different local voltages); in wattage; and/or in design life at a given wattage and voltage combination (for example, several hundred hours for applications where output is desired; or a thousand hours or more where longer life and fewer lamp changes are the priority).

Such lamp variants generally share the same envelope design, light center, and base design to assure their physical and optical interchangeability in the same fixture. The manufacturer relies upon the user to employ a lamp suitable for the application.

In some cases, where different lamps might be stocked and used by a given facility or vendor and their characteristics differ sufficiently that the accidental insertion of the “wrong” lamp variant or its connection to the “wrong” input power could result in damage to the lamp and/or to the fixture, provision may sometimes be made to reduce the likelihood of such errors.

In one example, the Source Four ellipsoidial from Electronic Theatre Controls of Middleton, Wis. (as is generally described in U.S. Pat. Nos. 5,446,637 and 5,544,027) is available with a range of lamp variants include not only the previously-described variations in line voltage, wattage, and design operating life, but also in a half-wave variant that is used with the “multiplexing” system described in U.S. Pat. No. 5,323,088. (The half-wave lamp for a 120-volt system is a 77-volt variant, but it will be understood that the actual lamp design voltage for other than 120-volt power systems will differ.) The direct connection of a half-wave lamp to normal line voltage will result in its rapid failure. The “dimmer doubler” unit (identified as 3B in the '088 patent) being separately packaged, the probability of so connecting a fixture with a half-wave lamp are reduced by using a different electrical power connector on all half-wave portions of the system; one incompatible with the various connector types used for line-voltage applications. Like most “lekos”/ellipsoidials, the Source Four fixture uses a “lamp cap” to which both the lamp socket and the fixture power lead are permanently attached. (The lamp cap is identified as “burner assembly 23” in the '637 patent, the socket is 77, and the power lead is 72.) Therefore, the half-wave system requires use of a lamp cap identical to the line-voltage version, except that its power lead is terminated in such an incompatible connector. The same connector is employed on the outputs of the “dimmer doubler”, and is required for the intermediate extension cables needed when the two fixtures supplied from a common “dimmer doubler” are not immediately adjacent.

FIG. 1B illustrates. Lamp 90 is a line-voltage variant. Lamp 91 is a half-wave variant. The conductors 41A and 42A of power lead 40A are attached to socket 50A and terminated at the supply end in a “stage-pin” type plug 30A as is often employed on line-voltage portions of a lighting system. The power lead 40B attached to socket 50B is terminated in a twist-lock connector 30B of a configuration limited to use on half-wave portions of the “multiplexed” system. (In these and most other embodiments, provisions will also be made for a safety ground.)

While reducing the likelihood of an accidental connection of a fixture with a half-wave lamp directly to line voltage, this approach has several disadvantages. Because field exchange of connectors on the same power lead is not practical, separate lamp caps with different power connectors are required if the same fixture is to be used in both half-wave and line-voltage modes, resulting in the need to stock additional lamp caps at significant cost, as well as is the need to physically exchange lamp caps (and not just lamps) to convert the same fixture between the two modes. The separate “dimmer doubler” unit is also required, as are specialized extension cables, should the two fixtures sharing a “dimmer doubler” not be (or remain) physically adjacent.

Also, because the lamp variants in this system are physically interchangeable, nothing prevents the accidental insertion of a half-wave lamp (e.g., lamp 91) in the socket (e.g., socket 50A) of a line-voltage lamp cap, which will generally only be discovered when application of line voltage destroys such a lamp.

The same ETC Source Four fixture design was also upgraded after its introduction to accept a 750-watt lamp, in addition to the 575-watt lamp that had previously represented the fixture's upper wattage limit. To prevent use of the 750-watt lamp in older fixtures, the 750-watt version has a lamp cap whose lamp socket, while otherwise similar to that for the 575-watt fixture, incorporates a recess that will accommodate an additional, non-conducting, pin that projects from the base of the 750-watt lamp. The 575-watt lamp socket, lacking such a recess, will not accept a 750-watt lamp.

FIG. 1C illustrates. Lamp 90 and socket 50A are the 575-watt variant also seen in FIG. 1B. Lamp 92 and socket 50C are the 750-watt variant with pin 92P and recess 50C illustrated.

Beyond the issues that attend the need for such lamp variants in fixtures, can also be those of employing lamps operating on very different principles in the same fixture; for example, to employ at least one incandescent source, as well as at least one gas discharge source, for reasons that can include differences in lamp life, replacement cost, power efficiency, color rendering, and/or for matching color temperature with other fixtures having the same type of source.

Even were lamps of these different types to be physically and optically interchangeable, their electrical requirements are generally very different. As in the half-wave example, the use of the “wrong” lamp (for example, an incandescent lamp on the igniter and ballast for a gas discharge source) is undesirable; yet minimizing the variations in a fixture necessary to accommodate different source types is very desirable.

Refer now to FIG. 1D. Like the prior Figures, two lamp variants 93 and 94 are illustrated, as is a socket 50D. Unlike the prior Figures, the socket is illustrated with at least one additional electrical contact on the supply side of the interface.

It will be seen that, when lamp 93 is employed, filament 93F will appear, via lamp base contacts 81D and 82D, between socket contacts 61D and 62D. When lamp 94 is substituted in the same socket 50D, its filament 94F will appear, via lamp base contacts 81E and 82E, in an electrical circuit between socket contacts 61D and 63D.

Therefore, while lamps 93 and 94 may be made optically and mechanically interchangeable, the insertion of one or the other lamp results in different electrical circuiting. Such different electrical circuiting can be used to protect each lamp, if not to provide for its connection to the appropriate power.

In any of the embodiments herein and in others, many techniques can be used to protect lamp variants and/or to assure the “correct” supply of power, including variations in contact size, shape, orientation, and number, and in features of the lamp base and socket configuration. In the case of a design like that disclosed in design patent D477,885 S, different contacts can be located at different radiuses from the lamp's central axis and/or in different planes perpendicular to it. (While FIG. 1D illustrates three contacts on each lamp base (e.g., contacts 81D, 82D, and 83D on base 93B of lamp 93) it will be understood that the unused contact(s) can be omitted. It will also be understood that “backward-compatible” designs are possible in which some existing lamp and lamp base designs can be employed.)

The additional contact(s) can be wired to the appropriate pole of a different power connector, such that a circuit will result only when the appropriate lamp is connected with the appropriate power.

FIG. 1E illustrates.

Contacts 61E and 62E of socket 50E are wired to “stage-pin” connector 30A. Contacts 61F and 63F of socket 50F are wired to “twist-lock” connector 30B. Unlike the prior art approach of FIG. 1B, insertion of a bulb in the “wrong” assembly will not result in a circuit on the “wrong” power system and, therefore, in damage to lamp or fixture.

In FIG. 1F, a socket 50F is mounted with a power inlet connector 36, and the two may be either mounted in or readily removable from fixture housing 5F. Power leads can be terminated in a connector mating with the power inlet connector 36 on one end (e.g. 35G) and terminated with the desired power connector (e.g., “stage-pin” connector 30A) on the other. Such power leads are less expensive than the present complete lamp cap assembly and can be readily exchanged for another assembly terminated in the same or a different (e.g., twist-lock 30B) power connector. The lamp socket and power inlet connector can be separate components or can be fabricated in a unified assembly.

In FIG. 1G, the power lead 40G terminates in an assembly 51A that provides the lamp socket function, but can be readily removed and replaced. Power lead 40G is shown terminated at the other end in a “stage-pin” connector 30A, and the entire assembly can be readily removed from the lamp housing 5G, in this example, by pulling latch 6G, which withdraws plunger 6GP from a recess 51AR in assembly 51A. Thus, the entire electrical system can be quickly replaced with a similar or a different assembly.

In these examples, it will be understood that an electrical circuit will result only when a power lead having the appropriate power connector is used with an appropriate lamp—for example, when a line-voltage power lead is used with a line-voltage lamp.

The techniques disclosed can be employed with many different lamp variants, including, but not limited to, half-wave variants. As will be seen, they can be employed with lamps of different types.

The Figures following include some of the techniques that permit half-wave lamp variants to be used without requiring either specialized “dimmer-doublers” or connectors.

In FIG. 1H, the necessary diode(s) is integrated at the fixture, rather than in a separate unit. As will be seen, the insertion of a line-voltage lamp 93 in socket 50H results in its connection to line-voltage connector 30A. The insertion of a half-wave lamp 94 in the same socket also results in its connection to line voltage, but via the necessary diode. A double-pole, double-throw switch 72 allows selecting diode polarity and, therefore, the assignment of the lamp to one side or the other of a “multiplexed” dimmer. (Alternatively, a single diode whose polarity of insertion is changed by a switch or other means can be employed.)

It will be understood that the reversing function can be provided by means other than a physical switch. For example, if a power inlet connector similar in principle to inlet connector 36 of FIG. 1F is employed, its design could permit two or more orientations of mating, which could be employed to change circuiting and, therefore, polarity.

Refer now to FIG. 1I, which illustrates several techniques that can be employed separately or together in the illustrated and in other embodiments.

FIG. 1I illustrates the use of a bipolar semiconductor power control means inserted in series relationship between the supply (via connector 30A) and the lamp socket 50I. In this embodiment, inverse-parallel thyristors are illustrated, although other devices and/or other topologies can be employed. It will be apparent that the power semiconductor means can be used to accommodate both line-voltage and half-wave bulbs by the simple expedient of causing it to conduct in half-cycles of one or both polarities, and that reversing polarity is trivial. Thermal losses in the device(s) are limited and there are no potential EMI/RFI issues, as any mode changes can be performed at the zero-crossing.

A semiconductor power control means at or near the fixture providing selectable full-wave and half-wave operation can also be used in intensity control.

The mode(s) of operation of such a semiconductor power control means in intensity control can be one or more of many and can be varied.

For example, the use of known “skipped half-cycle” techniques requires no significant increase in either parts cost or thermal losses, providing a measure of intensity control that can be suitable in some applications.

Thyristors can be used with an inductor for phase-control. Field-effect devices/IGBTs can be operated in linear, controlled-transition, and/or PWM modes.

It will be understood that the mode of operation of such a semiconductor power control means can be made responsive to the lamp variant and/or to the desired intensity relative to the supply voltage.

A common semiconductor power control means can be used with provisions to add or exchange the additional components required for intensity control, including drive electronics, inductors, and other additional components, and/or additional heat sink or heat dissipation provisions.

FIG. 1I illustrates a control means 75 that drives the power devices 73A and 73B via their gates on line 73C. Control means 75 is illustrated as sensing voltage/power waveform via input 75V and current from sensor 75C. It also illustrates an input 75I for a desired intensity value and one from a sensor 75S, that sensor illustrated at lamp socket 50I.

While the circuiting of a fixture can be changed as a consequence of the use of different circuit paths at the electrical interface to the lamp, such is hardly the only method of identifying lamp variants and controlling the power applied. Additional contacts on or physical or other features of the lamp can be used to identify lamp variants—for example, feature 93N is detected by sensor 75S when lamp 93 is inserted in socket 50I. The very differences between lamp variants that result in their differing power requirements can produce detectable differences in their response (for example, impedance/current demands) that can be non-destructively tested for and operation adjusted accordingly.

FIG. 1J is a detail of one example power device alternative; a single field-effect device 74D inserted in a diode bridge comprising diodes 71C, 71D, 71E, and 71F, which permits its bipolar operation.

In any of these or other embodiments, the semiconductor power control means and/or control means can be packaged in one or more readily replaceable modules(s).

In any of these or other embodiments, the semiconductor power control means could be packaged in or insertable in the fixture; separately from the fixture in, for example, an enclosure installed in-line in an attached or a removable power lead; or packaged in an independent enclosure.

Where prior Figures make changes on the supply side of the lamp interface to change half-wave polarity, FIG. 1K illustrates polarity change by the simple expedient of changing the orientation of the lamp in the socket. When line-voltage lamp 93K is inserted in socket 50K it is directly connected to line voltage via 41K and 42K. With half-wave lamp 94K inserted in socket 50K in the orientation illustrated, lamp 94K will be connected to the same line-voltage connector 30A, but via diode 71H. By reversing the same half-wave lamp 94K upon its insertion in socket 50K, lamp contact 83K will mate with socket contact 64K instead of socket contact 63K, resulting in a connection to line voltage via diode 71G, and, therefore, in reversed polarity.

FIG. 1L incorporates the diode required by half-wave operation at the lamp itself. Base 94LB of lamp 94L inserts diode 71I in the circuit path between contact 82L and filament 94LF. The contacts 61L and 62L of socket 50L can be connected directly to line-voltage (or such other power source as desired). Insertion of lamp 93L in socket 50L results in its direct connection. Insertion of lamp 94L in the same socket 50L will always insert the required diode in series. Reversing lamp 94L in socket 50L will reverse diode polarity and, therefore, “assign” the lamp to the other side of the “multiplexed” dimmer supplying it.

Diode 71I may be made integral with the lamp. As previously described, one or more semiconductor power control devices can be used in lieu of a diode(s). In lamp-designs like that illustrated in U.S. D477,885 S, rotation of the bulb about its central axis between one and the other of two “locked” positions/orientations (in addition to at least one “insertion” position/orientation) can produce diode reversal Such lamp designs can include a portion external to the fixture housing operating at substantially lower temperatures than portions within the fixture housing. Diode 71I can be located at this exterior portion, if not provided with a heat sink there.

In the “multiplexed” system as has been described, a given half-waved lamp filament is coupled to the alternating-current supply only during half-cycles of one polarity. It is, therefore, necessary that the lamp loads be divided/assigned between the two polarities, to make efficient use of dimmer and circuit and to achieve the object of separate control of lamp intensities on the same dimmer output.

It is further necessary that the control electronics of the dimmer supplying such lamps and the lighting controller sending desired intensity values to that dimmer both be re-configured to provide for separate control of the two “sides”/polarities of the dimmer's output.

At present, both the assignment of lamps to one or the other “side”/polarity and the re-configuration for “multiplexed” operation require the intervention of the user.

Both such re-configuration and the assignment of half-wave bulbs to one or the other “side”/polarity can be simplified, if not made automatic.

“Half-waved” lamp filaments conduct only in half-cycles of one polarity. Therefore, if only a single such lamp is connected to a dimmer, continuity will be “seen” through a half-waved filaments in only half-cycles of one polarity, where one or more line-voltage filament will conduct in both. When multiple half-waved filaments are connected via diodes in both polarities (i.e., to both “sides” of the dimmer), other methods of detection can be employed. The impedance and/or the current demands of the connected lamp load can be determined, using, for example, a sensor at the dimmer power stage level or one shared by multiple dimmer power stages. Differences between the impedance/current demands on either “side” of the dimmer power stage can be sensed or inferred to-detect the presence of “multiplexed” lamps. For example, if different total half-waved filament wattages are connected to the two “sides”, the difference can be detected and “multiplexed” operation deduced. Regardless of the relative wattage “balance” of connected half-waved lamps between the two “sides” of a dimmer, the impedance of a lamp filament changes dramatically between its “cold” state and its energized, “warm” state, such that half-waved lamps can be detected by applying power differently to half-cycles of different polarity. If half-waved lamps are attached, a detectable difference can be created in load impedance/current demands by “cooling” filaments on one side and “warming” those on the other. If such differences appear, “multiplexed” operation can be deduced. If one or more line-voltage lamps are connected, no significant difference in impedance/current demand will be apparent between the lamp load in two nearby half-cycles of opposite polarity. Upon detection of half-waved (or line-voltage) lamps on the dimmer output, the corresponding configuration adjustments by both dimmer and controller can be made automatic.

The insertion and/or the polarity selection of a diode in series with a lamp can also be made automatic, either as a strictly local operation or in cooperation with other components of the lighting system.

The assignment of “multiplexed” fixtures to one or the other polarity can be made by the user at the fixture, for example by the use of a mechanical switch, a mode selection, or changing lamp orientation.

It is also possible to make such assignment automatic and/or remotely modifiable. For example, the current demands of an energized lamp load on a circuit will typically result in a voltage drop as a result of losses in cable and dimmer chokes, relative to the same lamp load's un-energized state. By connecting a half-waved lamp to first one and then to the other polarity of half-cycles, it can be determined from the resulting relative voltage drop whether another such half-waved lamp is also present on the same circuit, and if so, on which polarity, and the other polarity selected. (As in collision sensing digital addressing schemes, differing time bases can be used in sampling.)

Polarity selection can be made or altered remotely.

For example, the applicant's U.S. Pat. Nos. 6,211,627 B1 and 6,469,457 B2 discloses methods by which values can be encoded in dimmer outputs, for example, by relative variations in average power passed in different half-cycles. Such techniques can be used to signal means associated with the fixtures (in only one example, control means 75 of FIG. 1I) to, for example, interrogate them as to the lamp variant connected. Such circuits can respond by connecting or not connecting or by delaying the connection of the lamp load so as to be detected. Encoded instructions can be used to remotely set and change fixture polarity/half-cycle. Other methods of communication can be employed.

The disclosed detection and polarity-setting techniques can be used whether the device(s) “half-waving” lamps are packaged with or independently of the fixture.

As earlier described, there is also frequently the desire, if not the need, to operate not just variants of lamps of the same type, but lamps of completely different types (for example, both incandescent and gas-discharge lamps) in the same fixture, although their power requirements and the auxiliary equipment that they require can be very different and often incompatible.

Any of the techniques of the present invention can be employed to achieve this object.

Refer now to FIG. 1M, an embodiment in which, for example, an incandescent lamp 93M or a gas-discharge lamp 95 can be employed. In this embodiment, (phase-to-neutral) lamp-side contacts 81M and 82M of incandescent lamp 93M mate with supply-side contacts 61M and 62M of socket 50M. If, on the other hand, gas-discharge lamp 95 is employed, its lamp-side contacts 85M and 86M mate with supply-side contacts 65M and 66M of socket 50M.

Therefore, either lamp type can be inserted in the same socket, but different circuiting results.

The additional components/auxiliary equipment in the circuit path for each lamp type, as well as the input power connection, can differ. In the illustrated embodiment, for example, incandescent lamp 93M is supplied with line voltage via 41M and 42M from a typical phase-to-neutral connection between phase 17Z and neutral 17N of source 17. However, if gas-discharge lamp 95 is inserted in socket 50M, it will be supplied via 76C and 76D from a ballast and igniter 76 which, in turn, is supplied a higher input voltage by a phase-to-phase connection via 76A and 76B between phase 17Y and 17Z.

Separate contacts are illustrated here for the two lamp types. It will be understood that some contacts can-be shared between different lamp types. It will also be understood that additional contacts or other features may also be provided for variants within lamp types, such as between line-voltage and half-wave incandescent lamps.

In FIG. 1M, the supply of power to both “sides” of the system are illustrated as different, in that line voltage will typically be applied to at least some incandescent lamp variants, and at least the option of higher voltage (phase-to-phase) operation can be both practical and desirable for gas discharge sources. In the context of FIG. 1F, it will be understood that different power leads could be employed to assure that, for example, a phase-to-phase supply could not be connected to the incandescent lamp 93M. (In these and other cases, a ballast for gas-discharge lamps will often be capable of operating on either connection.)

Referring now to FIG. 1N, an embodiment is illustrated in which one “side” includes auxiliary equipment 76 for gas discharge sources and the other includes a semiconductor power control means 73N that permits use of either line-voltage or half-wave incandescent lamps and/or intensity control. In this or other embodiments, such a semiconductor power control means can be used to permit operation of an incandescent lamp from a supply voltage well in excess of the lamp's design voltage (a voltage that might be preferred for the gas discharge source).

In FIG. 1N, an embodiment is also illustrated in which at least two different lamp types can be accommodated and both “sides” are connectorized to permit the insertion/exchange of auxiliary-equipment. The types of equipment on each “side” can be varied—for example, a fixture might permit the use of multiple gas discharge source types operating on different principles, and therefore, potentially requiring different auxiliary equipment. Different such equipment can be inserted/attached, depending upon the requirements of the light source employed. The previously-described or other techniques can be employed to assure that the appropriate power is applied to a given lamp.

Where FIG. 1N illustrates an embodiment in which separate power conditioning/power control apparatus are provided on a plurality of “paths” between a lamp and power, there will be cases where there is potential commonality between the components required by different lamp types. FIG. 1O illustrates an embodiment in which a common portion 77 is shared between multiple lamp types. Certain additional elements (for example, high-voltage igniter 78) may be required for only one type of lamp (if not being undesirable for another). Such elements can be located in separate circuit “paths”, as is illustrated—or their connection or operation may be made conditional upon the previously described connection or sensing of the appropriate lamp type and variant.

In every illustrated and in other embodiments, the lamp or an adapter or carrier used with it can incorporate one or more feature that changes circuiting and/or changes the state of a supply-side sensor, resulting in the protection of the lamp, if not the application of the appropriate power to it. Alternatively, the differing characteristics of different lamp types and variants permit the use of techniques that apply power to identify the type of lamp (if not the variant within that type) without applying potentially destructive voltages and/or currents.

The techniques employed to achieve the benefits of the invention should not be understood as limited except by the claims.

FIG. 1PA-1PI illustrate but one of many possible embodiments, in this case, of a traditional “single-ended” lamp design.

The example employs a variation in the design of base and socket to limit the orientations in which a lamp can be inserted. FIG. 2PA, a frontal elevation of the lamp socket, and FIGS. 2PB and 2PC, which are sections, the planes of which include the lamp/socket centerline, and are at right angles to each other, illustrate an extended “collar” 50PC forming a well into which the lamp base is inserted. That “collar” has a curved face 50PA, and flatted sides 50PC, that prevent the insertion of lamp bases 93PB and 95PB unless their flatted sides are parallel to those of the socket “collar”.

Lamp base 50P is illustrated with five contact wells, for contacts including 61P, 62P, 65P, and 66P. It will be seen from examination of the Figures that lamp 95P (which is shown from two sets of angles rotated 90 degrees), when inserted in socket 50P, will mate pins/contacts 85P and 86P only with socket contacts 65P and 66P. In the other hand, the pins/contacts 81P and 82P of lamp 93P will mate only with socket contacts 61P and 62P. Thus, lamps 93P and 95P will be circuited separately as in, for example, FIGS. 1M and 1N.

As illustrated, either lamp can be inserted in two possible orientations, each rotated 180 degrees from the other. This might provide, for example, the diode reversal of FIG. 1L. It will be apparent that variations in base/socket and/or contact design (among other techniques) might prevent an undesirable such reversal.

FIGS. 1QA-1QD illustrate example techniques applied to a different lamp base configuration. It will be seen that contacts 65Q and 66Q of the base 95QB of lamp 95Q are at a different radius from the centerline of lamp 95Q, relative to contacts 81Q and 82Q of lamp 93C, such that they will mate with different socket contacts and different circuiting will result. It will also be apparent that either lamp can be inserted in a socket and rotated 180 degrees in one direction or the other to produce two different circuiting alternatives—including a diode reversal. The use of techniques including lamp base and socket features and contact design can be used to limit the mating orientation.

Where prior Figures have illustrated lamps having a single, fixed power requirement, FIGS. 1R and 1S illustrate lamps that have a plurality of possible power requirements based on variable circuiting.

In FIG. 1R, lamp 96 has at least two filaments or filament segments 96F and 96FF, with three illustrated conductors 96G, 96H, and 96I and three contacts 81R, 82R, and 83R to an external source of power via socket 50R. It will be understood that connecting power to contacts 41R and 42R will energize only filament 96F; that connecting power to contacts 42R and 43R will energize only filament 96FF; and that connecting power to contacts 41R and 43R will energize both filaments in series.

Thus, lamp 96 could be operated on at least two very different power services.

FIG. 1S illustrates a lamp 97 that provides even greater flexibility. Filament 97F is circuited (via conductors 97G and 97J and by the socket contacts 61S and 64S that mate with them) independently of filament 97FF. Thus, by varying the circuiting of conductors 41S-44S, filaments 97F and 97FF can be used independently; in parallel; or in series, further increasing versatility.

In most fixtures, the electrical path between the lamp socket and the power source is not interrupted unless the fixture is physically disconnected from the power source. Therefore, there is frequently nothing, save caution, that prevents the user from handling the lamp (whether in trouble-shooting and/or replacing it) while still connected to an energized circuit. Such work is frequently performed with both the fixture and the user at some distance above the ground and/or in other potentially hazardous circumstances. Energizing an exposed lamp produces a dazzling light and a rapid increase in lamp envelope surface temperature. There is the possibility of electrical shock. Therefore, it is always desirable (if seldom provided), that the lamp be de-energized for lamp changes and trouble-shooting.

Fixtures with gas discharge sources can present additional hazards from high igniter voltages, UV radiation, and potentially explosive pressures. Many have incorporated interlock switches in their housings, which interrupt lamp power when opened for access to the bulb, but such switches can generally be defeated and can themselves become a source of problems when they cease to close reliably. Most gas discharge and some incandescent fixtures include power switches, but there is, of course, no assurance that the user will turn the fixture “off”. Such switches can themselves become sources of failure, and, in normal use, might not be turned “on” when used, requiring trouble-shooting and correction later.

FIG. 1T illustrates an improved approach, illustrated in the context of embodiments in which the fixture's power lead 40T is attached to the same removable element 52 as the lamp socket (for example, the traditional “lamp cap” of the previously-identified Source Four and others). At least one conductor between the lamp and the fixture is routed through a contact assembly having one side (contacts 67T and 68T) on the removable element and the other side (contacts 87T and 88T) on the fixture housing 5T. The electrical path through this contact assembly results in its automatic interruption when the removable element 52 is withdrawn. Such contact assemblies are simpler, more dimensionally-tolerant, and more reliable than traditional interlock switches. In that portion on the fixture side, the electrical path can be (or can be conditionally) routed through other components, and it will be understood that the contact assembly can allow for alternate orientations that change the electrical path, for example, for changing diode polarity. The contacts/contact assembly can be individual or can be integrated with other components.

FIG. 1U illustrates an embodiment in which power to the fixture is not routed through a removable element carrying the lamp. In this case, the electrical interface between contacts 87U and 88U on housing 5U and contacts 67U and 68U on removable element 53 connect power upon insertion and removal. The arrangement is intrinsically safe as withdrawal of the element 53, which carries the lamp, will automatically result in its disconnection from power. Because the removable element 53 (unlike prior art units with leads connecting the lamp socket with the housing) is not permanently attached to the fixture housing, it can be readily replaced as a unit.

In the context of both prior and subsequent Figures, embodiments are proposed in which a semiconductor power control means is used to limit the maximum power applied to a lamp to the region of its design voltage, which is substantially less than the input voltage supplied. Many techniques for limiting the power to the lamp are possible including, but not limited to, pulse-width-modulation and “phase control” dimmers that pass either equal or unequal portions in different half cycles. FIG. 3P illustrates an alternative waveform in which relatively low intensities can be produced by either forward or reverse phase control, but, at least as desired intensity approaches the lamp's design voltage, the illustrated waveform is employed in which the “first and last” of the AC waveform is employed to limit the maximum instantaneous voltage and current applied.

Power and Data Distribution in Lighting Systems

It has long been the case that different fixtures (and other devices) in the same lighting system can have substantially different input power requirements, heretofore generally dictating the need for multiple, essentially independent, power distribution and cabling systems, with a variety of important disadvantages.

Refer now to FIGS. 2A and 2B.

In traditional practice, virtually all of what are now called “conventional” (non-automated) lighting fixtures (e.g., PAR, fresnel, leko, striplight) in most entertainment applications have employed incandescent lamps, operating at the locally-available phase-to-neutral line voltage (120 volts in the United States). They require a distribution system in which 2-wire circuits (plus grounds) connect dimmer racks or packs (if intensity control is desired) with the fixtures. In many temporary and portable applications, multi-circuit multi-cables are used. In common practice, the multi-cable is often a 19-pin “Socopex” connector (as produced by several manufacturers) generally terminating 14-conductor 12-gauge cable and used for six circuits of 2400-watt capacity sharing grounds via the 13^{th} and 14^{th} conductors. FIG. 2A illustrates one such multi-cable 141. At the load/fixture end, that connector is adapted (generally by a “fan-out”) (e.g., 144) to six single-circuit 20A three-pole connectors (e.g., 145A) to mate with those installed on the fixtures' line cords or on extension cables to them (e.g., 146A). At the supply end, such multi-cables can be similarly adapted to single-circuit connectors for plugging into single-circuit receptacles on a dimmer or distribution unit or can be plugged directly into compatible multi-circuit receptacles on a dimmer or distribution unit. In the case of larger dimmer racks with such multi-circuit receptacles, a load patch is generally included to permit selectively assigning and combining the circuits of several multi-cables on the dimmers (often 48 or 96) in the rack.

In the case of both multi-cables and dimmers, the industry has largely standardized on a 20A/2400-watt capacity, in large part, to accommodate those fixtures (notably fresnels) having a single 2000-watt bulb. In fact, most fixtures are of 1000 watts or less, and the trend has been downward with the widespread adoption of fixtures having more efficient compact-filament 575-watt lamps. Although multiple such fixtures can be combined on the same dimmer and cable circuit, there can be limits to such combination. The desired artistic effect and/or the physical distribution of fixtures in the lighting system—as well as the desire to preserve flexibility for future changes—can limit the ability to combine fixtures to make efficient use of the capacity of dimmer and/or cable. In one example, a position with twenty-four 575-watt fixtures could, theoretically, be supplied by a single such six-circuit multi-cable, but the need for separate control of the fixtures in more than just six groups and the added complexity of using “twofers” and “jumpers” to combine loads at the position (and the resulting loss of flexibility in changing such combinations later), in practice, often requires many more circuits, in some cases, as many as four multi-cables, with a single 575-watt load on each 2400 watt capacity circuit (if not also an additional multi-cable for spare circuits for additions and/or replacements). At the dimmer rack, the many circuits in those multi-cables can often be load-patched down to a smaller number of dimmers, but the result will still frequently be that many dimmers will be used for only a portion of their capacity.

Varying the average power supplied to fixtures with incandescent sources varies their intensity non-mechanically. Changing other beam parameters requires mechanisms at the fixture. There is a long history of the use of remote control beam modifying mechanisms. Such remotely controlled mechanisms require power for both actuators and local electronics, as well as the distribution to and around the fixture locations of control-values corresponding to the desired-parameter adjustments. Use of such accessories (e.g., color changer 880 on fixture 875), therefore, has required the addition of manufacturer-specific “power supplies” (e.g., 881), which typically accept both an un-dimmed line voltage circuit (via 881A) and a DMX512-formatted control input (from 172B), and that include output connectors carrying both low voltage power and control data, which are connected with such accessories using small-gauge jumper cables (e.g., 882) equipped with compatible connectors (often the 4-pin “XLR”).

Of those so-called “automated” fixtures (e.g., 885) (as first generally described in U.S. Pat. No. 3,845,351) that employ gas discharge sources, many are configured, in the interests of both efficient cabling and international operation, to accept input voltages in excess of 200 volts which, in countries with lower available line voltage, is obtained by a phase-to-phase, rather than phase-to-neutral connection to the local alternating current supply. While certain firms have assembled specialized cabling and distribution systems for their automated fixtures, many users have effectively standardized on the use of single-circuit cables with three-pole twist-lock connectors (typically the NEMA L6-20 or L6-15 configuration) and of the same 19-pin “Soco” cable with all twelve un-earthed pins connected to phases (see Table A below), adapted to the same twist-lock connector (e.g., 155A) by “fan-outs” (e.g., 154).

Although physically identical multi-cable is used for both 120-volt “conventional” and 208-volt “automated” fixtures (e.g., multi-cables 141 and 151), even when both fixtures are at the same location, separate multi-cables are generally required for each function, because of the complexities of mixing circuits with both voltages in varying configurations and quantities in the same cable and the consequences of the accidental application of 208 volts to a conventional fixture's 120-volt bulb.

The result is the requirement for two separate distribution systems, including separate 120-volt dimmer and 208-volt distribution units; separate multi-circuit cables; and different single-circuit “break-outs” and extension cables, at an increase in the cost to acquire, to prepare, to transport, and to install this quantity of equipment.

In one example, ten “conventional” fixtures and ten “automated” fixtures are used at the same position. Because of the difficulties and risks of mixing 120-volt and 208-volt circuits in the same multi-cable, a minimum of two multi-cables will be required (one for “conventionals” connected to dimmers and one for the “automated” fixtures connected to 208-volt distribution). As has been seen, the “conventionals” may require more than one multi-cable to provide the required degree of control and flexibility.

The above example is typical when the “automated” fixtures are “stand-alone” units that contain onboard power supplies for actuators and electronics; an arc power supply or a local dimmer for the light source; and that accept an input with control values directly. Certain fixtures have been designed to rely on an external unit similar in principle to the “power supplies” used with conventional fixture accessories; one that provides low-voltage power and data distribution (if not some control functions) to more than one fixture, and which requires its own un-dimmed power source, input data, and specialized power and data jumpers between it and the fixtures.

In addition, in many portable applications, fixtures are supported by temporary structures, often trusses, that are suspended from chain motors (e.g., 895). Such chain motors typically require a three-phase supply rather than the two phases employed by automated fixtures and by most other gas discharge sources. Hence, such chain motors require yet another, independent, cabling and distribution system, even though they will generally be operated only for the few minutes that the chain motors are in operation.

FIG. 3A, which appeared in similar form as FIG. 1M in parent application Ser. No. 10/403,651, included in its entirety by reference, illustrates these differing requirements: separate circuits 810A/811A and 810B/811B to provide independent intensity control of incandescent lamps 499A and 499B; line-voltage power distribution for outlet 490; a phase-to-phase connection to supply ballast 497 for gas discharge lamp 498 with a higher voltage; and three-phase distribution to chain motor 496. The result has been the need for several distribution and cabling systems, such as dimming systems and cabling for conventional fixtures; single-phase power distribution units for un-dimmed phase-to-neutral loads; two-phase distribution and cabling for gas-discharge sources; and three-phase distribution and cabling for chain motors.

“Automated” fixtures (like remotely-controlled accessories to conventional fixtures) also require the distribution of control data to and around the fixture positions. Certain proprietary systems excepted, both “automated” fixtures and remotely controlled accessories for conventional fixtures have generally been configured to accept their control data via DMX512, an RS-485-based transmission protocol for 512 8-bit values (plus an additional preamble byte) originally adopted for the limited purpose of conveying dimmer values between a console and dimmers.

“Automated” fixtures each consume a large number of such values for their various adjustable parameters and a large lighting system may require the distribution of more than one discrete set or “universe” of DMX512 values to the fixture positions. Most such distribution is performed with small-diameter shielded cables (e.g., TMB Associates ProFlex) terminated in 3-pin or 5-pin XLR connectors (as opposed to the 4-pin “XLR” connector typically used for conventional fixture accessories). Various enhancements to DMX512 and higher-capacity methods of data distribution have been proposed, including the use of an Ethernet “backbone” down-converted to multiple DMX512 “universes” and “RDM” a bi-directional variant of DMX512 with several enhancements.

Powering Chain Motors

Referring now, in greater detail, to the requirements of chain motors:

In general practice, the chain motor itself contains two contactors. A given contactor's closure sends the motor in one or the other direction. The chain motor is typically supplied with multi-phase (typically three-phase) power. A three-wire control circuit is extended from the motor, in which switch closure between the “common” and one or the other of the remaining two conductors closes one or the other of the two contactors in the chain motor, causing the motor to move chain in one direction. These power and control inputs are either combined in a common multi-connector or in two twist-lock or other connectors (one for power and one for control).

Some chain motors are configured with the contactors located remotely from the motor, such that only three-phase conductors and a ground are required by the motor—in turn, requiring only a single 4-pole twistlock connector.

Providing power and control to the chain motors presently requires its own distribution system, including the specialized multi-cables (or twist-lock cables) that connect each motor with a distribution/contactor unit (e.g., 181D); low-voltage control cables that connect the distribution/contactor unit with a handheld remote control; and power cables (often 30A-50A 4-pole or 5-pole) that connect each of several distribution/contactor units with upstream power distribution unit(s), which, in turn, are connected with the main alternating current supply.

To the various power and control data cables required at a lighting position, will therefore be added this additional system of specialized power and control cables required by the chain motors supporting it.

One aspect of the present invention relates to improvements by which the total power and data cabling and distribution “infrastructure” required by a modern lighting system can be dramatically simplified—permitting a reduction in the amount and variety of equipment needed, in its capital cost, in its shipping cost, and in the time and labor required to prepare and set-up such equipment.

One aspect of the invention relates to powering and controlling chain motors, which, at present, typically requires the above-described separate system.

In reality, chain motor power and control are required for only those brief periods that the chain motors are raising or lowering the loads that they support. The lighting fixtures on the structure supported by the chain motors generally do not require full power during the same periods that the chain motors are in operation.

One aspect of the invention shares common power distribution between the chain motors or other motive actuators and lighting or other loads.

Refer now to FIGS. 2C-2N, which illustrate some of many possible embodiments.

In the illustrated embodiment, unit 201 is packaged in an enclosure designed to be capable of insertion inside a typical truss 400—a feature which can be of value in maintaining a low profile in constricted environments and by permitting the unit to be shipped while installed in such a truss.

As seen in sectional drawings FIG. 2D and 2E, the enclosure can be designed not only to fit within such a truss, but to do so while allowing sufficient clearance with the truss chords (e.g., 400A and 400B) so as not to interfere with the ability to make “spanset” wraps and/or to hang fixtures using clamps in the same area.

As seen from the Figures, unit 201 is modular in construction, comprising a backshell 201B that accepts two or more modules, in this case, an input module 201I and an output module 201O, as are both visible, for example, in FIG. 2J. The enclosure can mount one or more clamps that allow hanging it from a truss, pipe, or other structure.

One possible input module 201IA illustrated (e.g., in FIG. 2F) includes inlet 253 and outlet 252 19-pin Soco connectors and a motor control connector 273.

One possible output module 201OA illustrated (e.g., in FIG. 2H) mounts known 7-pin multi-conductor receptacles 280A-280D for the chain motors. (As illustrated in these and other Figures, such a module could, for example, supply and control four such chain motors.)

Like prior art chain motor controllers, unit 201 can contain relays or contactors for the previously described remote control of motor operation. As also previously described, in addition to variations in motor connector, there can be at least two electrical alternatives available—one, which is used with motors containing contactors, and another, which is used when the motors do not contain contactors. The design of such relay/contactor packages is well known. The former type typically includes one or more “motor enable” contactors (e.g., 206) that apply and-remove power to the motors, plus lower-current relays for direction control of each motor. The latter type will typically include one contactor (or contactor position) for each direction of each motor.

Different output modules can mount different motor connectors. For example, output module 201OA (seen in FIG. 2H) mounts 7-pin coarse-thread receptacles, while output module 201OB (seen in FIG. 2I) mounts 11-pin bayonet receptacles. Another output module could provide twist-lock power and control receptacles (or, more space-efficiently, flying leads terminated in such connectors). All three of these modules can be made interchangeable and can share the same contactor package. FIG. 2L illustrates an output module 201OC for use with those motors without contactors. One 4-pole twist-lock receptacle is provided for each motor (divided, for reasons of panel space, in this embodiment between the end and bottom surfaces of the module).

A modular design for such a unit allows, as will be seen, not just the field assembly of a chassis/backshell with different modules, but the incorporation of the same modules in other chassis, for example, the double-wide backshell 101BB illustrated in FIG. 2K, that can accommodate, in one configuration, one input and up to three output modules, producing a twelve-motor unit. Other modules, providing for functions like data communication/distribution and power supply for remotely controlled fixtures and fixture accessories, could also be employed.

Like prior art chain motor controllers, unit 201 provides an input connector (here 273) to connect a (typically handheld) remote control pendant.

Like prior art chain motor controllers, unit 201 accepts multi-phase power that is distributed to the chain motors.

Unlike such prior art chain motor controllers, unit 201 shares such multi-phase power with lighting loads.

FIGS. 2M and 2N illustrate (each representing a representative portion).

Input module 201IA employs, for example, the previously-described 19-pin “Soco” multi-cable 151 for power input via inlet connector 253. Multi-cable 151 is typically supplied from a generic 208-volt (phase-to-phase) distribution unit, as is typically employed for “automated” fixtures (although, as will be seen, many other approaches are also possible). As seen in FIG. 2M, the poles of inlet multi-connector 253 are paralleled with output multi-connector receptacle 252, such that, as seen in FIGS. 2C and 3M, a known “break-out” 154 can be plugged into output receptacle 252 and used to supply lighting fixtures.

Certain poles of input connector 253 are also paralleled with the chain motor receptacles 280A-280D, as well as being used to derive power for operation of contactors, relays, and for other functions.

As summarized in Table A below, pins 1, 3, and 5 of the inlet multi-connector 253 can supply one 3-phase motor power circuit (with pins 3 and 5 reversed after paralleling to restore correct phase rotation) and pins 7, 9, and 11 represent another motor power circuit (with pins 9 and 11 reversed for the same reason). When the inlet multi-connector 253 is plugged via multi-cable 151 to a generic 208-volt distribution unit, the result is two 20A 3-phase motor circuits. (As will be understood, the specific phase distribution on the inlet multi-cable will determine the connections required to produce the desired phase configuration for the chain motors or other actuators. As will also be seen, the unit can also be used with 120-volt distribution.) If used only in a 208-volt application, the input poles paralleled to for motor power could just as readily be, for example, poles 1-3 and 4-6.

One application of the illustrated unit is with typical 208-volt distributions. Such distributions are typically used to supply moving lights, which often contain discharge lamps that can be turned on and off by remote control commands via their data input without requiring either manual operations at the fixture or interruption of the AC supply. Therefore, when a unit (or another embodiment) is connected to both motors and to such fixtures on its output side and to a 208-volt distribution on its input side, power is always available to both types of equipment. The chain motors can thus be operated to attach them to the truss; to “float” the truss to a working height to attach fixtures and cable; and then can be “flown” out to ultimate “trim”. During this period, power will also be applied to the moving lights or other loads, which allows them to complete their self-test/calibration routine and which allows the user to check and reset their digital addresses and modes. The user can also “strike” (turn on) their lamps for additional testing purposes while at working height. During the periods during the set-up that the motors are operated, there is no necessity that the lamps be lit, and therefore virtually all of the power is available to the motors. Once at final trim, there is generally no further need for motor power until the “load-out”, and the power available from the input connector is exclusively for the moving lights or other loads.

One benefit of this or another embodiment is the elimination of a separate, dedicated, chain motor distribution system. The only specialized power-level cable required is the cable (e.g., 181A) between the chain motor and unit 201, which will typically be of a short length as unit 201 can be located near the motors. As will be seen, the small-gauge control cable 271 used for motor control can be the same or similar cable used for other purposes. And the same multi-cable 151 and associated 208-volt distribution used to supply power to the moving lights also supplies power to the motors. The result is a substantial reduction in the amount of equipment required and hence in total capital cost, in shop preparation, in shipping size and weight, and in set-up time and labor.

There may be circumstances in which the multi-cable supplying the lighting load is a 120-volt application, and in those circumstances, it is desirable that the unit operate in a 120-volt mode. Such an alternative is the reason for a selection of odd-numbered pins on the multi-cable inlet connector 253, which, as seen in Table A below, also corresponds to the “hots” on such multi-cables/-connectors in 120-volt applications.

When operating in a 120-volt mode with so-called “conventional” fixtures, the input multi-cable supplying the unit will typically be connected to a dimmer rack, which will not necessarily provide either constant power and/or the required phase rotations (although, in theory, both could be provided, in the patching of the rack and the use of non-dims or dimmers as non-dims). Alternatively, during motor operations, the user could plug the multi-cable into a 120-volt distribution with the correct phase relationships. In either case, because the motor circuits and lamp loads are paralleled, energizing the multi-cable will cause the fixtures to light, and the power available to the motors will be reduced by the amount of those lamp loads.

One alternative is to insert additional power contactors (or their equivalent) between the odd-numbered pins of the power input 253 and the outlet 252 to the lamp load. Normally closed, these contactors can be opened when the motors are enabled, temporarily disconnecting the lamp loads, such that those loads are “off” during motor operation, and the motors get the full benefit of the available power. In fact, this function can be provided by the use of double-throw relays or contactors for “motor enable” contactors, with the motors on the normally-open sides and the lamp load connector(s) on the normally-closed sides. In the type used with motors without contactors, each incoming phase can be connected to the common pole of one motor contactor, the normally-closed side of which is connected to the common pole of the second motor contactor, the normally-closed side of which is connected to the lamp load output connector. Energizing either relay to send the connected motors in the selected direction will also interrupt power to the lamp load.

If a separate relay/contactor package is provided to disconnect lamp loads during motor operation, the unit can provide for the insertion of such additional contactor package, by, for example, including the necessary harnesses, which can be plugged through when not in use, or by receptacles with shorting plugs.

The following “Table A” relates the pins of a typical 19-pin input “Soco” multi-cable to the various 120-volt and 208-volt functions, and to one possible set of motor uses. In this one of many possible embodiments, the motor functions are distributed on the odd-numbered pins of the input multi-connector to provide for both 120-volt and 208-volt operation as two 20A three-phase circuits. The table also illustrates that two additional three-phase circuits can be derived from the even-numbered pins in 208-volt mode.

TABLE A

| Soco | | 120-volt | 208-volt | |
|---|---|---|---|---|
| Contact | Circuit | Function | Function | Motor Function |
| 1 | 1 | Hot | Phase X | Motor Ckt #1 Phase X |
| 2 | 1 | Neutral | Phase Y | (Motor Ckt #3 Phase Y) |
| 3 | 2 | Hot | Phase Z | Motor Ckt #1 Phase Z |
| 4 | 2 | Neutral | Phase X | (Motor Ckt #3 Phase X) |
| 5 | 3 | Hot | Phase Y | Motor Ckt #1 Phase Y |
| 6 | 3 | Neutral | Phase Z | (Motor Ckt #3 Phase Z) |
| 7 | 4 | Hot | Phase X | Motor Ckt #2 Phase X |
| 8 | 4 | Neutral | Phase Y | (Motor Ckt #4 Phase Y) |
| 9 | 5 | Hot | Phase Z | Motor Ckt #2 Phase Z |
| 10 | 5 | Neutral | Phase X | (Motor Ckt #4 Phase X) |
| 11 | 6 | Hot | Phase Y | Motor Ckt #2 Phase Y |
| 12 | 6 | Neutral | Phase Z | (Motor Ckt #4 Phase Z) |
| 13-18 | All | Ground | Ground | Ground |

Any embodiment can include such additional features as may be desired, either as standard or as options.

Power indicators are one. A phase-rotation indicator is another. Another feature would sense the presence of power on each of the three poles of the inlet power connector as would be required by a given motor circuit (with or without also examining their phase rotation). Only if power were present on all three of the phase conductors would it be possible for the corresponding contactor(s) to close. Thus, no power would be supplied to a motor unless all three phases were available and opening any upstream switch or breaker that interrupted any one phase would positively assure that-all three would be interrupted. Contactors can be used to identify the phases required from the input can connect them appropriately to the motors.

It will be understood that some chain motors are configured for one or two phases and that a unit that shares common input power between both such motor and lighting loads can be produced.

The Figures also illustrate a motor control inlet connector 273 on the Input Module (located there in this embodiment, although it could be located elsewhere).

That motor control inlet connector could well be one of the existing types in use. If, for example, an eight-motor connector is chosen then the user could employ a splitter (whether external or built into the unit) to move control for motors #5-8 where they can be used by a second such 4-motor group.

The motor control connector may or may not be used for other forms of control signal distribution, as will be described below. As the motor control function is required only during those periods when the motors are in motion, therefore, the same control cable used for motor control could also change modes and be employed to distribute lighting or other data when the chain motors are not in use.

Like other chain motor controllers, the unit could supply power suitable for powering a handheld local remote controller via the motor control connector—as well as being capable of plugging to more elaborate controllers.

Other forms of power input can be accepted by such a unit—including by means of interchangeable connectors and/or input modules. Examples include (but are not limited to) the 5-pole twistlocks found in 20A and 30A versions with associated #12/5, #10/5 or larger cable as are used in portable power distribution systems and in permanent installations like convention centers, and the 4-pole 50A twistlock connector with associated #8/4 or other cable as is used in some present chain motor distribution systems. FIG. 2G illustrates a 5-pole twist-lock inlet connector 254 (a similar female receptacle could be paralleled). FIG. 2N is a wiring diagram.

In any of these (or other) configurations, benefits include the use of cable and distribution equipment already in inventory.

Where required by electrical code and/or by the use of a power inlet connector/supply of a higher ampacity than the output connector, circuit breakers and/or other branch circuit protection devices (e.g., breaker 204 of FIG. 2N) can be provided between the inlet power connector and the output connectors.

While specific connectors have been shown for both lamp load and motor outputs other single- and/or multi-circuit connectors can be used.

While the advantages of supplying both lamp loads and chain motors from a common unit are described, some advantages attend the use of a unit that supplies only chain motors, but is supplied via a generic multi-connector like the 19-pin Soco or the various twist-locks illustrated, so that generic cabling and distribution equipment can be employed.

In another alternative, a multi-circuit-to-single-circuit-connector adapter (“break-out”) could be wired with motor connectors, which would be supplied by a Soco or other cable connected to a standard 208-volt distribution, the control inputs to each motor being connected with a handheld remote chain motor control pendant by discrete 3-pole connectors and 3-conductor cables (which would also serve for local control of a motor) and/or a multi-motor control cable.

Similarly, a unit could parallel the respective 2-phase and 3-phase output connectors while omitting the contactors and exporting the motor direction control function via a multi-motor multi-cable to another location.

Also, while the use of such a unit has been illustrated in connection with lighting fixtures, other versions and applications are possible. For example, chain motors are used to support video projectors, which themselves require power, frequently multi-phase. A unit with a suitable output power connector(s) could be employed. Another application is sound-reinforcement, where chain motors are used to support clusters of loudspeakers. In this case, the loudspeakers may employ internal power amplifiers such that they, like a moving light or video projector, require AC power. Alternatively, they may require connection to power amplifier outputs at another location—in which case a multi-connector-equipped multi-cable (including, in some cases, the same type of 19-pin Soco) is used. In such applications, relay/contactors can be used to change the mode of the multi-cable from AC power for chain motors to DC speaker outputs. The assignment of AC phases to connector poles may spread around separate circuits/groups of speakers so that accidental connection of AC power to speakers would not cause current to pass through a driver.

Dimming

As has also been described, lighting systems can require the use of large numbers of “conventional” or other fixtures of a wattage substantially less than would make efficient use of the capacity of multi-cables and dimmers. Such systems can also require the use of “moving lights” operated most efficiently at 208 volts, while most “conventional” fixtures require 120 volts.

Another aspect of the invention is designed for use in proximity to the lamp loads, and can be capable of using the same connectors and/or voltages used to supply loads like “automated” lights configured for 208 volts.

Various approaches are possible.

FIGS. 3A-3I illustrate some examples designed for such an application.

Such a unit 301 can be of a size and form factor similar to that of the previous-described unit 201.

An enclosure can be provided with one or more power inlet connectors.

The power inlet-connectors may be of single-phase or multi-phase configuration, providing 120 volts.

The power inlet connector(s) also may be of the configuration typically used to supply 208 volts to moving lights.

In one approach, the dimmers contained in the enclosure can be designed to accept an input voltage typical for a phase-to-neutral connection.

FIG. 3J illustrates an improved power distribution unit 101 that can be located at the supply end of a multi-circuit multi-cable. The improved distribution unit provides for selectively connecting the second pole of each output circuit (typically six) either to a phase (to produce a 208-volt supply for moving lights) or to neutral (to produce a 120-volt supply for conventional fixtures or for other loads).

Such a distribution unit can mount one or more single-circuit 120-volt receptacles (e.g., 124A). Such receptacles can be provided with an intermediate electrical interconnection (e.g., 119 and 121) such that the single-circuit 120-volt output connectors or a panel mounting them (e.g., panel 121) can be added to or removed from the same chassis and/or displaced to another location (for example, to another surface of the rack or roadcase mounting the distribution unit).

Such intermediate connections can be adapted with a multi-circuit connector like the “Soco” type to permit the remote location of the 120-volt connector panel and the use of a standard multi-cable between the two.

The risk of bulb damage by accidental connection of a lamp to a distribution circuit while in a 208-volt mode can be addressed by including a protective circuit or feature at the lamp or dimmer that prevents the application of the higher voltage to a lamp load. A variety of alternatives are possible including limiting dimmer output and tripping the circuit breaker on the distribution unit with a “crowbar” function. The dimmer or protective device can signal the over-voltage condition, for example, by repeatedly applying a modest voltage to the lamp load—causing it to “wink” or by communication, for example, over the data link supplying the dimmer unit with desired intensity values. The mode change at the distribution unit can also be made automatic—for example, in response to a command received from the dimmer or system administrator and/or by sensing the presence of the dimmer or a signal produced by it on the power wiring.

Another approach is to employ dimmers designed to accept a power input of in excess of 200 volts, while being capable of regulating their output to within the acceptable voltage range of a lamp load designed for substantially less—such as 120-volt (or half-wave) variants. One advantage is that such dimmers can be supplied from the same distributions and multi-cable as 208-volt moving lights, eliminating the need for separate 120-volt dimmers and cabling. Further, because the available voltage at the dimmer input is well in excess of the lamp design voltage, such a dimmer can regulate its output to voltages in excess of the available phase-to-neutral voltage, readily compensating for line losses (voltage drop) to an extent not possible with conventional dimming schemes, including to voltages in excess of the lamp's design voltage (for example, to 132 volts) for additional light output. Such a dimming approach is also international—allowing fixtures to be used on services either substantially above (200-240 volts) or below (100 volts) the design voltage of a lamp.

Many different electronic approaches are possible.

One such approach limits the maximum phase angle/on-time of a phase-control dimmer to apply an amount of energy to the lamp load comparable to normal 120-volt operation. Where the supply voltage is in excess of the lamp's design voltage (for example, a 120-volt bulb on a 208-volt phase-to-phase connected circuit, the power device(s) can pass up to one entire half-cycle and then “make up” any remaining difference to lamp design voltage by passing a fraction of another half-cycle—or can pass a fraction of both.

Other dimming approaches (for example, PWM) are possible, as is filtration or rectification/filtration of the dimmer output. There are also advantages to controlled-transition dimming in the application, including in reverse-phase control. Such power stages can be configured—and actively re-configured —to change modes to extract the maximum energy from the AC input waveform while minimizing current draw. For example, by operating different power stages in forward and reverse phase control mode so that pairs of power stages are, at most phase angles, not simultaneously in conduction (such pairing preferably further factoring in the relative load on each power stage) current demands can be minimized.

FIG.30 illustrated an approach in which a controlled transition dimmer (such as been previously disclosed in U.S. Pat. Nos. 4,633,161, 4,975,629 and others by the applicant and others) is used to apply one or more portions of the AC waveform to the lamp load. For example, at very low levels, the dimmer might operate in a simple “turn-on” or “turn-off” mode. However, as the desired lamp intensity approaches “full”, almost the full amplitude of the 208-volt alternating-current waveform will be applied to the filament, resulting in a higher instantaneous voltage than would be the case in more conventional 120-volt operation. A controlled transition dimmer can also adopt a “double-bump” output as illustrated, employing both a “turn-off” and a “turn-on” transition in the same half-cycle to limit the maximum instantaneous voltage.

FIGS. 3A-3I illustrate some of the many possible embodiments of a dimmer enclosure.

As described above, an embodiment can provide a power inlet connector in the form of the known “L6-20” or another connector type typically used for 208-volt systems.

Embodiments are illustrated that include four or six dimmer power stages. The output of such dimmer power stages can be supplied to single-circuit connectors (such as the illustrated pin and/or other connector type) and/or to a multi-circuit connector such as the “Soco” multi-connector, as is illustrated in FIG. 3E.

A four-dimmer embodiment is illustrated in FIGS. 3A-3D. The capacity of its dimmers can be sized to permit supplying at least one 2400-watt load; or two 1000-watt loads; or three 750-watt loads; or four 575-watt loads, via output connectors 280A-280D.

To make the most effective use of such dimmers, the unit could include at least a second power input (e.g., inlet connector 353B), permitting the use of more of the dimmer power stages to a higher total capacity. For example, by transferring two (e.g., 309C and 309D) of the four power stages to the second 20A input, the capacity of the unit can be doubled, for example, allowing all four power stages to supply 1000-watt loads.

There are variety of methods for connecting the power stages in such a unit to either one or more than one power inputs including external twofers; manual switches; a microswitch in the additional inlet connector (like switch 306) that transfers one or more dimmers to the second input when a female connector (e.g., 155B) is inserted into the additional inlet connector and depresses a plunger (e.g., 306P); as well as internal relays or power devices, including those responding to the presence of power on the additional input and/or to the actual loads connected to the dimmer outputs.

FIGS. 3E-3G illustrate another embodiment, in which six dimmer power stages are included, such that a single such unit can supply a six fixture group (such as a six-lamp bar) via a common multi-circuit connector 386. Where the bar's fixtures are lamped at 575 or 750 watts, two 20A circuits are sufficient; when lamped at 1000 watts, three 20A circuits are required. Three inlet connectors 253A, 253B, and 253C are illustrated, although other connectors and configurations could be employed.

Like the previously-illustrated unit supplying chain motors, a variety of both input and output configurations for such a dimming unit are possible. FIG. 3H illustrates an input configuration using the 5-wire connectors typical of power distribution systems provided by portable power generation/distribution vendors, and also found in convention centers and other facilities. This configuration allows directly supplying the units without the requirement for any additional specialized distribution or cable on the input side. With a 20A 3-phase input via inlet connector 254, three 2000-watt or six 1000-watt fixtures could be supplied, and by providing a paralleled “feed-through” receptacle 255, such that one or more additional dimmer enclosures can be “daisy-chained” on a common supply cable, use of the available power can be maximized.

Such a dimming unit can also provide for a variety of data inputs.

Because it provides an enclosure, a processor, some form of user interface and at least one data input, such a unit can also be inexpensively used as part of the overall data distribution scheme in a lighting system.

For example, the unit (or a specialized module) could accept an Ethernet input and down-convert it to multiple DMX512/“RDM” universes.

At present, digital data is generally distributed as “DMX512” by 3-pin or 5-pin “XLR” connector terminated cables and sometimes (at an intermediate stage) by “data multi-cables” that carry a number of separate such DMX512/RS-485 signals. Alternatively, cables and connectors, including ruggedized shells for standard inserts, are available for carrying higher-bandwidth Ethernet-based signals to locations where they can be used as such and/or down-converted to multiple DMX512 signals.

Preferably, a multi-conductor cable and connector can be employed that will either accommodate an Ethernet signal (with or without power supply for downstream down-converters) or multiple DMX512 signals.

The previously illustrated unit used with chain motors requires a motor control input cable. The same multi-conductor cable used to transmit either Ethernet or multiple DMX512 signals (and preferably both) could also be used for motor control. Separate runs of the same cable type could be used for the two functions, or the “mode” of the same cable could be changed between the functions when motor control is required; or the motor control function could be integrated into the same data stream as lighting control. Therefore, cable 271 could be the same cable type, if not the same cable, as cable 371. Data could be coupled between different units by jumpers (e.g., jumper 277).

Certain fixtures and fixture accessories include actuators and local electronics that, in turn, presently require separate manufacturer-specific, if not product-specific, power supplies that also have data distribution, if not control, functions. Power supply/distribution modules and/or units designed to support the products of multiple manufacturers can be provided—and also include or provide for such features as data distribution and/or dimming. FIG. 3D illustrates a power supply 386 with at least one output 387 that supplies receptacles 387A-387D, which also provide control data derived from the data input 373. As seen in FIG. 3P, a fixture accessory can be supplied from this power supply and data/control source with both power and data via a jumper 882.

The presence of a bi-directional communication node in proximity to chain motors or other actuators has additional advantages in providing a ready pathway for the transmission and return of data for various functions. For example, more sophisticated control/feedback for the “trim” of a load lifted by a chain motor relies upon feedback as to motor/load position derived from absolute and/or incremental encoders mounted in the motor. Load cells can define the present weight suspended by the motor. Present chain motor power distribution and control systems do not provide for such feedback. If the basic motor power and control functions are located in or near a unit that also includes a bi-directional communications node that can be used for other (for example, lighting, purposes) then the same node and communications pathway can readily be used for feedback from the motors to another location, such as a master control or display. Similarly, motor control commands can be communicated over the same pathway as may also be used for other functions, like lighting data. FIG. 2I includes receptacles 285A-285D, which accept feedback from the chain motors, via, for example, a jumper like 185D, as seen in FIG. 3P.

Various Figures illustrate provisions for data input and distribution. FIGS. 3B and 3F illustrate an “XLR” type DMX512 input connector 373A and control multi-cable input connector 373 that is usable for multiple DMX512 “universes” or Ethernet or other high-speed protocol. FIG. 3I illustrates the bottom surface of a dimmer or other enclosure. A user interface panel 301U includes a display 301UD and a keypad 301UK. An output data connector panel 301D includes four “XLR” type output receptacles 374A-374D. When the data multi-cable plugged to input connector 373 carries multiple DMX512 “universes”, they are adapted to the “XLR” receptacles 374A-374D, with or without buffering or opto-isolation. When the data multi-cable carries Ethernet or another high-speed protocol that is down-converted to multiple DMX512 “universes” they are made available on the same receptacles 374A-374D. Data received can be used by the dimmers enclosed as well as by other “consumers”, such as automated fixture 885, which is connected by data jumper 171C.

FIG. 3M illustrates how a unit like 201 and a dimmer enclosure like 301 can be combined in a lighting system to advantage.

FIG. 3M illustrates a single cable carrying power, that may be a multi-circuit multi-cable 151 or a multi-phase power cable that plugs to unit 201, previously described, which supplies and controls a plurality of chain motors via cables like 181D, which is terminated by motor connector 180D.

Power supplied to unit 201 is paralleled to a receptacle (like receptacle 252 of various Figures) that supplies the circuits of break-out 154. Those circuits can supply dimmer enclosures (for example, dimmer enclosure 301) and/or fixtures or other loads (for example, automated fixture 885) in any combination. Thus, both the cabling and the distribution equipment required in a lighting system is both simplified and reduced in quantity. Where separate dimmer and distribution racks and separate cabling are presently required to supply “conventional” fixtures, “automated” fixtures, and chain motors, the disclosed system results in a simplified, unified distribution scheme and a single cable type. Because chain motors share power and cabling with lighting equipment, all specialized prior art distribution equipment prior to unit 201 is eliminated. Because “conventional” and “automated” fixtures can be used interchangeably on a common cable and because dimmers are distributed in proximity to fixtures, the quantity of cabling and the complexity of the dimming/distribution scheme are drastically reduced.

Similarly, when a power distribution scheme like the previously-described 4-wire or 5-wire multi-phase system is employed, units 201 and 301 and others can be connected. FIG. 3N is an end elevation of an input module 301ID that could be employed for unit 201 and/or 301 that provides multi-phase power input (via 354); a feed-through receptacle (355) and a receptacle 352 that allows paralleling a break-out 154 to supply lighting fixtures and/or other loads. Units and dimmer enclosures can be connected and paralleled with the same power cable type and for maximum efficiency.

Temporary Powering of Electronics

Another aspect of the invention is additional and alternative methods for providing temporary power to devices in a lighting system to permit, among other purposes, displaying and setting serial addresses, modes, and other functions.

For more than two decades, entertainment lighting has employed devices including dimmers, “automated” fixtures, and remotely controlled fixture accessories that are responsive to multiplexed communications over a common serial bus. Each such device is provided with a serial address, which permits it to respond to the appropriate desired parameter values within a common serial data stream.

Such devices require a method by which the user can specify the serial address and of displaying for the user the presently selected serial address. It is also desirable that the selected address be preserved when device is powered-down, for example, for transport.

In addition, the device can be capable of various user-selectable “modes”.

In many cases in the early use of such devices, the serial address and mode(s) were determined by a mechanical switch bank with some indicating function—typically thumbwheels and “DIP” switches.

However, for a variety of reasons, many more recent devices have replaced mechanical switches that both retain and display the selected address with electronic displays (e.g., LEDs or LCDs) that perform the display function. They retain the address (and other information, such as modes) internally in non-volatile memory. An undesirable consequence is that the address and such other information cannot be viewed or changed unless and until power is supplied to the device, such that its internal power supplies can energize the necessary display and electronics. Especially in the case of fixtures and fixture accessories, the time during the setup of a lighting system at which the address and mode of a device is often most necessary to determine and change is often prior to the time at which power is provided.

As a result, two approaches are employed:

One is to “pre-address” the fixtures or accessories before arrival at the venue. This requires that at another location each, while removed from its shipping case, be connected to AC power; set to the desired address and mode; and then that both fixture and case be marked with the selected address. The fixtures and accessories are then trucked to the point of use where, despite the fact that all fixtures or accessories of a given model may otherwise be identical, the user must locate each such fixture or accessory and hang it at a specific location, so that the correctly-addressed fixture or accessory is hung in each position. Where the lighting system is being toured from venue-to-venue, each fixture must be returned to the specific roadcase with the corresponding address and location labeling so that the same fixture or accessory can be restored to the correct location at the next venue.

Another approach is to address the fixtures after they have been hung at the set-up. In this case, the user must connect each fixture with a temporary AC supply either by means of a long “cheater” extension cord or by temporarily connecting power to the cabling that will ultimately be used to power the fixtures. The user will then set each fixture's address in turn.

Either approach consumes time and labor, especially of the limited number of more-skilled production electricians or technicians responsible for the system's installation and operation.

One alternative is the previously-described unit 201 that supplies power to both chain motors and lighting fixtures at the same time.

Another alternative would be to assemble an adapter cable that is terminated on one end with a specialized chain motor connector (for example, a 7-pin Soco or 11-pin bayonet or 4-pole twist-lock) and, on the other, with a connector mating with that used on “automated” fixtures or on power supplies for accessories like color scrollers. As most chain motors are typically configured for three phases, the two phases required by many such “automated” fixtures can be obtained and fixtures tested and addressed.

Each of the previously-described approaches can have limitations. Not all applications include chain motors, and, therefore, chain motor distribution of whatever design. Further, most fixture accessories (color changers, for example) are not designed to operate directly from any line voltage, but from lower voltages as supplied by manufacturer-specific power supply units, via specific low-current cables carrying both the lower voltage and control information.

In the present alternative, a device, such as a dimmer, fixture, or fixture accessory includes an input through which low-voltage, low-current power can be accepted.

Such an input can be a relatively low-voltage, low-current input already provided for the unit's normal operation, such as the 4-pin XLR input provided on most color changers.

It can be an existing input normally used for line voltage.

And/or it can be a separate input provided for the purpose.

Such input can take the form of physical contacts or of coupler, such as an inductor.

In any such case, a portable unit, not relying on a substantially continuous connection to a fixed power source, is employed, that can supply at least relatively low current across the connection or coupling to the dimmer or other device.

It will be understood that the power demands of a dimmer, fixture, or accessory, in declining order of current demand, include that of any light source; of any fans and/or electro-mechanical actuator(s); and of the control electronics and displays. Relative to the demands of the first two, those of the control electronics and displays are modest.

Therefore, by connecting or coupling a relatively low-current power supply to the device, sufficient power can be applied to permit the user to interact with it, for functions including checking and changing addresses and modes.

In principle, such a relatively low-current power source could be incorporated in the fixture or accessory in the form of a power-storage means, such as a battery. However, by making the power source external, an economy is achieved, and the user's ability to interact with the fixture or accessory does not rely on the present state of an internal power-storage means.

In one example, a small, hand-held unit terminated in a compatible connector or coupler is used, and provides sufficient power to energize the fixture or accessory control electronics, while being insufficient for extended normal operation.

Importantly, the current demands of the fixture or accessory when connected or coupled to such a temporary power source are limited so as not to overcome the latter with non-essential demand.

In some cases, the point at which the temporary power source is connected will be at a branch in the overall internal power distribution scheme of the fixture or accessory that supplies only relevant control electronics and not high-current components like motor drives and lamps.

In others, the fixture or accessory can be made to sense—from either the input power (for example, its limited voltage) or from some other input or condition, input parameter, or signal provided by the temporary power source, that less than the normal full operating power is available, and limit its operation and current demands appropriately.

Such power could be applied at the device's normal data or power input, or, as the inputs of multiple devices are frequently paralleled by data distribution cables and/or at a shared power supply, power could be applied to multiple devices simultaneously. As data inputs are—or should be—protected against application of excessive voltages, a data input could be used, with the temporary power routed to the appropriate electronics by features prior to (or incorporated with) such protective features.

In other cases, the user could interact with the supplied fixture or accessory such that it enters a mode providing the necessary display and access to relevant parameters such as address and mode, but also inhibits the operation of higher-current components like actuators and lamps.

An additional connector or coupler could be provided specifically as an inlet connector for the temporary power source.

Most such fixtures and other devices also offer only a limited user interface, making for a less efficient address entry and mode display/selection functions. For improved user-interface and, potentially, lower current demands, such a temporary power source may employ or be employed with an interface external to the connected or coupled fixture or accessory with which the user can interact. An external unit that affords a more elaborate and efficient user interface can be used for the address/mode function and connected to the device via the same or a different means as the temporary power.

Where the devices is, for example, an accessory like a color scroller configured to rely upon an external unit, like a “power supply”, for control functions, the portable source of temporary power can provide such functions as are required to display and set addresses and modes.

The portable source of temporary power may provide, or cooperate with another unit providing, test functions, software downloads, and/or other interactions.

FIG. 3Q illustrates, as one example, a color changer 880 comprising scroll 880S, actuated by motor 880M, which is driven by motor drive 880D. Device electronics 880E interface to motor drive 880D and to a user interface 880U. In the known manner, scroller 880 accepts a low-voltage power input 880P and a data input 880Q. The power input is shared by both the control electronics 880E and user interface 880U and by the motor drive 880D. Typically, scroller 880 requires connection to a “power supply” 881 that accepts line voltage via connector 881A and data via connector 172B. “Power supply” 881 has output receptacles for jumpers like 882 that connect it with the power and data input to the device.

However, FIG. 3Q illustrates an alternative, in the form of unit 390, which includes a power source, illustrated as battery 390B, that supplies the appropriate poles of a connector mating with the power and data inlet connector of scroller 880. When plugged to scroller 880, temporary power source 390B provides sufficient voltage and current to energize control electronics 880E and user interface 880U, but is not required to supply motor drive electronics 880D, fans, or other high-current (and sometimes higher-voltage) demands.

Improved user interface 392 can also be provided with unit 390 or can be independently employed with it, connecting with scroller 880 via data input 880Q or coupled by other means/routes.

FIG. 3R illustrates another of the approaches described above: the application of power to what is nominally a data input as a source of power for certain functions.

As illustrated in FIG. 3R, scroller 880 has an internal power supply 880V and accepts line voltage via 880T. Its internal features are otherwise similar to the prior Figure.

Scroller 880 accepts data via input 880R. In this Figure, unit 391, which includes a power source 391B and an optional or cooperating or independent improved user interface 393, plugs to scroller 880 via data input 880R. Data input 880R has feature 880G that protects control electronics 880E from excessive voltages and/or currents from any cause. A path is illustrated, prior to feature 880G, that shunts voltage applied to data input 880R to the power supply rail 880L via protective feature 880J, such that voltages and currents (for example, from device 391) suitable to power control electronics 880E and user interface 880U, are allowed to pass from data input 880Q to the low voltage power supply rails. Diodes 880I and 880K illustrate features that prevent the application of power from the data input 880R to the motor drive 880D, or power from power supply 880V, once energized, to the data input.

Only two of many possible approaches are illustrated in the Figures.

Improvements To Fixtures

It has been a long-sought object of not just decades but of generations, to create lighting fixtures, suitable and practical for the application, that are capable of efficiently changing beam parameters, most notably “from any color to any color at any speed” under remote control and without undesirable intermediate effects, either visual or audible. Traditional “color changers”, including color wheels, color scrollers, and “semaphores”, allowed for changing filters, but not for mixing any desired color, and not for color-to-color transitions, and have a variety of other aesthetic and practical disadvantages.

During the 1980s, several reasonably effective methods of color-mixing were developed and introduced in the context of automated fixtures. But remotely controlled color-changing and color-mixing for “conventional” fixtures are still approached with accessory devices that are attached to the front end of the fixture where the beam exits.

For many fixture types, there would be no advantage to locating a color-changer or color-mixer internal to the fixture, as the beam there is not substantially smaller. However, in the case of fixture types in which the fixture's optics converge the beam to at least one focal point within the fixture's housing, the reduced size of the beam internally permits a similar reduction in the size of the color filters. In addition to the filter size reduction and its related benefits, the size reduction may also permit the use of different approaches (like a filter wheel or disc) that would not be practical if located at the beam exit.

In such fixtures having at least one internal focal point, an internal color-changer or color-mixer can therefore be made much smaller, much faster, much quieter, and potentially more economical, by virtue of reduced size, different operating principles, and by the reduction or elimination of those components that would be required by a larger and/or by an external device.

Referring to FIG. 4A, a light source 401, reflector 403, and a lens 407 are illustrated. Line 406 indicates the light beam, which converges internally at 406F. Some such fixtures include a “gate” or aperture 405, which can be imaged by the lens or lenses. Some such fixtures include shutters, an iris, and/or a gobo located at or near the gate and used to change beam size and shape. Lens 407 is typically moved along the optical centerline to adjust the sharpness of the “gate” aperture, of shutter blades, and of gobos for a given fixture-to-subject distance or “throw”. The “gel” typically used to change beam color or the gel scroll 413 of a typical accessory scroller 480 is attached to the forward end of the fixture housing. FIG. 4B illustrates a variable focal length or “zoom” optical system comprising lens 408 and lens 410 each of which is moveable along the centerline.

As illustrated in FIG. 4C, a color changer or, preferably, a color mixing assembly (e.g., comprising elements 415, 416, and 417) can be inserted at an appropriate location in the optical path nearer a focal point. The result can be superior performance, by virtue of the reduced size, weight, and complexity of the internal device relative to prior art external solutions, with increased speed, less audible noise, and greater reliability.

By allowing the user to change the color of light by fluidly changing the color of the beam of a single fixture, rather than requiring the user to “dim” between otherwise identical fixtures with fixed “gels” or await the travel of a scroll that may be limited to pre-selected “gel” colors, important practical and aesthetic advantages can be gained.

One of the disadvantages of prior art, external color-changers and color-mixers is their previously-described requirement for shared “power supplies” that convert line voltage to low voltage for actuators and electronics and that distribute incoming control data (if not provide control functions). In addition to their capital cost, such “power supplies” and the specialized cables required to connect them with the color-changer or color-mixer complicate the lighting system and its assembly and operation, as does the requirement to supply them with control data and constant.

It would, therefore, represent a significant advantage to reduce or eliminate the requirement for such “power supplies” and/or for separate power and data distribution.

In an ideal situation, a fixture incorporating remotely controllable color and/or in other beam parameter(s) would require no additional wiring or components over a “conventional” fixture, which requires only a two-wire-plus-earth circuit from a dimmer.

Prior related application now U.S. Pat. No. 6,211,627 B1, included in its entirity by reference, discloses methods by which this object can be achieved.

As disclosed in '627 patent, power for actuators and electronics can be derived from the same dimmer output used to vary the brightness of the incandescent lamp. It has long been known that certain dimmer power stages will “leak” some power even in an “off” condition. It is also often the case that dimmers are designed to apply a minimum voltage to their connected lamp loads even when the lamp is nominally “off”; a voltage sufficient to warm/reduce the impedance of the filament without its generating light, for purposes of reducing inrush current demands on the dimmer, speeding filament response, and extending lamp life.

Operation of actuators may require additional current that a dimmer in such an “off” condition may not supply. Various techniques are disclosed in the prior related application, including an energy-storage means (e.g., a capacitor) and an increase in the power output from the dimmer that is prevented by a power controller at the lamp end from producing an undesirable increase in light output.

The location of a color-changer or color-mixer at the typical “gel frame” position where the beam exits the fixture housing results in a relatively large beam cross-section and therefore in large filters. Such filters are generally “gels” wound in scrolls for reasons of space and require both time and torque to move. “High-speed” movement is less than instantaneous; tends to produce significant and undesirable audible noise; and accelerates wear.

By contrast, such an internal color-changer or color-mixer can employ small filter panels or discs. The amount of motive power required is dramatically less, and changes can be essentially instantaneous with no penalty in noise or wear. Such a color-changer or color-mixer can derive the energy necessary from a dimmer output. It will be understood that if the lamp is energized (making the color change visible), that, by definition, the dimmer will also supply sufficient power for the change. If, on the other hand, the lamp is not producing significant visible light, then the completion of the execution of any change in color dictated by a change in control values need not, in fact, be completed until sufficient power is also applied to the lamp to generate significant visible light. Therefore, the duration of the color change can be extended, relative to the change in control values, to make better use of limited power. Further, because the thermal mass of a lamp filament results in a time lag in response between the application of power and a corresponding light output, the increase in power supplied by a dimmer when the lamp is next “dimmed up” provides additional power to rapidly perform (or complete) the change in color before the filament generates enough light to see the effect.

The same technique can be employed for other parameters whose mechanisms require relatively little time and energy to actuate.

The prior related application also discloses methods by which control and other values can be “encoded” in the output of a dimmer or other power controller, such that the electronics and the remotely controlled mechanisms associated with a fixture or an accessory can be provided over the power wiring.

It will be understood that control values and/or power can be supplied to a fixture or accessory independently, and that a fixture that employs a local dimmer or a gas discharge source will be provided with a constant source of power.

FIG. 4E is a block diagram that illustrates three filter wheels 883A-883C, driven by actuators 883Ma-883MC and motor drives 883MA-883MC. The motor drives, electronics 883E, and optional user interface 883U are supplied by power supply(s) 883V, which can derive power from a line-voltage connection via 883T; a low-voltage input via 883P, or lamp power via 30A. Control data can be received via dedicated data input 883Q or lamp power input 30A.

Although internal color-changers and color-mixers have been used in some “automated” fixtures, importantly, the present invention employs them in a “conventional” fixture. As such, the base fixture can be comparable in size, weight, cost, and reliability to present “conventional” fixtures. In a manner analogous to the use of present outboard color-changers the user can use the color-changing or color-mixing module, at comparable cost, but with vastly superior results.

Such a base fixture will preferably be designed or adapted for the application.

FIG. 4D is a side elevation of a lighting fixture 431I that provides an opening 415O for the insertion of a color-changing or color-mixing module 420.

FIG. 4E is a block diagram . . .

Such a fixture may also incorporate other features, options, and improvements that may also be employed in other fixtures and fixture types.

To be of value, fixtures like ellipsoidials require the ability to provide different beam spreads so as to achieve the desired beam size and do so at different fixture/subject distances or “throws”. The ETC Source Four is typical, with a range from 50 degrees to 5 degrees. As illustrated in FIG. 4F, typically, changing beam spreads requires changing between various fixed focal length lenses, which requires stocking and changing entire lens barrels (e.g., barrels 432, 433, and 434). Typically, a “zoom” or variable focal length lens system is also available, with two lenses, but such “zoom” lens systems are available only in dedicated fixtures (e.g., fixture 435) and are not compatible with the wider range of fixed focal length lenses.

FIG. 4G illustrates an improvement in which the variable focal-length lens assembly 437 is packaged so as to be interchangeable with fixed focal length lenses in a common rear housing 431.

FIG. 4H is a section through one such embodiment, in which the rear lens 408H is fixedly mounted in barrel 437 and the front lens 410H is, like that in traditional “zoom” fixtures, mounted in a lens carrier 438 that is moveable along the optical centerline. It will be understood that displacement of the entire barrel 437 along the optical centerline moves the rear lens 408H along the optical centerline as in traditional “zoom” fixtures, and that displacement of the front lens is produced by its movement relative to the barrel 437.

FIG. 4I illustrates an alternative in which both lenses are moveable relative to a barrel 437A, that barrel insertable in a rear housing as an alternative to fixed focal length lenses/barrels. Control 439 for movement of the front lens can extend directly from the lens carrier through the barrel. The control 440 for the rear lens is illustrated as located forward of the lens carrier itself and can be connected by a linkage.

It is a characteristic of the optical systems of the general type illustrated in previous Figures that they extend for some distance beyond the light source and reflector. Either the lens(es) are moved within a housing of fixed length (e.g., “zoom” fixture 435 and prior art automated fixtures), or (as in the case of fixtures like the Source Four and its precursors of the last half-century, the displacement for focal adjustment of a lens barrel (e.g., 432) in which a lens is fixedly mounted, produces a modest variation in the fixture's overall length. In either case, such fixture length is far in excess of that required by some other fixture types, which has an undesirable impact on fixture shipping space requirements (especially in applications in which the fixture is shipped mounted internal to a supporting structure like a truss) as well as complicating the mechanization of such a fixture in azimuth and elevation adjustment.

FIGS. 4J and 4K illustrate an improved alternative. In this example, the fixture's optical system, comparable to that of FIG. 4A, includes a front lens 447, which is required, in use, to be located a substantial distance from the nearest other optical component in the optical path, the gate. Front lens 447 is mounted in a housing assembly 441, but one, as seen in FIG. 4K, that is capable of being displaced between one position in which lens 447 is located within the region required in use and at least one additional position in which the lens and housing assembly are retracted or telescoped into a shorter package that is optically unsuitable but far more compact. In these Figures, linear actuator 442 and linear bearing 443 cooperate to extend and retract the forward portion of the housing 441 with lens 447 relative to rear portion 444, but it will be understood that both mechanized and un-mechanized embodiments are possible, as is the application of the disclosed technique to other fixture types and to embodiments with multiple lenses. In, for example, the variable-focal-length system illustrated in FIG. 4B, both lenses could be independently displaced forward of a common rear portion or one lens could be displaced relative to an assembly carrying the other. In addition to its application in reducing the size of the fixture for transit, in a mechanized version, the length of the housing can be reduced to permit it to rotate through the fixture's yoke.

One example of an application for the disclosed “telescoping” fixture is in trusses and other structures designed to permit shipping fixtures installed. And “telescoping” housings can be used with other fixture types.

For at least a quarter-century, one method of reducing the amount of time and labor required to convert a lighting system from its shipping configuration to its “use” configuration is the “drop-frame” or “pre-rig” truss, in which the fixtures travel mounted and contained within the structure that will support them for use. Upon arrival at the point of use, some operation displaces the intermediate support on which the fixtures are mounted within the truss to move the fixtures generally exterior to the truss structure so that it does not unduly interfere with the fixtures' use. In “conventional” lighting practice, the truss structure is a rigid rectangle in section and the fixtures are mounted on a common support and manually displaced towards the exterior of the truss to reach “use” position. “Automated” fixtures are, however, many times heavier than “conventionals” and the same method is not as practical. One alternative is a specialized truss structure in which individual or mechanized supports displace the fixtures between “shipping” and “use” positions. Another folds up the sides of the truss structure to remove their potential obstructions to fixture use.

In either case, the result is the requirement for a specialized truss structure that is more complex and expensive than traditional, rigid truss structures, and one that requires both time and labor to reconfigure onsite.

Refer now to FIGS. 4L through 4S, in which are illustrated an alternative approach.

FIG. 4L is a side elevation of an improved fixture housing as installed in a typical prior art truss of generally rectangular cross-section, the truss seen in section, the fixture being in its shipping condition.

FIG. 4M is a plan or top view of the improved fixture as installed.

FIG. 4N is a reverse plan or bottom view of the improved fixture as installed, shown in its shipping condition.

FIG. 4O is a sectional view from the same perspective as FIG. 4L.

FIG. 4P is a sectional view from the same perspective as FIGS. 4M and 4N.

The improved fixture housing 450 is designed to be contained within the structure of a truss 400. The housing 450 is supported within the structure of truss 400, here by means of mounting brackets that engage truss members. Brackets like 451A and 451B hook over truss members like 400G and 400H. Brackets like 452A and 452B similarly engage truss members like 400E and 400F. In the illustrated embodiment, the brackets engage truss members so as not to extend beyond the envelope defined by the truss structure, so as not to be impacted in shipping. Both brackets and housing provide ample clearance to the main chords so as not to interfere with the use of those chords for supporting the truss and/or other loads.

The mounting brackets or other mounting method are designed to permit adjustment to varying spacing of truss members and to different truss sizes and types.

As seen in the various Figures, the improved fixture housing contains a fixture head 460, pivotally mounted to yoke arms 461 and 462, which, in turn, are mounted to slides 463 and 464, that permit their extension and retraction (and with them, that of fixture head 460) between a shipping position (illustrated in FIGS. 4L, 4N, and 4O) in which the fixture 460 is contained within both the fixture housing 450 and the envelope defined by the members of truss 400; and a “use” position (illustrated in FIGS. 4Q, 4R, and 4S) in which the fixture is extended outside of both the fixture housing 450 and the envelope defined by the members of truss 400.

Displacement between one and the other position can be manual or mechanized and, in either case, assisted by counter-balancing weights, springs, gas springs, or other means.

The various components need not be enclosed or completely enclosed as has been illustrated.

The illustrated embodiment provides for fixture adjustment in the nominal tilt axis by rotation of the fixture head 460 relative to yoke arms 461 and 462. Yoke arms 461 and 462 are illustrated as mounted to slides 463 and 464 which, in turn, are mounted to two ring bearings 465 and 466, which provide for adjustment in the nominal “pan” axis.

The disclosed fixture housing can be employed with the simplest; most economical; and most widely-owned of truss types, while achieving all the advantages of “pre-rig” design, with less time and labor required on-site as no manual change to truss configuration is necessary and the movement between “shipping” and “use” conditions can be mechanized.

The size and weight of the moveable portion of the fixture 460 can be reduced by locating components like power supplies, ballasts, and electronics in the non-moving portion.

FIG. 4T illustrates one method by which the size of a fixture head can be reduced. Color filter 472 is one of several and requires driving from its perimeter. To reduce the overall size of the fixture head 460 actuator 473 is one of those relocated to the rear of the housing and a shaft 474 supported by bearing 476 extended forwardly to drive filter 472 by means of beveled gear 475. The result is a useful reduction in housing size.

It will be understood that the telescoping fixture design previously disclosed will also be of value.

Other embodiments are possible and should not be understood as limited except by the claims.

Improved Fixture Optics and Parameter Adjustment Design

The improved lighting system of the present invention includes improvements to fixture design and to methods of varying beam parameters having many advantages.

Refer now to FIG. 5A.

In contrast to FIG. 4A, the fixture of FIG. 5A employs a compound optical element or assembly 505 (seen in frontal elevation in FIG. 5B) to divide and converge the output of a common light source 501 illustrated in reflector 503 into a plurality of separate beams (e.g., 506A and 506B) and focal points that can be further processed by compound array 507, as, in one embodiment, illustrated in FIG. 5C as employing fresnels. Like lens 407 of FIG. 4A, compound optical element 507 can be displaced along the optical centerline to adjust focus or other parameters.

The designs of the compound optical elements of these and subsequent Figures are for illustration only, and should not be understood as limited except by the claims. Lens/element type, lens/element profile, and the number, shape, and distribution of elements across a compound array can be varied to suit the application.

The number and sequence of elements and arrays can also be varied. FIG. 5D illustrates an embodiment having two forward elements 508 and 510, each of which can be moveable relative to the optical centerline, in some embodiments corresponding to the two elements of FIG. 4B, and similarly providing for variable beam size by varying focal length.

It will be seem that one advantage of the present invention is the “miniaturization” of both the optic system and of beam modifying components for it.

For example, both the length of the optical system of FIGS. 5A and 5B and the displacement required of its optical elements for focus, focal, and other adjustments are very different.

FIG. 5E illustrates the insertion of various beam-modifying elements 515-518 in the optical path.

FIG. 5F illustrates a portion of one embodiment of one such element. Due to the action of the condensing elements like 505C, the size each of the beams is reduced at the point at which it intersects the beam-modifying element (e.g., beam 506C). A common substrate 515S or a support can carry a plurality of beam-varying features (e.g., 515C and 515D) on a common assembly 515. It will be seen that displacement of the common substrate or support 515 along axis 515N between position 515P and 515Q will serve to move the beam-modifying features (e.g., 515C) from having no effect at position 515Q to having full effect at position 515P (where beam 506C intersects at point 505CC). It will also be seen that only a short, linear displacement of the substrate or support is necessary to achieve the full range of effect and that fine resolution is possible as the beam-modifying feature extends along an axis several multiples longer than the beam diameter. Beam-modifying features can comprise color filter, diffuser, or other materials or features. Multiple discrete sections can be employed as can other axes of displacement.

FIG. 5G illustrates an optical system in which the output compound arrays, are capable of imaging one or more beam-modifying elements, for example 519 and 520.

In FIG. 5H, a beam-modifying element 519 is illustrated in which “clear” circular apertures (e.g., 519C) are produced in an opaque material, whether as physical openings (for example, laser-cut, punched, or photo-etched) in a solid material, or by selective deposition or removal of an opaque material 519T applied to a clear substrate 519S. It will be understood that the individual elements of compound arrays 508 and 510 can be used to image the apertures, producing a similar beam shape. Displacement of the beam-modifying element and/or the compound arrays along the optical axis will vary the effect and compensate for “throws”. Fixed or variable parallax adjustment can be provided.

In FIG. 5I, the beam-modifying element 520 is illustrated with at least one “open” aperture (e.g., 520C) and a plurality of surrounding patterns or “gobos” (e.g., 520CA and 520CB) that can be imaged.

In FIG. 5J, a beam-modifying system serving a function equivalent to a “shutter” is illustrated. Opaque elements (e.g., 521C) are provided for each of the beams (e.g., 506C). The opaque elements each include a clear aperture (e.g., 521CO) large enough to permit unmodified passage of the beam. That aperture includes at least one flat side (e.g., 521CS). When the opaque elements are displaced along axis 521X so as to bring the flat side into each beam, the effect is of a known “shutter cut”. Provision may be made to rotate the opaque elements (e.g., by gear teeth 521CU) to rotate the angle of the “shutter cut”.

Where prior Figures have illustrated the output of plural beams, FIG. 5K illustrates the use of a compound optical array designed to converge the beams to a common focal point for use of more conventional optical and beam-modifying components.

FIG. 5L is a detail of one of the many possible embodiments of a compound optical array. In this embodiment, elements are configured as hexagonal cells (e.g., 505E) and each cell includes six triangular segments whose profile is shaped to provide the desired effect.

FIG. 5M illustrates that the improved optical systems of the present invention are equally adaptable to the use of plural light sources (e.g., lamps 501A and 501B) and reflectors (e.g., reflectors 503A and 503B).

Multi-Stage Color

As has been described, techniques that permit remotely varying the color of a fixture's light beam have long been known, both as integral to so-called “automated” lighting fixtures and as accessories employed with so-called “conventional” fixtures.

A wide variety of methods have been disclosed.

“Color-changing” is a term that can be used to describe altering beam color by moving specific color filters completely in and out of the light beam. Examples include known “color wheels”, traditional single-scroll “color scrollers”, and traditional “semaphore” color changers.

“Color-mixing” is a term that can be used to describe altering beam color by the proportional insertion in the light beam of a limited number of filters (or, in the case of additive primaries, of variable quantities of primary-colored light) to generate a far larger number of color sensations.

A popular such “color-mixing” approach is the so-called “CYM” technique as disclosed in U.S. Pat. Nos. 4,914,556 and 4,984,143. It employs filters for each of the subtractive color primaries (cyan, yellow, and magenta) to produce a wide range of color sensations.

In most embodiments, separate filters are provided for each such primary. Refer now to FIG. 5A, a view of one such filter. For simplicity of illustration, the filter and beam are displaced relative to each other in a single, linear axis 539N, although other embodiments are well-known with filters that rotate about an axis, and also in which two or more filter segments enter the beam from different directions.

The relative degree of filtration/saturation is varied by displacing the filter 540 between positions in which all (506NA), part (506NB), or none (506NC) of the light beam passes through the filter material 540M. That portion 541 with no filter material can either comprise the same substrate with no filter material applied, or no substrate at all.

Disadvantages of the approach illustrated in FIG. 5N include the requirement that filter 540 be so located (or the beam “homogenized”) in an optical system such that the saturation across the beam at the subject illuminated is substantially uniform, and also the relatively limited resolution resulting from the limited travel between full and no effect.

FIG. 50 illustrates one embodiment of an improvement disclosed in the '556 and '243 patents—a graduated transition. In the illustrated embodiment, filter material 542M is selectively applied to a substrate to produce a progressive increase in filtration between 542B and 543B. For simplicity in illustration, filter material of constant density and wedge-shaped transitions (e.g., 542N) are illustrated, although more complex patterns can be employed. Similarly, FIG. 50 illustrates another “linearly-displaced” filter although rotary and other embodiments can be employed.

Relative displacement of filter and beam between no (506OD), some (506OC), more (506B), and full (506A) effect produces the required variation in saturation. Resolution is improved and application is more flexible.

In either of these embodiments the performance of the filters determines the versatility of the color system. Achieving saturated colors requires that the filters themselves be saturated, and, therefore, that they have limited transmission. There is, however, a requirement in many applications for relatively-unsaturated “tints” or “pastels”. Color-mixing systems employing highly-saturated filters are not efficient in reproducing such “tints”, for reasons including substantial light losses in the highly-saturated filters and a limited range of adjustment.

One aspect of the present invention is an improved “multi-stage” color approach, that permits both the reproduction of saturated colors and the efficient production of subtle pastels in a color system that is comparable in simplicity and economy to the present systems.

Refer now to FIG. 5P, which illustrates one filter in one embodiment of the improved “multi-stage” color system of the present invention.

For simplicity, one filter, in linear form, is again illustrated, displaced relative to the light beam along a single axis 539P.

Prior color systems provided for the displacement of a filter (or of plural cooperating filter segments) from positions in which substantially no ray in the light beam passes through the filter material to a position in which substantially all of the rays in the light beam pass through the filter material, as well as for various intermediate positions/conditions in which some fraction of the rays pass through the filter and some do not.

In all of these prior art systems, the filter material itself is of a single given characteristic/saturation.

Refer now to FIG. 5P. Unlike such prior art systems, the present invention employs filter areas having related but different transmission characteristics on a common element. In FIG. 5P, filter material 544M is relatively saturated, where filter material 545M can be of similar color, but substantially less saturated than is filter material 554M. As in prior Figures, there is a filter portion 546 or filter position which is of substantially no effect. Like prior Figures, the filter is illustrated as being displaced linearly along axis 539P, although other configurations are possible.

Because filter material 545M is of a substantially higher transmission than filter material 544M, mid-saturation colors produced by the former are more efficient than those produced by the latter. Another effect of the illustrated embodiment and its variations is to improve the resolution of the transition between the effect of a “no effect” position 506PE and a “full saturation” position 506PA.

FIG. 5Q illustrates a variation in which the transition between the more- and the less-saturated segments is “equalized”. As filter material 544Q is of a higher saturation (or other characteristic) than filter material 545Q, “trimming back” filter material 544Q along line 544QB produces a smoother transition at the intersection 545QB between filter material 544Q and 545Q.

FIG. 5R illustrates the application of other “progressive” gradation techniques. The filter or filter array includes at least two filter materials, one (544R) less saturated and one (545R) more saturated (or differing in one or more other characteristic). As in FIG. 5O, the filter material(s) are selectively applied or removed to produce a progressive increase in average effect/saturation (e.g., wedge-shaped patterns like 544RN and 545RN). Note, at the intersection between the two filter materials, the use of different relative degrees of application/removal/density to produce a substantially comparable effect and a smoother transition. As described in the context of FIG. 5O and other embodiments, other techniques can be employed to vary average saturation.

FIG. 5S illustrates the application of techniques comparable to those illustrated in FIG. 5R to a circular, rather than a linear, filter. The illustrated filter has a “no saturation” region 546S, which can be produced by removing the filter material, if not the substrate, (for example, along line 546SB). A first portion has filter material of one characteristic 545S, progressively increasing in average saturation. A second portion has filter material of a more saturated (or other) characteristic 544S that progressively increases in average saturation to a “fully saturated” area. As in prior examples, various techniques can be employed to produce the effect of progressively increasing saturation or other characteristic. As will be apparent, such a filter wheel could be assembled from segments.

The “multi-stage” filters disclosed herein offer the deep saturates of those prior art filters required to produce saturated colors, but, having a portion of filter material substantially less saturation and/or other characteristics, have the capability of producing “tints” or “pastels” with higher efficiency and resolution.

While two “filter materials”, one having more and the other less saturation (or other characteristic) three or more materials could be used.

As will be understood, if combined in what is an essentially common filter array (whether produced on a common substrate or assembled from more than one substrate panel), the color system of the present invention can employ the same optical path location and actuators as prior-art systems, and, therefore, comes at no significant incremental cost, other than that of the filter itself.

Further, because the “less-saturated” filter material is, in effect, a “subset” of the more-saturated, that the less- and the more-saturated filter materials can be mechanically independent, located in different planes, and one such filter replace or is added to the other.

While the embodiment illustrated in the prior Figures has been that of a filter displaced linearly along one axis, it will be apparent that many other filter designs are practical. Mechanical embodiments other than linearly-displaced filters or filter wheels can be employed. It will be understood, for example, in the context of other implementations of color-mixing, such as those that insert one or more filters or “flags” into the beam from one or more sides, that a “multi-stage” approach can be employed in such embodiments.

In another alternative disclosed in U.S. Pat. No. 6,142,652, a color-mixing system has a first lens having radial segments condensing the light beam into narrow radial bands, which permit the insertion of filter material deposited on a disc in a similar pattern into the radial bands by limited rotation of the wheel/substrate about its center. FIG. 5T is a detail of one portion of one such filter disc. Three possible intersections of one of the radial bands are as 506TA-506TC, with intermediate positions possible. The “multi-stage” approach disclosed herein is employed in such a color-mixing system by application of both the more-saturated (544T) and less-saturated (545T) filter material in adjacent radial segments.

While many color-mixing systems employ three filters each capable of independent adjustment, other embodiments can be employed. It is well known that, for example, in CYM color-mixing, only two of the three subtractive primaries are required to create a color, and various applications disclose the use of color systems employing two, not three, moveable filters, each of those filters having two of the three subtractive primaries, one of the three primaries appearing on both filters. It will be apparent that the “multi-stage” approach can also be employed in such color systems.

U.S. Pat. No. 4,894,760 to the applicant discloses a color mixing system in which color filters are changed by rotating the filter array about its center and saturation is changed by displacing the array relative to the light beam, changing the proportion of the light beam passing through the filter array versus that passing around it. FIG. # illustrates a “compound color” filter wheel that is also capable of displacement in a second direction to vary saturation by varying the proportion of the light beam passing through the filter versus that passing outside of one.

Similarly, it will be understood that the “multi-stage” approach can be used in other color-changing and color-mixing systems.

Improved Gel Mounting

Fixed “gel” will continue to be used to impart color to some fixtures. Originally dyed gelatine, such materials have been supplanted by various plastic materials with color either infused in or applied to the material.

The method by which such “gels” are retained to the fixture has not, however, improved. Because such materials are flexible (and are subject to distortion and shrinkage resulting from the thermal energy in the light beam) such “gels” are mounted in a metal carrier or “gel frame”, which is then inserted into clips, tracks, or slots provided on or in the fixture housing for frame retention.

However traditional, such a method has a long list of drawbacks.

The “gel” material is typically provided in individual sheets measuring approximately 24″ on a side and must be ordered, sorted, and cut to the various sizes required by the “gel frame” dimensions of the various fixture types in use by a production—generally by hand using an ordinary paper cutting-board. Hundreds of such “cuts” of color may be needed. Generally, each such “cut” must be manually marked with its identifying color number to allow its later identification. Each “cut” must then be manual inserted into a “gel frame”. The “gel frame” sandwiches the cut color between two facing halves, which may be formed from a single, folded metal shape or from two parallel shapes that are joined together by a hinge or by mechanical fasteners (typically paper pins). Even if the frame design does not require the use of such fasteners to assemble the two halves/shapes, mechanical fasteners (such as paper pins) and/or tape may be advised or required to prevent the gel material from falling out. The gel frames must then be inserted in the appropriate fixtures either before shipping or after hanging at the venue, which may require that they be marked not only with numbers identifying the gel color used but the specific fixture in which each must be inserted.

Such metal “gel frames” have associated costs to produce and are seldom purchased by a user or a rental operation in significantly greater quantity than the number of corresponding fixtures purchased. As a result, there may be insufficient numbers of “gel frames” to permit “stuffing” a significant additional number with alternative color choices or “spares” to permit rapid replacement. Typically, replacing “gel” color onsite requires bringing the new “cuts” to the fixtures in question; removing the gel frames from the fixtures; removing the old “cut” of color and replacing it with the new; then reinserting the frame.

Metal gel frames can be heavy and can be a safety hazard if they should fall or be dropped from a height.

Modern gel materials are generally durable enough to permit their reuse for multiple productions. However, as the traditional gel frame is too expensive to permit storing used color in frames, “cuts” must be removed after a given production to permit the reuse of the frame on the next one. This requires additional labor and the process of removal can result in damage to the “gel” material, limiting its reuse. Once removed from the frame, the gel material is more difficult to handle and store, and will require at least as much labor to reinsert in a frame for a future production as would the purchase of new color.

There has been some use of gel frames made from thin cardboard in an effort to reduce frame cost and make retention of gel color for subsequent reuse more practical. Such frames are also lighter and therefore easier to handle and safer. However, they are similar in design to metal frames and not more efficient in labor to use. They have met very limited acceptance.

The preparation of gel for retention in fixtures remains a significant consumer of time and labor in the preparation of a lighting system.

The improvements disclosed are intended to reduce these time and labor requirements.

One such improvement is to employ a relatively thin and stiff material for gel frames (including, but not limited to, plastic, metal, cardboard, fibre, etc.) but which is supplied in sheet form similar in size to that in which the gel color is supplied. One such “frame sheet” will thus incorporate more than one gel frame—the quantity and layout depending upon the dimensions of the gel frame in question. All gel frames on a given “sheet” may be of the same size and type and/or different types can be mixed to make the most efficient use of the gel material.

FIG. 5V illustrates. “Frame sheet” 552 is similar in size to gel sheet 550, and provides openings (e.g., 5520) and at least indications of cutting lines (e.g., 552C).

Typical gel frames, whether metal or cardboard, sandwich the gel material between two halves of the gel frame, the improved frame (whether in sheet form or individual) can be used on one side of the gel material. The gel material and improved frame can be attached to each other by any suitable means. One such means can be stapling. Another can be stitching. Another can be an adhesive, whether pre-applied to the frame material or applied in the process of attaching the two. For example, a pressure-sensitive adhesive could be applied to the frame material that would bond to the gel material when the two were placed in contact. Another method would be the use of an adhesive that would be triggered by the application of heat—for example, by a heated press or heated rollers (like the fusing rollers in copiers) used to marry the frame and gel materials.

Such an approach allows mounting the gel material to frames on a whole-sheet, rather than individual “cut” basis. The combined gel/frame can then be sliced apart into discrete frames with dramatically less labor required than prior methods. The sheet frame material can be pre-marked or pre-scored with cutting lines for the frame edges; or can be largely pre-cut, such that only a sharp knife—using the pre-cut outlines in the frame material—is required to cut gel and frame.

The cutting process can be automated by use of a travelling knife moving over the gel/frame material or roller cutters past which the material is driven. Such a mechanism can incorporate a print head that applies codes identifying the gel material, if not the specific fixture in which the gel frame should be inserted, in human-readable and machine-readable (e.g., bar code) form, either directly in ink or via a label.

Compatible software, accepting an input from lighting database software, can determine the quantity of each gel material and of each frame material required; prompting an operator to insert the appropriate combinations of gel material and frame material and driving the marking operation.

Upon completion of its use for one production, the combined gel/frame could be readily removed and filed—including by mechanized and/or automated sorting by frame size, if not gel type (the later by use of a machine-readable code).

While an embodiment has been described in which a sheet of frame material approximately equal in size to the sheet size of gel material is employed, other alternatives are possible—the gel material, whether in sheet or roll form can be trimmed to one relevant dimension before attachment to the frame material, which may itself be in sheet or continuous roll form.

Instead of complete frames, the function of a frame can be served by individual strips of stiff material that are either pre-fabricated in the outline of the required gel frame or are attached directly to the gel material (and each other). Such frames generally being rectangular, such strips could be used to fabricate frames in almost any size. In addition to the use of a rigid material cut to length, other techniques could be employed such as the application of a liquid to the surface of the gel material that would harden to rigidity.

In the fabrication of gel materials, laser-cutting has, on occasion been used and can be used in any of these embodiments. Laser cutting also provides the possibility of marking the gel material itself and/or the frame material with identifying numbers or codes by burning through the material.

In a related area, FIG. 5W illustrates an improved tape that can be used both for labeling equipment and for holding certain non-locking connectors together. Like present self-adhesive “gaffers tape” improved tape 555, has a flexible (typically fabric) backing to which a re-usable adhesive is applied. However, in a regular pattern, sections with adhesive (e.g. 555AS and 555BS) alternate with sections (e.g., 555AT and 555BT) without adhesive. Perforations or other means to simplify tearing the tape at the boundary between one pattern and the next (e.g., perforations 555AL and 555BL) are illustrated. The section without adhesive produce a “courtesy tab” that allows for ready removal.

FIG. 5X illustrates pre-cut tape or labels produced on a backing (e.g., labels 560A, 560B, and 560C). Like the prior Figure, they may have a portion with adhesive and another without. A sheet of such labels/tapes 560 is sized to permit its use in inkjet and other printers to permit direct application of labeling data from a database program.

Improved Truss Support and Handling

FIGS. 4L-4S illustrate one method of reducing the time and labor required to convert a lighting system from its shipping to its “use” configuration. It does, however, require a specialized fixture.

Other methods are applicable to systems using present fixtures.

FIGS. 11A-11M the prior related application illustrate wheeled “legs” that support a prior art rigid truss at a height sufficient that it can be shipped with fixtures and other loads attached.

FIGS. 6A-6I illustrate an additional embodiment.

The design is based on four “columns” 601-604 of a structural shape such as rounded-corner square stock, which are maintained parallel by welding to cross-pieces 605 and 607 and diagonal 606.

The distance between the inner faces of two adjacent columns (e.g., 601 and 603) is determined by the width of the stock used for cross-pieces 605-607, which exceeds the width of the tube stock used for the “rungs” 400E and 400G of the truss supported.

The distance between the outer faces of opposite columns (e.g., 601 and 602) is less than the clearance between the inside surfaces of the main chords of the truss (e.g., 400A and 400B).

These columns 601-604 are inserted into the truss from below and straddle the “rungs” 400E and 400G on the top and bottom faces of that truss. No clamp or other attachment is required. A locking pin 626 or 627 can be inserted through pass holes in the two columns on the same side of the truss either above (e.g., pin 627) the low “rung” 400G in the bottom face of the truss, or the high rung 400E (e.g., pin 626), to prevent the leg assembly from coming off. Alternatively, a latch can be used, for example, similar to that used in extension ladders.

When landed on the leg assembly, the truss lower main chords 400C and 400D and lower “rung” 400G of the truss rest atop cross-piece 605.

The columns 601-604 distribute the weight of the truss down to two casters 628 and 629.

The casters 628 and 629 shown are plate- rather than pin-mounted, and a piece of flat plate (617 and 618) is welded to the bottom of columns 601-604 and lower cross-piece 607 to mount casters 628 and 629.

To allow the truss to be strapped to the truck walls for transit without damage to equipment hung from it that extends beyond the truss itself, the legs mount plastic bumpers 631-634. To get the proper height (and also serving as stiffening for the leg assembly) short lengths of stock 621-624 are welded to the columns for mounting them.

If, in an embodiment sized for 20.5″ truss, the “columns” are made from stock 1.5″ in width, 12×12 truss can be accommodated on the same legs, with the truss falling entirely between the two sets of columns. To prevent the leg from rotating around the low rung of the truss, fifth and sixth columns can be provided either permanently or attached that fall between the main chords of the smaller truss.

It has also been found that truss legs are easier to insert it the legs on opposite corners (e.g., 601 and 604) are trimmed down such that they engage only the low rung.

Shapes 608 and 609 can receive lengths of pipe or tube that span between two or more such truss leg sets.

The illustrated is only one of many possible embodiments.

Benefits can be achieved by the use of wheeled dollies under assembled truss sections, especially those (illustrated in in the prior related application), that allow stacking multiple sections atop each other and provide a significant space between the stacked trusses to permit stacking/shipping them with “spansets” and cables attached.

FIGS. 6J-7E illustrate several embodiments of wheeled truss dollies.

Only a few of the many possible embodiments are here illustrated.

In the Figures beginning with FIG. 6J, the truss section sits atop members 641 and 642. Casters like 655 are attached to caster plates 645 and 646, which are mounted to the underside of members 641 and 642 and atop members 643 and 644. The result is a clearance between the caster's mounting flange and its mounting hardware and the main chords of the trusses above (e.g., 400D) and below (e.g., 400AB), which permits the casters to be located outboard for increased stability. As seen in FIG. 6M and 6N, the caster wheels serve to lock the truss above into the truss below. A member (e.g., 643) can also be used to lock trusses together. The embodiment illustrated in FIGS. 6J through 6P requires no specific provision to keep the wheeled dolly attached to the truss so long as the truss's weight rests atop it. When the truss is “flown” the dolly will remain on the ground. The embodiment, however, provides a feature, in the form of locking bar 657, which inserts in shape 650 and is retained by locking pin 658, that retains the wheeled dolly on the truss.

The embodiment illustrated in FIGS. 6J-6P is assembled from standard structural shapes. FIGS. 6Q-6W illustrates an embodiment assembled from two custom shapes, for example, extrusions. FIG. 6Q illustrates a shape 659 that serves the function of the lower portion of the prior embodiment, as is apparent from FIG. 6S, an end elevation. FIG. 6R illustrates a second shape 660 that provides for attachment of the lower portion to the truss. In the illustrated embodiment, two sections of shape 660 are used. One section 660G is fixedly attached to the lower portion 559G. The second section 660H is mounted to permit movement between a first position in which the “hooks” 660HA and 660HB formed in shape 660H engage the chord of a truss, retaining the dolly to the truss, and a second position in which they can be retracted from the truss chord to permit attaching or separating the dolly to or from the truss. A compression spring 661 urges the moveable section 660H into the “engaged” position.

FIGS. 6V and 6W illustrate how the same wheeled dolly can be used with two sizes of truss, here “20.5” sections 400K and 400L and “12×12” sections 400M and 400N or combinations of the two. Accessory shape 662 locks the dolly into a section of “12×12” truss below.

FIGS. 7A through 7E illustrate a “rocking” wheel dolly having advantages where heavy loads (such as stacks of truss loaded with cable and chain motors) are rolled across rough surfaces.

The truss is retained between shapes 662-667 while resting on plate 661. Plate 661 is mounted by means of a pivot, such as hinge 682, to a lower frame including shapes 671-676, which, in turn, is castered. When approaching an irregularity in the surface on which the dolly rolls, those casters 680 on the forward side are free to “ride up” (or down) by the “rocking” action of the lower frame relative to both the upper frame and the truss.

In addition to trusses, whether with or without fixtures and other loads, there is often a need to ship large quantities of (generally steel) pipe used in building and reinforcing structures. FIGS. 7G-7H illustrate an improved “pipe rack adapter” 685, two or more of which are used with four lengths of pipe (e.g., 400P-400S) to which they clamp (e.g., with bolts 691B and 694B). As seen in the end elevations FIGS. 7G and 7H, the result is a “U-shaped” bin into which pipes can be laid. Desirably, the adapter 685 is designed to put pipes 400P-400S at the same centers as truss, such that a “pipe rack” assembled from them is dimensionally equivalent to such truss sections, and can be stacked on each other; can be stacked on truss sections: or truss sections stacked on them. FIGS. 7G and 7H differ in the lower corner reinforcement detail.

FIGS. 7IA-7K illustrate a part that addresses another present shipping problem, that of “striplights”, especially of the MR-16 type. Part 707, which can be fabricated or assembled of any of many possible materials, provides a spacer level 707S on which striplights rest and ribs 707R that separate them. As seen in FIGS. 7J and 7K, quantities of part 707 can be used to stack such striplights for shipping, and will prevent damage. While part 707 can be used independently or in other containers, the Figures demonstrate that they also allow the use of a “pipe rack” as previously disclosed. The design of a part like 707 can be varied.

FIGS. 7L-7Q illustrate an improved truss stacker, with can be fabricated or assembled from any different materials. Portion 711 separates the chords of one truss (e.g., 400V or 400W) from those of the truss above (e.g., 400T or 400U). Portions 712-715 abut the truss chords and lock the trusses in a fixed relationship to the stacker, and therefore, each other. As illustrated the stacker will engage two different truss sizes (here, “12×12” and “20.5”). While the stacker need not be fixed to the truss, means in the form of plates 711 and 722 allow retaining the stacker on a truss (plate 722 being illustrated as reversable. A stacker can ride or be retained on the top or bottom of a truss. When on the bottom, it can be used to reduce friction between the truss and the surface on which it rests to simplify movement. The parts 714 and 715 can be or have applied a low-friction material or part (e.g., a metal or nylon “glide” or the ball casters 724 and 725 illustrated).

To stack and unstack trusses safely FIGS. 7R-7T illustrate a “claw”, hung from a chain motor 895, that is lowered into the interior of a truss and then raised until it lifts the truss by the latter's upper chords. FIG. 7T illustrates a variant that lifts trusses of two different sizes.

Improvements to Truss Construction

The Figures in this section illustrate various improvements to trusses and truss construction.

In the prior application, a class of elongated structural shapes were disclosed, having a recess along one side that permit the insertion of an intersecting member which is terminated with a simple and low tolerance cut, rather than requiring coping to conform to the typically cylindrical cross-section of the prior art elongated shape. FIGS. 8A-8D illustrate. The intersecting members can be fixed using welding, bonding, or mechanical fastening.

The illustrated shape 802 allows ready construction of structures in a single plane such as “flat truss or “ladder beam”. Members intersecting a shape like 802 in other than the same plane as its recess would require coping in the prior art manner.

FIGS. 8EA-8EF illustrate that the inclusion on a bend in those intersecting members not coplanar with the recess in shape 802 bring the same advantages in fabrication to more complex structures.

FIGS. 8EG-8EL illustrate one possible simplified shape 802L that accepts intersecting members from a range of angles. Interlocking shape 802M, which is trimmed into sections that fill in between intersecting members, restores the generally circular cross-section required by many clamps and other hanging and interconnecting devices and stiffens shape 802L.

FIG. 8M is one cross-section of a “Trolley Truss” that incorporates a central structural member 805 that provides for moveable attachment of the truss to a supporting structure and loads to the truss. While many methods of fabricating such a truss are possible, the embodiment illustrated employs shape 802 for the main chords and intersecting diagonal members like 803, which join to the central member 805 and can include bolt holes 803DH for joining sections.

FIG. 8N is a cross-section at another point illustrating intersecting members parallel to the outside faces of the structure.

FIGS. 80A-80D are details of some methods by which moveable attachments can be made to the upper (805U) and lower (805L) recesses that may be formed in separate, interlocking, or a common shape. A wheeled trolley 802 is shown. Also shown are hangers 807, pairs of which can be used. Such hangers incorporate a “hook” detail 807J that engages a corresponding detail in the structural shape 805. The hook 807J of one such hanger 807 can be inserted through the opening in the elongated track formed in shape 805, as its width is less than that of the opening. When a second hanger, flipped in the opposite direction, is inserted elsewhere in the track and the two hangers are brought into alignment and fixed, for example, by the illustrated shackle also used to attach the load, the paired hangers cannot be removed—although they can, of course, be slid along the track if not under load.

FIG. 8P is a “low-profile” version. FIG. 8Q illustrates another approach in which diagonal members 803D are allowed to cross between main chords 802 on opposite corners—and members between pairs of opposite corners are slightly offset so as not to intersect (except, perhaps, for adjacent adjoining faces where they may be fixed to each other). FIG. 8P also illustrates another approach to the central member, in which elongated shapes abut 809 and 810 and are attached to the diagonals.

FIG. 8R is an end view of a truss section 400R as, for example, illustrated in the prior Figures. A separate shape 811 can be bolted or otherwise attached to the truss, and affords a variety of hanging options including a larger track 811C, several smaller tracks (e.g., 811B), and facing recesses (e.g., 811A) any and all of which can be used to hang loads (or, if attached to the top of the truss, in suspending it).

FIGS. 8SA-8TC illustrate other techniques for simplifying construction. In these cases, an extrusion or other shape 815 is formed such that it has an elongated opening 815O produced by a channel 815A whose exterior width falls within the recess 802O in the elongated structural shape 802 used for the main chords, where it is fastened. Shape 815 may have a flange that produces both additional stiffening and a bolting surface to the next section of truss, here illustrated as incorporating a nut track of the type previously disclosed in the prior related application.

In addition to joining truss sections by means of these flanges and bolts, a plate 816 may be inserted in the opening 8150 in the shape 815, which plate can be retained by pins or bolts thru both the faces of the channel 815 and the plate 816 (e.g., 816H and 816HH). When such a plate 818 is inserted in the opening of the facing shape 815 in an adjacent truss section and is fixed to it by similar bolts or pins, the sections are joined.

Only a few of the many possible embodiments are here illustrated.

Improved Methods of Joining Trusses

The Figures in this section illustrate some of the possible embodiments of parts that serve the functions in joining truss sections and similar structures that presently require specialized “spigot” fittings, hinges, and “corner cubes”.

FIG. 9AA illustrates a shape 821 that may, for example, be milled or extruded. By trimming the shape on one side or the other of vertical section 821B, interlocking male (821M) and female (821F) shapes can be created. (Separate shapes could be separately produced). The illustrated shapes can be trimmed to lengths approximately equal to the width of a given truss type—for example, 20″ for 20.5″ truss. Pass holes 821E and 821G are produced in section 821B that align with the pass holes in the truss section ends used to connect sections. Pass holes are also made through the interlocking flanges (821I in the case of male flange 821A, and 821H in the case of female flanges 821C and 821DD).

FIG. 9B illustrates a shape 822 offering additional strength.

It will be apparent that a hermaphroditic fitting can also be created with an appropriate offset between the two mating parts.

As illustrated in FIGS. 9C, 9D, and 9F, lengths of such shapes can be bolted to truss ends to form “clevis” fittings that can be quickly connected by means of a pin or locking pin 825.

FIG. 9E illustrates that inserting a pin or other fastener thru the pass holes on only one side of a truss permit using such shapes as a hinge.

FIG. 9F illustrates the use of shapes having additional flanges for increased strength.

FIGS. 9GA-9GC illustrate one of several methods by which the same or similar shape to 821 can be used to form a stiffener that locks a hinged connection at a desired angle—in this case 90 degrees. The various views illustrate how the basic shape 821 can be milled to insert in the male and female sections on the ends of two trusses as FIG. 9H. A similar part can be produced from a stack of three layers. It will be seen that two additional pass holes are provided in the male and female shapes 821M and 821F, whose purpose is to accept a stiffener without consuming a hole that might be used to attach a truss. In FIG. 9I, three truss sections are joined via the male or female adapters bolted to their ends—an additional adapter is used as a stiffener to close the fourth side. (It will be understood that four sections could be joined at right angles, and that with a slightly more complex shape or adaptor, that a fifth or sixth truss section could be joined at the intersection at right angles to the illustrated plane.)

In these Figures the parts at the top plane of the trusses are visible, it will be understood that similar parts will typically also be employed near the bottom plane.

FIGS. 9J and 9K illustrate the connection of two stiffeners to form a “gate”. FIG. 9L illustrates the use of a second “gate” closing the fourth side for added stiffness (note that the two interior pass holes on a section are spaced such that the distance between the inner holes used for a “gate” or other stiffener is the same as the distance between the outer holes so that the same parts can be used. The illustrated spacing is for a 90 degree connection, but additional holes for other angles could be provided.)

FIGS. 9MA-9ME illustrate an alternative that uses a “sandwich” of three identical plates and two identical spacers to form a male fitting on one end and a female on the other that mate with the standard adapter shape. FIG. 9N illustrates one in use. FIG. 9O illustrates how the use of the doubled adapter shape of FIG. 9B also allows doubling the number of certain stiffeners, here the “wedges”. FIG. 9Q illustrates how the approaches disclosed permit the mixing of both rigid and hinged connections. The “skinny wedge” illustrated has a lower profile to permit hinged connections at 45 degree angles. In fact, a “wedge” having a recessed “B” layer and a suitable profile along the hypotenuse of the “A” and “C” layers could accept a third truss at a rigid 45 degree or other angle.

It will also be understood that the sections of shapes like 821 or 822 used to connect truss sections in-line, in hinged, or in fixed angle connections can be mounted to truss ends oriented either vertically or horizontally.

Only a few of the many possible embodiments are here illustrated.

Improvements to Packaging

In addition to the fixtures, cabling, distribution and support equipment described, many lighting systems require roadcases or other containers for shipping this equipment to the point of use.

FIGS. 10A-10F illustrate some improvements.

In FIG. 10A, shape 831 forms a continuous, recessed, handle detail. 835A and 835B are panels forming the “skin” or surface of the roadcase or container and can be physically attached to shape 831, for example, at flanges 831A and 831H. Rounded surface 831C forms the lifting handle and surfaces 831D and 831F form a recess 831E for the fingers of the user's hand.

FIG. 10B is an alternative shape with some advantages. The basic shape 831 interlocks with a second shape, which is used for both part 832 and 833. One advantage of this and similar designs is that the exterior faces of flanges 831A and 831H can be attached to a suitable vertical corner shape 837 as illustrated in FIGS. 10D and 10E at its flange 837A with only a simple, square cut of shape 831. The two shapes, 831 and 837 can be welded, bonded, and/or mechanically fastened at the intersection of the square-cut end of shape 831 and the face 837C of corner shape 837. As seen in FIG. 10D, shapes 832 and 833 are cut square at a length less than the opening between the inner faces of the flanges 837A of corner shape 837. As illustrated in FIG. 10B mechanical fasteners can be driven through flange 832A of shape 832 and flange 831A of shape 831, locking them together, if not fixing panel 835A, if desired. The interlocking shapes of rib 831B and recess 831B lock the two together, particularly under vertical loads. The same shape and fastening detail can be used for shape 833.

FIG. 10C shows a similar detail applied to structural shape 836 at the lower edge of the roadcase or container. Flange 836A is in the same plane as flange 831H. Shape 834 can be the same used for 832 and 833. A comparable detail can be used around the top edge and/or at base/lid interfaces.

FIGS. 10F and 10G show how shape 831 can be used to lift the roadcase or container. A hook or bracket 842 is inserted in the handle recess and bears up under handle surface 631C in a manner equivalent to a human hand. Hook 842 can be attached to a lifting device. One such lifting device would attach attach hook 842 to a carrier 841 that rides vertically on a track 840. That track can be attached to a portable frame and/or to the side wall of a truck. The weight could be borne by, for example, the “E-track” installed in the truck wall or be distributed downwards by track 840 or a vertical element into the truck floor. Two or more such hooks are used, at least two such hooks being spaced apart less than the length/width of the handle shape 831 on the narrowest roadcase. Carrier 841 and therefore the hook 842 is raised and lowered by suitable electric, hydraulic, or other actuator. The carrier 841 and hook 842 are lowered to a level that the top of hook 842 is below the handle, and the roadcase pushed against the carrier 841 to place hook 842 in the position shown. When the carrier 841 is raised, the hook 842 engages handle 831 and the case is lifted. (The case will rotate slightly around the hook center and it will also bear against the carrier below the hooks.) If the handle detail 831 is designed to match the radius of the 1.9″ and 2″ OD tubing used in the construction of trusses, then the same lifting method can be used to stack and unstack trusses. The process can be made semi-automatic by the use of controls or sensors that determine the correct hook height for insertion in the handle pocket. By determining the type of load, the lifter can determine the relative distance the load must be raised and lowered to stack or unstack. A series of such lifters can be spaced along the wall of a truck and be synchronized to permit handling long loads.

These and subsequent Figures illustrate techniques useable for fabricating a variety of roadcases or containers from a few simple extrusions or otherwise formed shapes. The resulting cases are both light and strong, while offering long useable life, and ready stackability. They are applicable to cases, bins, and containers for a variety of contents and uses.

Refer now to FIGS. 10LA and 10LB. One approach to the roadcase structure is to use a generally “L-shaped” extrusion at each vertical edge of the case. The Figures shows two of the many possible variations in the profile, FIG. 10LA incorporating a stiffening detail in the corner and FIG. 10LB providing for the insertion of a bumper 853 (for example of wood, plastic, or rubber) that protects the corner and the objects it bumps into.

The four lower edges of the roadcase can be fabricated of the same or similar shape.

As seen in FIG. 10M, the lower edge extrusion is mounted with one of its flanges vertical, and preferably resting against the inner surface of one of the two vertical flanges of the corner extrusion 853, which provides several opportunities for welding, bonding, or otherwise fastening. As will be seen from this Figure, the lower edge extrusions on two adjacent sides (e.g., 852A and 852B) can be offset vertically by a distance sufficient that the bottom surface of one lower edge extrusion's horizontal flange rests on top of the upper surface of the horizontal flange of the adjacent shape. This produces a strengthening overlap 852O of the two lower edge shapes; provides edges and surfaces for mutual attachment; and simplifies the trimming of the extrusions in fabrication.

Referring to FIG. 10N, a sectional drawing, there is illustrated a top edge shape 851, which is shown in detail in FIG. 10O. This shape (which can, of course be produced in a single part or assembled from several parts, whether extruded or formed) combines several functions. It defines the top edge of the roadcase frame. It incorporates a built-in continuous handle 851H in a recess 851R. It provides a point of attachment for the side panels of the case and a recess 851L that accepts the case lid. And it provides a groove 851G that accepts the caster of a roadcase stacked above. The resulting shape is very stiff, adding to the strength of the roadcase frame.

As will be seen this shape, like the lower edge shape 852, provides surfaces that align with the corner shape 853 for fastening purposes.

Unlike many cases, bins, and containers, the strength of such a case resides primarily in its frame, so that the side panels need not be structural—and can be made of a wider range of materials and so as to be readily replaced if damaged.

By including a built-in recess 851G for the caster of a stacked roadcase, this design assures that such a case will always be ready to be stacked-upon. And unlike typical roadcases that require the weight of the stacked case be borne by the lid of the case below it, this design transmits the weight of the stacked case directly through the case frame—indeed, no lid is required.

Because the lid is not required for case stacking, it can be both non-structural and omitted when not required to protect the contents. A rigid lid 857 need be no more than a piece of wood or fiberglass. Indeed, as illustrated in FIG. 10N, a light, inexpensive, but rain-resistant cover 864 can be produced from plastic or another material by molding or simply stretching plastic film over the case top.

Although the same top edge shape could be used on all four sides, the illustrated shape extends over the interior of the case, reducing the size of the top opening, and so there will be applications where another shape is employed either for two facing sides or all four. The Figures 10QA and 10QB illustrate two such shapes, which include the recessed continuous handle and, in one version, the lid recess of the shape 851, but are both significantly narrower.

Referring to the Figures, it will be seen how the various shapes can be used to assemble roadcases and containers for many purposes, in a wide variety of sizes and proportions.

FIGS. 10K, 10UA, and 10UB illustrate that such a case makes efficient use of typical truck volume—and that other case types (e.g., 870), can also be stacked atop any such case.

Figures 10H and 10R illustrates the addition of at least two offset interior casters which make it possible to send a larger roadcase up or down a ramp otherwise too narrow. Four such additional casters allow the case to take the ramp at a right angle.

Succeeding figures illustrate additional variations.

FIG. 10S illustrates that a case, bin, or container this general construction can include diagonal braces between the various members for increased strength.

FIGS. 10TA and 10TB illustrate a simple method of providing additional reinforcement at the joints between shapes—the inclusion of a detail that engages a corner brace which, itself, could be a length of stock extrusion.

FIG. 10V is a variation in which the caster recess is offset to increase the case opening.

FIG. 10W is a similar variation on a top edge with an extrusion recess, but which uses a folding handle 869.

FIG. 10X is a variation in which the case lid has an extruded frame 872. Like the prior drawings, a recess is provided for the stacked case's casters, in this case in the lid edge extrusion. The weight of the stacked case is still transmitted efficiently into the case frame.

FIG. 10Y is another variation in which the case lid has an extruded frame.

FIG. 10Z is a section through a case adapted for shipping automated fixtures (e.g., fixture 885Z). Upper shape 851Z includes the handle and stacking details and a “shelf” 851ZS that supports the fixture's upper enclosure. The fixture can be inserted from above or from one end. (In the case of end insertion, bearings or low-friction surfaces can be provided.) The lower edge shape 852Z includes a handle detail and nut tracks used to attach casters.

FIGS. 11A and 11B is another variation of particular value for cases having relatively narrow top openings. Like the prior drawings, a recess is provided for the stacked case's casters and the weight of the stacked case is still transmitted efficiently into the case frame. A portion 876H of the shape is, however, designed to hinge open to increase the size of the top opening.

Several such shapes illustrate a built-in handle detail (which could be produced by other or additional shapes fabricated with or attached to the main edge member(s)). In the illustrated embodiments, the handle detail's lower profile is a semi-cylindrical shape approximately 2″ in a diameter—and therefore equivalent to the lower profile of the tube stock used in the main chords of most trusses. As previously described, a “J”-shaped hook/adapter with a mating profile on a lifting device would therefore engage both truss chords and roadcase handles, being useable to stack or unstack both.

The same or similar components and techniques can be used in a variety of cases, bins, containers and other shipping carrier types.

Improvements can also be made by improved packaging of the chain motors for transport such that fewer operations are required between transport and use.

The prior related disclosure includes a combined shipping case and corner cube. The next group of Figures illustrate such a unit assembled from a simple family of structural shapes.

Referring to FIG. 11C, the basic extrusion 901 is essentially an equal-length “L”, preferably with a rounded corner and radiused edges. The width of the two flanges is largely determined by the location of the truss bolting holes.

Referring to FIG. 11E, four lengths (901-904) of such extrusion form the vertical corners of the cube.

Referring to FIGS. 11F and 11G, it will be seen that the lower edges of the cube are also formed from the same extrusion—four more pieces (911-914) in two layers, whose flanges parallel to the floor (the “G” suffix”) overlap each other, where they are attached to each other as in FIG. 10M. The vertical (“F” suffix”) flanges of these four extrusion lengths (911-914) overlap the lower ends of the vertical extrusions (901-904) forming the vertical edges.

As shown in the various drawings, a pass hole for the truss bolts is provided through both overlapping flanges at each corner (for example, hole 944 where extrusions 901 and 914 overlap and hole 913 where 901 overlaps with 911). The result is that the points of connection between the cube and trusses is reinforced and the truss bolts only serve to compress the structural connections within the cube. The various extrusions at these intersections can be welded, bonded, and/or mechanically fastened together.

The “Cubase” shown is, as a corner cube, a 5-way.

The structure of the “Cubase” can be further reinforced by a variety of methods.

FIG. 11J illustrates that a second “layer” of the same or a similar extrusion (lengths 991-994) can be added to the vertical corners, fastened to the inward faces of the vertical (“F”) flanges of the lower edge extrusions (911-914) and those at the top edge.

The drawings illustrate that the various extrusion flanges define a square opening in the center of each face. As illustrated in various of the sections—notably FIG. 11I—these openings can be covered by plate or extrusion (e.g. 961-964) that serve as additional reinforcement; to close the opening for the Cubase's “case” function, and to provide for attachment of lifting handles (e.g., 969). The handles shown are spring-loaded surface-mount designs, partially recessed behind the flanges of corner extrusions 901-904. Where the infill panel is not structural, materials like fiberglass can be used and, of course, handles can be further recessed in a dish mounted to the infill panel. The mounting location of the handle side-to-side, relative to the physical center of the unit can be adjusted to the actual center-of-gravity of the assembled unit with a chain motor inside.

Other designs for the corner member (whether produced by extrusion or not) are possible. FIG. 11D illustrates a more complex shape with a stiffening detail in the corner (comparable to that in FIGS. 10LA and 10LB) to which the intersecting extrusions could also butt squarely.

The illustrated design employs a second extrusion type for its top edge. Referring FIG. 11K, this extrusion combines a flange that can be equivalent to that of the corner extrusion, with a top edge that both stiffens and finishes the top edge of the unit. As illustrated, the top edge is rounded and equivalent to the shape of the tube stock used in truss. The inward lower corner has been partially squared for a better grip and, as illustrated in FIG. 11N, to allow a latch to engage it. As seen in FIG. 11A, the ends of the top edge extrusion can be mitered and trimmed to form the corner—or, in one alternative, a simple cast fitting could be used to finish the corner and allow square-cutting the extrusion.

These figures present a simple, basic structure. There are a variety of suitable methods for accommodating the chain motor and for providing for the shipping needs of the unit.

As previously disclosed, such a unit would, ideally, accommodate a chain motor in four modes: with the load bolted to the unit and the motor internal to it; with the load bolted to the unit and the unit hung from the motor by a bridle; with the motor internal to the unit and the load hung from the unit; and with the load hung from the motor, the unit having been used as a shipping container for the motor but not employed in hanging the load.

Internal structure for attachment of a motor can be readily provided, FIG. 11M illustrates one use of additional lengths (921-924) of the corner extrusion for the purpose—other extrusions, including stock types, can be used.

For shipping purposes, a cover 864A may need to be little more than a formed plastic lid with half-round edges 864AB that fit over the top edge extrusion. Because of this overlap, such a lid would largely waterproof the unit. Wells 864AR could be formed in the lid to accommodate casters when units are stacked. A version with a rubber gland in the center through which the chain would pass (and a recess formed in the lid to keep the hook on the top-side of the lid) would provide a high degree of protection when the unit were used outdoors. Were the lid formed from clear plastic, the user could observe the motor's operation with the lid closed.

Casters can be mounted to unit either semi-permanently or be mounted to one or more caster-boards (like PA cabinets) on which the unit sits—the choice depends, in part, on how frequently the bottom (fifth-way) of the Cubase will be used for truss attachment.

The bottom of the unit can also include plastic skids and/or ball casters (e.g., 855R in FIG. 11P) to permit it to be slid more easily across a floor with casters removed. If located on the centerlines of the base and inset slightly from the edge, they would nest inside 20.5″ truss when a section was bolted to the base. They could also have value in interlocking stacked units and/or units with caster-plates.

Additional figures illustrated additional features including an alternative extrusion for the lower edge.

Various methods of stacking and interlocking multiple such units are possible, including casters or bumpers extending from the bottom of one cube that nest within the top edge extrusions of the one below.

The figures illustrate a variation in which the extrusion used for the cube's lower edges 911A has a concave rather than a convex corner, allowing it to nest in the top edge extrusions of the cube below.

Also illustrated is the use of ball casters 855R. When a cube is bolted into a run of truss and the cube is still on casters, it would, of course, be necessary to lift up the truss sections several inches in the bolting process to align their holes. Using ball casters in the locations shown does not interfere with bolting truss to the cube bottom when desired; requires lifting the trusses only about an inch to align; and still allows rolling the cube (if not the whole bolted structure) on a smooth surface.

For transport, cubes can be castered; placed on individual wheel dollies; or on larger dollies (for example, the double-wide dolly 955D illustrated in FIG. 11R). Alternatives include a four-wheel dolly; two-wheel dolly brackets that engage the unit; and individual casters either attached directly or via a bracket (including, for example, via the truss-bolt holes on the cube's bottom).

The foregoing application discloses a lighting system incorporating a number of improvements in many aspects of its construction. As each of these improvements can be applied individually, they have been described individually, although it will be understood that, advantageously, they can be combined in the same fixture, if not in the same lighting system. For example, an optimal fixture might employ the compound optical element design, multi-stage color system, and multiple lamp type/variant approaches disclosed. The lamp head incorporating these inventions, would be modular in nature and might be employed with a conventional motorized or non-motorized yoke as well as in the improved package disclosed that ships in prior art truss and displaces between “shipping” and “use” positions. That truss might be constructed using prior art methods but, advantageously, could employ the improved methods disclosed. The efficiency of the system would be further increased by use of the unified power and data distribution scheme disclosed, and that system and other components of the system would advantageously be shipped in cases and bins fabricated as disclosed.

The scope of the inventions herein should not be understood as limited, except by the claims.

What is claimed is:

1. A lighting fixture including:
a fixture head, said fixture head including
at least one lamp,
a reflector for gathering substantial luminous output of said lamp and directing it in a substantially common direction,
at least one socket for coupling power to said lamp, said socket accepting a plurality of lamps having differing power requirements and circuiting said plurality of lamps differently, so as to couple said different power to each of said lamps,
a compound optical element for receiving the luminous output from said lamp and said reflector and producing a plurality of substantially parallel beams converging to a point of reduced size,
a multi-stage color mixing system having, in each of a plurality of independent filter arrays, filter material having at least a plurality of different bandpass characteristics when applied in equal density,
said fixture head disposed in a housing, said housing capable of attachment within the envelope of a truss structure, said housing having means for displacing said fixture head between a first position in which said fixture head is contained within said envelope and a second position in which said fixture head is substantially exterior to it.
